(19) United States
(12) Patent Application Publication
(10) Pub. No.: US 2025/0300747 A1
(43) Pub. Date: Sep. 25, 2025

(54) SYSTEMS AND METHODS FOR SELECTING AND UPDATING A SET OF SOUNDING DEVICES

(71) Applicant: COGNITIVE SYSTEMS CORP., Waterloo (CA)

(72) Inventors: Chris BEG, Waterloo, Ontario (CA); Mohammad OMER, Waterloo, Ontario (CA)

(21) Appl. No.: 18/862,786

(22) PCT Filed: May 17, 2023
(86) PCT No.: PCT/IB2023/055051

§ 371 Date: Nov. 4, 2024

Related U.S. Application Data
(60) Provisional application No. 63/343,354, filed on May 18, 2022.
(60) Provisional application No. 63/344,208, filed on May 20, 2022.
(60) Provisional application No. 63/344,206, filed on May 20, 2022.
(60) Provisional application No. 63/345,622, filed on May 25, 2022.
(60) Provisional application No. 63/355,814, filed on Jun. 27, 2022.
(60) Provisional application No. 63/367,483, filed on Jun. 30, 2022.
(60) Provisional application No. 63/367,392, filed on Jun. 30, 2022.
(60) Provisional application No. 63/357,171, filed on Jun. 30, 2022.

(51) Int. Cl. H04B 17/318; H04W 24/08; H04W 48/18; H04W 76/15

(52) U.S. Cl. CPC H04B 17/318; H04W 24/08; H04W 48/18; H04W 76/15

(57) ABSTRACT

Systems and methods for Wi-Fi sensing are provided. Wi-Fi systems include a plurality of networking devices including a plurality of sensing capable devices and an access point. The Wi-Fi systems are configured for identifying a candidate set of the plurality of networking devices, establishing a plurality of candidate sensing links between the plurality of candidate devices and the access point, monitoring sensing transmissions transmitted via the plurality of candidate sensing links, identifying a sensing link set according to the sensing transmissions, establishing the plurality of selected sensing links between selected devices of the plurality of candidate devices and the access point. Wi-Fi systems are further configured for updating sensing links according to detected sensing transmissions. Wi-Fi systems may be configured to identify sensing links according to sensing sounding information and/or a plurality of time-domain channel representation information (TD-CRI) profile sets between candidate sensing links.

### TECHNICAL FIELD

The present disclosure generally relates to systems and methods for Wi-Fi sensing. In particular, the present disclosure relates to systems and methods for selecting and updating a set of sounding devices for Wi-Fi sensing.

### BACKGROUND OF THE DISCLOSURE

Motion detection systems have been used to detect movement, for example, of objects in a room or an outdoor area. In some example motion detection systems, infrared or optical sensors are used to detect movement of objects in the sensor's field of view. Motion detection systems have been used in security systems, automated control systems, and other types of systems. A WLAN sensing system (which may be referred to as a Wi-Fi sensing system) is one recent addition to motion detection systems. A Wi-Fi sensing system may be a network of Wi-Fi-enabled devices that may be a part of an IEEE 802.11 network. In an example, a Wi-Fi sensing system may be configured to detect features of interest in a sensing space. A sensing space may refer to any physical space in which the Wi-Fi sensing system may operate, such as a place of residence, a place of work, a shopping mall, a sports hall or sports stadium, a garden, or any other physical space. Features of interest may include motion of objects and motion tracking, presence detection, intrusion detection, gesture recognition, fall detection, breathing rate detection, and other applications.

### BRIEF SUMMARY OF THE DISCLOSURE

The present disclosure generally relates to systems and methods for Wi-Fi sensing. In particular, the present disclosure relates to systems and methods for selection of a set of sounding devices for Wi-Fi sensing.

Systems and methods are provided for Wi-Fi sensing. In an example embodiment, a method for Wi-Fi sensing carried out by a Wi-Fi system including a plurality of networking devices is described. The plurality of networking devices include a plurality of sensing capable devices and an access point. The method includes identifying a candidate set of the plurality of networking devices, the candidate set including a plurality of candidate devices capable of establishing transmission links with the access point. The method further includes establishing a plurality of candidate sensing links between the plurality of candidate devices and the access point. In some embodiments, the method includes monitoring sensing transmissions transmitted via the plurality of candidate sensing links. The method also includes identifying a sensing link set according to the sensing transmissions, the sensing link set including a plurality of selected sensing links selected from the plurality of candidate sensing links. In some embodiments, the method includes establishing the plurality of selected sensing links between selected devices of the plurality of candidate devices and the access point.

In some embodiments, monitoring the sensing transmissions includes determining an average power of the sensing transmissions over an analysis period.

In some embodiments, monitoring the sensing transmissions includes identifying a plurality of power variations, each power variation being characterized by a grouping of one or more candidate sensing links that display a variation in received power compared to an average power of the sensing transmissions of the respective candidate sensing links for one or more sampling instances during the analysis period.

In some embodiments, identifying the sensing link set includes identifying the plurality of sensing links according to a sensing space coverage metric.

In some embodiments, identifying the plurality of sensing links according to the sensing space coverage metric includes determining a power variation test set including a subset of power variations selected from the plurality of power variations for analysis by the sensing space coverage metric, determining a power ratio parameter for a test power variation of the power variation test set, comparing the power ratio parameter to a ratio threshold factor, and selecting, responsive to the power ratio parameter exceeding the ratio threshold factor, for inclusion in the sensing link set, a selected candidate sensing link from the grouping of the test power variation according to the candidate sensing link occurring in a largest number of groupings of the plurality of power variations.

In some embodiments, identifying the plurality of sensing links according to the sensing space coverage metric further includes determining additional power ratio parameters for additional power variations of the power variation test set, comparing the additional power ratio parameters to the ratio threshold factor for each of the additional power variations, and selecting, for each additional power variation having an additional power ratio parameter exceeding the ratio threshold factor, for inclusion in the sensing link set, an additional selected candidate sensing link from each grouping of the additional power variations according to the candidate sensing link occurring in a largest number of the plurality of power variations.

In some embodiments, determining the power variation test set includes selecting a first power variation from the plurality of power variations according to a significance ranking of the plurality of power variations and selecting a second power variation from remaining ones of the plurality of power variations having no candidate sensing links in common with the first power variation according to the significance ranking of the remaining ones of the plurality of power variations, wherein the power variation test set includes the first power variation and the second power variation.

In some embodiments, the power variation test set further includes one or more further power variations such that each candidate sensing link occurs in only one grouping from the first power variation, the second power variation, and the one or more further power variations.

In some embodiments, the significance ranking is determined according to at least one of a combo length representing a number of candidate sensing links occurring in the plurality of power variations, a variation counter representing a number of occurrences of each power variation from the plurality of power variations, and a maximum string length representing a largest number of consecutive occurrences of each power variation from the plurality of power variations.

In some embodiments, determining the power ratio parameter includes dividing a first maximum string length representing a largest number of consecutive occurrences of a test power variation from the power variation test set in the analysis period by a second maximum string length representing a largest number of consecutive occurrences in the analysis period from among single link power variations associated with each candidate sensing link of the grouping of the test power variation.

In some embodiments, determining the power ratio parameter includes dividing a first variation counter representing a number of occurrences of a test power variation from the power variation test set in the analysis period by a second variation counter representing a largest number of occurrences in the analysis period from among single link power variations associated with each candidate sensing link of the grouping of the test power variation.

The present disclosure generally relates to systems and methods for Wi-Fi sensing. In particular, the present disclosure relates to systems and methods for updating a set of sounding devices.

Systems and methods are provided for Wi-Fi sensing. In an example embodiment, a method for Wi-Fi sensing carried out by a Wi-Fi system including a plurality of networking devices is described. The plurality of networking devices include a plurality of sensing capable devices and an access point. The method includes maintaining a plurality of selected sensing links as a sensing link set between selected devices of the plurality of sensing capable devices and the access point. In some embodiments, the method further includes identifying a plurality of candidate links as a candidate link set between unselected devices of the plurality of sensing capable devices and the access point, and identifying a plurality of assessment links as an assessment link set from the candidate link set and the sensing link set. Further, in some embodiments, the method includes determining an allocation of channel resources for the plurality of assessment links, establishing the plurality of assessment links according to the allocation, and monitoring sensing transmissions on the plurality of assessment links during an analysis period. In some embodiments, the method includes identifying an updated sensing link set according to the sensing transmissions. The updated sensing link set includes a plurality of updated sensing links selected from the plurality of assessment links according to a sensing space coverage metric. The method further includes establishing the updated sensing link set.

In some embodiments, identifying the plurality of candidate links includes performing a discovery process for sensing capable devices, and including discovered sensing capable devices as candidate devices in the candidate link set representing candidate links.

In some embodiments, identifying the plurality of candidate links includes identifying trimmed links not included in the sensing link set, and including the trimmed links in the candidate link set as candidate links.

In some embodiments, determining the assessment link set includes selecting one or more of the plurality of sensing links as assessment links, and selecting a subset of the plurality of candidate links as assessment links.

In some embodiments, the method further includes determining that a metric of congestion of the access point is above a congestion threshold, and selecting one or more active sensing capable devices of the candidate devices in the candidate link set for inclusion in the assessment link set.

In some embodiments, determining the allocation of channel resources for the one or more active sensing capable devices includes in the assessment link set includes maintaining an existing allocation of resource units (RUs) for the one or more active sensing capable devices included in the assessment link set.

In some embodiments, the method further includes determining that a metric of the congestion of the access point is below a congestion threshold, and selecting one or more idle sensing capable devices of the candidate devices in the candidate link set for inclusion in the assessment link set.

In some embodiments, determining the allocation of channel resources for the one or more idle sensing capable devices included in the assessment link set includes allocating resource units (RUs) to the one or more idle sensing capable devices included in the assessment link set.

In some embodiments, the method further includes selecting one or more active sensing capable devices of the candidate devices in the candidate link set for inclusion in the assessment link set, wherein determining the allocation of channel resources for the sensing capable devices included in the assessment link set includes for the selected devices, maintaining an existing allocation of RUs, for the one or more idle sensing capable devices, allocating RUs, and for the one or more active sensing capable devices, maintaining an existing allocation of RUs.

In some embodiments, the method further includes determining a reallocation of channel resources for the plurality of assessment links according to changes in data link bandwidth on the plurality of assessment links during an analysis period.

The present disclosure generally relates to systems and methods for Wi-Fi sensing. In particular, the present disclosure relates to systems and methods for adapting a selection of a set of sounding devices according to network utilization.

Systems and methods are provided for Wi-Fi sensing. In an example embodiment, a method for Wi-Fi sensing carried out by a Wi-Fi system including a plurality of networking devices is described. The plurality of networking devices include a plurality of sensing capable devices and an access point. The method includes obtaining sensing sounding information. The sensing sounding information includes information about a plurality of power variations among a plurality of candidate sensing links between the plurality of sensing capable devices and the access point, each power variation being characterized by a grouping of one or more candidate sensing links that display a variation in received power compared to an average power of sensing transmissions of the respective candidate sensing links during one or more sampling instances of an analysis period. In some embodiments, the method further includes determining a plurality of data usage values corresponding to the plurality of candidate sensing links. The method further includes identifying a sensing link set according to a sensing space coverage metric determined from the sensing sounding information and the plurality of data usage values. The sensing link set includes a plurality of representative sensing links selected from the plurality of candidate sensing links. In some embodiments, the method includes establishing the plurality of representative sensing links between corresponding ones of the plurality of sensing capable devices and the access point.

In some embodiments, obtaining the sensing sounding information includes establishing a plurality of candidate sensing links between the plurality of sensing capable devices and the access point, monitoring sensing transmissions transmitted via the plurality of candidate sensing links during the analysis period, and identifying the plurality of power variations based on the sensing transmissions.

In some embodiments, obtaining the sensing sounding information includes accessing previously stored sensing information, and the plurality of candidate sensing links include original sensing links of a previously established sensing link set and trimmed sensing links not included in the previously established sensing link set, each power variation having at least one original sensing link.

In some embodiments, identifying the sensing link set includes identifying a congested sensing link from among the original sensing links as having a corresponding data usage value from the plurality of data usage values exceeding a congestion threshold, identifying a power variation corresponding to the congested sensing link, identifying one or more trimmed sensing links belonging to the power variation, and selecting the representative sensing link for the power variation from among the congested sensing link and the one or more trimmed sensing links.

In some embodiments, identifying the sensing link set further includes identifying additional congested sensing links from among the original sensing links according to the plurality of data usage values, identifying additional power variations corresponding to the additional congested sensing links, identifying additional sets of one or more trimmed sensing links belonging to the additional power variations, and for each additional power variation, selecting a corresponding representative sensing link from among the corresponding additional congested sensing links and the corresponding additional set of one or more trimmed sensing links.

In some embodiments, selecting the representative sensing link further includes selecting the trimmed sensing link occurring in a largest number of a plurality of groupings characterizing the plurality of power variations as the representative sensing link.

In some embodiments, selecting the representative sensing link further includes selecting the trimmed sensing link having a lowest data usage value from the plurality of data usage values as the representative sensing link.

In some embodiments, selecting the representative sensing link for the power variation from among the congested sensing link and the one or more trimmed sensing links is performed according to a switch factor defined for each of the congested sensing link and the one or more trimmed sensing links.

In some embodiments, the switch factor is defined as a number of occurrences of a link in the groupings of the plurality of power variations divided by a data usage value corresponding to the link.

In some embodiments, the power variation includes the congested sensing link and an uncongested trimmed sensing link and the representative sensing link is selected according to a highest switch factor among the congested sensing link and the uncongested trimmed sensing link.

In some embodiments, the power variation includes the congested sensing link and a plurality of uncongested trimmed sensing links and the representative sensing link is selected according to a highest switch factor among the congested sensing link and the plurality of uncongested trimmed sensing links.

In some embodiments, the representative sensing link is further selected among two uncongested trimmed sensing links having a same switch factor according to the uncongested trimmed sensing link having a lower link number.

In some embodiments, the representative sensing link for the power variation is selected to balance link loads in the sensing link set.

The present disclosure generally relates to systems and methods for Wi-Fi sensing. In particular, the present disclosure relates to systems and methods for selecting sensing devices using physical parameters of the link.

Systems and methods are provided for Wi-Fi sensing. In an example embodiment, a method for Wi-Fi sensing carried out by a Wi-Fi system including a plurality of networking devices is described. The plurality of networking devices include a plurality of sensing capable devices and an access point. The method includes identifying a candidate set of the plurality of networking devices. The candidate set includes a plurality of candidate devices capable of establishing transmission links with the access point. In some embodiments, the method further includes establishing a plurality of candidate sensing links between the plurality of candidate devices and the access point, and obtaining a plurality of time-domain channel representation information (TD-CRI) profile sets corresponding to respective ones of the plurality of candidate sensing links. Further, in some embodiments, the method includes identifying a plurality of TD-CRI spans corresponding to respective ones of the plurality of candidate sensing links according to the plurality of TD-CRI profile sets, and identifying a sensing link set according to the plurality of TD-CRI spans. The sensing link set includes a plurality of selected sensing links selected from the plurality of candidate sensing links. The method also includes establishing the plurality of selected sensing links between selected devices of the candidate devices and the access point.

In some embodiments, obtaining each TD-CRI profile of the plurality of TD-CRI profile sets for a candidate sensing link of the plurality of candidate sensing links includes obtaining a plurality of TD-CRI measurements at a plurality of sampling instances in a filter window for each candidate sensing link, and applying an averaging filter to the plurality of TD-CRI measurements to obtain each TD-CRI profile.

In some embodiments, the averaging filter includes at least one of a low pass filter and an exponential moving average filter.

In some embodiments, the method further includes removing a time shift from one or more of the plurality of TD-CRI measurements prior to applying the averaging filter.

In some embodiments, the plurality of TD-CRI profile sets includes one TD-CRI profile set for each of the plurality of candidate sensing links obtained over an analysis period, wherein each TD-CRI profile set includes a plurality of TD-CRI profiles, each corresponding to a filter window in the analysis period.

In some embodiments, each TD-CRI span of the plurality of TD-CRI spans corresponds to a TD-CRI profile set of the plurality of TD-CRI profile sets and is selected from a plurality of filter window TD-CRI spans, wherein the plurality of filter window TD-CRI spans correspond to the plurality of TD-CRI profiles of the TD-CRI profile set.

In some embodiments, selecting the plurality of TD-CRI spans includes determining each TD-CRI span as the maximum filter window TD-CRI span for each TD-CRI profile set.

In some embodiments, selecting the plurality of TD-CRI spans includes determining each TD-CRI span as an average of the plurality of filter window TD-CRI spans for each TD-CRI profile set.

In some embodiments, each filter window TD-CRI span of the plurality of filter window TD-CRI spans is obtained from a corresponding TD-CRI profile.

In some embodiments, obtaining the plurality of filter window TD-CRI spans includes identifying effective time domain pulses in the corresponding TD-CRI profile as time domain pulses having an amplitude surpassing an amplitude threshold, identifying a first index of a first effective time domain pulse having a lowest time delay of the effective time domain pulses in the corresponding TD-CRI profile, identifying a last index of a last effective time domain pulse having a greatest time delay of the effective time domain pulses in the corresponding TD-CRI profile, and defining each filter window TD-CRI span as the last index minus the first index for the corresponding TD-CRI profile.

In some embodiments, the amplitude threshold is determined for each TD-CRI profile as a percentage of a maximum amplitude of time domain pulses in the TD-CRI profile.

In some embodiments, identifying a sensing link set according to the plurality of TD-CRI spans includes identifying a plurality of power variations, each power variation being characterized by a grouping of one or more candidate sensing links that display a variation in received power compared to an average power of sensing transmissions of the respective candidate sensing links for one or more sampling instances during an analysis period, determining a power variation test set including a subset of power variations selected from the plurality of power variations, and selecting, for each power variation of the power variation test set, for inclusion in the sensing link set, a selected candidate sensing link from the grouping of the test power variation according to the candidate sensing link having a largest TD-CRI span.

Other aspects and advantages of the disclosure will become apparent from the following detailed description, taken in conjunction with the accompanying drawings, which illustrate by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a diagram showing an example wireless communication system;

FIG. 2A and FIG. 2B are diagrams showing example wireless signals communicated between wireless communication devices;

FIG. 3A and FIG. 3B are plots showing examples of channel responses computed from the wireless signals communicated between wireless communication devices in FIG. 2A and FIG. 2B;

FIG. 4A and FIG. 4B are diagrams showing example channel responses associated with motion of an object in distinct regions of a space;

FIG. 4C and FIG. 4D are plots showing the example channel responses of FIG. 4A and FIG. 4B overlaid on an example channel response associated with no motion occurring in the space;

FIG. 5 depicts an implementation of some of an architecture of a system for Wi-Fi sensing, according to some embodiments;

FIG. 6 depicts an example of a WLAN sensing procedure, according to some embodiments;

FIG. 7A depicts an example of a Sensing Measurement Setup Request frame format, according to some embodiments;

FIG. 7B illustrates an example of a Sensing Measurement Parameters element, according to some embodiments;

FIG. 7C illustrates an example of a format of a Sensing Measurement Parameters field, according to some embodiments;

FIG. 7D depicts an example of a Sensing Measurement Setup Response frame, according to some embodiments;

FIG. 8A depicts one-to-many and many-to-one aspects of an example of a WLAN sensing procedure, according to some embodiments;

FIG. 8B depicts pairwise aspects of an example of a WLAN sensing procedure, according to some embodiments;

FIG. 9 depicts a message flow of a trigger-based (TB) sensing measurement instance of a WLAN sensing procedure that consists of either NDPA sounding or TF sounding, according to some embodiments;

FIG. 10A and FIG. 10B depict examples of trigger-based (TB) sensing measurement instances, according to some embodiments;

FIG. 11A and FIG. 11B depict an example of a single TB sensing measurement instance including a polling phase, a trigger frame sounding phase, and an NDPA sounding phase, according to some embodiments;

FIG. 12 depicts a message flow of a non-TB sensing measurement instance of a WLAN sensing procedure with both uplink and downlink sounding, according to some embodiments;

FIG. 13 depicts an example of a single non-TB sensing measurement instance, according to some embodiments;

FIG. 14 depicts an example of a Public Action frame format of a Sensing Measurement Report frame and a Sensing Measurement Report field format, according to some embodiments;

FIG. 15A to FIG. 15H depict a hierarchy of fields within a sensing trigger, according to some embodiments;

FIG. 16 illustrates a representation of communication of location of selected one or more time domain pulses from a sensing receiver to a sensing algorithm using an active tone bitmap, according to some embodiments;

FIG. 17 illustrates a representation of communication of location of selected one or more time domain pulses from a sensing receiver to a sensing algorithm using a full bitmap, according to some embodiments;

FIG. 18 illustrates a representation of communication of location of selected one or more time domain pulses from a sensing receiver to a sensing algorithm using position of the selected one or more time domain pulses in full time-domain CRI (full TD-CRI), according to some embodiments;

FIG. 19 illustrates a management frame carrying sensing measurement parameters for a sensing transmission, according to some embodiments;

FIG. 20A illustrates an example of a format of a control frame and FIG. 20B illustrates a format of a sensing transmission announcement control field of the control frame, according to some embodiments;

FIG. 21A illustrates another example of a format of a control frame and FIG. 21B illustrates a format of a sensing measurement control field of the control frame, according to some embodiments;

FIG. 22 illustrates a management frame carrying a CRI transmission message, according to some embodiments;

FIG. 23 depicts an illustration of a filtered time domain CRI (filtered TD-CRI), according to some embodiments;

FIG. 24 depicts an example of a set of changed time domain pulses in a full TD-CRI, according to some embodiments;

FIG. 25 depicts another example of a set of changed time domain pulses in a full TD-CRI, according to some embodiments;

FIG. 26 depicts an example representation of an overlapping coverage area in a Wi-Fi sensing system, according to some embodiments;

FIG. 27 depicts an example of a Wi-Fi sensing system comprising a plurality of candidate devices, according to some embodiments;

FIG. 28 depicts an example representation of a plurality of links in a sensing space, according to some embodiments;

FIG. 29 depicts an example of updated sensing links established between an access point and a plurality of sensing capable devices, according to some embodiments;

FIG. 30 depicts an example representation of a plurality of links in a changed sensing space, according to some embodiments;

FIG. 31 depicts an example representation of a TD-CRI of a candidate sensing link for a sampling instance, according to some embodiments;

FIG. 32 depicts an example representation of a TD-CRI profile of a candidate sensing link, according to some embodiments;

FIG. 33 depicts a flowchart for establishing a plurality of selected sensing links between selected devices of a plurality of candidate devices and an access point, according to some embodiments; and

FIG. 34A and FIG. 34B depict a flowchart for establishing a selected candidate sensing link between a selected device of a plurality of candidate devices and an access point, according to some embodiments.

FIG. 35A and FIG. 35B depict a flowchart for establishing an updated link set, according to some embodiments; and

FIG. 36A and FIG. 36B depict another flowchart for establishing an updated link set, according to some embodiments.

FIG. 37 depicts a flowchart for establishing a plurality of representative sensing links between corresponding ones of a plurality of sensing capable devices and an access point, according to some embodiments;

FIG. 38A and FIG. 38B depict a flowchart for establishing a representative sensing link between corresponding one of a plurality of sensing capable devices and an access point, according to some embodiments; and

FIG. 39A, FIG. 39B, and FIG. 39C depict a flowchart for establishing a plurality of representative sensing links between corresponding ones of a plurality of sensing capable devices and an access point, according to some embodiments.

FIG. 40A and FIG. 40B depict a flowchart for establishing a plurality of selected sensing links between selected devices of candidate devices and an access point, according to some embodiments; and

FIG. 41A, FIG. 41B, and FIG. 41C depict another flowchart for establishing a plurality of selected sensing links between selected devices of candidate devices and an access point, according to some embodiments.

### DETAILED DESCRIPTION

Wireless sensing enables a device to obtain sensing measurements of transmission channel(s) between two or more devices. With the execution of a wireless sensing procedure, it is possible for a device to obtain sensing measurements useful for detecting and tracking changes in the environment. In some aspects of what is described herein, a wireless sensing system may be used for a variety of wireless sensing applications by processing wireless signals (e.g., radio frequency (RF) signals) transmitted through a space between wireless communication devices. Example wireless sensing applications include motion detection, which can include the following: detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications. Other examples of wireless sensing applications include object recognition, speaking recognition, keystroke detection and recognition, tamper detection, touch detection, attack detection, user authentication, driver fatigue detection, traffic monitoring, smoking detection, school violence detection, human counting, human recognition, bike localization, human queue estimation, Wi-Fi imaging, and other types of wireless sensing applications. For instance, the wireless sensing system may operate as a motion detection system to detect the existence and location of motion based on Wi-Fi signals or other types of wireless signals. As described in more detail below, a wireless sensing system may be configured to control measurement rates, wireless connections, and device participation, for example, to improve system operation or to achieve other technical advantages. The system improvements and technical advantages achieved when the wireless sensing system is used for motion detection are also achieved in examples where the wireless sensing system is used for another type of wireless sensing application.

In some example wireless sensing systems, a wireless signal includes a component (e.g., a synchronization preamble in a Wi-Fi PHY frame, or another type of component) that wireless devices can use to estimate a channel response or other channel information, and the wireless sensing system can detect motion (or another characteristic depending on the wireless sensing application) by analyzing changes in the channel information collected over time. In some examples, a wireless sensing system can operate similar to a bistatic radar system, where a Wi-Fi access point (AP) assumes the receiver role, and each Wi-Fi device (station (STA), node, or peer) connected to the AP assumes the transmitter role. The wireless sensing system may trigger a connected device to generate a transmission and produce a channel response measurement at a receiver device. This triggering process can be repeated periodically to obtain a sequence of time variant measurements. A wireless sensing algorithm may then receive the generated time-series of channel response measurements (e.g., computed by Wi-Fi receivers) as input, and through a correlation or filtering process, may then make a determination (e.g., determine if there is motion or no motion within the environment represented by the channel response, for example, based on changes or patterns in the channel estimations). In examples where the wireless sensing system detects motion, it may also be possible to identify a location of the motion within the environment based on motion detection results among a number of wireless devices.

Accordingly, wireless signals received at each of the wireless communication devices in a wireless communication network may be analyzed to determine channel information for the various communication links (between respective pairs of wireless communication devices) in the network. The channel information may be representative of a physical medium that applies a transfer function to wireless signals that traverse a space. In some instances, the channel information includes a channel response. Channel responses can characterize a physical communication path, representing the combined effect of, for example, scattering, fading, and power decay within the space between the transmitter and receiver. In some instances, the channel information includes beamforming state information (e.g., a feedback matrix, a steering matrix, channel state information, etc.) provided by a beamforming system. Beamforming is a signal processing technique often used in multi-antenna (multiple-input/multiple-output (MIMO)) radio systems for directional signal transmission or reception. Beamforming can be achieved by operating elements in an antenna array in such a way that signals at some angles experience constructive interference while others experience destructive interference.

The channel information for each of the communication links may be analyzed (e.g., by a hub device or other device in a wireless communication network, or a sensing transmitter, sensing receiver, or sensing initiator communicably coupled to the network) to, for example, detect whether motion has occurred in the space, to determine a relative location of the detected motion, or both. In some aspects, the channel information for each of the communication links may be analyzed to detect whether an object is present or absent, e.g., when no motion is detected in the space.

In some cases, a wireless sensing system can control a node measurement rate. For instance, a Wi-Fi motion system may configure variable measurement rates (e.g., channel estimation/environment measurement/sampling rates) based on criteria given by a current wireless sensing application (e.g., motion detection). In some implementations, when no motion is present or detected for a period of time, for example, the wireless sensing system can reduce the rate that the environment is measured, such that the connected device will be triggered or caused to make sensing transmissions or sensing measurements less frequently. In some implementations, when motion is present, for example, the wireless sensing system can increase the triggering rate or sensing transmissions rate or sensing measurement rate to produce a time-series of measurements with finer time resolution. Controlling a variable sensing measurement rate can allow energy conservation (through the device triggering), reduce processing (less data to correlate or filter), and improve resolution during specified times.

In some cases, a wireless sensing system can perform band steering or client steering of nodes throughout a wireless network, for example, in a Wi-Fi multi-AP or extended service set (ESS) topology, multiple coordinating wireless APs each provide a basic service set (BSS) which may occupy different frequency bands and allow devices to transparently move between from one participating AP to another (e.g., mesh). For instance, within a home mesh network, Wi-Fi devices can connect to any of the APs, but typically select one with good signal strength. The coverage footprint of the mesh APs typically overlap, often putting each device within communication range or more than one AP. If the AP supports multi-bands (e.g., 2.4 GHz and 5 GHz), the wireless sensing system may keep a device connected to the same physical AP but instruct it to use a different frequency band to obtain more diverse information to help improve the accuracy or results of the wireless sensing algorithm (e.g., motion detection algorithm). In some implementations, the wireless sensing system can change a device from being connected to one mesh AP to being connected to another mesh AP. Such device steering can be performed, for example, during wireless sensing (e.g., motion detection), based on criteria detected in a specific area to improve detection coverage, or to better localize motion within an area.

In some cases, beamforming may be performed between wireless communication devices based on some knowledge of the communication channel (e.g., through feedback properties generated by a receiver), which can be used to generate one or more steering properties (e.g., a steering matrix) that are applied by a transmitter device to shape the transmitted beam/signal in a particular direction or directions. Thus, changes to the steering or feedback properties used in the beamforming process indicate changes, which may be caused by moving objects, in the space accessed by the wireless communication system. For example, motion may be detected by substantial changes in the communication channel, e.g., as indicated by a channel response, or steering or feedback properties, or any combination thereof, over a period of time.

In some implementations, for example, a steering matrix may be generated at a transmitter device (beamformer) based on a feedback matrix provided by a receiver device (beamformee) based on channel sounding. Because the steering and feedback matrices are related to propagation characteristics of the channel, these matrices change as objects move within the channel. Changes in the channel characteristics are accordingly reflected in these matrices, and by analyzing the matrices, motion can be detected, and different characteristics of the detected motion can be determined. In some implementations, a spatial map may be generated based on one or more beamforming matrices. The spatial map may indicate a general direction of an object in a space relative to a wireless communication device. In some cases, many beamforming matrices (e.g., feedback matrices or steering matrices) may be generated to represent a multitude of directions that an object may be located relative to a wireless communication device. These many beamforming matrices may be used to generate the spatial map. The spatial map may be used to detect the presence of motion in the space or to detect a location of the detected motion.

In some instances, a motion detection system can control a variable device measurement rate in a motion detection process. For example, a feedback control system for a multi-node wireless motion detection system may adaptively change the sample rate based on environmental conditions. In some cases, such controls can improve operation of the motion detection system or provide other technical advantages. For example, the measurement rate may be controlled in a manner that optimizes or otherwise improves air-time usage versus detection ability suitable for a wide range of different environments and different motion detection applications. The measurement rate may be controlled in a manner that reduces redundant measurement data to be processed, thereby reducing processor load/power requirements. In some cases, the measurement rate is controlled in a manner that is adaptive, for instance, an adaptive sample can be controlled individually for each participating device. An adaptive sample rate can be used with a tuning control loop for different use cases, or device characteristics.

In some cases, a wireless sensing system can allow devices to dynamically indicate and communicate their wireless sensing capability or wireless sensing willingness to the wireless sensing system. For example, there may be times when a device does not want to be periodically interrupted or triggered to transmit a wireless signal that would allow the AP to produce a channel measurement. For instance, if a device is sleeping, frequently waking the device up to transmit or receive wireless sensing signals could consume resources (e.g., causing a cell phone battery to discharge faster). These and other events could make a device willing or not willing to participate in wireless sensing system operations. In some cases, a cell phone running on its battery may not want to participate, but when the cell phone is plugged into the charger, it may be willing to participate. Accordingly, if the cell phone is unplugged, it may indicate to the wireless sensing system to exclude the cell phone from participating; whereas if the cell phone is plugged in, it may indicate to the wireless sensing system to include the cell phone in wireless sensing system operations. In some cases, if a device is under load (e.g., a device streaming audio or video) or busy performing a primary function, the device may not want to participate; whereas when the same device's load is reduced and participating will not interfere with a primary function, the device may indicate to the wireless sensing system that it is willing to participate.

Example wireless sensing systems are described below in the context of motion detection (detecting motion of objects in the space, motion tracking, breathing detection, breathing monitoring, presence detection, gesture detection, gesture recognition, human detection (moving and stationary human detection), human tracking, fall detection, speed estimation, intrusion detection, walking detection, step counting, respiration rate detection, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications). However, the operation, system improvements, and technical advantages achieved when the wireless sensing system is operating as a motion detection system are also applicable in examples where the wireless sensing system is used for another type of wireless sensing application.

In various embodiments of the disclosure, non-limiting definitions of one or more terms that will be used in the description are provided below.

A term “measurement campaign” may refer to a bi-directional series of one or more sensing transmissions between a sensing receiver and a sensing transmitter that allows a series of one or more sensing measurements to be computed.

A wireless access point (WAP) or simply an access point (AP) is a networking device in a WLAN network that allows other networking devices in a WLAN network to connect to a wired network. In examples, an AP creates a wireless local area network.

A station (STA) is any device that is connected to a WLAN network and which contains 802.11 compliant MAC and PHY interface to the wireless medium. A STA may be a laptop, desktop, smartphone, or a smart appliance. A STA may be fixed, mobile or portable. A STA that does not take on the roles of an AP may be referred to as a non-AP STA.

A term “transmission opportunity (TXOP)” may refer to a negotiated interval of time during which a particular quality of service (QOS) station (e.g., a STA, an AP, or either a STA or an AP, for example in the role of a sensing initiator, a sensing responder, a sensing transmitter or a sensing receiver) may have the right to initiate a frame exchange onto a wireless medium. A QOS access category (AC) of the transmission opportunity may be requested as part of a service or session negotiation. In examples, TXOP may be a period of time for the transmission (e.g., data transmission or sensing transmission).

A term “Quality of Service (QOS) access category (AC)” may refer to an identifier for a frame which classifies a priority of transmission that the frame requires. In an example, four QOS access categories are defined namely AC_VI: Video, AC_VO: Voice, AC_BE: Best-Effort, and AC_BK: Background. Further, each QoS access category may have different TXOP parameters defined for it.

A term “short interframe space (SIFS)” may refer to a period within which a processing element (for example, a microprocessor, dedicated hardware, or any such element) within a device of a Wi-Fi sensing system is able to process data presented to it in a frame. In an example, a short interframe space may be 10 ms.

A term “PHY-layer Protocol Data Unit (PPDU)” may refer to a data unit that includes preamble and data fields. The preamble field may include transmission vector format information and the data field may include payload and higher layer headers.

A term “null data PPDU (NDP)” may refer to a PPDU that does not include a data field. In an example, a null data PPDU may be used for a sensing transmission, where a MAC header of the NDP includes information required for a sensing receiver to make a sensing measurement on the sensing transmission.

A term “transmission parameters” may refer to a set of IEEE 802.11 PHY transmitter configuration parameters which are defined as a part of transmission vector (TXVECTOR) corresponding to a specific PHY and which may be configurable for each PHY-layer PPDU transmission or each null data PPDU (NDP) transmission.

A term “resource unit (RU)” may refer to an allocation of orthogonal frequency division multiplexing (OFDM) channels which may be used to carry a modulated signal. An RU may include a variable number of carriers depending on the mode of the modem.

A term “sensing goal” may refer to a goal of a sensing activity at a time. A sensing goal is not static and may change at any time. In an example, a sensing goal may require sensing measurements of a specific type, a specific format, or a specific precision, resolution, or accuracy to be available to a sensing algorithm.

A term “sensing space” may refer to any physical space in which a Wi-Fi sensing system may operate.

A term “sensing measurement” may refer to a measurement of a state of a wireless channel between a transmitter device (for example, a sensing transmitter) and a receiver device (for example, a sensing receiver) derived from a sensing transmission. In an example, sensing measurement may also be referred to as channel response measurement.

A term “sensing algorithm” may refer to a computational algorithm that achieves a sensing goal. A sensing algorithm may be executed on any device in a Wi-Fi sensing system.

A sensing receiver is a station (STA) that receives sensing transmissions (for example, PPDUs or any other transmission including a data transmission which may be opportunistically used as a sensing transmission) sent by a sensing transmitter and performs sensing measurements as part of a WLAN sensing procedure. An AP is an example of a sensing receiver. In some examples, a STA may also be a sensing receiver.

A sensing transmitter is a station (STA) that transmits a sensing transmission (for example, PPDUs or any other transmission) used for sensing measurements (for example, channel state information) in a WLAN sensing procedure. In an example, a STA is an example of a sensing transmitter. In some examples, an AP may be a sensing transmitter for Wi-Fi sensing purposes, for example where a STA acts as a sensing receiver.

A sensing initiator is a station (STA) that initiates a WLAN sensing procedure. The role of sensing initiator may be taken on by a sensing receiver, a sensing transmitter, or a separate device which includes a sensing algorithm (for example, a remote processing device).

A sensing responder is a station (STA) that participates in a WLAN sensing procedure initiated by a sensing initiator. The role of sensing responder may be taken on by a sensing receiver, a sensing transmitter, or a separate device which includes a sensing algorithm (for example, a remote processing device). In examples, multiple sensing responders may take part in a Wi-Fi sensing session.

An algorithm agent may be a part of a sensing algorithm. In examples, the algorithm agent may discover sensing initiators which are part of a Wi-Fi sensing system. In some examples, the algorithm agent may report sensing results that are generated by the sensing algorithm and available to Wi-Fi devices.

An initiator agent may run on a device which is capable of acting as a sensing initiator. In examples, where there are multiple Wi-Fi devices in a Wi-Fi sensing system capable of acting as sensing initiator, an instance of an initiator agent may run on each of the multiple Wi-Fi devices. The initiator agent may be configured to discover one or more sensing responders with which the initiator agent may open a sensing session and details of the one or more sensing responders (e.g., whether they are associated with the sensing initiator or actively generating sensing measurements with the sensing initiator). In examples, the initiator agent may declare that its host device is capable of being a sensing initiator. The initiator agent may discover capabilities of sensing responders with which the initiator agent may open a sensing session. In an example, the initiator agent may request a report of capabilities from the sensing responder.

A responder agent may run on a device which is capable of acting as a sensing responder. In examples, where there are multiple Wi-Fi devices in a Wi-Fi sensing system capable of acting as sensing responder, an instance of a responder agent may run on each of the multiple Wi-Fi devices. The responder agent may report its presence in a Wi-Fi sensing system and may report the sensing responder's capabilities.

A term “sensing capable device” may refer to a device that is capable of participating in a sensing session. In an example, sensing capable device may be an AP or a non-AP STA. The role of sensing capable device may be taken on by a sensing receiver, a sensing transmitter, or a separate device which includes a sensing algorithm (for example, a remote processing device).

A term “sensing transmission” may refer to any transmission made from a sensing transmitter to a sensing receiver that may be used to make a sensing measurement. In an example, sensing transmission may also be referred to as wireless sensing signal or wireless signal.

A term “sensing trigger message” may refer to a message sent from a sensing initiator to a sensing transmitter to initiate or trigger one or more sensing transmissions.

A term “sensing response message” may refer to a message which is included within a sensing transmission from a sensing transmitter to a sensing receiver. A sensing transmission that includes a sensing response message may be used by a sensing receiver to perform a sensing measurement.

A term “sensing response announcement” may refer to a message that is included within a sensing transmission from a sensing transmitter to a sensing receiver that announces that a sensing response NDP will follow within a short interframe space (SIFS). An example of a sensing response announcement is an NDP announcement, or NDPA. In examples, a sensing response NDP may be transmitted using a requested transmission configuration.

A term “sensing announcement” may refer to a message that is included within a sensing transmission from a sensing transmitter to a sensing receiver that announces that a sensing NDP will follow within a short interframe space (SIFS). An example of a sensing announcement is an NDP announcement, or NDPA. In examples, a sensing NDP may be transmitted using a requested transmission configuration.

A term “sensing response NDP” or “sensing NDP” may refer to a response transmitted by a sensing transmitter and used for a sensing measurement at a sensing receiver. In examples, a sensing response NDP may be used when a requested transmission configuration is incompatible with transmission parameters required for successful non-sensing message reception. A sensing response NDP may be announced by a sensing response announcement. In an example, a sensing response NDP may be implemented with a null data PPDU. In some examples, a sensing response NDP may be implemented with a frame that does not contain any data.

A “transmission channel” may refer to a tunable channel on which the sensing receiver performs a sensing measurement and/or on which the sensing transmitter performs a sensing transmission.

A term “clear to send (CTS)” may refer to a function that may be used to let the AP know that the STA is ready (or is clear without channel conflicts) to send or receive data.

A term “link” may refer to a connection between a sensing capable device and an access point, and may be denoted as “Ln”, where “n” is defined as the link number. In an example, multiple links may be numbered by the link number as L1, L2, . . . , Ln.

A term “sensing link” may refer to a link between a sensing capable device and an access point that may be used for sensing transmissions.

A term “trimmed link” may refer to a link between a sensing capable device and access point not selected for sensing transmissions.

A term “sensing link set” may refer to a steady-state set of sensing links of a Wi-Fi system at a given point in time.

A term “candidate sensing link” may refer to a link between a sensing capable device and an access point which is not used for sensing transmissions for now but may be used for sensing transmissions later.

A term “link combo” may be defined as a set of links with substantial coverage overlap in a physical space. As a result of the coverage overlap, one link of a link combo can be used for sensing measurements.

A term “necessary link” may refer to a link that has no or minimal overlapping coverage area with other links.

A term “sampling instance” may be defined as an instance (or a small period of time) during which a receiver samples (or measures) one or more sensing transmissions from one or more links. A sampling instance may be denoted as “s”.

A term “coverage area” may refer to an area in which a motion could be detected by a sensing transmission between a sensing capable device and an access point.

A term “analysis period” may refer to a period comprising multiple sampling instances for sensing link analysis.

A term “average received power” may refer to power P0 of a link received at a receiver without any motion in a sensing space such that it will be stable as long as the topology of the sensing space does not change.

A term “power variation of a link” may be defined as a difference between received power over a sampling instance P(s) of a link and an average received power of the link, that is, p(s)=P0-P(s). If a motion impacts the received power of multiple links at the same sampling instance s, then the impacted received powers may be defined as a “power variation of a link combo”.

A “Combo or Not” parameter may be used to indicate if the power variation impacts a single link (Not) or more than one link (Combo).

A term “variation counter” may be defined as the number of occurrences of a specific power variation of a link or a link combo during all sampling instances in an analysis period.

A term “string” may refer to a power variation of a link or a link combo which occurs at consecutive sampling instances.

A term “string counter” may be defined as the number of times a power variation of a link or a link combo occurs within a string.

A term “string length” may be defined as the value of a final string counter of a string.

A term “maximum string length” may be defined as the maximum number of string lengths.

A term “in-combo counter” for a link may be defined as the number of times the link occurs in all power variations of link combos during all sampling instances in an analysis period.

A term “combo link” may be defined as any link that is a part of at least one power variation of a link combo.

A term “combo length” may be defined as the number of links in a power variation of a link combo.

A term “power variation test set” may refer to a set of power variations of link combos that are selected for analysis to determine which links are selected as sensing links.

A “sensing space coverage metric” may refer to parameters and methods used to determine which links are selected as sensing links from a power variation test set.

A term “single link power variation” may refer to power variation of a link within a link combo.

A term “data link” may refer to a link between a sensing capable device and an access point that is used for data transmissions.

A term “candidate link” may refer to a link that could be established between a sensing capable device and an access point for sensing transmissions, but which is not being used for sensing transmissions prior to the analysis period.

A term “candidate link set” may refer to a set of candidate links.

A term “assessment link” may refer to a link established between a sensing capable device and an access point which is assessed over an analysis period.

A term “assessment link set” may refer to a set of assessment links which are being evaluated to determine whether one or more of the links may be trimmed to form a sensing link set at the end of an analysis period. An assessment link set may include the sensing link set which is established when the analysis period starts.

A term “idle sensing capable device” may refer to a sensing capable device that is capable of participating in a sensing session or data session but is not currently in an active sensing or data session.

A term “channel representation information (CRI)” may refer to a collection of sensing measurements which together represent the state of the channel between two devices. Examples of CRI are channel state information (CSI) and full time-domain channel representation information (full TD-CRI).

A term “channel state information (CSI)” may refer to the properties of a communications channel which is known or measured by a technique of channel estimation.

A term “time-domain channel representation information (TD-CRI)” may be a series of complex pairs of time domain pulses which are created by performing an Inverse Fast Fourier Transform (IFFT) on CSI values, for example CSI calculated by a baseband receiver processor.

A term “sensing measurement poll” may refer to a message which is sent from the sensing transmitter to the sensing receiver to solicit the transmission of channel representation information which has been determined by the sensing receiver.

A term “reconstructed filtered time-domain channel representation information (reconstructed filtered TD-CRI)” may refer to a version of a full TD-CRI created from a filtered TD-CRI.

A term “full time-domain channel representation information (full TD-CRI)” may refer to a series of complex pairs of time domain pulses which are created by performing an inverse fast Fourier transform (IFFT) on CSI values, for example CSI calculated by a baseband receiver.

A term “filtered time-domain channel representation information (filtered TD-CRI)” may refer to a reduced series of complex pairs of time domain pulses created by applying an algorithm to a full TD-CRI. The algorithm may select some time domain pulses and reject others. The filtered TD-CRI contains information that relates a selected time domain pulse to the corresponding time domain pulse in the full TD-CRI.

A term “channel representation information transmission message” may refer to a message sent by the sensing receiver that has performed a sensing measurement on a sensing transmission, in which the sensing receiver sends CRI to a sensing initiator or the sensing algorithm manager.

A term “reconstructed CSI (R-CSI)” may refer to representation of original CSI values as measured by the baseband receiver, where R-CSI is calculated by taking original CSI values (frequency domain), performing an IFFT to translate those values into the time domain, selecting a number of time domain pulses, zeroing or nulling time domain tones that do not include a selected time domain pulse, and performing an FFT. The resulting frequency domain complex values are the R-CSI.

A term “sensing imprint” may refer to a steady state or semi-static representation of the propagation channel between the sensing receiver and the sensing transmitter in the sensing space calculated by the sensing receiver in the form of a time domain channel impulse response.

A term “delivered transmission configuration” may refer to transmission parameters applied by the sensing transmitter to a sensing transmission.

A term “requested transmission configuration” may refer to requested transmission parameters of the sensing transmitter to be used when sending a sensing transmission.

A term “imprint delta” may refer to a single dimension matrix of complex values which represent the difference between a time domain channel impulse response generated by converting a CSI measurement to the time domain using an IFFT, and a stored sensing imprint.

A term “measurement imprint delta threshold” may refer to minimum difference between a TD-CRI value and the corresponding sensing imprint value for which the sensing receiver or the sensing algorithm manager considers that there is a change in the propagation channel propagation characteristics.

A term “measurement imprint delta count” may refer to a number of times which a measurement imprint delta threshold is exceeded before the sensing receiver or the sensing algorithm manager considers that there is a change in propagation channel propagation characteristics.

A term “imprint delta derivative period” may refer to a period during which imprint delta derivatives must remain below an imprint delta derivative threshold before the sensing receiver or the sensing algorithm manager may determine that a new sensing imprint needs to be calculated.

A term “imprint delta derivative” may refer to the rate of change of the imprint delta over one or more tones and over one or more frames.

A term “imprint delta derivative threshold” may refer to a maximum value of the rate imprint delta derivative for which the sensing receiver or the sensing algorithm manager considers that there is ongoing movement or motion in the sensing space. If the imprint delta derivative drops below the imprint delta derivative threshold, the sensing receiver or the sensing algorithm manager may determine that a new sensing imprint needs to be calculated.

A term “steady-state imprint delta threshold” may refer to the maximum difference between a TD-CRI value and the corresponding sensing imprint value for which the sensing receiver or the sensing algorithm manager considers that the TD-CRI has not returned to its steady-state (i.e., a stored sensing imprint).

A term “sensing imprint average count” may refer to a number of sensing measurements which may be averaged to generate a sensing imprint.

A term “analysis period” may be defined as a period consisting of multiple sampling instances for sensing link analysis. Normally, an analysis period may be long, in examples covering an hour, a half day, a day, or longer.

A term “TD-CRI profile” is the TD-CRI at the output of a filter window.

A term “filter window” is the period of time to generate the stable TD-CRI profile. In an example, a filter window may consist of a number of TD-CRI sampling instances. For example, since CSI is generated from a 64-point FFT in the frequency domain, the filter window can be set to 64 TD-CRI sampling instances.

A term “TD-CRI profile set” is a collection of TD-CRI profiles for a link over an analysis period.

A term “phase shift” may be a difference between the actual phase of the TD-CRI without the receiver time delay and the phase of the TD-CRI with the receiver time delay. The phase shift may also be referred to as time shift.

A term “wireless local area network (WLAN) sensing session” or “Wi-Fi sensing session” may refer to a period during which objects in a physical space may be probed, detected and/or characterized. In an example, during a WLAN sensing session, several devices participate in, and thereby contribute to the generation of sensing measurements. In an example, a measurement campaign may be carried out within a WLAN sensing session.

For purposes of reading the description of the various embodiments below, the following descriptions of the sections of the specifications and their respective contents may be helpful:

Section A describes a wireless communications system, wireless transmissions and sensing measurements which may be useful for practicing embodiments described herein.

Section B describes systems and methods that are useful for a wireless sensing system configurated to send sensing transmissions and make sensing measurements.

Section C describes embodiments of systems and methods that are useful for selecting a set of sounding devices for Wi-Fi sensing.

### A. Wireless Communications System, Wireless Transmissions, and Sensing Measurements

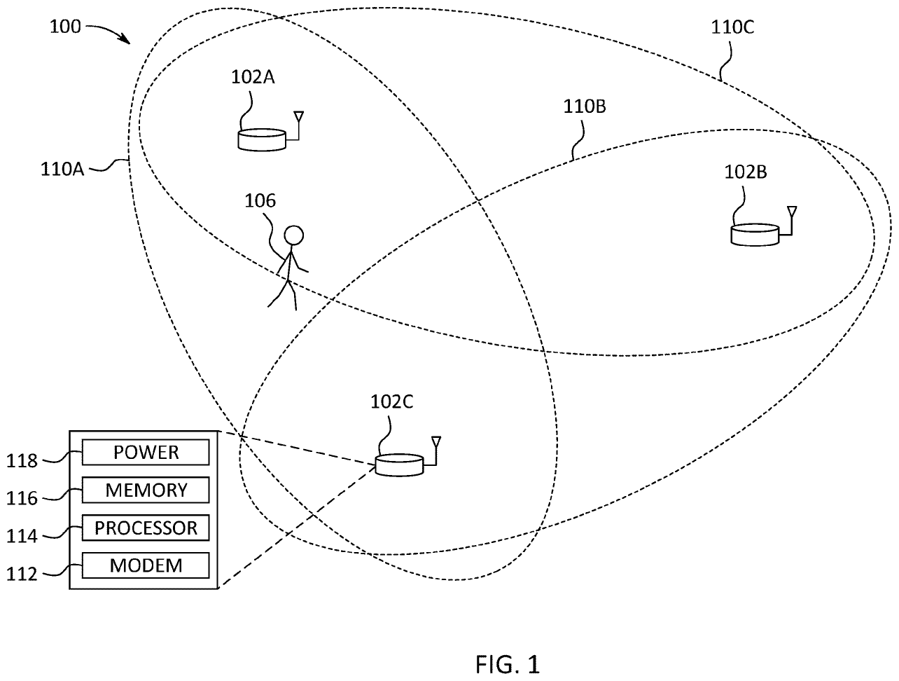

FIG. 1 illustrates wireless communication system 100. Wireless communication system 100 includes three wireless communication devices: first wireless communication device 102A, second wireless communication device 102B, and third wireless communication device 102C. Wireless communication system 100 may include additional wireless communication devices and other components (e.g., additional wireless communication devices, one or more network servers, network routers, network switches, cables, or other communication links, etc.).

Wireless communication devices 102A, 102B, 102C can operate in a wireless network, for example, according to a wireless network standard or another type of wireless communication protocol. For example, the wireless network may be configured to operate as a wireless local area network (WLAN), a personal area network (PAN), a metropolitan area network (MAN), or another type of wireless network. Examples of WLANs include networks configured to operate according to one or more of the 802.11 family of standards developed by IEEE (e.g., Wi-Fi networks), and others. Examples of PANs include networks that operate according to short-range communication standards (e.g., Bluetooth®., Near Field Communication (NFC), ZigBee), millimeter wave communications, and others.

In some implementations, wireless communication devices 102A, 102B, 102C may be configured to communicate in a cellular network, for example, according to a cellular network standard. Examples of cellular networks include networks configured according to 2G standards such as Global System for Mobile (GSM) and Enhanced Data rates for GSM Evolution (EDGE) or EGPRS; 3G standards such as code division multiple access (CDMA), wideband code division multiple access (WCDMA), Universal Mobile Telecommunications System (UMTS), and time division synchronous code division multiple access (TD-SCDMA); 4G standards such as Long-Term Evolution (LTE) and LTE-Advanced (LTE-A); 5G standards, and others.

In the example shown in FIG. 1, wireless communication devices 102A, 102B, 102C can be, or they may include standard wireless network components. For example, wireless communication devices 102A, 102B, 102C may be commercially-available Wi-Fi APs or another type of wireless access point (WAP) performing one or more operations as described herein that are embedded as instructions (e.g., software or firmware) on the modem of the WAP. In some cases, wireless communication devices 102A, 102B, 102C may be nodes of a wireless mesh network, such as, for example, a commercially-available mesh network system (e.g., Plume Wi-Fi, Google Wi-Fi, Qualcomm Wi-Fi SON, etc.). In some cases, another type of standard or conventional Wi-Fi transmitter device may be used. In some instances, one or more of wireless communication devices 102A, 102B, 102C may be implemented as WAPs in a mesh network, while other wireless communication device(s) 102A, 102B, 102C are implemented as leaf devices (e.g., mobile devices, smart devices, etc.) that access the mesh network through one of the WAPs. In some cases, one or more of wireless communication devices 102A, 102B, 102C is a mobile device (e.g., a smartphone, a smart watch, a tablet, a laptop computer, etc.), a wireless-enabled device (e.g., a smart thermostat, a Wi-Fi enabled camera, a smart TV), or another type of device that communicates in a wireless network.

Wireless communication devices 102A, 102B, 102C may be implemented without Wi-Fi components; for example, other types of standard or non-standard wireless communication may be used for motion detection. In some cases, wireless communication devices 102A, 102B, 102C can be, or they may be part of, a dedicated motion detection system. For example, the dedicated motion detection system can include a hub device and one or more beacon devices (as remote sensor devices), and wireless communication devices 102A, 102B, 102C can be either a hub device or a beacon device in the motion detection system.

As shown in FIG. 1, wireless communication device 102C includes modem 112, processor 114, memory 116, and power unit 118; any of wireless communication devices 102A, 102B, 102C in wireless communication system 100 may include the same, additional, or different components, and the components may be configured to operate as shown in FIG. 1 or in another manner. In some implementations, modem 112, processor 114, memory 116, and power unit 118 of a wireless communication device are housed together in a common housing or other assembly. In some implementations, one or more of the components of a wireless communication device can be housed separately, for example, in a separate housing or other assembly.

Modem 112 can communicate (receive, transmit, or both) wireless signals. For example, modem 112 may be configured to communicate RF signals formatted according to a wireless communication standard (e.g., Wi-Fi or Bluetooth). Modem 112 may be implemented as the example wireless network modem 112 shown in FIG. 1, or may be implemented in another manner, for example, with other types of components or subsystems. In some implementations, modem 112 includes a radio subsystem and a baseband subsystem. In some cases, the baseband subsystem and radio subsystem can be implemented on a common chip or chipset, or they may be implemented in a card or another type of assembled device. The baseband subsystem can be coupled to the radio subsystem, for example, by leads, pins, wires, or other types of connections.

In some cases, a radio subsystem in modem 112 can include one or more antennas and RF circuitry. The RF circuitry can include, for example, circuitry that filters, amplifies, or otherwise conditions analog signals, circuitry that up-converts baseband signals to RF signals, circuitry that down-converts RF signals to baseband signals, etc. Such circuitry may include, for example, filters, amplifiers, mixers, a local oscillator, etc. The radio subsystem can be configured to communicate radio frequency wireless signals on the wireless communication channels. As an example, the radio subsystem may include a radio chip, an RF front end, and one or more antennas. A radio subsystem may include additional or different components. In some implementations, the radio subsystem can be or may include the radio electronics (e.g., RF front end, radio chip, or analogous components) from a conventional modem, for example, from a Wi-Fi modem, pico base station modem, etc. In some implementations, the antenna includes multiple antennas.

In some cases, a baseband subsystem in modem 112 can include, for example, digital electronics configured to process digital baseband data. As an example, the baseband subsystem may include a baseband chip. A baseband subsystem may include additional or different components. In some cases, the baseband subsystem may include a digital signal processor (DSP) device or another type of processor device. In some cases, the baseband system includes digital processing logic to operate the radio subsystem, to communicate wireless network traffic through the radio subsystem, to detect motion based on motion detection signals received through the radio subsystem or to perform other types of processes. For instance, the baseband subsystem may include one or more chips, chipsets, or other types of devices that are configured to encode signals and deliver the encoded signals to the radio subsystem for transmission, or to identify and analyze data encoded in signals from the radio subsystem (e.g., by decoding the signals according to a wireless communication standard, by processing the signals according to a motion detection process, or otherwise).

In some instances, the radio subsystem in modem 112 receives baseband signals from the baseband subsystem, up-converts the baseband signals to RF signals, and wirelessly transmits the RF signals (e.g., through an antenna). In some instances, the radio subsystem in modem 112 wirelessly receives RF signals (e.g., through an antenna), down-converts the RF to baseband signals, and sends the baseband signals to the baseband subsystem. The signals exchanged between the radio subsystem and the baseband subsystem may be digital or analog signals. In some examples, the baseband subsystem includes conversion circuitry (e.g., a digital-to-analog converter, an analog-to-digital converter) and exchanges analog signals with the radio subsystem. In some examples, the radio subsystem includes conversion circuitry (e.g., a digital-to-analog converter, an analog-to-digital converter) and exchanges digital signals with the baseband subsystem.

In some cases, the baseband subsystem of modem 112 can communicate wireless network traffic (e.g., data packets) in the wireless communication network through the radio subsystem on one or more network traffic channels. The baseband subsystem of modem 112 may also transmit or receive (or both) signals (e.g., motion probe signals or motion detection signals) through the radio subsystem on a dedicated wireless communication channel. In some instances, the baseband subsystem generates motion probe signals for transmission, for example, to probe a space for motion. In some instances, the baseband subsystem processes received motion detection signals (signals based on motion probe signals transmitted through the space), for example, to detect motion of an object in a space.

Processor 114 can execute instructions, for example, to generate output data based on data inputs. The instructions can include programs, codes, scripts, or other types of data stored in memory. Additionally, or alternatively, the instructions can be encoded as pre-programmed or re-programmable logic circuits, logic gates, or other types of hardware or firmware components. Processor 114 may be or include a general-purpose microprocessor, as a specialized co-processor or another type of data processing apparatus. In some cases, processor 114 performs high level operation of the wireless communication device 102C. For example, processor 114 may be configured to execute or interpret software, scripts, programs, functions, executables, or other instructions stored in memory 116. In some implementations, processor 114 may be included in modem 112.

Memory 116 can include computer-readable storage media, for example, a volatile memory device, a non-volatile memory device, or both. Memory 116 can include one or more read-only memory devices, random-access memory devices, buffer memory devices, or a combination of these and other types of memory devices. In some instances, one or more components of the memory can be integrated or otherwise associated with another component of wireless communication device 102C. Memory 116 may store instructions that are executable by processor 114. For example, the instructions may include instructions for time-aligning signals using an interference buffer and a motion detection buffer, such as through one or more of the operations of the example processes herein disclosed.

Power unit 118 provides power to the other components of wireless communication device 102C. For example, the other components may operate based on electrical power provided by power unit 118 through a voltage bus or other connection. In some implementations, power unit 118 includes a battery or a battery system, for example, a rechargeable battery. In some implementations, power unit 118 includes an adapter (e.g., an alternating current (AC) adapter) that receives an external power signal (from an external source) and coverts the external power signal to an internal power signal conditioned for a component of wireless communication device 102C. Power unit 118 may include other components or operate in another manner.

In the example shown in FIG. 1, wireless communication devices 102A, 102B transmit wireless signals (e.g., according to a wireless network standard, a motion detection protocol, or otherwise). For instance, wireless communication devices 102A, 102B may broadcast wireless motion probe signals (e.g., reference signals, beacon signals, status signals, etc.), or they may send wireless signals addressed to other devices (e.g., a user equipment, a client device, a server, etc.), and the other devices (not shown) as well as wireless communication device 102C may receive the wireless signals transmitted by wireless communication devices 102A, 102B. In some cases, the wireless signals transmitted by wireless communication devices 102A, 102B are repeated periodically, for example, according to a wireless communication standard or otherwise.

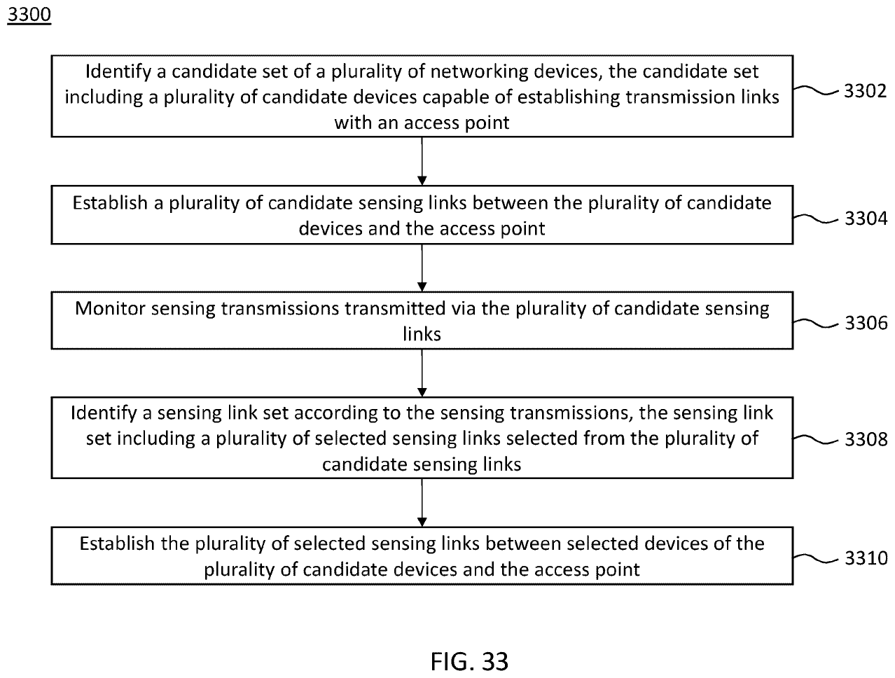

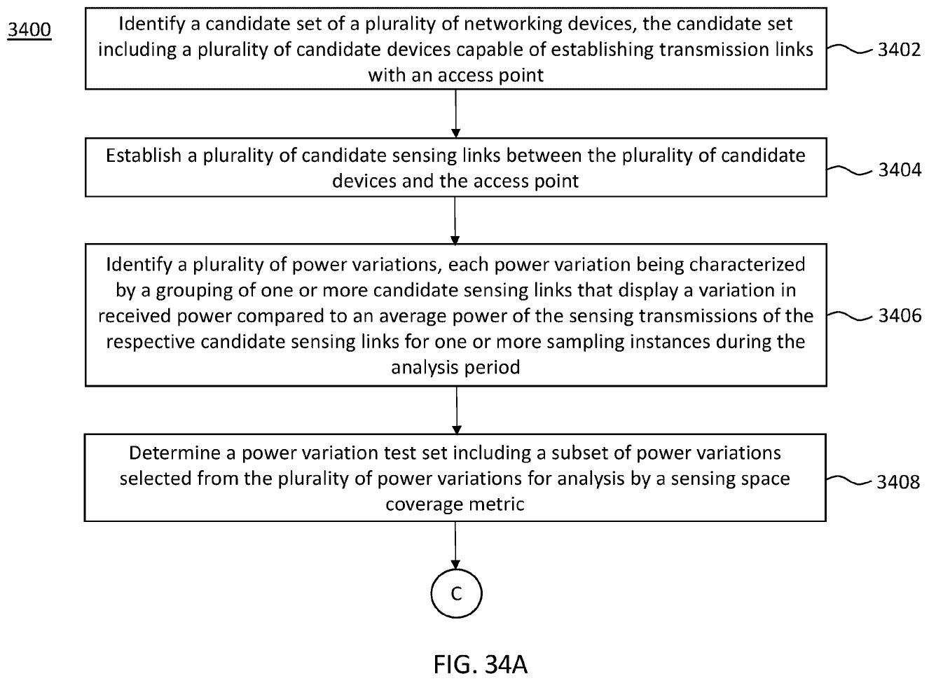

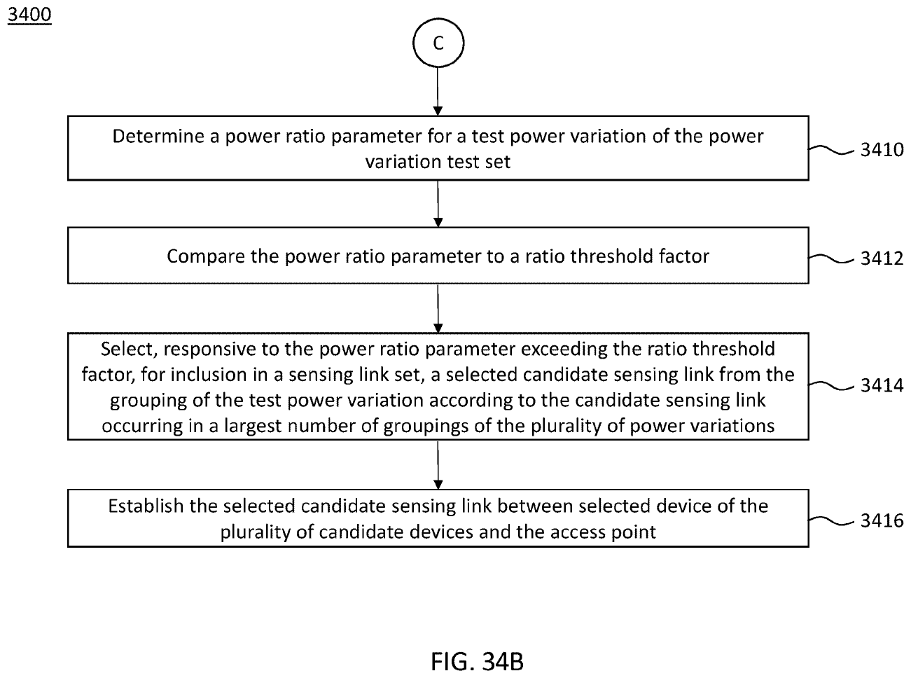

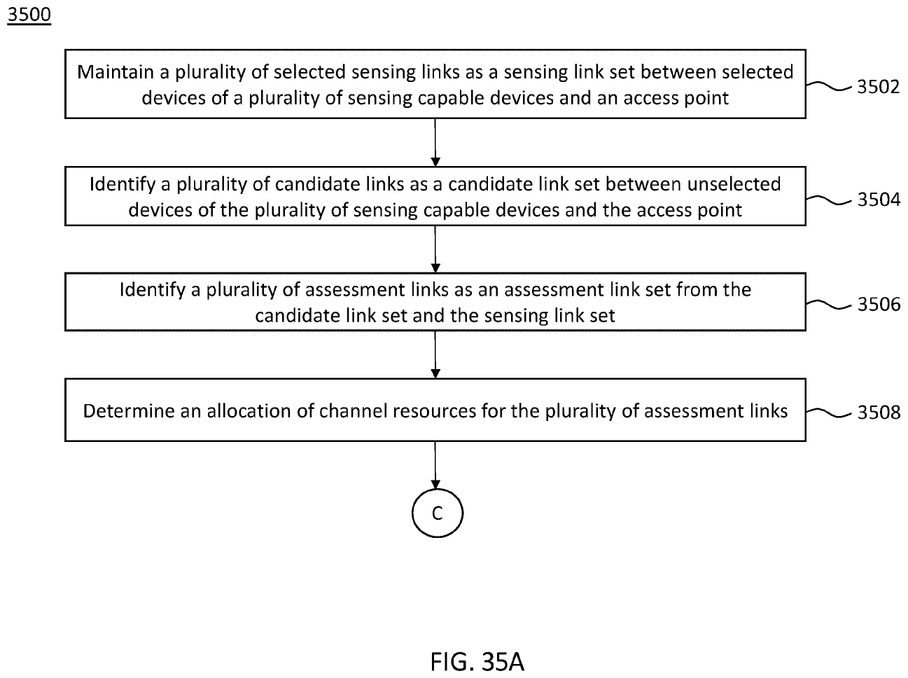

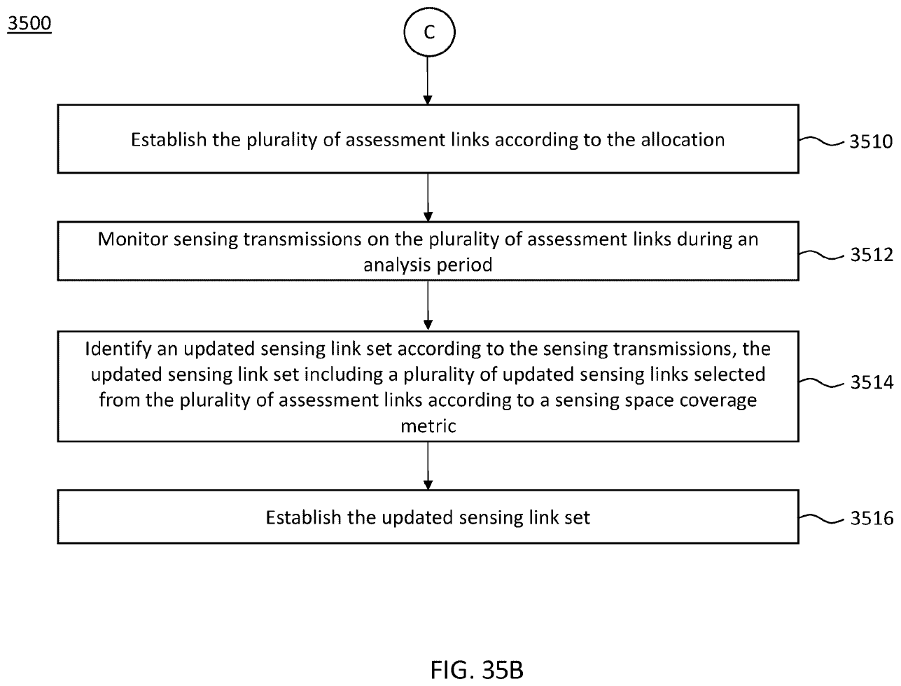

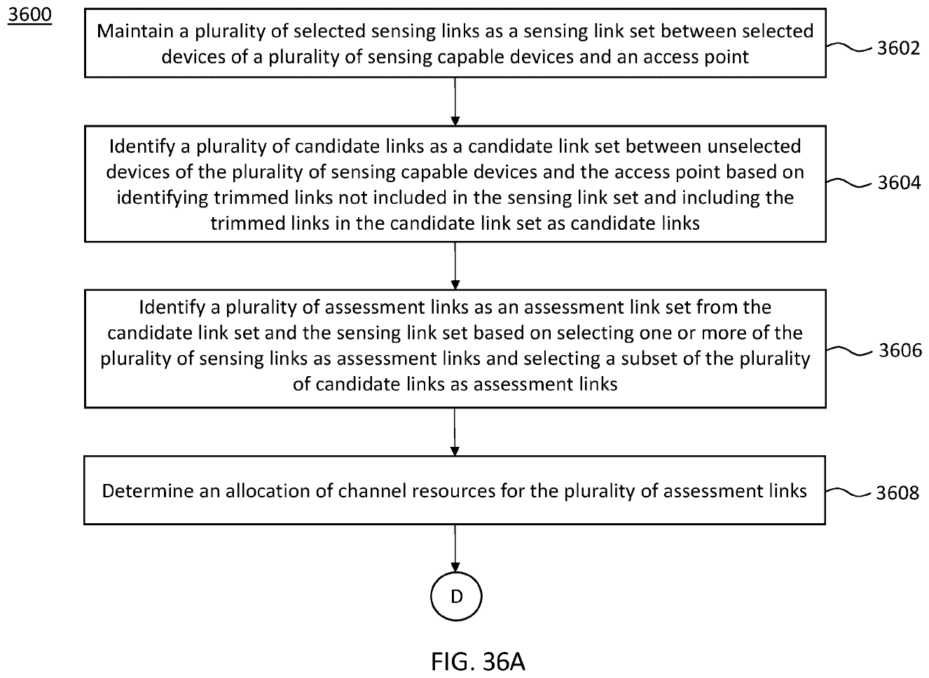

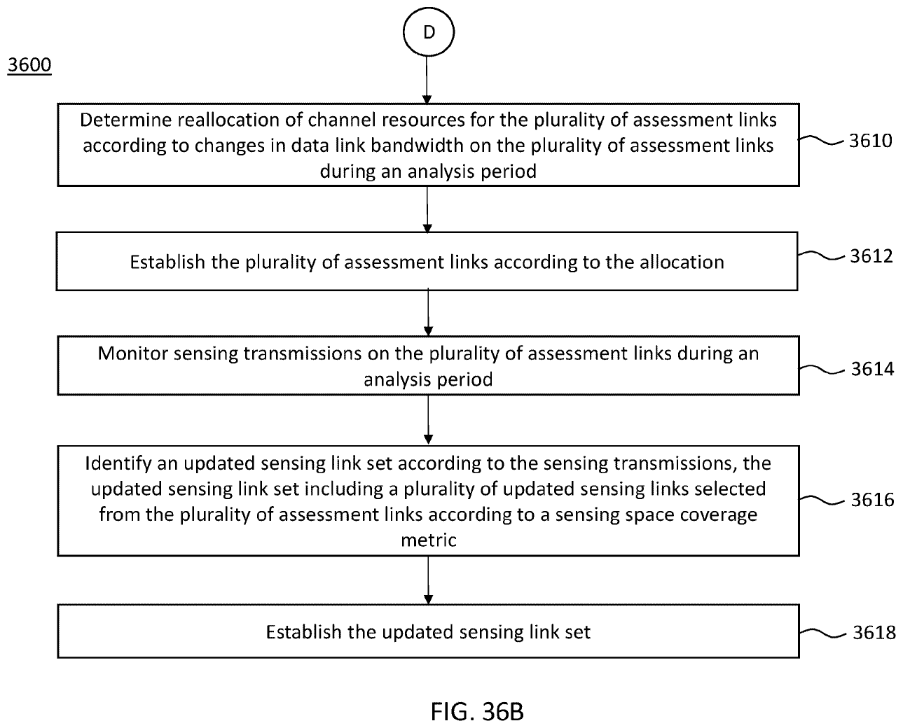

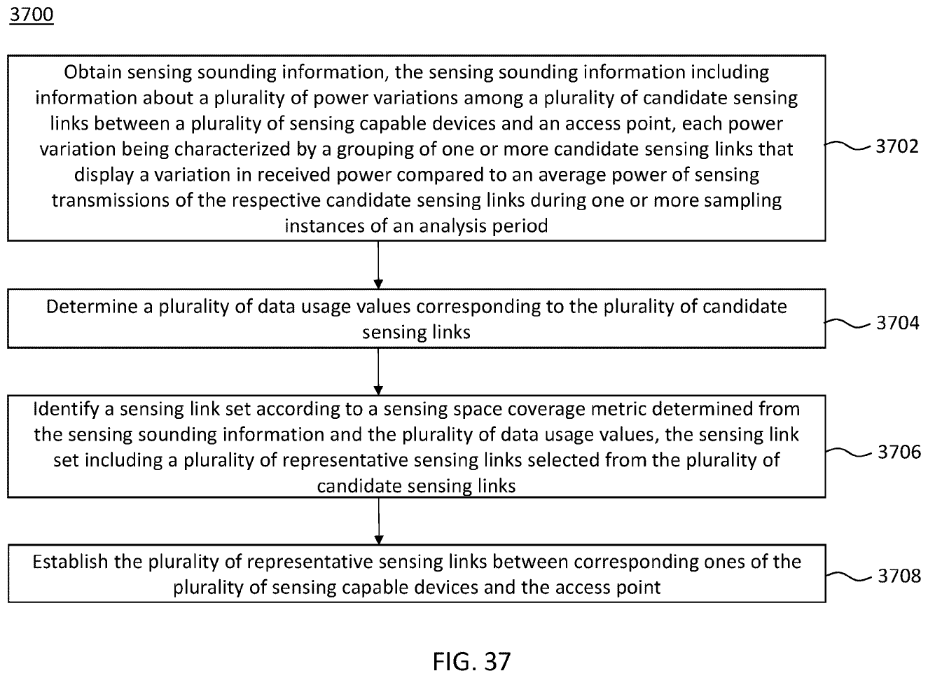

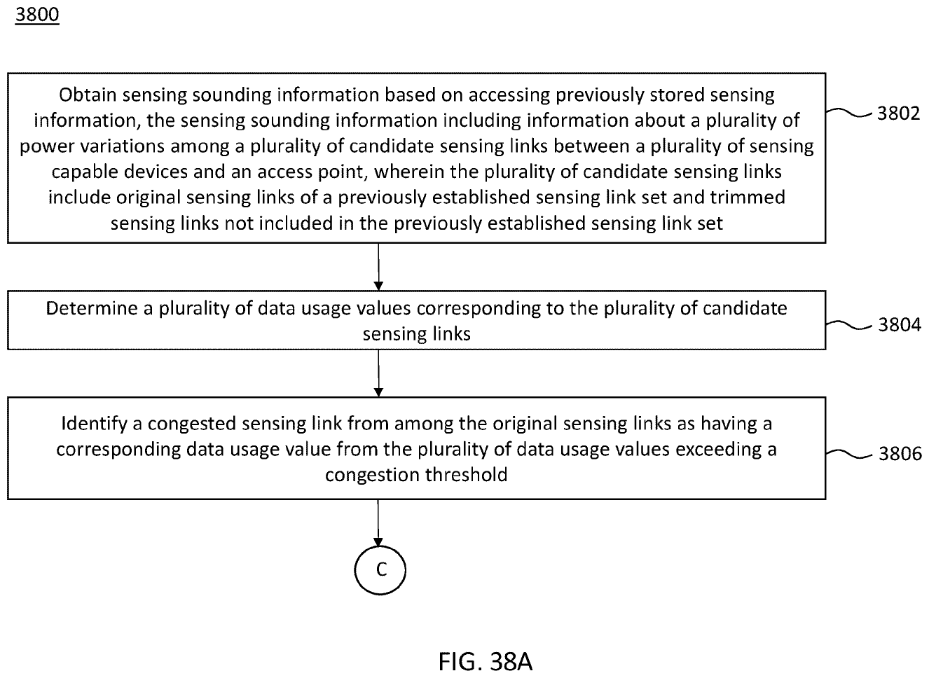

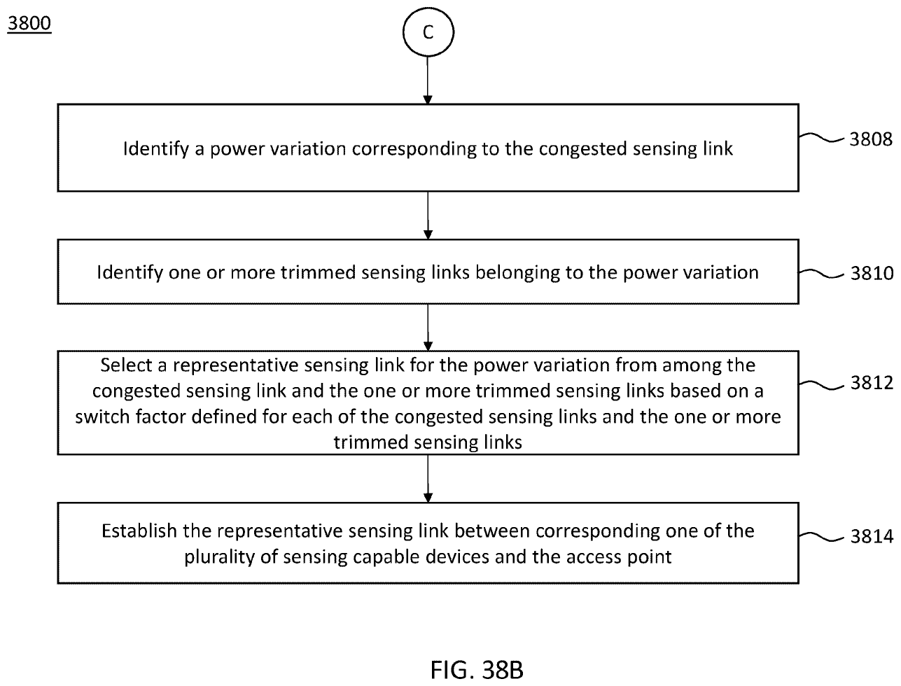

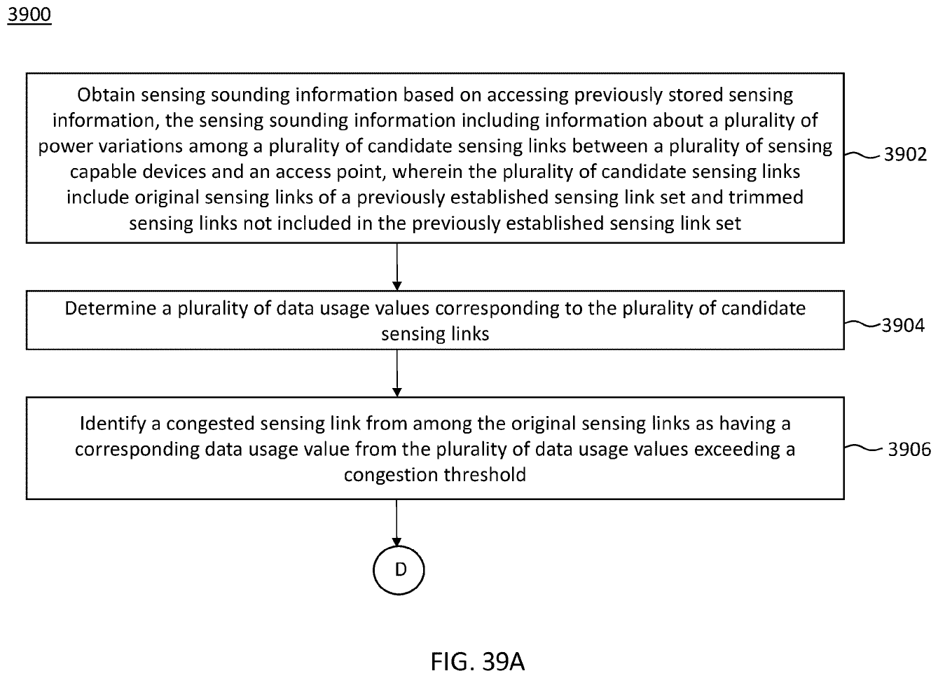

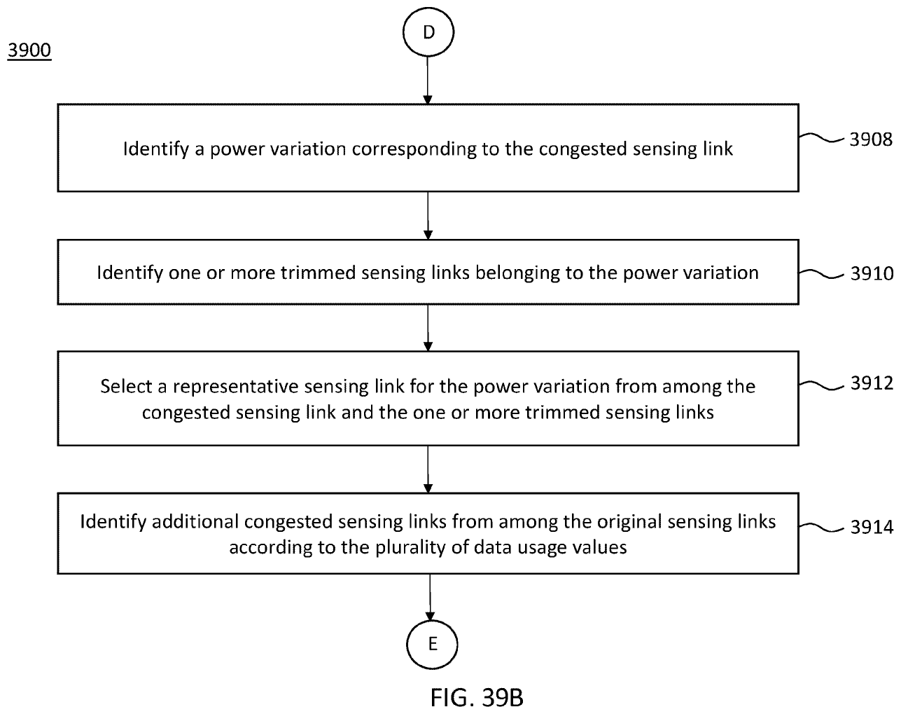

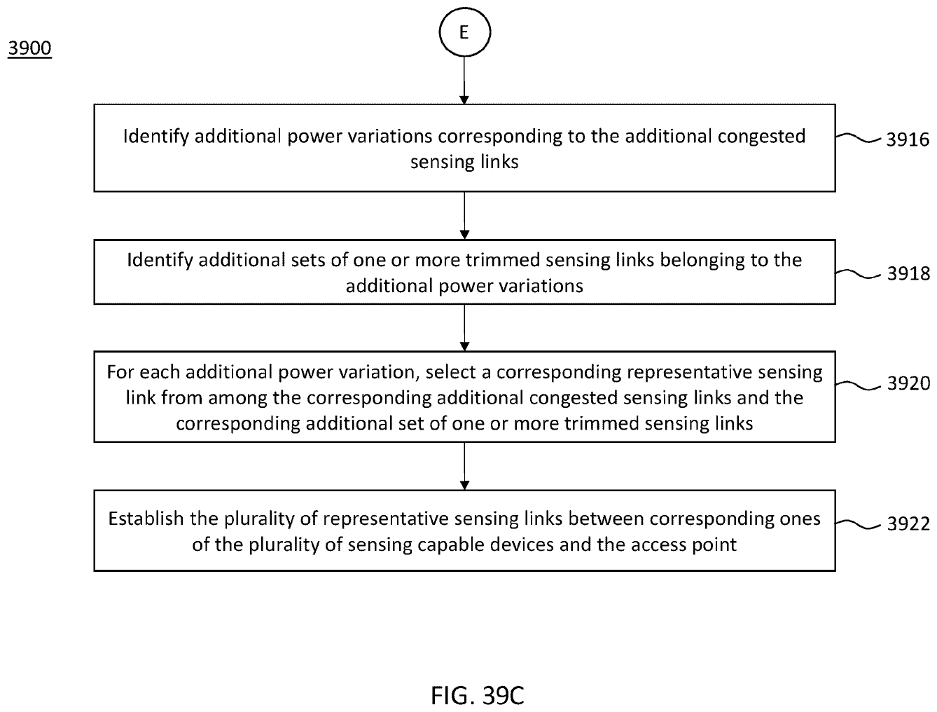

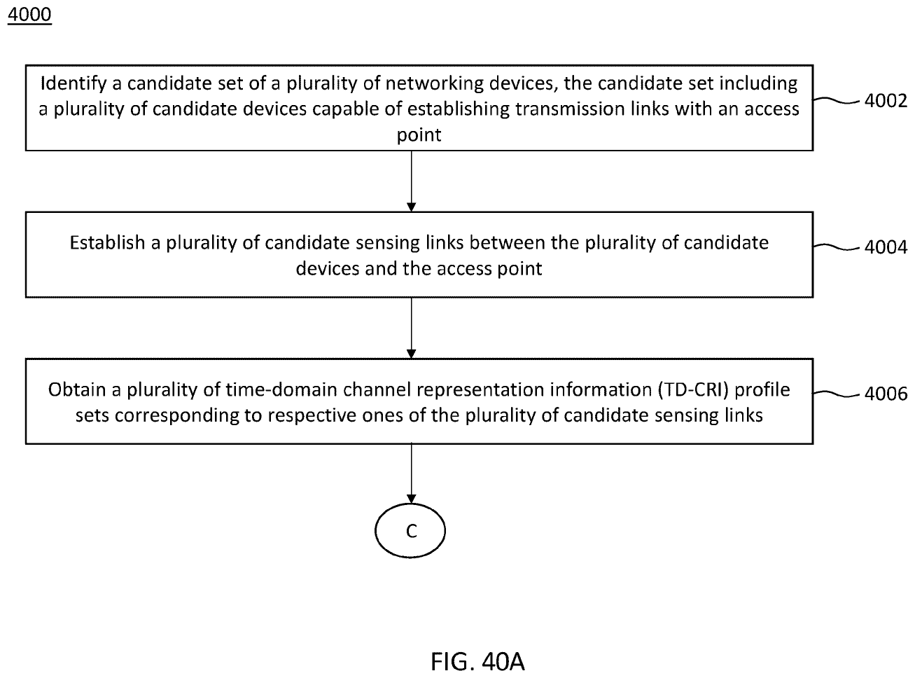

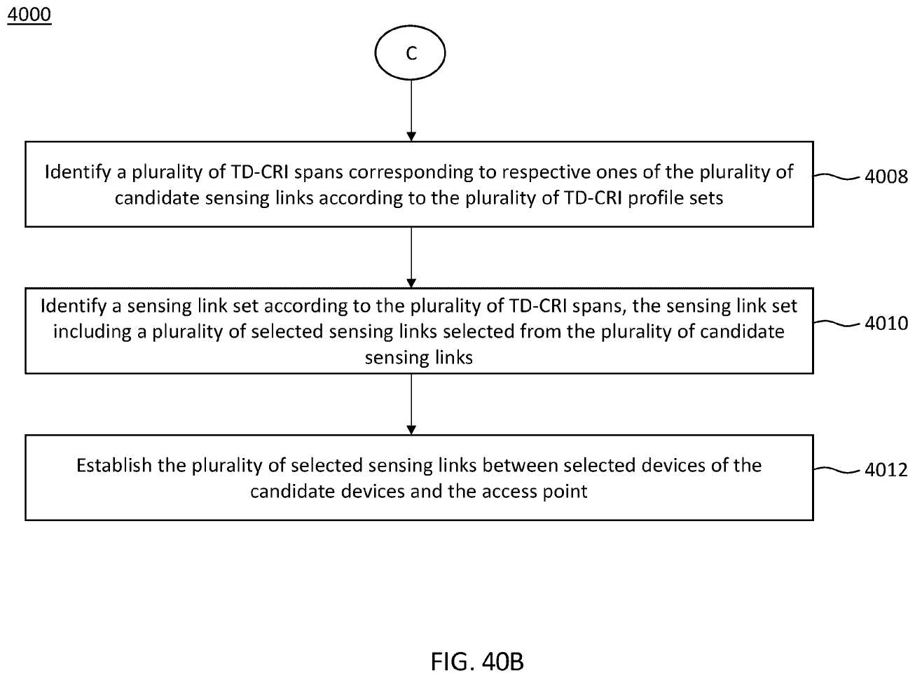

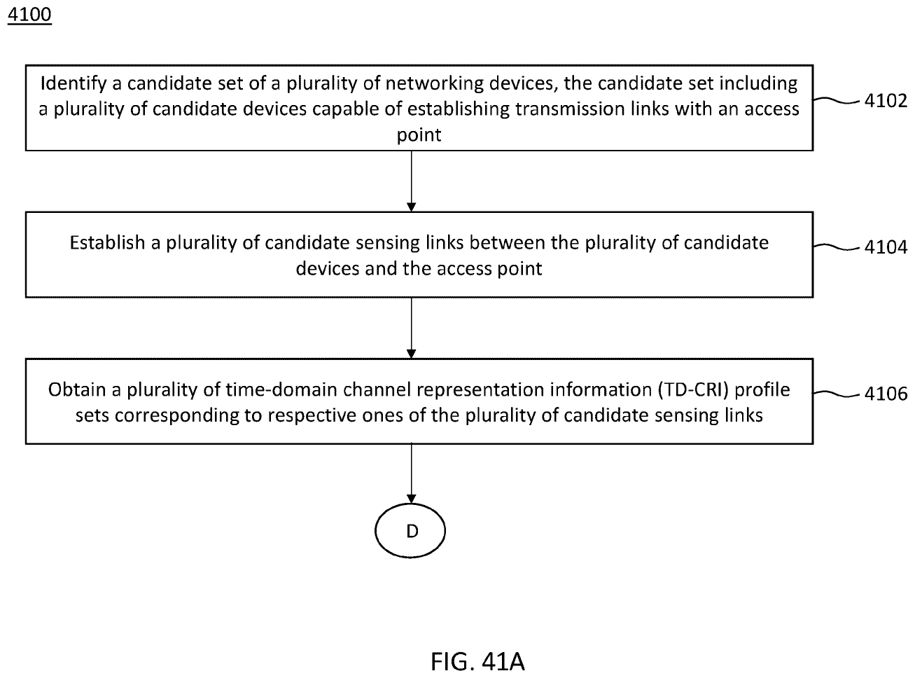

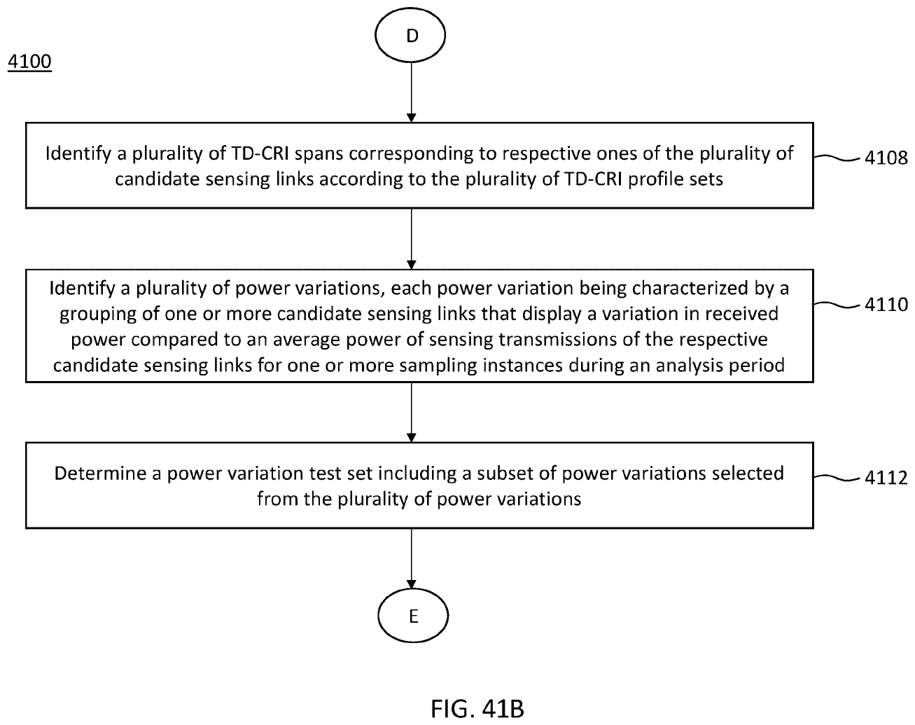

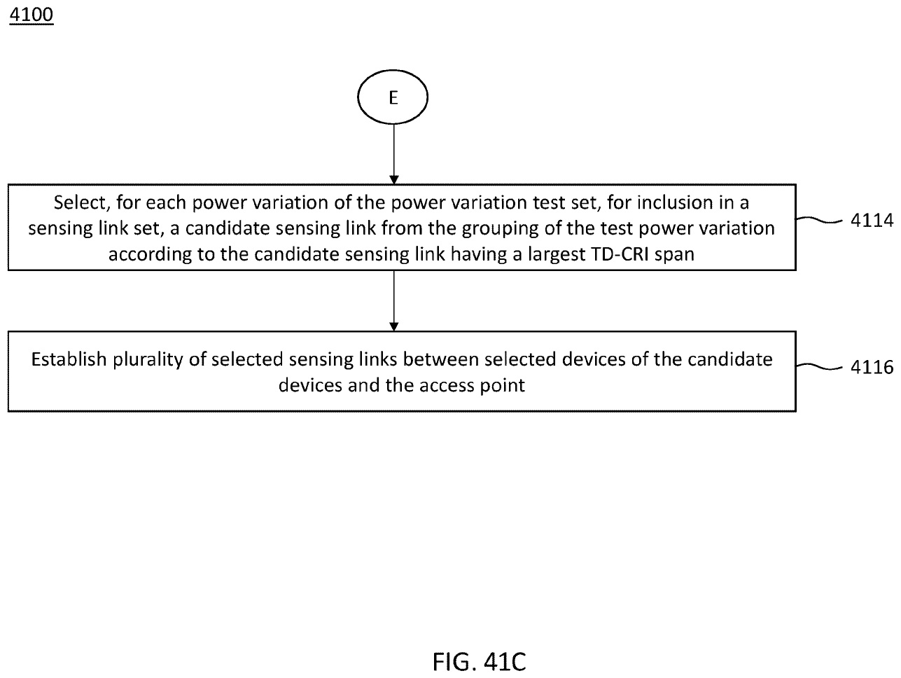

In the example shown, wireless communication device 102C processes the wireless signals from wireless communication devices 102A, 102B to detect motion of an object in a space accessed by the wireless signals, to determine a location of the detected motion, or both. For example, wireless communication device 102C may perform one or more operations of the example processes described below with respect to FIG. 33, FIG. 34A, FIG. 34B, FIG. 35A, FIG. 35B, FIG. 36A, FIG. 36B, FIG. 37, FIG. 38A, FIG. 38B, FIG. 39A, FIG. 39B, FIG. 39C, FIG. 40A, FIG. 40B, FIG. 41A, FIG. 41B, FIG. 41C or another type of process for detecting motion or determining a location of detected motion. The space accessed by the wireless signals can be an indoor or outdoor space, which may include, for example, one or more fully or partially enclosed areas, an open area without enclosure, etc. The space can be or can include an interior of a room, multiple rooms, a building, or the like. In some cases, the wireless communication system 100 can be modified, for instance, such that wireless communication device 102C can transmit wireless signals and wireless communication devices 102A, 102B can processes the wireless signals from wireless communication device 102C to detect motion or determine a location of detected motion.

The wireless signals used for motion detection can include, for example, a beacon signal (e.g., Bluetooth Beacons, Wi-Fi Beacons, other wireless beacon signals), another standard signal generated for other purposes according to a wireless network standard, or non-standard signals (e.g., random signals, reference signals, etc.) generated for motion detection or other purposes. In examples, motion detection may be carried out by analyzing one or more training fields carried by the wireless signals or by analyzing other data carried by the signal. In some examples data will be added for the express purpose of motion detection or the data used will nominally be for another purpose and reused or repurposed for motion detection. In some examples, the wireless signals propagate through an object (e.g., a wall) before or after interacting with a moving object, which may allow the moving object's movement to be detected without an optical line-of-sight between the moving object and the transmission or receiving hardware. Based on the received signals, wireless communication device 102C may generate motion detection data. In some instances, wireless communication device 102C may communicate the motion detection data to another device or system, such as a security system, which may include a control center for monitoring movement within a space, such as a room, building, outdoor area, etc.

In some implementations, wireless communication devices 102A, 102B can be modified to transmit motion probe signals (which may include, e.g., a reference signal, beacon signal, or another signal used to probe a space for motion) on a separate wireless communication channel (e.g., a frequency channel or coded channel) from wireless network traffic signals. For example, the modulation applied to the payload of a motion probe signal and the type of data or data structure in the payload may be known by wireless communication device 102C, which may reduce the amount of processing that wireless communication device 102C performs for motion sensing. The header may include additional information such as, for example, an indication of whether motion was detected by another device in communication system 100, an indication of the modulation type, an identification of the device transmitting the signal, etc.

In the example shown in FIG. 1, wireless communication system 100 is a wireless mesh network, with wireless communication links between each of wireless communication devices 102. In the example shown, the wireless communication link between wireless communication device 102C and wireless communication device 102A can be used to probe motion detection field 110A, the wireless communication link between wireless communication device 102C and wireless communication device 102B can be used to probe motion detection field 110B, and the wireless communication link between wireless communication device 102A and wireless communication device 102B can be used to probe motion detection field 110C. In some instances, each wireless communication device 102 detects motion in motion detection fields 110 accessed by that device by processing received signals that are based on wireless signals transmitted by wireless communication devices 102 through motion detection fields 110. For example, when person 106 shown in FIG. 1 moves in motion detection field 110A and motion detection field 110C, wireless communication devices 102 may detect the motion based on signals they received that are based on wireless signals transmitted through respective motion detection fields 110. For instance, wireless communication device 102A can detect motion of person 106 in motion detection fields 110A, 110C, wireless communication device 102B can detect motion of person 106 in motion detection field 110C, and wireless communication device 102C can detect motion of person 106 in motion detection field 110A.

In some instances, motion detection fields 110 can include, for example, air, solid materials, liquids, or another medium through which wireless electromagnetic signals may propagate. In the example shown in FIG. 1, motion detection field 110A provides a wireless communication channel between wireless communication device 102A and wireless communication device 102C, motion detection field 110B provides a wireless communication channel between wireless communication device 102B and wireless communication device 102C, and motion detection field 110C provides a wireless communication channel between wireless communication device 102A and wireless communication device 102B. In some aspects of operation, wireless signals transmitted on a wireless communication channel (separate from or shared with the wireless communication channel for network traffic) are used to detect movement of an object in a space. The objects can be any type of static or moveable object and can be living or inanimate. For example, the object can be a human (e.g., person 106 shown in FIG. 1), an animal, an inorganic object, or another device, apparatus, or assembly, an object that defines all or part of the boundary of a space (e.g., a wall, door, window, etc.), or another type of object. In some implementations, motion information from the wireless communication devices may be analyzed to determine a location of the detected motion. For example, as described further below, one of wireless communication devices 102 (or another device communicably coupled to wireless communications devices 102) may determine that the detected motion is nearby a particular wireless communication device.

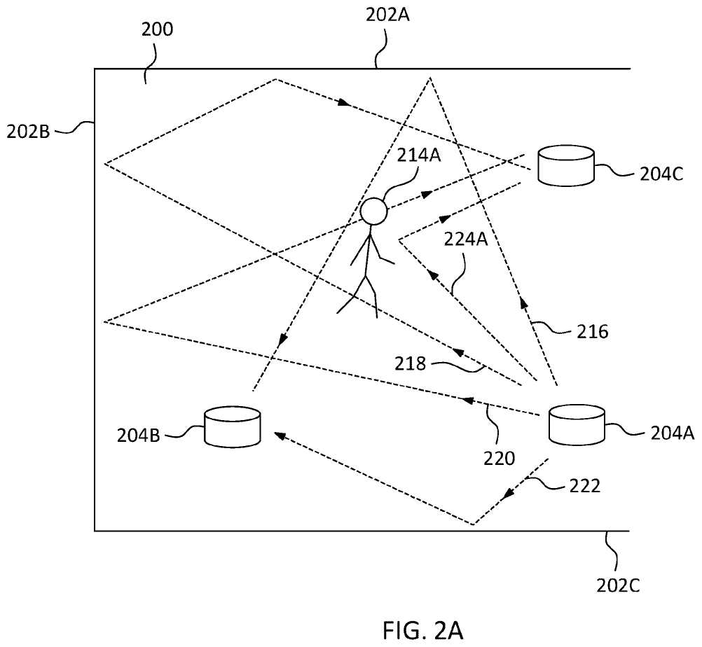

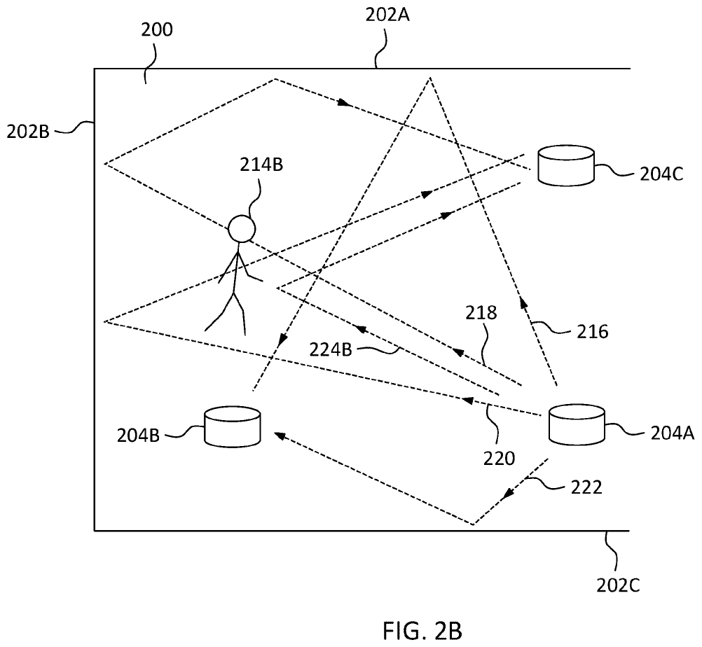

FIG. 2A and FIG. 2B are diagrams showing example wireless signals communicated between wireless communication devices 204A, 204B, 204C. Wireless communication devices 204A, 204B, 204C can be, for example, wireless communication devices 102A, 102B, 102C shown in FIG. 1, or other types of wireless communication devices. Wireless communication devices 204A, 204B, 204C transmit wireless signals through space 200. Space 200 can be completely or partially enclosed or open at one or more boundaries. In an example, space 200 may be a sensing space. Space 200 can be or can include an interior of a room, multiple rooms, a building, an indoor area, outdoor area, or the like. First wall 202A, second wall 202B, and third wall 202C at least partially enclose space 200 in the example shown.

In the example shown in FIG. 2A and FIG. 2B, wireless communication device 204A is operable to transmit wireless signals repeatedly (e.g., periodically, intermittently, at scheduled, unscheduled, or random intervals, etc.). Wireless communication devices 204B, 204C are operable to receive signals based on those transmitted by wireless communication device 204A. Wireless communication devices 204B, 204C each have a modem (e.g., modem 112 shown in FIG. 1) that is configured to process received signals to detect motion of an object in space 200.

As shown, an object is in first position 214A in FIG. 2A, and the object has moved to second position 214B in FIG. 2B. In FIG. 2A and FIG. 2B, the moving object in space 200 is represented as a human, but the moving object can be another type of object. For example, the moving object can be an animal, an inorganic object (e.g., a system, device, apparatus, or assembly), an object that defines all or part of the boundary of space 200 (e.g., a wall, door, window, etc.), or another type of object.

As shown in FIG. 2A and FIG. 2B, multiple example paths of the wireless signals transmitted from wireless communication device 204A are illustrated by dashed lines. Along first signal path 216, the wireless signal is transmitted from wireless communication device 204A and reflected off first wall 202A toward the wireless communication device 204B. Along second signal path 218, the wireless signal is transmitted from the wireless communication device 204A and reflected off second wall 202B and first wall 202A toward wireless communication device 204C. Along third signal path 220, the wireless signal is transmitted from the wireless communication device 204A and reflected off second wall 202B toward wireless communication device 204C. Along fourth signal path 222, the wireless signal is transmitted from the wireless communication device 204A and reflected off third wall 202C toward the wireless communication device 204B.

In FIG. 2A, along fifth signal path 224A, the wireless signal is transmitted from wireless communication device 204A and reflected off the object at first position 214A toward wireless communication device 204C. Between FIG. 2A and FIG. 2B, a surface of the object moves from first position 214A to second position 214B in space 200 (e.g., some distance away from first position 214A). In FIG. 2B, along sixth signal path 224B, the wireless signal is transmitted from wireless communication device 204A and reflected off the object at second position 214B toward wireless communication device 204C. Sixth signal path 224B depicted in FIG. 2B is longer than fifth signal path 224A depicted in FIG. 2A due to the movement of the object from first position 214A to second position 214B. In some examples, a signal path can be added, removed, or otherwise modified due to movement of an object in a space.

The example wireless signals shown in FIG. 2A and FIG. 2B may experience attenuation, frequency shifts, phase shifts, or other effects through their respective paths and may have portions that propagate in another direction, for example, through the first, second and third walls 202A, 202B, and 202C. In some examples, the wireless signals are radio frequency (RF) signals. The wireless signals may include other types of signals.

In the example shown in FIG. 2A and FIG. 2B, wireless communication device 204A can repeatedly transmit a wireless signal. In particular, FIG. 2A shows the wireless signal being transmitted from wireless communication device 204A at a first time, and FIG. 2B shows the same wireless signal being transmitted from wireless communication device 204A at a second, later time. The transmitted signal can be transmitted continuously, periodically, at random or intermittent times or the like, or a combination thereof. The transmitted signal can have a number of frequency components in a frequency bandwidth. The transmitted signal can be transmitted from wireless communication device 204A in an omnidirectional manner, in a directional manner or otherwise. In the example shown, the wireless signals traverse multiple respective paths in space 200, and the signal along each path may become attenuated due to path losses, scattering, reflection, or the like and may have a phase or frequency offset.

As shown in FIG. 2A and FIG. 2B, the signals from first to sixth paths 216, 218, 220, 222, 224A, and 224B combine at wireless communication device 204C and wireless communication device 204B to form received signals. Because of the effects of the multiple paths in space 200 on the transmitted signal, space 200 may be represented as a transfer function (e.g., a filter) in which the transmitted signal is input and the received signal is output. When an object moves in space 200, the attenuation or phase offset affected upon a signal in a signal path can change, and hence, the transfer function of space 200 can change. Assuming the same wireless signal is transmitted from wireless communication device 204A, if the transfer function of space 200 changes, the output of that transfer function—the received signal—will also change. A change in the received signal can be used to detect movement of an object.

Mathematically, a transmitted signal f (t) transmitted from the first wireless communication device 204A may be described according to Equation (1):

$$f ( t ) = {\sum }_{n = - ∞}^{∞} {c}_{n} {e}^{j {ω}_{n} t} \qquad ( 1 )$$

Where ωₙ represents the frequency of nth frequency component of the transmitted signal, cₙ represents the complex coefficient of the nth frequency component, and t represents time. With the f(t) being transmitted from the first wireless communication device 204A, an output signal rₖ(t) from a path, k, may be described according to Equation (2):

$${r}_{k} ( t ) = {\sum }_{n = - ∞}^{∞} {α}_{n , k} {c}_{n} {e}^{j ( {ω}_{n} t + {ϕ}_{n , k} )} \qquad ( 2 )$$

Where α_{n,k} represents an attenuation factor (or channel response; e.g., due to scattering, reflection, and path losses) for the nth frequency component along k, and ϕ_{n,k} represents the phase of the signal for nth frequency component along k. Then, the received signal, R, at a wireless communication device can be described as the summation of all output signals rₖ(t) from all paths to the wireless communication device, which is shown in Equation (3):

$$R = {\sum }_{k} {r}_{k} ( t ) \qquad ( 3 )$$

Substituting Equation (2) into Equation (3) renders the following Equation (4):

$$R = {\sum }_{k} {\sum }_{n = - ∞}^{∞} ( {α}_{n , k} {e}^{j {ϕ}_{n , k}} ) {c}_{n} {e}^{j {ω}_{n} t} \qquad ( 4 )$$

R at a wireless communication device can then be analyzed. R at a wireless communication device can be transformed to the frequency domain, for example, using a fast Fourier transform (FFT) or another type of algorithm. The transformed signal can represent R as a series of n complex values, one for each of the respective frequency components (at the n frequencies ωₙ). For a frequency component at frequency On, a complex value, Hₙ, may be represented as follows in Equation (5):

$${H}_{n} = {\sum }_{k} {c}_{n} {α}_{n , k} {e}^{j {ϕ}_{n , k}} \qquad ( 5 )$$

Hₙ for a given ωₙ indicates a relative magnitude and phase offset of the received signal at ωₙ. When an object moves in the space, Hₙ changes due to α_{n,k} of the space changing. Accordingly, a change detected in the channel response can be indicative of movement of an object within the communication channel. In some instances, noise, interference, or other phenomena can influence the channel response detected by the receiver, and the motion detection system can reduce or isolate such influences to improve the accuracy and quality of motion detection capabilities. In some implementations, the overall channel response can be represented as follows in Equation (6):

$${h}_{ch} = {\sum }_{k} {\sum }_{n = - ∞}^{∞} {α}_{n , k} \qquad ( 6 )$$

In some instances, the channel response, h_{ch}, for a space can be determined, for example, based on the mathematical theory of estimation. For instance, a reference signal, R_{ef}, can be modified with candidate h_{ch}, and then a maximum likelihood approach can be used to select the candidate channel which gives best match to the received signal (R_{cvd}). In some cases, an estimated received signal (R_{cvd}) is obtained from the convolution of R_{ef} with the candidate h_{ch}, and then the channel coefficients of h_{ch} are varied to minimize the squared error of \hat{R}_{cvd}. This can be mathematically illustrated as follows in Equation (7):

$${R}_{cvd} = {R}_{ef} ⊗ {h}_{ch} = {\sum }_{k = - m}^{m} {R}_{ef} ( n - k ) {h}_{ch} ( k ) \qquad ( 7 )$$

with the optimization criterion as in Equation (8):

$${min}_{{h}_{ch}} \{ \sum {( {\hat{R}}_{cvd} - {R}_{cvd} )}^{2} \} \qquad ( 8 )$$

The minimizing, or optimizing, process can utilize an adaptive filtering technique, such as least mean squares (LMS), recursive least squares (RLS), batch least squares (BLS), etc. The channel response can be a finite impulse response (FIR) filter, infinite impulse response (IIR) filter, or the like. As shown in the equation above, the received signal can be considered as a convolution of the reference signal and the channel response. The convolution operation means that the channel coefficients possess a degree of correlation with each of the delayed replicas of the reference signal. The convolution operation as shown in the equation above, therefore shows that the received signal appears at different delay points, each delayed replica being weighted by the channel coefficient.

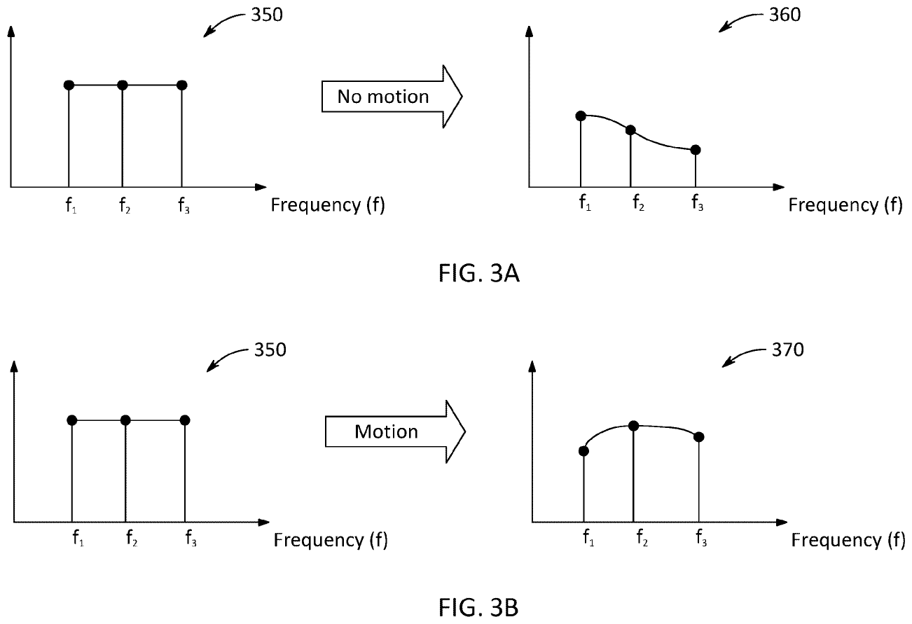

FIG. 3A and FIG. 3B are plots showing examples of channel responses 360, 370 computed from the wireless signals communicated between wireless communication devices 204A, 204B, 204C in FIG. 2A and FIG. 2B. FIG. 3A and FIG. 3B also show frequency domain representation 350 of an initial wireless signal transmitted by wireless communication device 204A. In the examples shown, channel response 360 in FIG. 3A represents the signals received by wireless communication device 204B when there is no motion in space 200, and channel response 370 in FIG. 3B represents the signals received by wireless communication device 204B in FIG. 2B after the object has moved in space 200.

In the example shown in FIG. 3A and FIG. 3B, for illustration purposes, wireless communication device 204A transmits a signal that has a flat frequency profile (the magnitude of each frequency component, f₁, f₂ and f₃ is the same), as shown in frequency domain representation 350. Because of the interaction of the signal with space 200 (and the objects therein), the signals received at wireless communication device 204B that are based on the signal sent from wireless communication device 204A are different from the transmitted signal. In this example, where the transmitted signal has a flat frequency profile, the received signal represents the channel response of space 200. As shown in FIG. 3A and FIG. 3B, channel responses 360, 370 are different from frequency domain representation 350 of the transmitted signal. When motion occurs in space 200, a variation in the channel response will also occur. For example, as shown in FIG. 3B, channel response 370 that is associated with motion of object in space 200 varies from channel response 360 that is associated with no motion in space 200.

Furthermore, as an object moves within space 200, the channel response may vary from channel response 370. In some cases, space 200 can be divided into distinct regions and the channel responses associated with each region may share one or more characteristics (e.g., shape), as described below. Thus, motion of an object within different distinct regions can be distinguished, and the location of detected motion can be determined based on an analysis of channel responses.

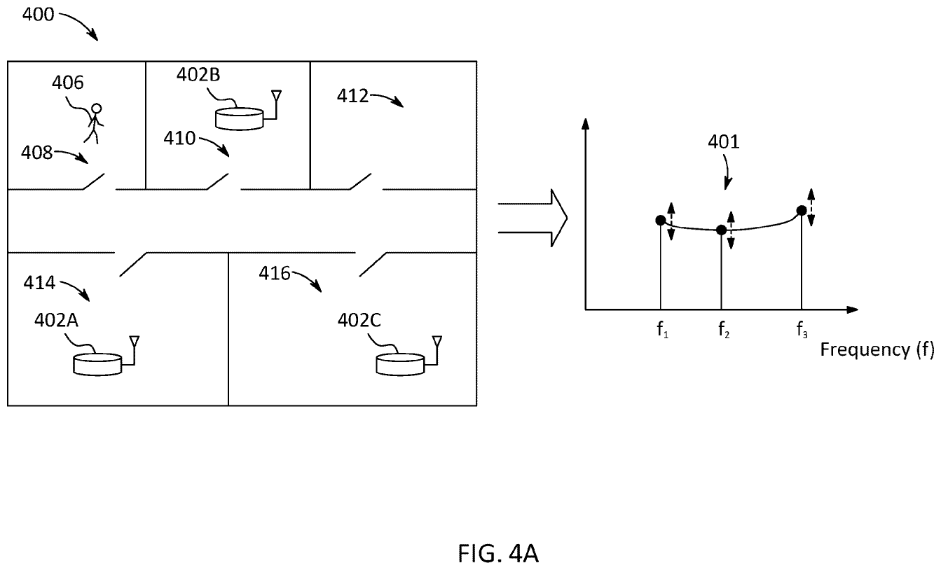

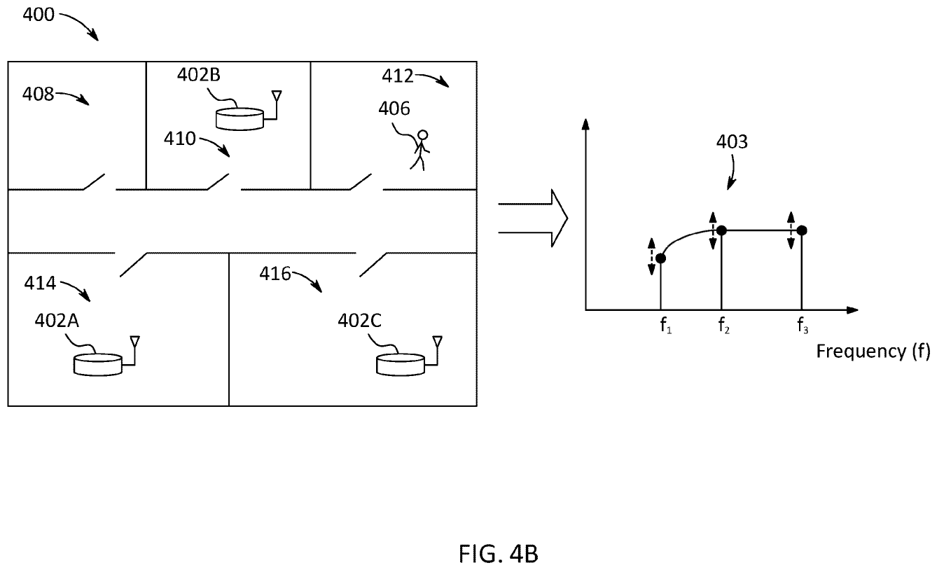

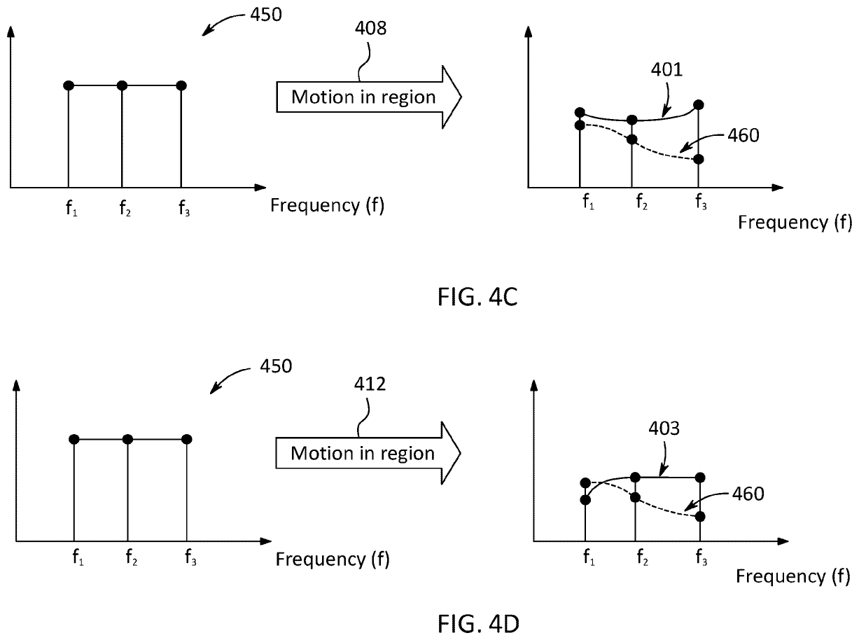

FIG. 4A and FIG. 4B are diagrams showing example channel responses 401, 403 associated with motion of object 406 in distinct regions 408, 412 of space 400. In the examples shown, space 400 is a building, and space 400 is divided into a plurality of distinct regions-first region 408, second region 410, third region 412, fourth region 414, and fifth region 416. Space 400 may include additional or fewer regions, in some instances. As shown in FIG. 4A and FIG. 4B, the regions within space 400 may be defined by walls between rooms. In addition, the regions may be defined by ceilings between floors of a building. For example, space 400 may include additional floors with additional rooms. In addition, in some instances, the plurality of regions of a space can be or include a number of floors in a multistory building, a number of rooms in the building, or a number of rooms on a particular floor of the building. In the example shown in FIG. 4A, an object located in first region 408 is represented as person 406, but the moving object can be another type of object, such as an animal or an inorganic object.

In the example shown, wireless communication device 402A is located in fourth region 414 of space 400, wireless communication device 402B is located in second region 410 of space 400, and wireless communication device 402C is located in fifth region 416 of space 400. Wireless communication devices 402 can operate in the same or similar manner as wireless communication devices 102 of FIG. 1. For instance, wireless communication devices 402 may be configured to transmit and receive wireless signals and detect whether motion has occurred in space 400 based on the received signals. As an example, wireless communication devices 402 may periodically or repeatedly transmit motion probe signals through space 400, and receive signals based on the motion probe signals. Wireless communication devices 402 can analyze the received signals to detect whether an object has moved in space 400, such as, for example, by analyzing channel responses associated with space 400 based on the received signals. In addition, in some implementations, wireless communication devices 402 can analyze the received signals to identify a location of detected motion within space 400. For example, wireless communication devices 402 can analyze characteristics of the channel response to determine whether the channel responses share the same or similar characteristics to channel responses known to be associated with first to fifth regions 408, 410, 412, 414, 416 of space 400.

In the examples shown, one (or more) of wireless communication devices 402 repeatedly transmits a motion probe signal (e.g., a reference signal) through space 400. The motion probe signals may have a flat frequency profile in some instances, wherein the magnitude of f₁, f₂ and f₃ is the same or nearly the same. For example, the motion probe signals may have a frequency response similar to frequency domain representation 350 shown in FIG. 3A and FIG. 3B. The motion probe signals may have a different frequency profile in some instances. Because of the interaction of the reference signal with space 400 (and the objects therein), the signals received at another wireless communication device 402 that are based on the motion probe signal transmitted from the other wireless communication device 402 are different from the transmitted reference signal.

Based on the received signals, wireless communication devices 402 can determine a channel response for space 400. When motion occurs in distinct regions within the space, distinct characteristics may be seen in the channel responses. For example, while the channel responses may differ slightly for motion within the same region of space 400, the channel responses associated with motion in distinct regions may generally share the same shape or other characteristics. For instance, channel response 401 of FIG. 4A represents an example channel response associated with motion of object 406 in first region 408 of space 400, while channel response 403 of FIG. 4B represents an example channel response associated with motion of object 406 in third region 412 of space 400. Channel responses 401, 403 are associated with signals received by the same wireless communication device 402 in space 400.

FIG. 4C and FIG. 4D are plots showing channel responses 401, 403 of FIG. 4A and FIG. 4B overlaid on channel response 460 associated with no motion occurring in space 400. In the example shown, wireless communication device 402 transmits a motion probe signal that has a flat frequency profile as shown in frequency domain representation 450. When motion occurs in space 400, a variation in the channel response will occur relative to channel response 460 associated with no motion, and thus, motion of an object in space 400 can be detected by analyzing variations in the channel responses. In addition, a relative location of the detected motion within space 400 can be identified. For example, the shape of channel responses associated with motion can be compared with reference information (e.g., using a trained artificial intelligence (AI) model) to categorize the motion as having occurred within a distinct region of space 400.

When there is no motion in space 400 (e.g., when object 406 is not present), wireless communication device 402 may compute channel response 460 associated with no motion. Slight variations may occur in the channel response due to a number of factors; however, multiple channel responses 460 associated with different periods of time may share one or more characteristics. In the example shown, channel response 460 associated with no motion has a decreasing frequency profile (the magnitude of each of f₁, f₂ and f₃ is less than the previous). The profile of channel response 460 may differ in some instances (e.g., based on different room layouts or placement of wireless communication devices 402).

When motion occurs in space 400, a variation in the channel response will occur. For instance, in the examples shown in FIG. 4C and FIG. 4D, channel response 401 associated with motion of object 406 in first region 408 differs from channel response 460 associated with no motion and channel response 403 associated with motion of object 406 in third region 412 differs from channel response 460 associated with no motion. Channel response 401 has a concave-parabolic frequency profile (the magnitude of the middle frequency component, f₂, is less than the outer frequency components f₁ and f₃), while channel response 403 has a convex-asymptotic frequency profile (the magnitude of the middle frequency component f₂ is greater than the outer frequency components, f₁ and f₃). The profiles of channel responses 401, 403 may differ in some instances (e.g., based on different room layouts or placement of the wireless communication devices 402).

Analyzing channel responses may be considered similar to analyzing a digital filter. A channel response may be formed through the reflections of objects in a space as well as reflections created by a moving or static human. When a reflector (e.g., a human) moves, it changes the channel response. This may translate to a change in equivalent taps of a digital filter, which can be thought of as having poles and zeros (poles amplify the frequency components of a channel response and appear as peaks or high points in the response, while zeros attenuate the frequency components of a channel response and appear as troughs, low points, or nulls in the response). A changing digital filter can be characterized by the locations of its peaks and troughs, and a channel response may be characterized similarly by its peaks and troughs. For example, in some implementations, analyzing nulls and peaks in the frequency components of a channel response (e.g., by marking their location on the frequency axis and their magnitude), motion can be detected.

In some implementations, a time series aggregation can be used to detect motion. A time series aggregation may be performed by observing the features of a channel response over a moving window and aggregating the windowed result by using statistical measures (e.g., mean, variance, principal components, etc.). During instances of motion, the characteristic digital-filter features would be displaced in location and flip-flop between some values due to the continuous change in the scattering scene. That is, an equivalent digital filter exhibits a range of values for its peaks and nulls (due to the motion). By looking this range of values, unique profiles (in examples profiles may also be referred to as signatures) may be identified for distinct regions within a space.

In some implementations, an AI model may be used to process data. AI models may be of a variety of types, for example linear regression models, logistic regression models, linear discriminant analysis models, decision tree models, naïve bayes models, K-nearest neighbors models, learning vector quantization models, support vector machines, bagging and random forest models, and deep neural networks. In general, all AI models aim to learn a function which provides the most precise correlation between input values and output values and are trained using historic sets of inputs and outputs that are known to be correlated. In examples, artificial intelligence may also be referred to as machine learning.

In some implementations, the profiles of the channel responses associated with motion in distinct regions of space 400 can be learned. For example, machine learning may be used to categorize channel response characteristics with motion of an object within distinct regions of a space. In some cases, a user associated with wireless communication devices 402 (e.g., an owner or other occupier of space 400) can assist with the learning process. For instance, referring to the examples shown in FIG. 4A and FIG. 4B, the user can move in each of first to fifth regions 408, 410, 412, 414, 416 during a learning phase and may indicate (e.g., through a user interface on a mobile computing device) that he/she is moving in one of the particular regions in space 400. For example, while the user is moving through first region 408 (e.g., as shown in FIG. 4A) the user may indicate on a mobile computing device that he/she is in first region 408 (and may name the region as “bedroom”, “living room”, “kitchen”, or another type of room of a building, as appropriate). Channel responses may be obtained as the user moves through the region, and the channel responses may be “tagged” with the user's indicated location (region). The user may repeat the same process for the other regions of space 400. The term “tagged” as used herein may refer to marking and identifying channel responses with the user's indicated location or any other information.

The tagged channel responses can then be processed (e.g., by machine learning software) to identify unique characteristics of the channel responses associated with motion in the distinct regions. Once identified, the identified unique characteristics may be used to determine a location of detected motion for newly computed channel responses. For example, an AI model may be trained using the tagged channel responses, and once trained, newly computed channel responses can be input to the AI model, and the AI model can output a location of the detected motion. For example, in some cases, mean, range, and absolute values are input to an AI model. In some instances, magnitude and phase of the complex channel response itself may be input as well. These values allow the AI model to design arbitrary front-end filters to pick up the features that are most relevant to making accurate predictions with respect to motion in distinct regions of a space. In some implementations, the AI model is trained by performing a stochastic gradient descent. For instance, channel response variations that are most active during a certain zone may be monitored during the training, and the specific channel variations may be weighted heavily (by training and adapting the weights in the first layer to correlate with those shapes, trends, etc.). The weighted channel variations may be used to create a metric that activates when a user is present in a certain region.

For extracted features like channel response nulls and peaks, a time-series (of the nulls/peaks) may be created using an aggregation within a moving window, taking a snapshot of few features in the past and present, and using that aggregated value as input to the network. Thus, the network, while adapting its weights, will be trying to aggregate values in a certain region to cluster them, which can be done by creating a logistic classifier based decision surfaces. The decision surfaces divide different clusters and subsequent layers can form categories based on a single cluster or a combination of clusters.

In some implementations, an AI model includes two or more layers of inference. The first layer acts as a logistic classifier which can divide different concentrations of values into separate clusters, while the second layer combines some of these clusters together to create a category for a distinct region. Additionally, subsequent layers can help in extending the distinct regions over more than two categories of clusters. For example, a fully-connected AI model may include an input layer corresponding to the number of features tracked, a middle layer corresponding to the number of effective clusters (through iterating between choices), and a final layer corresponding to different regions. Where complete channel response information is input to the AI model, the first layer may act as a shape filter that can correlate certain shapes. Thus, the first layer may lock to a certain shape, the second layer may generate a measure of variation happening in those shapes, and third and subsequent layers may create a combination of those variations and map them to different regions within the space. The output of different layers may then be combined through a fusing layer.

### B. Wi-Fi Sensing System Example Methods and Apparatus

Section B describes systems and methods that are useful for a wireless sensing system configured to send sensing transmissions and make sensing measurements.

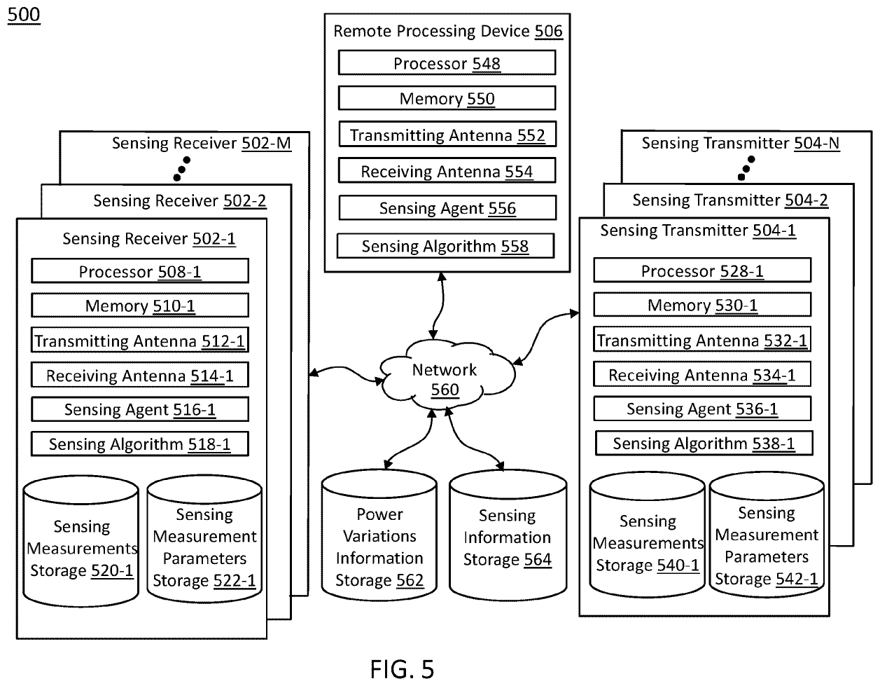

FIG. 5 depicts an implementation of some of an architecture of an implementation of system 500 for Wi-Fi sensing, according to some embodiments.

System 500 may include a plurality of networking devices including a plurality of sensing capable devices and a plurality of access points. In an example, system 500 may include plurality of sensing receivers 502-(1-M), plurality of sensing transmitters 504-(1-N), remote processing device 506, and network 560 enabling communication between the system components for information exchange. In an example, any of sensing receiver 502-(1-M) or any of sensing transmitter 504-(1-N) may be a sensing capable device. System 500 may be an example or instance of wireless communication system 100 and network 560 may be an example or instance of wireless network or cellular network, details of which are provided with reference to FIG. 1 and its accompanying description.

According to an embodiment, plurality of sensing receivers 502-(1-M) may be configured to receive one or more sensing transmissions (for example, from one or more of plurality of sensing transmitters 504-(1-N)) and perform one or more measurements (for example, channel representation information (CRI) measurements such as channel state information (CSI) or time domain channel representation information (TD-CRI)) useful for Wi-Fi sensing. In examples, these measurements may be known as sensing measurements. Sensing measurements may be processed to achieve a sensing goal of system 500. In an embodiment, one or more of plurality of sensing receivers 502-(1-M) may be an AP. In some embodiments, one or more of plurality of sensing receivers 502-(1-M) may be a non-AP STA. In some embodiments, one or more of plurality of sensing receivers 502-(1-M) may take a role of sensing initiator and/or sensing responder.

According to an implementation, one or more of plurality of sensing receivers 502-(1-M) may be implemented by a device, such as wireless communication device 102 shown in FIG. 1. In some implementations, one or more of plurality of sensing receivers 502-(1-M) may be implemented by a device, such as wireless communication device 204 shown in FIG. 2A and FIG. 2B. Further, one or more of plurality of sensing receivers 502-(1-M) may be implemented by a device, such as wireless communication device 402 shown in FIG. 4A and FIG. 4B. In an implementation, one or more of plurality of sensing receivers 502-(1-M) may coordinate and control communication among plurality of sensing transmitters 504-(1-N). According to an implementation, one or more of plurality of sensing receivers 502-(1-M) may be enabled to control a sensing measurement session comprising one or more sensing measurement instance to ensure that required sensing transmissions are made at a required time and to ensure an accurate determination of one or more sensing measurements. In some embodiments, one or more of plurality of sensing receivers 502-(1-M) may process sensing measurements to achieve the sensing goal of system 500. In an embodiment, one or more of plurality of sensing receivers 502-(1-M) may be a STA. In an embodiment, one or more of plurality of sensing receivers 502-(1-M) may be an AP. In some embodiments, one or more of plurality of sensing receivers 502-(1-M) may be configured to transmit sensing measurements to remote processing device 506, and remote processing device 506 may be configured to process sensing measurements to achieve the sensing goal of system 500.

Referring again to FIG. 5, in some embodiments, one or more of plurality of sensing transmitters 504-(1-N) may be configured to send one or more sensing transmissions to one or more of plurality of sensing receivers 502-(1-M) based on which one or more sensing measurements may be performed for Wi-Fi sensing. In an embodiment, one or more of plurality of sensing transmitters 504-(1-N) may be a STA. In an embodiment, one or more of plurality of sensing transmitters 504-(1-N) may be an AP. In some embodiments, one or more of plurality of sensing transmitters 504-(1-N) may take a role of sensing initiator and/or sensing responder.

According to an implementation, one or more of plurality of sensing transmitters 504-(1-N) may be implemented by a device, such as wireless communication device 102 shown in FIG. 1. In some implementations, one or more of plurality of sensing transmitters 504-(1-M) may be implemented by a device, such as wireless communication device 204 shown in FIG. 2A and FIG. 2B. Further, one or more of plurality of sensing transmitters 504-(1-M) may be implemented by a device, such as wireless communication device 402 shown in FIG. 4A and FIG. 4B. In some implementations, communication between one or more of plurality of sensing receivers 502-(1-M) and one or more of plurality of sensing transmitters 504-(1-N) may happen via station management entity (SME) and MAC layer management entity (MLME) protocols.

In some embodiments, remote processing device 506 may be configured to receive sensing measurements from one or more of plurality of sensing receivers 502-(1-M) and process the sensing measurements. In an example, remote processing device 506 may process and analyze sensing measurements to identify one or more features of interest. According to some implementations, remote processing device 506 may include/execute a sensing algorithm. In an embodiment, remote processing device 506 may be a STA. In some embodiments, remote processing device 506 may be an AP. According to an implementation, remote processing device 506 may be implemented by a device, such as wireless communication device 102 shown in FIG. 1. In some implementations, remote processing device 506 may be implemented by a device, such as wireless communication device 204 shown in FIG. 2A and FIG. 2B. Further, remote processing device 506 may be implemented by a device, such as wireless communication device 402 shown in FIG. 4A and FIG. 4B. In some embodiments, remote processing device 506 may be any computing device, such as a desktop computer, a laptop, a tablet computer, a mobile device, a personal digital assistant (PDA) or any other computing device. In embodiments, remote processing device 506 may take a role of sensing initiator where a sensing algorithm determines a Wi-Fi sensing session and the sensing measurements required to fulfill the measurement campaign. In an example, remote processing device 506 may communicate sensing measurement parameters and/or transmission parameters required to initiate a Wi-Fi sensing session to one or more of plurality of sensing receivers 502-(1-M) and/or to one or more of plurality of sensing transmitters 504-(1-N) to coordinate and control sensing transmissions for performing sensing measurements.

Referring to FIG. 5 in more detail, sensing receiver 502-1 (which is an example of one or more of plurality of sensing receivers 502-(1-M)) may include processor 508-1 and memory 510-1. For example, processor 508-1 and memory 510-1 of sensing receiver 502-1 may be processor 114 and memory 116, respectively, as shown in FIG. 1. In an embodiment, sensing receiver 502-1 may further include transmitting antenna(s) 512-1, receiving antenna(s) 514-1, and sensing agent 516-1. In some embodiments, an antenna may be used to both transmit and receive signals in a half-duplex format. When the antenna is transmitting, it may be referred to as transmitting antenna 512-1, and when the antenna is receiving, it may be referred to as receiving antenna 514-1. It is understood by a person of normal skill in the art that the same antenna may be transmitting antenna 512-1 in some instances and receiving antenna 514-1 in other instances. In the case of an antenna array, one or more antenna elements may be used to transmit or receive a signal, for example, in a beamforming environment. In some examples, a group of antenna elements used to transmit a composite signal may be referred to as transmitting antenna 512-1, and a group of antenna elements used to receive a composite signal may be referred to as receiving antenna 514-1. In some examples, each antenna is equipped with its own transmission and receive paths, which may be alternately switched to connect to the antenna depending on whether the antenna is operating as transmitting antenna 512-1 or receiving antenna 514-1.

In an implementation, sensing agent 516-1 may be responsible for causing sensing receiver 502-1 to receive sensing transmissions and associated sensing measurement parameters and/or transmission parameters, to calculate sensing measurements. In examples, sensing agent 516-1 may be responsible for processing sensing measurements to fulfill a sensing goal. In some implementations, receiving sensing transmissions and optionally associated sensing measurement parameters and/or transmission parameters, and calculating sensing measurements may be carried out by sensing agent 516-1 running in the medium access control (MAC) layer of sensing receiver 502-1 and processing sensing measurements to fulfill a sensing goal may be carried out by an algorithm running in the application layer of sensing receiver 502-1, for example sensing algorithm 518-1. In examples, a sensing algorithm 518-1 running in the application layer of sensing receiver 502-1 may be known as a Wi-Fi sensing agent, a sensing application, or sensing algorithm. In examples, sensing algorithm 518-1 may include and/or execute sensing agent 516-1. According to some implementations, sensing agent 516-1 may include and/or execute sensing algorithm 518-1. In some implementations, sensing agent 516-1 running in the MAC layer of sensing receiver 502-1 and sensing algorithm 518-1 running in the application layer of sensing receiver 502-1 may run separately on processor 508-1. In an implementation, sensing agent 516-1 may pass one or more of sensing measurement parameters, transmission parameters, or physical layer parameters (e.g., such as channel representation information, examples of which are CSI and TD-CRI) between the MAC layer of sensing receiver 502-1 and the application layer of sensing receiver 502-1. In an example, sensing agent 516-1 in the MAC layer or sensing algorithm 518-1 in the application layer may operate on physical layer parameters, for example, to detect one or more features of interest. In examples, sensing algorithm 518-1 may form services or features, which may be presented to an end-user. According to an implementation, communication between the MAC layer of sensing receiver 502-1 and other layers or components of sensing receiver 502-1 (including the application layer) may take place based on communication interfaces, such as an MLME interface and a data interface. In examples, sensing agent 516-1 may be configured to determine a number and timing of sensing transmissions and sensing measurements for the purpose of Wi-Fi sensing. In some implementations, sensing agent 516-1 may be configured to transmit sensing measurements to plurality of sensing transmitters 504-(1-N) and/or remote processing device 506 for further processing. In an implementation, sensing agent 516-1 may be configured to cause at least one transmitting antenna of transmitting antenna(s) 512-1 to transmit messages to one or more of plurality of sensing transmitters 504-(1-N) or to remote processing device 506. Further, sensing agent 516-1 may be configured to receive, via at least one receiving antenna of receiving antennas(s) 514-1, messages from one or more of plurality of sensing transmitters 504-(1-N) or from remote processing device 506. In an example, sensing agent 516-1 may be configured to make sensing measurements based on sensing transmissions received from one or more of plurality of sensing transmitters 504-(1-N).

In some embodiments, sensing receiver 502-1 may include sensing measurements storage 520-1. In an implementation, sensing measurements storage 520-1 may store sensing measurements computed by sensing receiver 502-1 based on received sensing transmissions. In an example, sensing measurements stored in sensing measurements storage 520-1 may be periodically or dynamically updated as required. In some embodiments, sensing receiver 502-1 may include sensing measurement parameters storage 522-1. In an implementation, sensing measurement parameters storage 522-1 may store sensing measurement parameters and/or transmission parameters applicable to one or more sensing measurement setups. In an implementation, sensing measurement parameters storage 522-1 may store sensing measurement parameters and/or transmission parameters applicable to one or more sensing measurement sessions. In an implementation, sensing measurement parameters storage 522-1 may store sensing measurement parameters and/or transmission parameters applicable to one or more sensing measurement instances. In an example, sensing measurement parameters and/or transmission parameters stored in sensing measurement parameters storage 522-1 may be periodically or dynamically updated as required. In an implementation, sensing measurements storage 520-1 and sensing measurement parameters storage 522-1 may include any type or form of storage, such as a database or a file system or coupled to memory 510-1.

Referring again to FIG. 5, sensing transmitter 504-1 (which is an example of one or more of plurality of sensing transmitters 504-(1-N)) may include processor 528-1 and memory 530-1. For example, processor 528-1 and memory 530-1 of sensing transmitter 504-1 may be processor 114 and memory 116, respectively, as shown in FIG. 1. In an embodiment, sensing transmitter 504-1 may further include transmitting antenna(s) 532-1, receiving antenna(s) 534-1, and sensing agent 536-1.

Sensing agent 536-1 may be configured to cause at least one transmitting antenna of transmitting antenna(s) 532-1 and at least one receiving antenna of receiving antennas(s) 534-1 to exchange messages with one or more of plurality of sensing receivers 502-(1-M)) or with remote processing device 506. In some embodiments, an antenna may be used to both transmit and receive in a half-duplex format. When the antenna is transmitting, it may be referred to as transmitting antenna 532-1, and when the antenna is receiving, it may be referred to as receiving antenna 534-1. It is understood by a person of normal skill in the art that the same antenna may be transmitting antenna 532-1 in some instances and receiving antenna 534-1 in other instances. In the case of an antenna array, one or more antenna elements may be used to transmit or receive a signal, for example, in a beamforming environment. In some examples, a group of antenna elements used to transmit a composite signal may be referred to as transmitting antenna 532-1, and a group of antenna elements used to receive a composite signal may be referred to as receiving antenna 534-1. In some examples, each antenna is equipped with its own transmission and receive paths, which may be alternately switched to connect to the antenna depending on whether the antenna is operating as transmitting antenna 532-1 or receiving antenna 534-1.

In an implementation, sensing agent 536-1 may be responsible for causing sensing transmitter 504-1 to send sensing transmissions and, in examples, receive associated sensing measurements from one or more of plurality of sensing receivers 502-(1-M). In examples, sensing agent 536-1 may be responsible for processing sensing measurements to fulfill a sensing goal. In some implementations, sensing agent 536-1 may run in the medium access control (MAC) layer of sensing transmitter 504-1 and processing sensing measurements to fulfill a sensing goal may be carried out by sensing algorithm 538-1, which in examples may run in the application layer of sensing transmitter 504-1. In examples, sensing algorithm 538-1 running in the application layer of sensing transmitter 504-1 may be known as a Wi-Fi sensing agent, a sensing application, or a sensing algorithm. In examples, sensing algorithm 538-1 may include and/or execute sensing agent 536-1. According to some implementations, sensing agent 536-1 may include and/or execute sensing algorithm 538-1. In some implementations, sensing agent 536-1 may run in the MAC layer of sensing transmitter 504-1 and sensing algorithm 538-1 may run in the application layer of sensing transmitter 504-1. In some implementations, sensing agent 536-1 of sensing transmitter 504-1 and sensing algorithm 538-1 may run separately on processor 528-1. In an implementation, sensing agent 536-1 may pass sensing measurement parameters, transmission parameters, or physical layer parameters between the MAC layer of sensing transmitter 504-1 and the application layer of sensing transmitter 504-1. In an example, sensing agent 536-1 in the MAC layer or sensing algorithm 538-1 in the application layer may control physical layer parameters, for example physical layer parameters used to generate one or more sensing transmissions. In examples, sensing algorithm 538-1 may form services or features, which may be presented to an end-user. According to an implementation, communication between the MAC layer of sensing transmitter 504-1 and other layers or components of sensing transmitter 504-1 (including the application layer) may take place based on communication interfaces, such as an MLME interface and a data interface. In examples, sensing agent 536-1 may be configured to determine a number and timing of sensing transmissions for the purpose of Wi-Fi sensing. In some implementations, sensing agent 536-1 may be configured to cause sensing transmitter 504-1 to transmit sensing transmissions to one or more of plurality of sensing receivers 502-(1-M). In an implementation, sensing agent 536-1 may be configured to cause at least one transmitting antenna of transmitting antenna(s) 532-1 to transmit messages to one or more of plurality of sensing receivers 502-(1-M) or to remote processing device 506. Further, sensing agent 536-1 may be configured to receive, via at least one receiving antenna of receiving antennas(s) 534-1, messages from one or more of plurality of sensing receivers 502-(1-M) or from remote processing device 506.

In some embodiments, sensing transmitter 504-1 may include sensing measurements storage 540-1. In an implementation, sensing measurements storage 540-1 may store sensing measurements computed by one or more of plurality of sensing receivers 502-(1-M) based on sensing transmissions sent by sensing transmitter 504-1 and sent by one or more of plurality of sensing receivers 502-(1-M) to sensing transmitter 504-1. In an example, sensing measurements stored in sensing measurements storage 540-1 may be periodically or dynamically updated as required. In an implementation, sensing measurements storage 540-1 may include any type or form of storage, such as a database or a file system or coupled to memory 530-1.

In some embodiments, sensing transmitter 504-1 may include sensing measurement parameters storage 542-1. In an implementation, sensing measurement parameters storage 542-1 may store sensing measurement parameters and/or transmission parameters applicable to one or more sensing measurement sessions. In an implementation, sensing measurement parameters storage 542-1 may store sensing measurement parameters and/or transmission parameters applicable to one or more sensing measurement setups. In an implementation, sensing measurement parameters storage 542-1 may store sensing measurement parameters and/or transmission parameters applicable to one or more sensing measurement instances. In an example, sensing measurement parameters and/or transmission parameters stored in sensing measurement parameters storage 542-1 may be periodically or dynamically updated as required. In an implementation, sensing measurements storage 540-1 and sensing measurement parameters storage 542-1 may include any type or form of storage, such as a database or a file system or coupled to memory 530-1.

Referring to FIG. 5 in more detail, remote processing device 506 may include processor 548 and memory 550. For example, processor 548 and memory 550 of remote processing device 506 may be processor 114 and memory 116, respectively, as shown in FIG. 1. In an embodiment, remote processing device 506 may further include transmitting antenna(s) 552, receiving antenna(s) 554, sensing agent 556, and sensing algorithm, 558. In some embodiments, an antenna may be used to both transmit and receive signals in a half-duplex format. When the antenna is transmitting, it may be referred to as transmitting antenna 552, and when the antenna is receiving, it may be referred to as receiving antenna 554. It is understood by a person of normal skill in the art that the same antenna may be transmitting antenna 552 in some instances and receiving antenna 554 in other instances. In the case of an antenna array, one or more antenna elements may be used to transmit or receive a signal, for example, in a beamforming environment. In some examples, a group of antenna elements used to transmit a composite signal may be referred to as transmitting antenna 552, and a group of antenna elements used to receive a composite signal may be referred to as receiving antenna 554. In some examples, each antenna is equipped with its own transmission and receive paths, which may be alternately switched to connect to the antenna depending on whether the antenna is operating as transmitting antenna 552 or receiving antenna 554.

In an implementation, sensing agent 556 may be responsible for determining sensing measurement parameters and/or transmission parameters for one or more sensing measurement setups. In examples, sensing agent 556 may receive sensing measurement parameters and/or transmission parameters for one or more sensing measurement setups from sensing algorithm 558. In an example, sensing agent 556 may receive sensing measurements from one or more of plurality of sensing receivers 502-(1-M) and may process the sensing measurements to fulfill a sensing goal. In an example, sensing agent 556 may receive channel representation information (such as CSI or TD-CRI) from one or more of plurality of sensing receivers 502-(1-M) and may process the channel representation information to fulfill a sensing goal. In implementations, sensing agent 556 may receive sensing measurements or channel representation information and may provide the received sensing measurements or channel representation information to sensing algorithm 558, and sensing algorithm 558 may receive the sensing measurements or channel representation information from sensing agent 556 and may process the information to fulfill a sensing goal.

In some implementations, receiving sensing measurements may be carried out by an algorithm running in the medium access control (MAC) layer of remote processing device 506 and processing sensing measurements to fulfill a sensing goal may be carried out by an algorithm running in the application layer of remote processing device 506. In examples, the algorithm running in the application layer of remote processing device 506 may be known as a Wi-Fi sensing agent, a sensing application, or sensing algorithm. In some implementations, the algorithm running in the MAC layer of remote processing device 506 and the algorithm running in the application layer of remote processing device 506 may run separately on processor 548. In an implementation, sensing agent 556 may pass physical layer parameters (e.g., such as channel representation information, examples of which are CSI and TD-CRI) from the MAC layer of remote processing device 506 to the application layer of remote processing device 506 and may use the physical layer parameters to detect one or more features of interest. In an example, the application layer may operate on the physical layer parameters and form services or features, which may be presented to an end-user. According to an implementation, communication between the MAC layer of remote processing device 506 and other layers or components of remote processing device 506 may take place based on communication interfaces, such as an MLME interface and a data interface. According to some implementations, sensing agent 556 may include/execute a sensing algorithm 558. In an implementation, sensing agent 556 may process and analyze sensing measurements using sensing algorithm 558 and identify one or more features of interest. Further, sensing agent 556 may be configured to determine a number and timing of sensing transmissions and sensing measurements for the purpose of Wi-Fi sensing. In some implementations, sensing agent 556 may be configured to cause one or more of plurality of sensing transmitters 504-(1-N) to transmit sensing measurements to one or more of plurality of sensing receivers 502-(1-M).

In some embodiments, system 500 may include power variations information storage 562. In an implementation, power variations information storage 562 may store information related to power variations of links and link combos. In an example, information related to power variations of links and link combos stored in power variations information storage 562 may be periodically or dynamically updated as required. Although, it has been described that power variations information storage 562 is implemented external to plurality of sensing receivers 502-(1-M) and plurality of sensing transmitters 504-(1-N), in some embodiments, power variations information storage 562 may be implemented within each of plurality of sensing receivers 502-(1-M) and/or each of plurality of sensing transmitters 504-(1-N).

In some embodiments, system 500 may include sensing information storage 564. In an implementation, sensing information storage 564 may store sensing sounding information. In examples, the sensing sounding information may include information about a plurality of power variations among a plurality of candidate sensing links between a plurality of sensing capable devices and access point. Each power variation may be characterized by a grouping of one or more candidate sensing links that display a variation in received power compared to an average power of sensing transmissions of the respective candidate sensing links during one or more sampling instances of an analysis period. In an example, sensing sounding information stored in sensing information storage 564 may be periodically or dynamically updated as required. Although, it has been described that sensing information storage 564 is implemented external to plurality of sensing receivers 502-(1-M) and plurality of sensing transmitters 504-(1-N), in some embodiments, sensing information storage 564 may be implemented within each of plurality of sensing receivers 502-(1-M) and/or each of plurality of sensing transmitters 504-(1-N). For ease of explanation and understanding, descriptions provided above may be with reference to sensing receiver 502-1 and/or sensing transmitter 504-1, however, the description is equally applicable to one or more of plurality of sensing receivers 502-(1-M) and/or one or more of plurality of sensing transmitters 504-(1-N).

According to one or more implementations, communications in network 560 may be governed by one or more of the 802.11 family of standards developed by IEEE. Some example IEEE standards may include IEEE 802.11-2020, IEEE 802.11ax-2021, IEEE 802.11me, IEEE 802.11az and IEEE 802.11be. IEEE 802.11-2020 and IEEE 802.11ax-2021 are fully-ratified standards whilst IEEE 802.11me reflects an ongoing maintenance update to the IEEE 802.11-2020 standard and IEEE 802.11be defines the next generation of standard. IEEE 802.11az is an extension of the IEEE 802.11-2020 and IEEE 802.11ax-2021 standards which adds new functionality. In some implementations, communications may be governed by other standards (other or additional IEEE standards or other types of standards). In some embodiments, parts of network 560 which are not required by system 500 to be governed by one or more of the 802.11 family of standards may be implemented by an instance of any type of network, including wireless network or cellular network. Further, IEEE 802.11ax included OFDMA, which allows sensing receiver 502 to simultaneously transmit data to all participating devices, such as plurality of sensing transmitters 504-(1-N), and vice versa using a single transmission opportunity (TXOP). The efficiency of OFDMA depends on how sensing receiver 502 schedules channel resources (interchangeably referred to as RUs) among plurality of sensing transmitters 504-(1-N) and configures transmission parameters. According to an implementation, system 500 may be an OFDMA enabled system.

Referring back to FIG. 5, according to one or more implementations, system 500 may participate in a sensing session. In examples, a sensing session may be an agreement between a sensing initiator and a sensing responder to participate in a WLAN sensing procedure (also known as a Wi-Fi sensing procedure). In examples, sensing measurement parameters associated with a sensing session may be determined by the sensing initiator and may be exchanged between the sensing initiator and the sensing responder. In examples, sensing initiator may be sensing transmitter 504-1 and sensing responder may be sensing receiver 502-1. In examples, sensing initiator may be sensing receiver 502-1 and sensing responder may be sensing transmitter 504-1. In examples, sensing initiator may be remote processing device 506, and both sensing transmitter 504-1 and sensing receiver 502-1 may be sensing responders. In examples, sensing transmitter 504-1 may participate in multiple sensing sessions either as a sensing initiator or as a sensing responder. In examples, sensing receiver 502-1 may participate in multiple sensing sessions either as a sensing initiator or as a sensing responder. In examples, remote processing device 506 may participate in multiple sensing sessions as a sensing initiator.

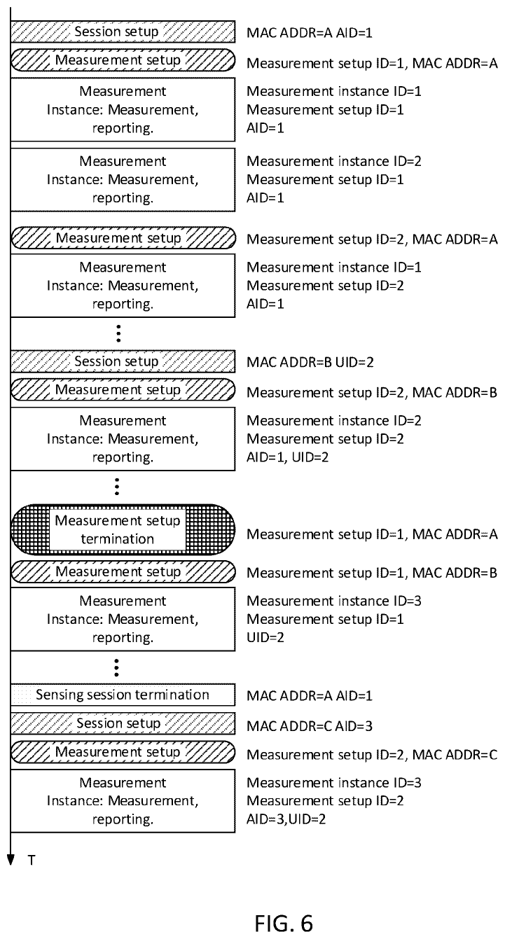

FIG. 6 illustrates an example of a WLAN sensing procedure (also known as a Wi-Fi sensing procedure) according to some embodiments. In examples, a WLAN sensing procedure allows a STA to perform WLAN sensing. In an example, a WLAN sensing procedure enables a STA to obtain one or more sensing measurements of the wireless transmission channel between two or more STAs and/or the wireless transmission channel between a receive antenna and a transmit antenna of a STA. In examples, a WLAN sensing procedure is composed of one or more of a sensing session setup, a sensing measurement setup, one or more sensing measurement instances, sensing measurement setup termination, and sensing session termination.

FIG. 6 illustrates a sensing session setup with a STA with MAC ADDR=A and AID=1. In examples, a sensing session setup establishes a sensing session. In examples, the sensing session may be identified by the AID of the STA involved in the sensing session. FIG. 6 illustrates a sensing measurement setup procedure for the STA with MAC ADDR=A, where the sensing measurement setup ID=1.

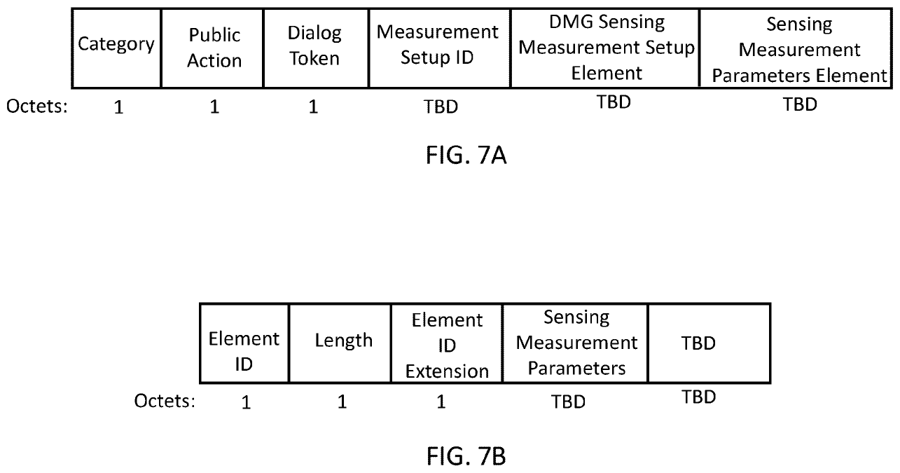

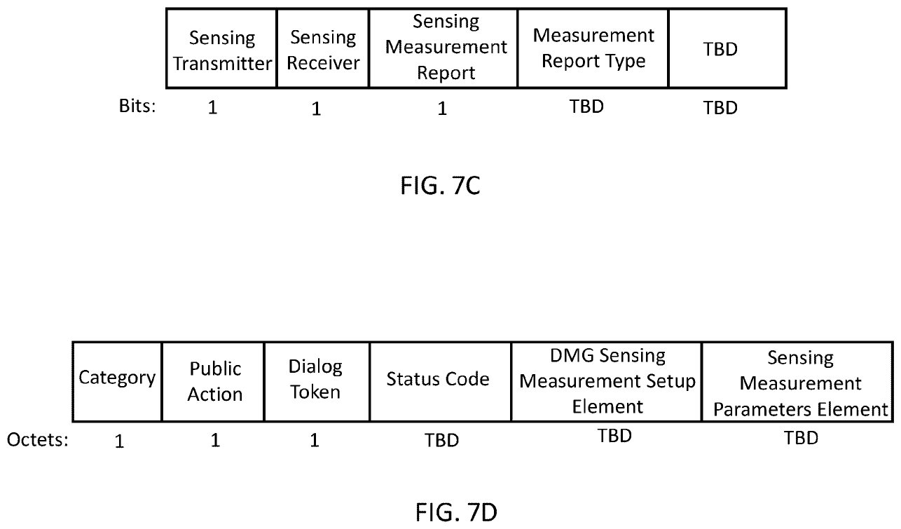

In examples, a sensing measurement setup allows for a sensing initiator and a sensing responder to exchange and agree on operational attributes associated with a sensing measurement instance. A sensing initiator may transmit a Sensing Measurement Setup Request frame to a sensing responder with which it intends to perform a sensing measurement setup. An example of a Sensing Measurement Setup Request frame is provided in FIG. 7A. In examples, the Sensing Measurement Setup Request frame is a Public Action frame, and in examples is identified by a Public Action field value. As shown in the example illustrated in FIG. 7A, in embodiments, a Sensing Measurement Set Request frame format may include one or more of a Category field, a Public Action field, a Dialog Token field, a Measurement Setup ID field, a DMG Sensing Measurement Setup Element field, and a Sensing Measurement Parameters element. In examples, a Category value code is defined for a “Protected Sensing Frame”. In an embodiment, a Protected Sensing Action field is defined in the octet immediately after the Category field in order to differentiate Protected Sensing Frame formats from Public Sensing Frame formats.

FIG. 7B illustrates an example, according to some embodiments, of a Sensing Measurement Parameters element. In examples, a Sensing Measurement Parameters element indicates operational attributes of a corresponding sensing measurement instance. In examples, the Sensing Measurement Parameters element comprises a Sensing Measurement Parameters field. FIG. 7C illustrates an example of a format of a Sensing Measurement Parameters field, according to some embodiments. In an example, a Sensing Measurement Parameters field comprises a Sensing Transmitter subfield. The Sensing Transmitter subfield may be set to 1 to indicate a sensing responder assumes a sensing transmitter role, such as sensing transmitter 504-1. In an example, the sensing responder assumes a sensing transmitter role according to the Sensing Transmitter subfield for the Sensing Measurement Setup ID associated with the Sensing Measurement Parameters field. In an example, the Sensing Measurement Parameters field comprises a Sensing Receiver subfield. The Sensing Receiver subfield may be set to 1 to indicate a sensing responder assumes a sensing receiver role, such as sensing receiver 502-1. In an example, the sensing responder assumes a sensing receiver role according to the Sensing Receiver subfield for the Sensing Measurement Setup ID associated with the Sensing Measurement Parameters field.

Referring again to FIG. 7C, in examples, a Sensing Measurement Parameters field format includes a Sensing Measurement Report subfield if the Sensing Receiver subfield indicates that the sensing responder should assume a sensing receiver role. In an example, the Sensing Measurement Report subfield may indicate that whether or not a sensing responder sends Sensing Measurement Report frames in sensing measurement instances that result from the sensing measurement setup.

Referring again to FIG. 7C, in examples a Sensing Measurement Parameters field format includes a Measurement Report Type subfield. In examples, the Measurement Report Type subfield indicates the type of measurement result reported in sensing measurement instance(s) corresponding to the sensing measurement setup ID, for example, when the sensing initiator is a sensing transmitter, such as sensing transmitter 504-1.

In examples, after the sensing responder receiver the Sensing Measurement Setup Request frame, the sensing responder may transmit a Sensing Measurement Setup Response frame. An example of a Sensing Measurement Setup Response frame is provided in FIG. 7D. In examples, the sensing responder may use a Status Code field in the Sensing Measurement Setup Response frame to indicate whether the sensing responder accepts the requested sensing measurement setup parameters in the received Sensing Measurement Setup Request frame. In an embodiment, the Status Code field may be set to 0 indicating a successful sensing measurement setup, where the sensing responder accepts the operational attributes included in the Sensing Measurement Setup Request frame. In examples, the sensing responder may indicate in the Sensing Measurement Setup Response frame that the operational attributes included in the Sensing Measurement Setup Request frame sent by the sensing initiator are not accepted, for example by setting a Status Code field to a non-zero value. In examples, the sensing responder may indicate in the Sensing Measurement Setup Response frame preferred sensing measurement parameters, for example to indicate to the sensing initiator one or more operational attributes preferred by the sensing responder. In examples, the sensing responder may indicate to the sensing initiator that preferred sensing measurement parameters are included in the Sensing Measurement Setup Response frame by setting a Status Code field to a non-zero value.

In examples, the sensing initiator may assign a role to the sensing responder as part of the sensing measurement setup sent in the Sensing Measurement Setup Request frame. For example, the sensing initiator may indicate to a sensing responder that the sensing responder is to assume the role of a sensing receiver, such as sensing receiver 502-1, or the role of a sensing transmitter, such as sensing transmitter 504-1, or the role of sensing receiver 502-1 and sensing transmitter 504-1. In examples, sensing initiator may indicate to sensing responder whether the sensing responder sends sensing measurement report frames in sensing measurement instances. In an embodiment, the role assigned to the sensing responder and/or whether the sensing responder sends sensing measurement report frames persists until the sensing measurement setup is terminated.

Referring again to FIG. 6 and the sensing session with the STA with MAC ADDR=A identified by the STA AID, AID=1, the sensing measurement setup is followed by one or more sensing measurement instances and measurement reporting instances which may be performed based on the defined operational attribute set. In the example shown in FIG. 6, the one or more sensing measurement instances for the STA with MAC ADDR=A may be assigned sensing measurement instance IDs, for example, a first sensing measurement instance may be assigned sensing measurement instance ID=1, and a second measurement instance may be assigned sensing measurement instance ID=2. In examples, a sensing measurement instance may be uniquely associated with a sensing measurement setup.

Referring again to FIG. 6, a second sensing measurement setup may be initiated for the STA with MAC ADDR=A, which may be identified as sensing measurement setup ID=2. As with sensing measurement setup ID=1, sensing measurement setup ID=2 may be associated with a second operational attribute set. In examples, after the second sensing measurement setup, any subsequent one or more sensing measurement instances may be performed based on either the first operational attribute set (sensing measurement setup ID=1) or the second operational attribute set (sensing setup measurement ID=2.)

Referring again to FIG. 6, FIG. 6 illustrates a sensing session setup with a STA with MAC ADDR=B and UID=2. In examples, the sensing session may be identified by the UID of the STA with MAC ADDR=B. FIG. 6 further illustrates a sensing measurement setup for the STA with MAC ADDR=B. In the example, the operational attribute set for the sensing measurement setup for the STA with MAC ADDR=B is the same as the second operational attribute set established with the STA with MAC ADDR-A, and the sensing measurement setup ID is used for both the STA with MAC ADDR=A and the STA with MAC ADDR=B. That is, a sensing measurement setup ID (which may also be referred to as a sensing measurement setup label) may apply to one or more STA. In examples according to FIG. 6, subsequent sensing measurement instances associated with sensing measurement setup ID=2 may be associated with the STA with MAC ADDR=A, the STA with MAC ADDR=B, or with both the STA with MAC ADDR=A and the STA with MAC ADDR=B. An example of one-to-many triggering is shown in FIG. 6 where AID=1 and UID=2 are both associated with a single measurement instance and measurement reporting (measurement instance ID=2 and measurement setup ID=2).

In examples, an operational attribute set of a sensing session may be terminated by performing a sensing measurement setup termination procedure, for example as is shown in FIG. 6 for sensing measurement setup ID=1 and the STA with MAC ADDR=A. In examples, the sensing measurement setup ID of a terminated sensing measurement setup may be used for a subsequent sensing measurement setup. This is shown in FIG. 6 where a sensing measurement setup with ID=1 is established for the STA with MAC ADDR=B, after the termination of the sensing measurement setup ID=1 with the STA with MAC ADDR=A. In some embodiments, a sensing session may be terminated using a sensing session termination procedure, as shown in FIG. 6.

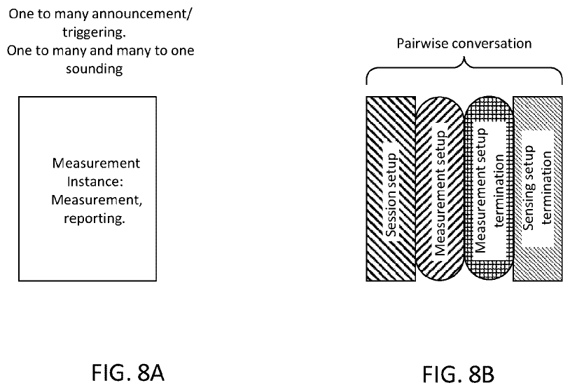

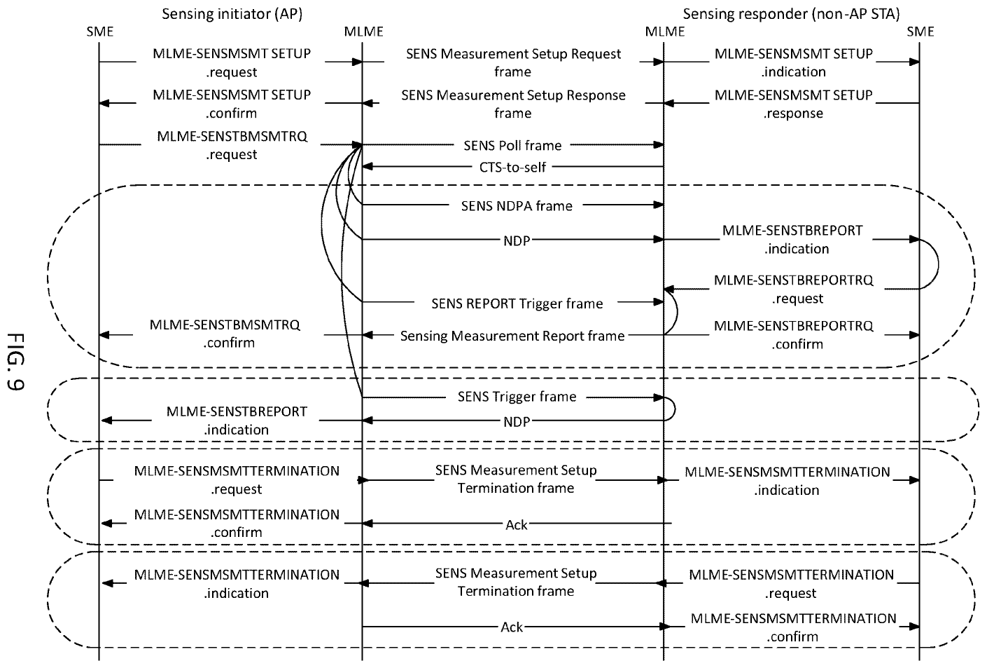

FIG. 8A illustrates exchanges between a sensing initiator and a sensing responder that may be one-to-many or many-to-one. In examples, a measurement instance and/or measurement reporting may have a one-to-one (single device to single device) announcement or triggering or may have a one-to-many (single device to multiple device) announcement or triggering. In examples, a measurement instance may have a one-to-one, one-to-many, or many-to-one (many devices to a single device) sounding.

As previously described, a sensing session is an agreement between a sensing initiator and a sensing responder to participate in a WLAN sensing procedure, that is a sensing session is pairwise and in examples, may be identified by MAC addresses of the sensing initiator and the sensing responder or by the associated AID/UID. FIG. 8B shows an example of pairwise exchanges or procedures that may take place between a sensing initiator and a sensing responder related to a sensing session, which include a sensing session setup, a sensing measurement setup, a sensing measurement setup termination, and a sensing session termination.

In examples, a sensing measurement instance of a WLAN sensing procedure may be a trigger-based (TB) sensing measurement instance. FIG. 9 depicts a message flow of a sensing session of a WLAN sensing procedure comprising a sensing measurement setup procedure followed by one or more trigger-based (TB) sensing measurement instances that consists of either NDPA sounding or trigger frame (TF) sounding, following by a sensing measurement setup termination procedure, according to some examples. In examples, a TB sensing measurement instance may be used where the sensing initiator is an AP and one or more non-AP STAs are sensing responders. In examples, a TB sensing measurement instance may include a polling phase, an NDPA sounding phase, a trigger frame (TF) sounding phase, and a reporting phase.

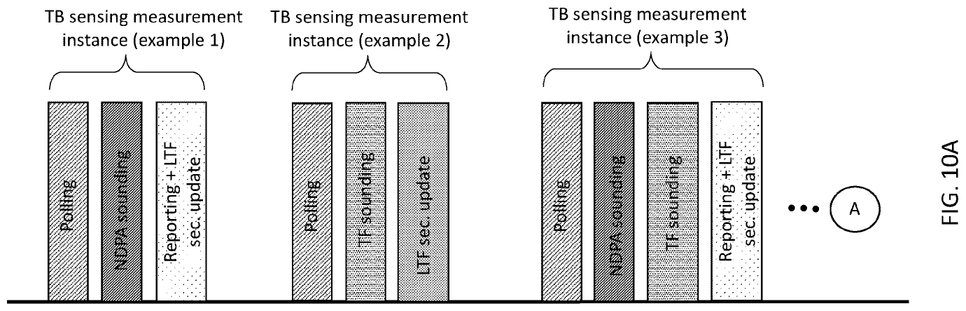

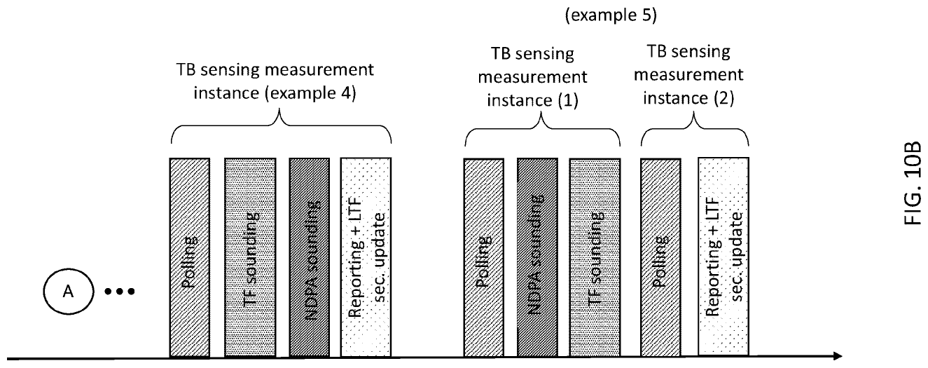

FIG. 10A and FIG. 10B illustrate five examples of TB sensing measurement instances. Example 1 of FIG. 10A illustrates an example of a TB sensing measurement instance comprising a polling phase, an NDPA sounding phase, and a reporting phase. Example 2 of FIG. 10A illustrates an example of a TB sensing measurement instance comprising a polling phase and a TF sounding phase. Example 3 of FIG. 10A and example 4 of FIG. 10B illustrate two examples of a TB sensing measurement instance comprising a polling phase, an NDPA sounding phase, a TF sounding phase, and a reporting phase. Example 5 of FIG. 10B shows two TB sensing measurement instances, where the first TB sensing measurement instance comprises a polling phase, an NDPA sounding phase, and a TF sounding phase, and the second TB sensing measurement instance comprises a polling phase and a reporting phase. In examples, the TF sounding phase of the TB sensing measurement instance may precede the NDPA sounding phase of the TB sensing measurement instance, for example, as in Example 4. In examples, the NDPA sounding phase of the TB sensing measurement instance may precede the NDPA sounding phase of the TB sensing measurement instance, for example as in Example 3. In some embodiments, the reporting phase of the second TB sensing measurement instance in Example 5 may be addressed to sensing responders other than the sensing responders involved in the TF sounding phase or the NDPA sounding phase of the first TB measurement instance.

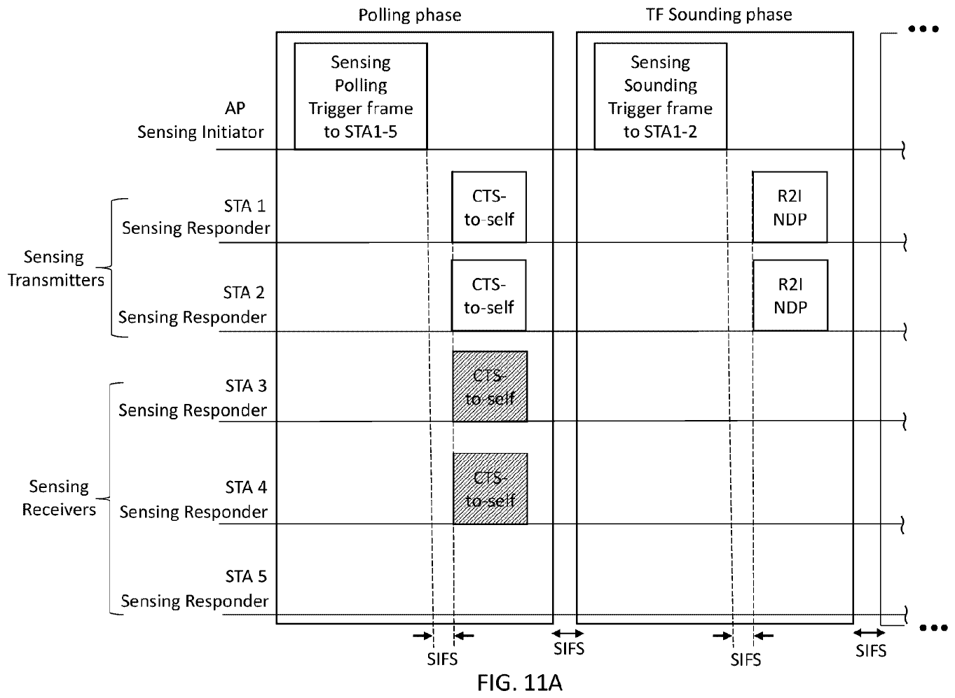

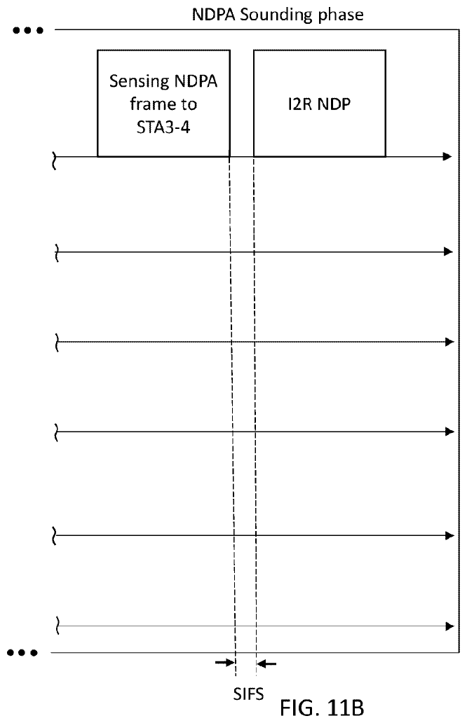

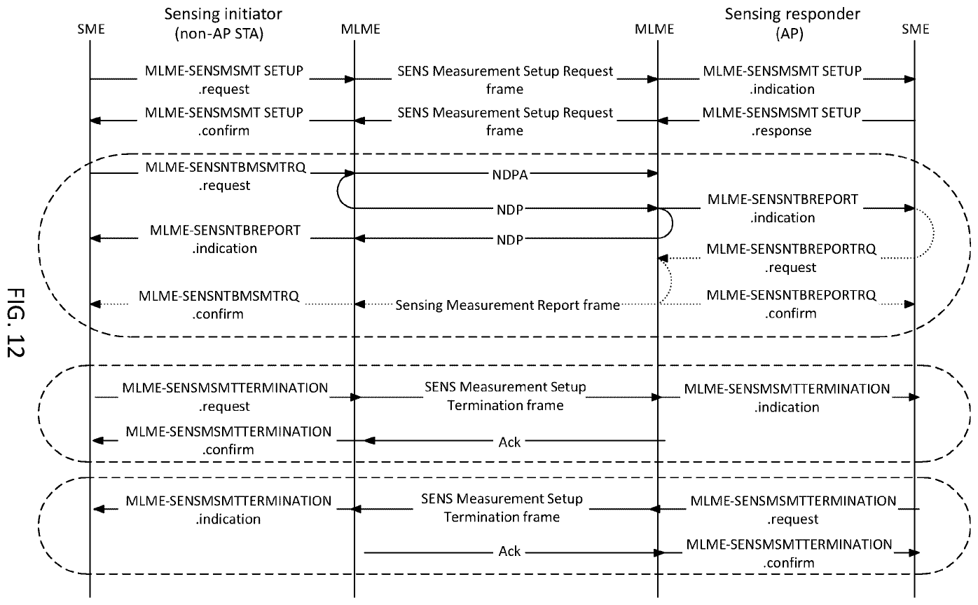

FIG. 11A and FIG. 11B is one example of a TB sensing measurement instance with a single AP in the role of a sensing initiator and five STAs, referred to as STA 1, STA 2, STA 3, STA 4, and STA 5, all of which in the example are sensing responders. In the example, the TB sensing measurement instance comprises a polling phase, a TF sounding phase, and an NDPA sounding phase. In the example, STA 1 and STA 2 are sensing transmitters, such as sensing transmitter 504-1 and sensing transmitter 504-2. In the example of FIG. 11A and FIG. 11B, STA 3, STA 4, and STA 5 are sensing receivers, such as sensing receiver 502-1, sensing receiver 502-2, and sensing receiver 502-3. In examples, in the polling phase, the AP as the sensing initiator transmits a Sensing Polling Trigger frame to STA 1, STA 2, STA 3, STA 4, and STA 5. In an embodiment, sensing transmitter STA 1 (504-1) and sensing transmitter STA 2 (504-2) respond to the Sensing Polling Trigger frame with an indication that the STA is available to participate in a sensing measurement instance. In examples, the indication is a CTS-to-self frame. In an embodiment, sensing receiver STA 3 (502-1) and sensing receiver STA 4 (502-2) respond to the Sensing Polling Trigger frame with an indication that the STA is available to participate in a sensing measurement instance. In examples, the indication is a CTS-to-self frame. In the example, sensing receiver STA 5 (502-3) does not respond to the Sensing Polling Trigger frame sent by the AP as the sensing initiator, indicating that STA 5 (502-3) will not participate in the sensing measurement instance.

The sensing measurement instance of FIG. 11A and FIG. 11B includes a TF Sounding phase. In examples, in the TF Sounding phase, the AP as the sensing initiator sends a Sensing Sounding Trigger frame to sensing transmitter STA 1 (504-1) and to sensing transmitter STA 2 (504-2). In examples, a period of one or more SIFS elapses between the AP receiving the CTS-to-self frames from STA 1, STA 2, STA 3, and STA 4 before sending the Sensing Sounding Trigger frame. In examples, responsive to receiving the Sensing Sounding Trigger frame, sensing transmitter STA 1 (504-1) and sensing transmitter STA 2 (504-2) send sensing transmissions to the AP. In examples, the sensing transmissions may comprise NDP transmissions. In an example, one or more of the NDP transmissions to the AP may be R2I NDP transmissions (as shown in the example of FIG. 11A and FIG. 11B). In examples, a period of one or more SIFS elapses between sensing transmitter STA 1 (504-1) receiving the Sensing Sounding Trigger frame and transmitting a sensing transmission, and in examples a period of one or more SIFS elapses between sensing transmitter STA 2 (504-2) receiving the Sensing Sounding Trigger frame and transmitting a sensing transmission. In examples, the AP may assume the role of sensing receiver 502-4, and the AP may make sensing measurements on the sensing transmissions from sensing transmitter STA 1 (504-1) and sensing transmitter STA 2 (504-2).

Referring again to FIG. 11A and FIG. 11B, in a NDPA sounding phase, the AP acting as sensing initiator assumes the role of sensing transmitter (504-3). In examples, the AP as sensing transmitter 504-3 transmits a sensing transmission. In examples, the sensing transmission may be a broadcast transmission. In examples, the sensing transmission may be a unicast transmission to one or more STAs, for example to sensing receiver STA 3 (502-1) and/or to sensing receiver STA 4 (502-2). In examples, a period of one or more SIFS elapses between the AP as sensing transmitter 504-3 sending the sensing NDPA frame and when the AP as sensing transmitter 504-3 sends the one or more sensing transmissions. In examples, one or more of the sensing transmissions may be a full bandwidth NDP frame. In examples, one or more of the sensing transmissions may be a partial bandwidth NDP frame. In examples, one or more of the NDP frames may be an I2R NDP frame.

In examples, a sensing measurement instance of a WLAN sensing procedure may be a non-trigger-based (non-TB) sensing measurement instance. FIG. 12 depicts a message flow of a sensing measurement setup procedure followed by one or more non-TB sensing measurement instances of a WLAN sensing procedure that consist of one or more of downlink sounding or uplink sounding, according to some embodiments, followed by a sensing measurement setup termination procedure, according to some examples. In examples, a non-TB sensing measurement instance may be used where the sensing initiator is a non-AP STA and an AP is the sensing responder. In examples of uplink sounding as shown in FIG. 12, the sensing initiator (non-AP STA) acting as a sensing transmitter (for example, sensing transmitter 504-1) transmits a sensing announcement frame followed by a sensing transmission. In examples, the sensing announcement frame may be an NDPA frame. In examples, the sensing transmission may be an NDP frame. In examples, responsive to receiving the sensing transmission, the AP acting as a sensing receiver (for example, sensing receiver 502-1), may transmit to the sensing initiator (non-AP STA in the role of sensing transmitter 504-1) a sensing measurement report, for example one or more Sensing Measurement Report frames. In examples of downlink sounding as shown in FIG. 12, the sensing initiator (non-AP STA) acting as a sensing receiver (for example, sensing receiver 502-1) transmits a sensing announcement frame. In examples, the sensing announcement frame may be an NDPA frame. In examples, responsive to receiving the sensing announcement frame, the AP acting as sensing transmitter (for example, sensing transmitter 504-1) may transmit one or more sensing transmissions. In examples, one or more of the sensing transmissions may be an NDP frame. In examples, the non-AP STA acting as a sensing receiver (502-1), responsive to receiving a sensing transmission, may make a sensing measurement on the sensing transmission. In examples, the sensing measurement setup may be terminated by the sensing initiator or the sensing responder transmitting a SENS Measurement Setup Termination frame. In examples, the sensing responder or sensing initiator (respectively) may respond with an acknowledgment.

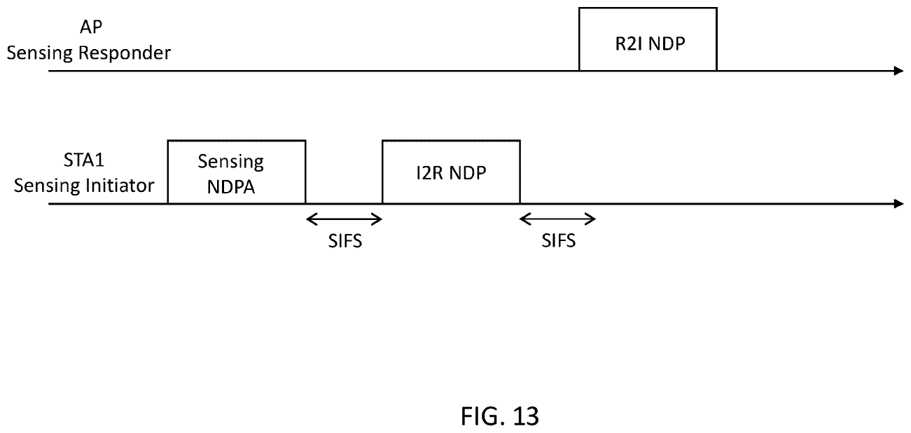

FIG. 13 illustrates a detailed example of a non-TB sensing measurement instance, according to some embodiments. In examples, STA 1 acting as sensing initiator and sensing transmitter, such as sensing transmitter 504-1, transmits a sensing announcement frame. In examples, the sensing announcement frame may be a sensing NDPA frame. In examples, one or more SIFS may elapse followed by STA 1 acting as sensing initiator and sensing transmitter (such as sensing transmitter 504-1) transmitting one or more sensing transmissions. In examples, one or more of the sensing transmissions may be an NDP frame. In an example. STA 1 acting as sensing initiator and sensing receiver, such as sensing receiver 502-1, transmits a sensing announcement frame. In examples, the sensing announcement frame may be a sensing NDPA frame. In examples, one or more SIFS may elapse followed by AP 1 acting as sensing responder and sensing transmitter (such as sensing transmitter 504-1) transmitting one or more sensing transmissions. In examples, one or more of the sensing transmissions may be an NDP frame.

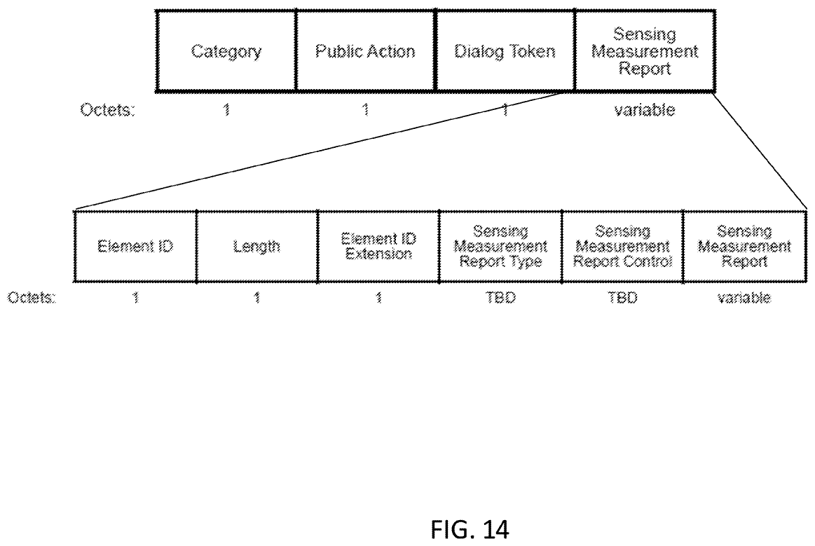

FIG. 14 illustrates an example of a Sensing Measurement Report frame. In some embodiments, a Sensing Measurement Report frame is a Public Action category or a Public Action No Ack category. In some examples, a Sensing Measurement Report frame may be transmitted to provide WLAN sensing measurements, for example to a sensing agent or a sensing algorithm of a sensing initiator. In examples, a Sensing Measurement Report frame may comprise one or more Sensing Measurement Report elements. A Sensing Measurement Report element may comprise a single sensing measurement report, in some embodiments. In examples, a Sensing Measurement Report element may include a Sensing Measurement Report type field, which may contain a number that identifies the type of sensing measurement report. For example, a value of 0 may indicate that the sensing measurement type is a CSI measurement, whereas a non-zero value may indicate that the sensing measurement type is a TD-CRI measurement.

Referring again to FIG. 14, in embodiments a Sensing Measurement Report element may include a Sensing Measurement Report Control field. In examples, the Sensing Measurement Report Control field may contain information necessary to interpret the Sensing Measurement Report field. For example, the Sensing Measurement Report Control field format may comprise one or more subfields. In an embodiment, one or more subfields of the Sensing Measurement Report Control field may include PHY layer parameters used by the sensing receiver when performing the sensing measurement, for example, receiver antenna beamforming or spatial layer information.

In a sensing session, exchanges of transmissions between one or more of plurality of sensing receivers 502-(1-M) and one or more of plurality of sensing transmitters 504-(1-N) may occur. In an example, control of these transmissions may be with the MAC layer of the IEEE 802.11 stack. According to an implementation, one or more of plurality of sensing receivers 502-(1-M) may secure a TXOP which may be allocated to one or more sensing transmissions by one or more of plurality of sensing transmitters 504-(1-N). According to an implementation, one or more of plurality of sensing receivers 502-(1-M) may allocate channel resources (or RUs) within a TXOP to the one or more of plurality of sensing transmitters 504-(1-N). In an example, one or more of plurality of sensing receivers 502-(1-M) may allocate the channel resources to the one or more of plurality of sensing transmitters 504-(1-N) by allocating time and bandwidth within the TXOP to the one or more of plurality of sensing transmitters 504-(1-N).

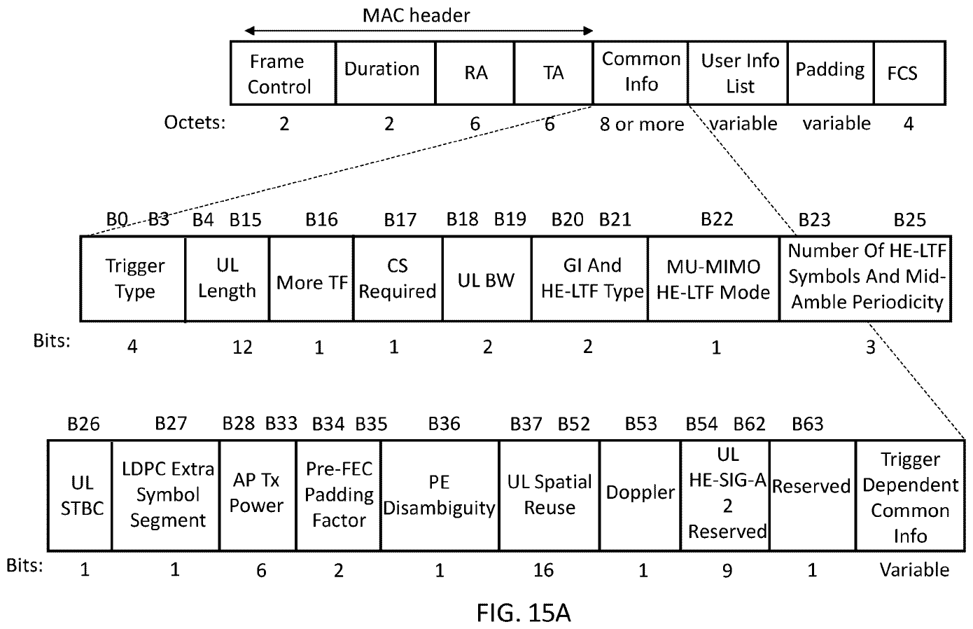

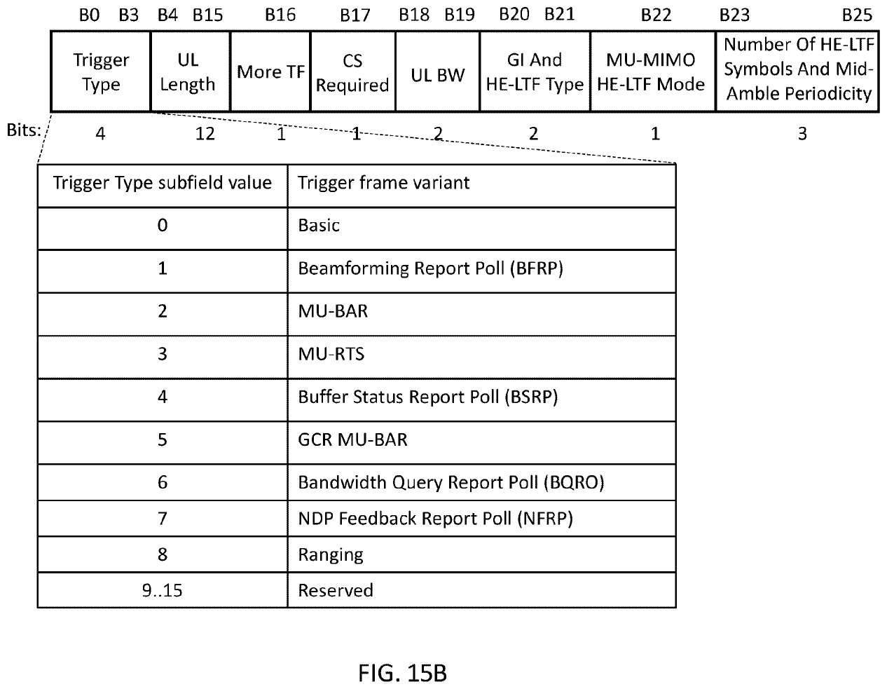

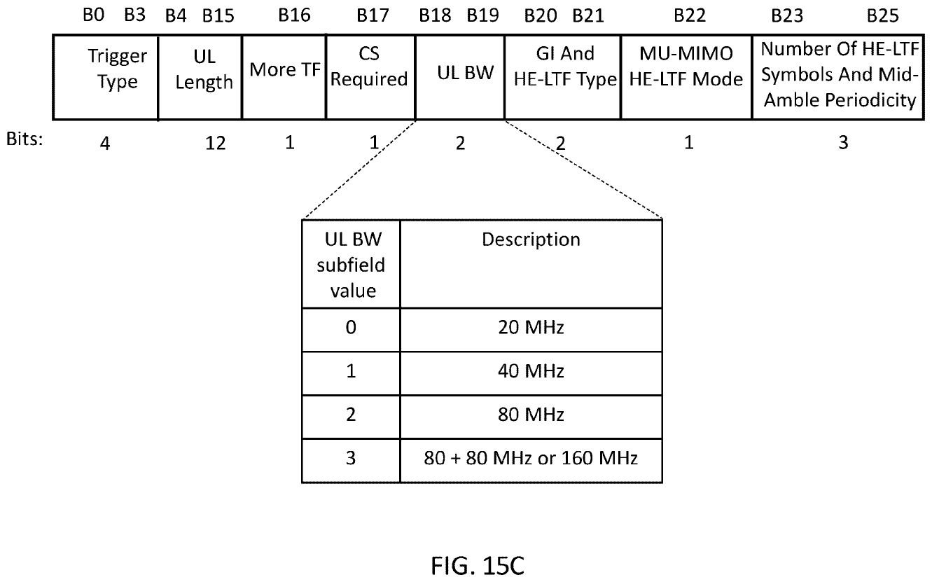

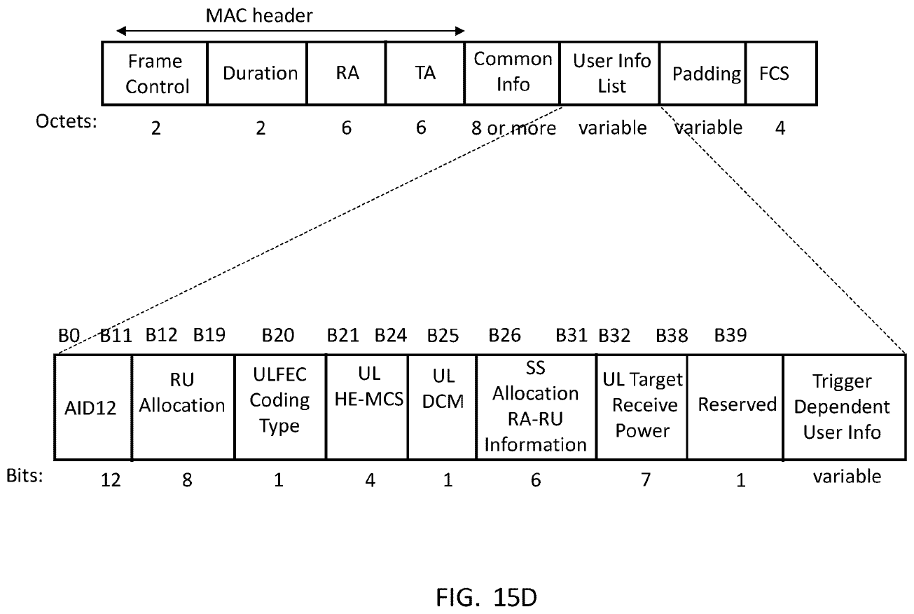

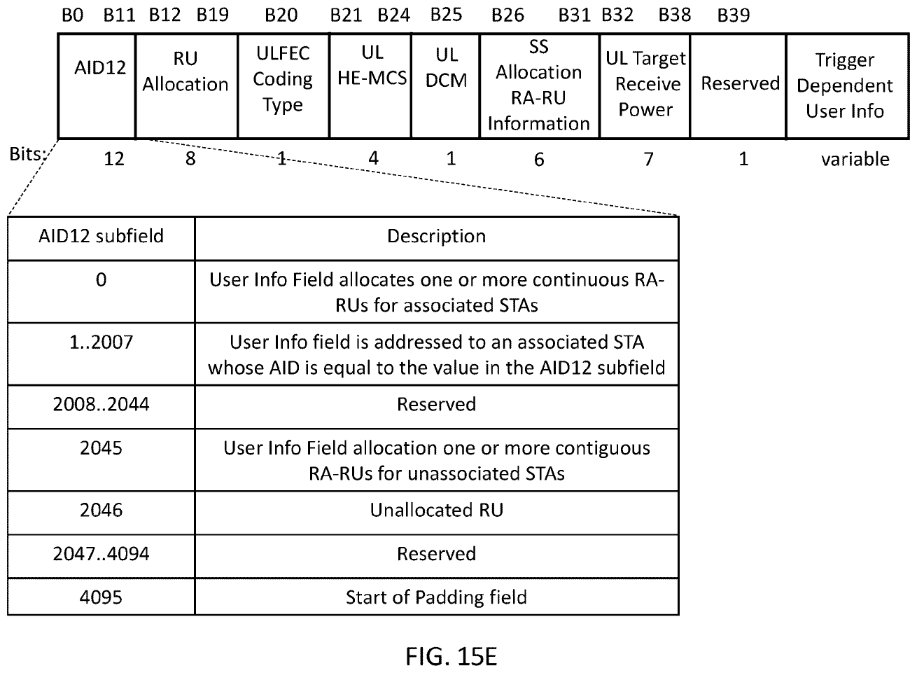

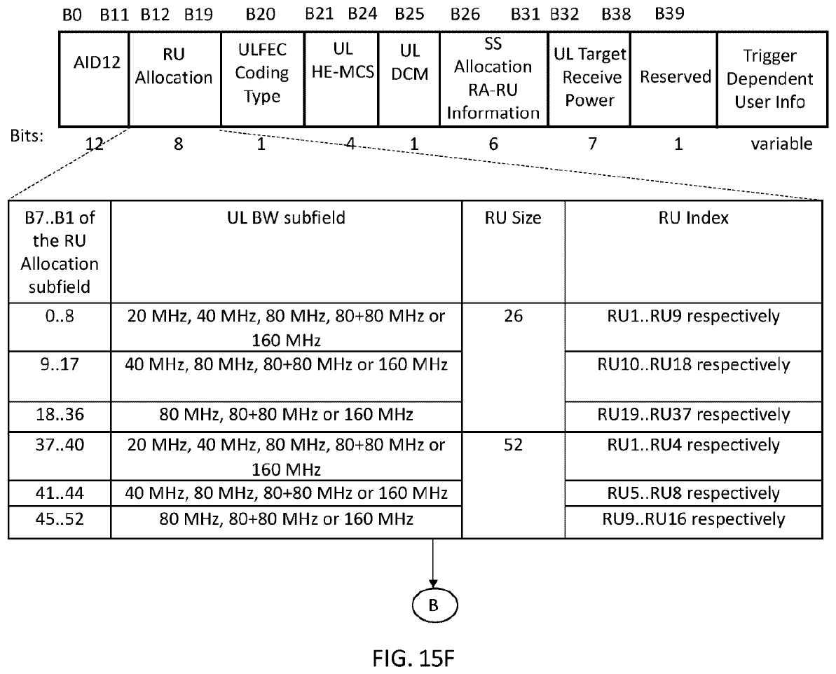

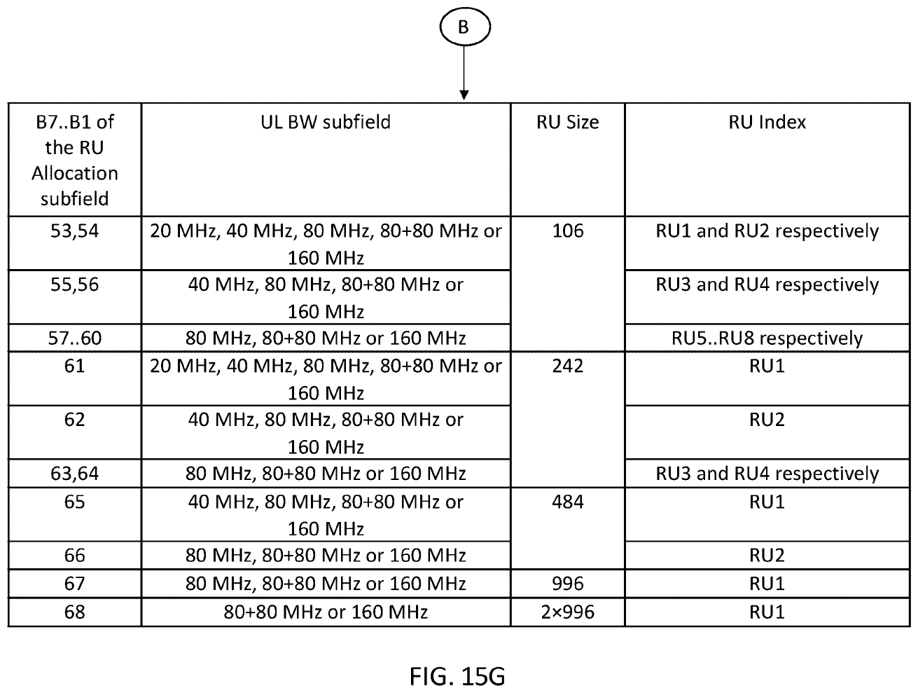

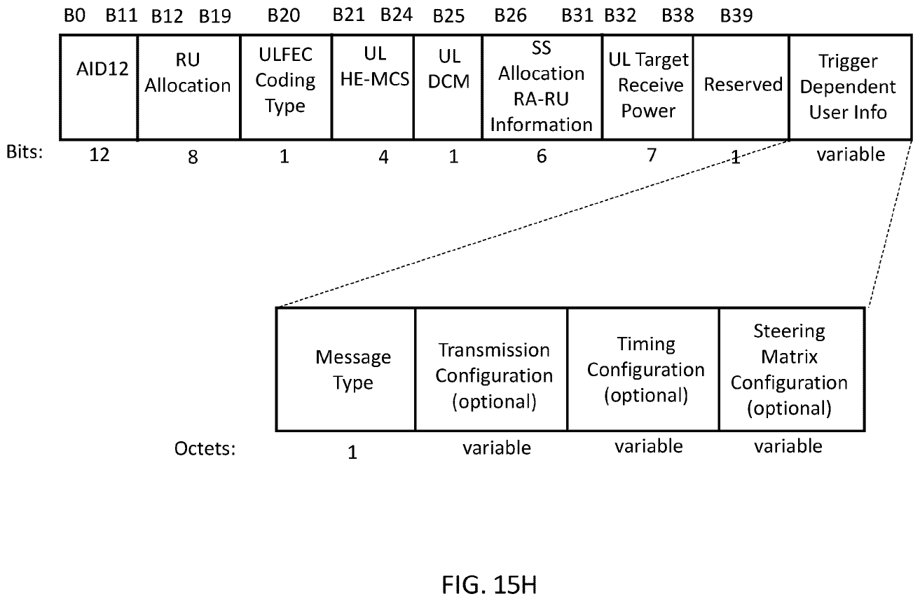

According to an implementation, example 1500 of a hierarchy of fields within sensing trigger message is shown in FIG. 15A to FIG. 15H.

As described in FIG. 15A, the Common Info field may contain information which is common to one or more of plurality of sensing transmitters 504-(1-N). According to some implementations, the requirement of an NDPA preceding an NDP may be optional. This may be indicated to one or more of plurality of sensing transmitters 504-(1-N) and may for example be encoded into a “Trigger Dependent Common Info” field if the requirement is common to plurality of sensing transmitters 504-(1-N), or into a “Trigger Dependent User Info” field if the requirement is specific to one or more of plurality sensing transmitters 504-(1-N). According to an example, the requirement for a sensing announcement (for example, and NDPA) preceding a sensing response NDP may be encoded by a single bit where 0 (bit clear) indicates that a sensing announcement is optional and 1 (bit set) indicates that a sensing announcement is required.

As described in FIG. 15B, a Trigger Type (within B0 . . . 3 of “Common Info” field) may be defined which represents a sensing trigger message. In examples, a sensing Trigger message may have a Trigger Type subfield value of any Reserved value from 9-15, for example a Sensing Trigger message may have a Trigger Type subfield value of 9. In an example of triggering a sensing transmission from a sensing transmitter 504-1, a Trigger Dependent User Info field may include sensing trigger message data. In an implementation, a time-synchronized sensing transmission may be required from plurality of sensing transmitters 504-(1-N) responding to a sensing trigger message. In an example, the requirement for one or more time-synchronized sensing transmissions may be encoded into a Trigger Dependent Common Info field. According to an example, the requirement for one or more time-synchronized sensing transmissions may be encoded by a single bit where 0 (bit clear) represents a request for a normal or non-time-synchronized response and 1 (bit set) represents a request for a time-synchronized response. In some examples, a method of time-synchronization may be requested in the sensing trigger. In examples, the method of time-synchronization to be requested may be encoded into a Trigger Dependent Common Info field. In examples the encoding may use two bits as shown in the following table.

| En- | | |
|---|---|---|
| coding | Method | Description |
| 00 | A | Sensing announcement followed by sensing NDP. |
| 01 | B | Padding followed by a sensing response message. |
| 10 | C | Sensing NDP without an initial sensing announcement. |
| 11 | N/A | For future use or extensions. |

As described in FIG. 15C the sensing trigger message may have an uplink bandwidth (UL BW) subfield value of 0, 1, 2 or 3 corresponding to bandwidths of 20 MHz, 40 MHz, 80 MHz, or 80+80 MHz (160 MHz).

As described in FIG. 15D, the User Info List contains information which is specific to each of the plurality of sensing transmitters 504-(1-N). In examples, the User Info List may include the AID of a sensing transmitter, an RU allocation for a sensing transmitter, and other Trigger Dependent User Info.

As described in FIG. 15E, the AID12 subfield of the User Info List illustrated in FIG. 15D may be used to address a specific sensing transmitter of the plurality of sensing transmitters 504-(1-N).

As described in FIG. 15F and FIG. 15G, the RU Allocation subfield is used to allocate resource units (RU) to each of the plurality of sensing transmitters 504-(1-N).

As described in FIG. 15H, the Trigger Dependent User Info subfield may be used to request the transmission configuration and/or steering matrix configuration for one or more of the plurality of sensing transmitters 504-(1-N) that the sensing trigger message is triggering.

In the following description, a sensing algorithm 558 on remote processing device 506 is referred to in the processing of channel representation information. In all examples, the processing of channel representation information may be instead or additionally performed by sensing agent 556 on remote processing device 506, and/or by sensing agent 516-(1-M) and/or sensing algorithm 518-(1-M) on one or more of plurality of sensing receivers 502-(1-M), and/or by sensing agent 536-(1-N) and/or sensing algorithm 538-(1-N) on one or more of plurality of sensing transmitters 504-(1-N).

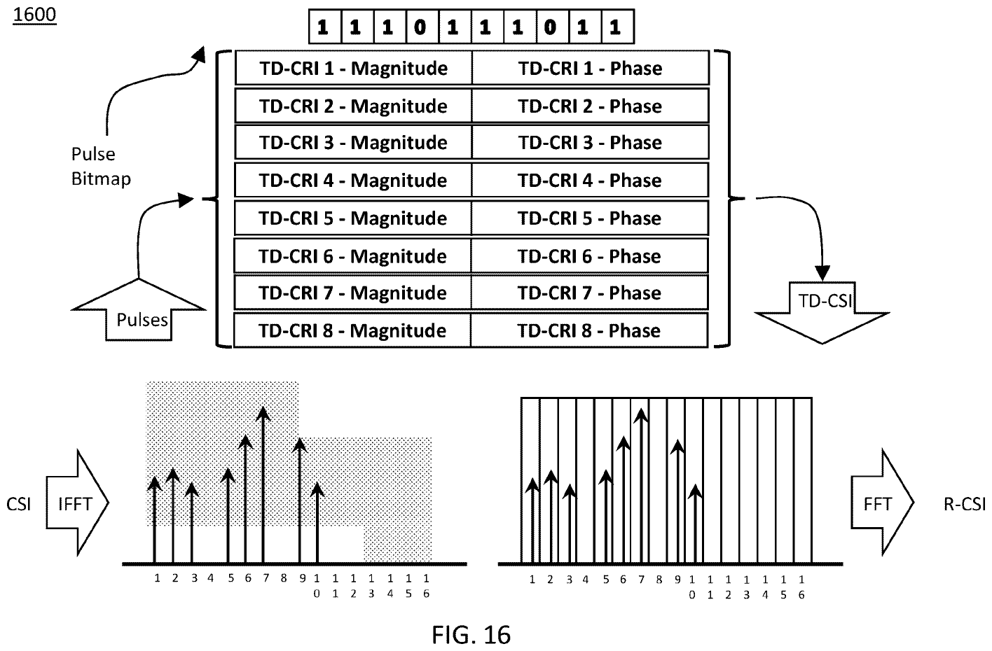

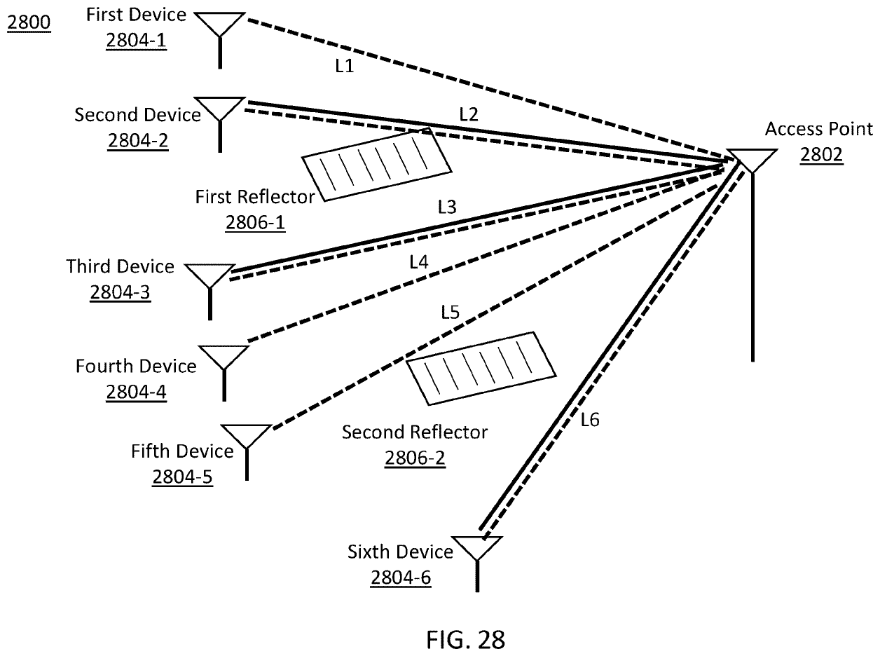

FIG. 16 illustrates representation 1600 of communication of location of the selected one or more time domain pulses from one or more plurality of sensing receivers 502-(1-M) to sensing algorithm 558 on remote processing device 506 using an active tone bitmap. In an example of FIG. 28, the active tone bitmap sent from one or more plurality of sensing receivers 502-(1-M) to sensing algorithm 558 is 10 bits long, corresponding to 10 pilot and data tones of a 16-point FFT. The value of the active tone bitmap, “1110111011” indicates that 8 filtered time domain channel representation information (TD-CRI) values will follow (as there are 8 “1”'s in the active tone bitmap), and sensing algorithm 558 should arrange the received filtered TD-CRI in the 10 tones by applying in order each filtered TD-CRI to a reconstructed filtered TD-CRI tone according to the active tone bitmap, i.e., TD-CRI 1 in tone 1, TD-CRI 2 in tone 2, TD-CRI 3 in tone 3, null in tone 4, TD-CRI 4 in tone 5, TD-CRI 5 in tone 6, TD-CRI 6 in tone 7, null in tone 8, TD-CRI 7 in tone 9, and TD-CRI 8 in tone 10.

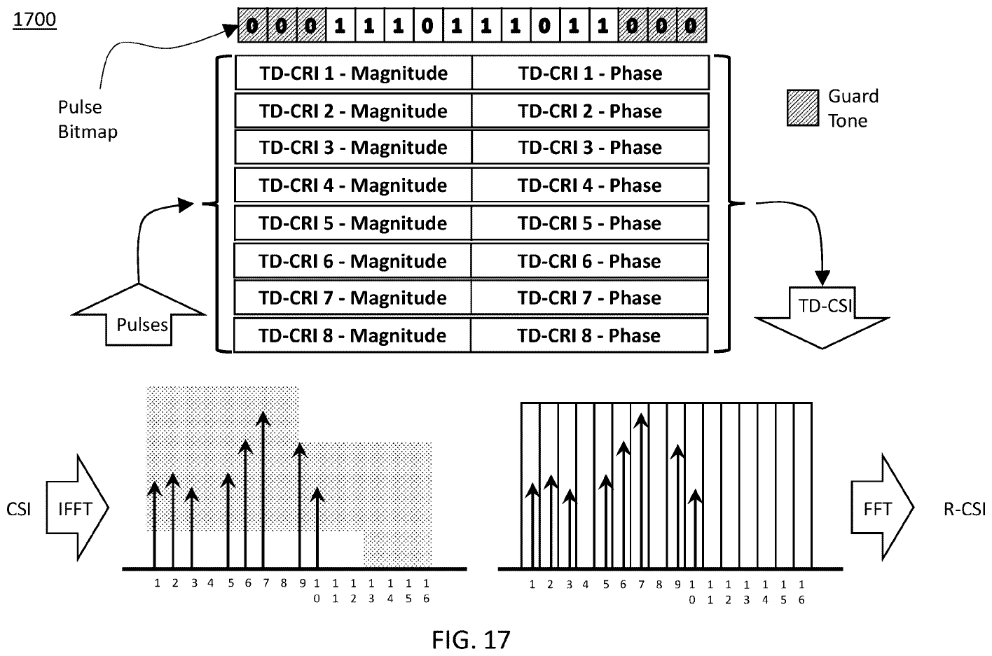

FIG. 17 illustrates representation 1700 of communication of location of the selected one or more time domain pulses from one or more plurality of sensing receivers 502-(1-M) to sensing algorithm 558 using a full bitmap. In an example, the full bitmap may be equal to the total number of tones in the full TD-CRI including the guard tones and DC tones, i.e., 64 bits for 20 MHz channel bandwidth and 128 bits for 40 MHz channel bandwidth. In the example, some most significant bit (MSB) would be “0” to account for the guard tones, and some least significant bit (LSB) would also be “0” to account for the direct current (DC) tone and the guard tones. In the 16-point fast Fourier transform (FFT) example shown in FIG. 17, zeros are placed in the first three locations of the full bitmap followed by the location of the eight TD-CRI, followed by three more zeros.

According to some implementations, for each filtered TD-CRI, one or more plurality of sensing receivers 502-(1-M) may send to sensing algorithm 558 on remote processing device 506 three values instead of two values (first value being amplitude of the complex number and second value being phase of the complex number). In an example, the third value may represent the position of the filtered TD-CRI value in the reconstructed filtered TD-CRI. In an example, the number of bits used to represent the third value may vary depending on the channel bandwidth and therefore the number of points in the full TD-CRI. For example, if the channel bandwidth is 20 MHz, a 64-point FFT may be required and thus the additional value may be 6 bits long. If the channel bandwidth is 40 MHz, a 128-point FFT may be required and thus the additional value may be 7 bits long. In an example, the additional value could precede the values of filtered TD-CRI. In some examples, the additional value could follow the values of filtered TD-CRI. In an example, the number of bits used for the filtered TD-CRI may be determined based on the resolution of the actual CSI output by the baseband receiver.

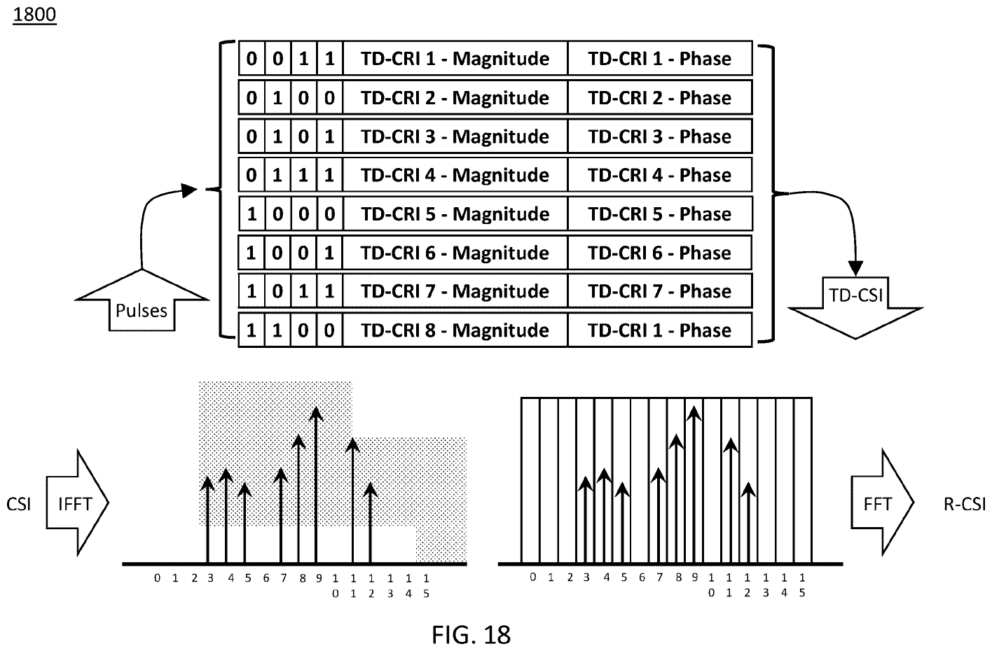

FIG. 18 illustrates representation 1800 of communication of location of selected one or more time domain pulses (filtered TD-CRI) from one or more plurality of sensing receivers 502-(1-M) to sensing algorithm 558 on remote processing device 506 using position of the selected one or more time domain pulses in the full TD-CRI, according to some embodiments. In the example of FIG. 18, the numbering of the symbols has been shifted to start at “0” and end at “15” to facilitate mapping of the symbols to the third value. Although FIG. 16 though FIG. 18 illustrate examples of communication of the selected one or more time domain pulses signaling utilizing 16-point FFT with 3 guard tones on either side (leaving 10 tones for pilot and data symbols), however the description is equally applicable to 32-point FFT, 64-point FFT, 128-point FFT, 256-point FFT, 512-point FFT, 1024-point FFT, and any other number of points in an FFT, and a variable number of guard tones.

According to an implementation, in response to receiving the representation of the location of the selected one or more time domain pulses in the full TD-CRI, sensing algorithm 558 on remote processing device 506 may be configured to construct the reconstructed filtered TD-CRI prior to performing the FFT to create a reconstructed CSI (R-CSI). In an example, the correctly positioned reconstructed filtered TD-CRI, when translated back to the frequency domain via the FFT, creates the R-CSI. In an implementation, since there are significantly fewer filtered TD-CRI than CSI values then there is a significant reduction in the amount of information that needs to be transmitted over the air as CRI to sensing algorithm 558 without losing the fidelity of the information which would compromise the performance of sensing algorithm 558. For example, for 52 CSI values (representing a 20 MHz channel bandwidth), between 10 and 15 time domain pulse in the filtered TD-CRI may be used to accurately represent transmission channel with minimal loss of fidelity. Accordingly, minimizing the amount of information that needs to be sent minimizes the overhead that system 500 puts on network 560.

According to aspects of the present disclosure, the amount of information that is passed from one or more plurality of sensing receivers 502-(1-M) to sensing algorithm 558 on remote processing device 506 may be significantly reduced by sending filtered time domain values (filtered TD-CRI, one complex value for each time domain pulse) instead of the frequency domain CSI values provided by the baseband receiver. Also, the number of time domain pulses that need to be sent may be about 25% or less of the CSI values for the smallest channel bandwidth (for example, 20 MHz channel bandwidth). Further, this percentage may significantly reduce as the total channel bandwidth increases.

According to an implementation, a sensing agent (for example, sensing agent 516-(1-M) on one or more of plurality of sensing receivers 501-(1-M) or sensing agent 556 on remote processing device 506) may store the set of time domain pulses of the full TD-CRI that make up the filtered TD-CRI as differences between the set of time domain pulses of the full TD-CRI and the corresponding time domain pulses of the sensing imprint as an imprint delta defining the filtered TD-CRI. In an implementation, the imprint delta values that make up filtered TD-CRI may be represented by a numerical format with fewer bits than may be required to represent a complete time domain pulse of the filtered TD-CRI. According to an example, there may be no or little loss of precision as the range of the value that is being represented is reduced by the difference operation.

In an implementation, once the imprint delta is obtained, sensing agent (for example, sensing agent 516-(1-M) on one or more of plurality of sensing receivers 502-(1-M) or sensing agent 556 on remote processing device 506) may evaluate the imprint delta individually for each time domain pulse of the full TD-C506RI. According to an implementation, sensing agent (for example, sensing agent 516-(1-M) on one or more of plurality of sensing receivers 502-(1-M) or sensing agent 556 on remote processing device 506) may compare each time domain pulse difference (i.e., difference between a time domain pulse of the full TD-CRI and a time domain pulse of the sensing imprint) to a measurement imprint delta threshold for amplitude or for phase, or for both amplitude and phase. Based on the comparison result, sensing agent (for example, sensing agent 516-(1-M) on one or more of plurality of sensing receivers 502-(1-M) or sensing agent 556 on remote processing device 506) may determine that a time domain pulse of the full TD-CRI has changed. In an example, sensing agent (for example, sensing agent 516-(1-M) on one or more of plurality of sensing receivers 502-(1-M) or sensing agent 556 on remote processing device 506) may determine that a time domain pulse of the full TD-CRI has changed when the measurement imprint delta threshold is exceeded only once. According to an implementation, the measurement imprint delta threshold must exceed a measurement imprint delta count on subsequent measurements before a time domain pulse of the full TD-CRI is considered to be different from a time domain pulse of the sensing imprint. In an example, the measurement imprint delta count may refer to a number of times that the measurement imprint delta threshold is exceeded before a time domain pulse of the full TD-CRI is considered to be different from a time domain pulse of the sensing imprint. Any of the previously described functions may alternatively or additionally be performed by sensing algorithm (for example, sensing algorithm 518-(1-M) on one or more of plurality of sensing receivers 502-(1-M) or sensing algorithm 558 on remote processing device 506)

In an implementation, the measurement imprint delta threshold and the measurement imprint delta count may be configured by sensing receiver 502-1. In some implementations, the measurement imprint delta threshold and the measurement imprint delta count may be configured by sensing algorithm 558. According to an implementation, sensing algorithm 558 may send one or more measurement imprint delta thresholds and corresponding one or more measurement imprint delta counts to sensing receiver 502-1. According to an embodiment, upon initial association of sensing receiver 502-1 with sensing algorithm 558, sensing algorithm 558 may communicate one or more measurement imprint delta thresholds and corresponding one or more measurement imprint delta counts to sensing receiver 502-1 for use in future Wi-Fi sensing session(s). In an example, the one or more measurement imprint delta thresholds may be associated with a specific sensing imprint. For example, the measurement imprint delta thresholds may be associated with the sensing imprint for an uplink path between sensing transmitter 504-1 and sensing receiver 502-1 in a specific channel bandwidth and for a specific delivered transmission configuration.

According to an implementation, as a representation of the reflections of the propagation channel between sensing receiver 502-1 and sensing transmitter 504-1 for Wi-Fi sensing, sensing receiver 502-1 may send the filtered TD-CRI to sensing algorithm 558. In an implementation, sensing agent 516-1 may send the filtered TD-CRI to sensing algorithm 558 via a CRI transmission message. In an example implementation, sensing agent 516-1 may send the CRI transmission message including the filtered TD-CRI to sensing algorithm 558 via transmitting antenna 512-1. In an example, filtered TD-CRI may contain time domain pulses of the full TD-CRI to sensing algorithm 558 that are determined to have changed from the sensing imprint (the time domain pulses of the full TD-CRI that are different from the sensing imprint may be transmitted to sensing algorithm 558). In some examples, filtered TD-CRI may contain the imprint delta values that represent the time domain pulses of the full TD-CRI that are determined to have changed from the sensing imprint (the imprint delta of the changed time domain pulses of the full TD-CRI may be transmitted to the sensing algorithm 558).

According to an implementation, sensing agent 516-1 may indicate a location of time domain pulses within the filtered TD-CRI that represent the reflections in the propagation channel (i.e., the time domain tone that the time domain pulse or imprint delta represents) to sensing algorithm 558.

In an implementation, to avoid using a longer than necessary data field, for example, media access control protocol data unit (MPDU) to send the filtered TD-CRI from sensing receiver 502-1 to sensing algorithm 558, the filtered TD-CRI time domain pulses or the imprint delta values may be arranged contiguously in the data message without gaps or nulls between them. However, there may have been gaps between the actual updated or selected full TD-CRI time domain pulses and therefore the original location of the selected full TD-CRI time domain pulses must be signaled from sensing receiver 502-1 to sensing algorithm 558. In an example, the updated or selected full TD-CRI time domain pulses may refer to the time domain pulses of the full TD-CRI that are different from the sensing imprint.

According to an implementation, sensing agent 516-1 may transmit a location bitmap indicating locations of the first time domain pulses in the full TD-CRI to sensing algorithm 558. In an example, the first time domain pulses may be a series of time domain pulses from within the full TD-CRI which have changed compared to the sensing imprint and are to be processed by sensing algorithm 558 to determine a current sensing measurement. Accordingly, each time domain pulse must be identified to allow reconstructed full TD-CRI to be generated at sensing algorithm 558 and the sensing measurement to be recreated.

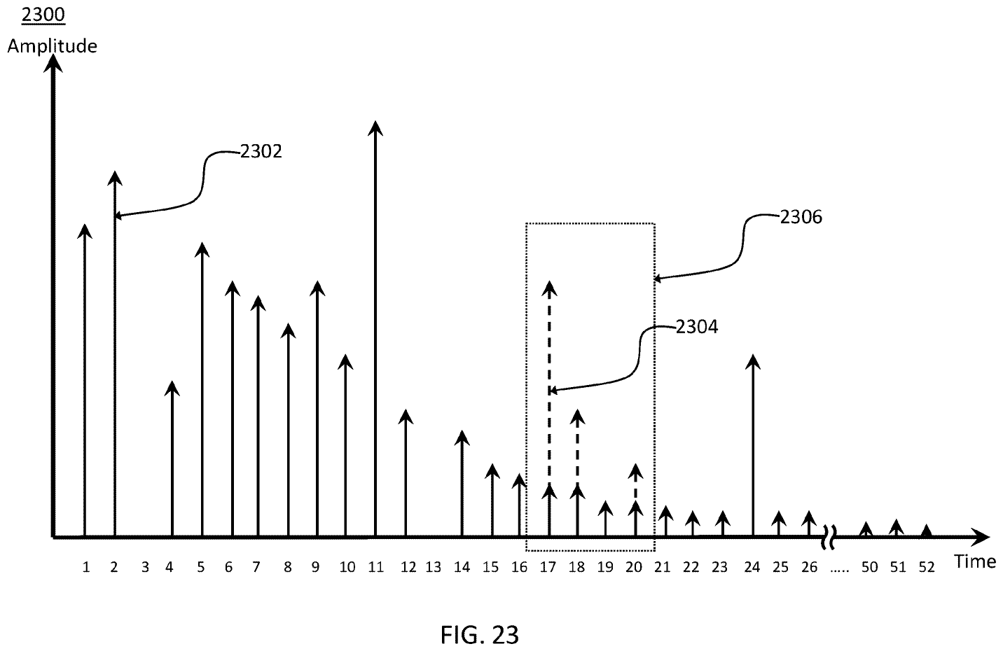

FIG. 23 depicts illustration 2300 of a filtered TD-CRI, according to some embodiments. An example of time domain pulses in a sensing imprint are shown using solid line arrows (represented as “2302”) and an example change to the sensing imprint in three time domain pulses is shown using dashed line arrows (represented as “2304”). For clarity, in the example of FIG. 23, the series of selected full TD-CRI time domain values that differ from the sensing imprint are within the window represented as “2306”. In an example, the propagation channel between sensing receiver 502-1 and sensing transmitter 504-1 may be 20 MHz in bandwidth and may be represented by 52 complex time domain pulses in the full TD-CRI.

According to an implementation, sensing agent 516-1 may create a bitmap of a length required to represent all time domain pulses which carry data. In an example, the bitmap may be 52 bits long. In other examples, the bitmap may be 104 bits long. In an example, sensing agent 516-1 may populate the bitmap with a “1” where a time domain pulse has been selected and is present and a “0” where a time domain pulse has not been selected and is absent. In an example, the MSB of the bitmap refers to the first time domain tone and the LSB of the bitmap refers to the last time domain tone.

Referring to the example in FIG. 23, a 52 bits long bitmap (or 52-bit bitfield) is created as below:

0000000000000000110100000000000000000000000000000000

In an implementation, the three updated time domain pulses (magnitude and phase) are transferred sequentially. In an example, the updated time domain pulses may be transferred as values which replace the corresponding value in the sensing imprint. In some examples, the imprint delta may be transferred to be applied as a change to the corresponding value in the sensing imprint. The type of update which is transferred may be signaled by additional bits in the bitfield. In an example, the value of an additional MSB may represent the type of update which is transferred. According to an implementation, to take advantage of the potential for low information content in the bitfield, sensing agent 516-1 may use a lossless data compression algorithm to reduce the number of bits transferred. An example of the lossless data compression algorithm is run-length encoding.

In an example, the bitmap may equal the number of tones in the FFT including the guard tones and DC tones, i.e., 64 bits for an example of a 20 MHz propagation channel bandwidth and 128 bits for an example of a 40 MHz propagation channel bandwidth. In the example, a first number of the MSB would be “0” to account for the guard tones and a second number of the LSB would also be “0” to account for the DC tone and the guard tones. According to an implementation, it may be assumed that the MSB of the bitmap maps to the first symbol of the FFT. Based on the assumption, the time domain pulses or imprint delta values may be populated according to the bitmap.

According to some implementations, for each time domain pulse in the filtered TD-CRI, sensing agent 516-1 may send three values instead of two values, where one of the three value may represent the position of the time domain pulse or imprint delta value in the full TD-CRI. In an example, the number of bits used to represent the additional value (i.e., the third value) or a size of the additional value may vary depending on the propagation channel bandwidth and the number of time domain pulses in the TD-CRI. For example, if the propagation channel bandwidth is 20 MHz and a 64-point FFT is required, the additional value may be 6 bits long. If the propagation channel bandwidth is 40 MHz and a 128-point FFT is required, the additional value may be 7 bits long. In examples, the additional value could precede the value of the time domain pulse or imprint delta value. In some examples, the additional value could follow the value of the time domain pulse or imprint delta value.

In an example, the type of the values of filtered TD-CRI which are transferred (i.e., those which replace the corresponding time domain pulse values in the sensing imprint or those which reflect changes to the corresponding value in the sensing imprint) is signaled by a dedicated type of update field transferred along with the values themselves.

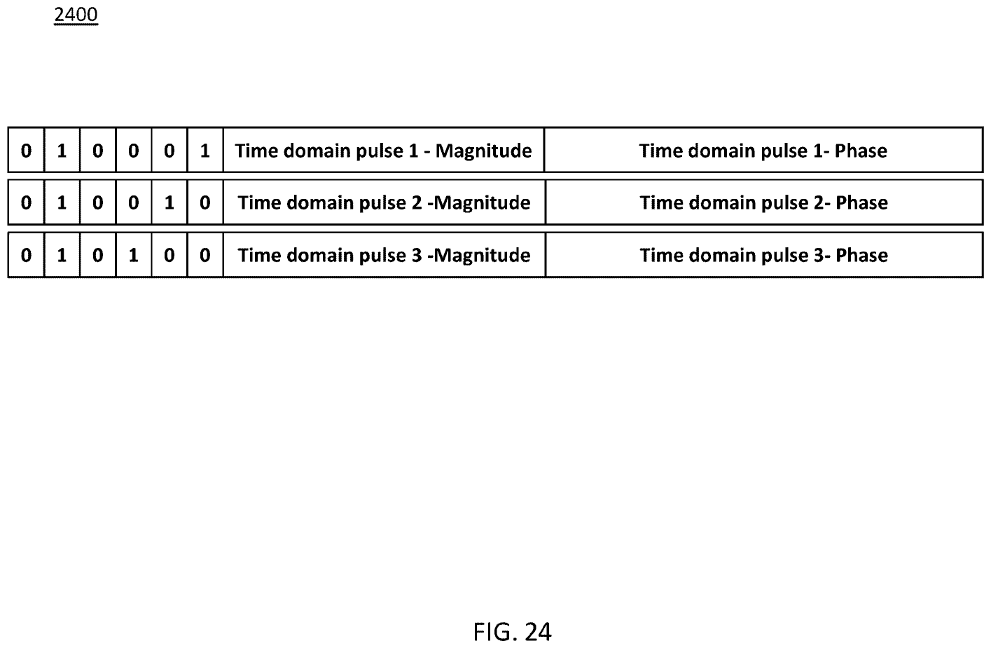

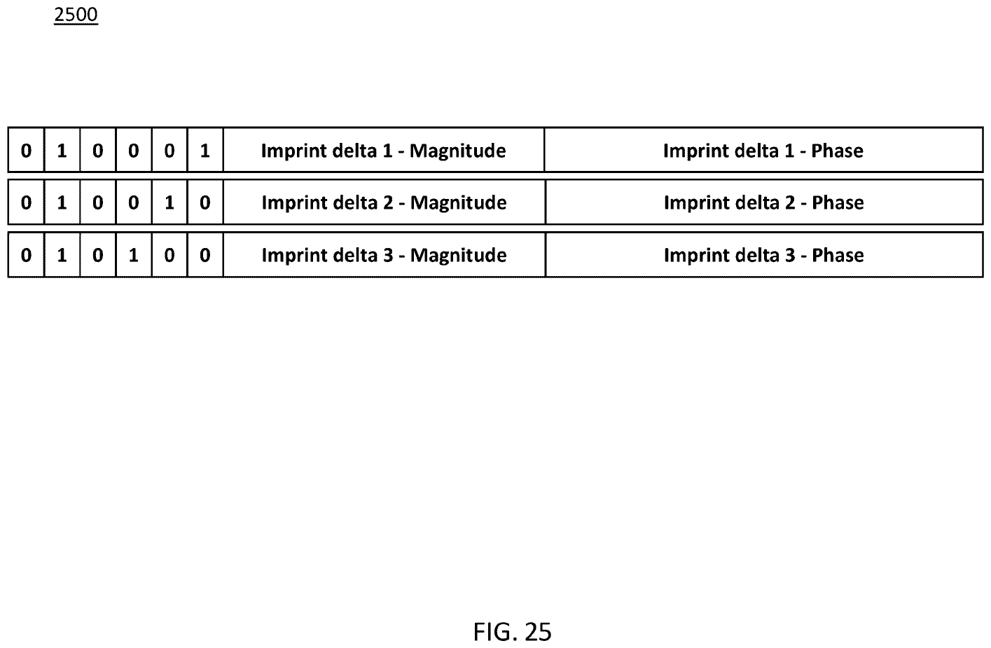

FIG. 24 depicts an example of set 2400 of changed time domain pulses in the full TD-CRI (selected time domain pulses) and FIG. 25 depicts another example of set 2500 of changed time domain pulses in the full TD-CRI (imprint delta), according to some embodiments. In an example, it may be assumed that there are no guard or DC tones prior to the start of the time domain representation. In both depictions, parameters that represent the location of the changed time domain pulses in the TD-CRI are transferred with the changed time domain pulses.

According to an implementation, sensing algorithm 558 may receive a filtered TD-CRI from sensing receiver 502-1. In an example, the filtered TD-CRI may include a plurality of time domain pulses. In an implementation, sensing algorithm 558 may receive a sensing imprint indicator along with the filtered TD-CRI. In an example, the sensing imprint indicator may refer to a version number or a unique identifier of the sensing imprint used by sensing receiver 502-1 to calculate the filtered TD-CRI. In an implementation, sensing algorithm 558 may also receive a location bitmap indicating locations of corresponding time domain pulses in the sensing imprint. In some implementations, sensing algorithm 558 may receive a cryptographic hash of the sensing imprint used by sensing receiver 502-1 to calculate the filtered TD-CRI along with the filtered TD-CRI to allow sensing algorithm 558 to determine which sensing imprint to use.

According to an implementation, upon receiving the filtered TD-CRI and the sensing imprint indicator and/or the cryptographic hash, sensing algorithm 558 may obtain a sensing imprint (or a copy of the sensing imprint) according to the sensing imprint indicator and/or the cryptographic hash from the data storage. In an implementation, sensing algorithm 558 may generate a reconstructed TD-CRI from the filtered TD-CRI and the sensing imprint. According to an implementation, sensing algorithm 558 may generate the reconstructed TD-CRI by replacing corresponding time domain pulses of the sensing imprint with the plurality of time domain pulses received in the filtered TD-CRI. Sensing algorithm 558 may then perform an FFT on the resulting time domain signal to obtain the near-exact frequency domain CSI. Subsequently, sensing algorithm 558 may detect a feature of interest in a sensing space according to the reconstructed frequency domain channel representation.

In some implementations, the filtered TD-CRI may include an imprint delta storing time domain pulse differences. Upon receiving the filtered TD-CRI, sensing algorithm 558 may generate the reconstructed TD-CRI by adding the time domain pulse differences to corresponding time domain pulses of the sensing imprint. In an example, sensing algorithm 558 may add the imprint delta to the corresponding time domain pulses in the sensing imprint using phasor addition. The operation of phasor addition is opposite to that of phasor subtraction. In an example, where the numerical representation of the imprint delta is modified to reduce the number of bits to transmit then the imprint delta is first cast to the numerical format and resolution of the corresponding time domain pulses in the copy of the stored sensing imprint to allow the phasor addition to proceed without numerical error. Thereafter, sensing algorithm 558 may perform an FFT on the resulting time domain signal to obtain the near-exact frequency domain CSI. Subsequently, sensing algorithm 558 may detect a feature of interest in a sensing space according to the reconstructed frequency domain channel representation.

In examples where the sensing imprint used to determine the filtered TD-CRI cannot be identified by sensing algorithm 558, either by the sensing imprint indicator or the cryptographic hash, then the time domain pulses or imprint delta values may be discarded. In some implementations, sensing algorithm 558 may send a message to sensing receiver 502-1 to invalidate the stored sensing imprint. In some implementations, if the sensing imprint used to determine the filtered TD-CRI cannot be identified by sensing algorithm 558, either by the sensing imprint indicator or the cryptographic hash, and time domain pulses (and not imprint delta values) were sent, sensing algorithm 558 may utilize the lossy time domain compression technique in place of the lossless time domain compression technique.

According to an implementation, the sensing imprint used by sensing algorithm 518-1 to calculate the reconstructed TD-CRI or the sensing imprint used by sensing receiver 502-1 to calculate the filtered TD-CRI may need to be recalculated or updated, for example, a scenario where sensing receiver 502-1 detects a moving object in the propagation channel between sensing receiver 502-1 and sensing transmitter 504-1, resulting in an imprint delta between the full TD-CRI and the sensing imprint, and then the object that caused this imprint delta stops moving but stays in the sensing space. In such scenario, the baseline sensing imprint that was formed before the object entered the sensing space is no longer valid. It is likely that the imprint delta varies minimally from sensing measurement to sensing measurement when the object is no longer moving, and hence there will be repeated transmission of identical or similar information from sensing receiver 502-1 to the sensing algorithm 558. In such scenario, a new sensing imprint may be determined. In an example, updating a sensing imprint may lead to creation of a new sensing imprint.

According to an implementation, when a new sensing imprint is required, sensing receiver 502-1 may generate the new sensing imprint based on sensing transmissions that are normally occurring and not specifically requested for the purposes of generating the new sensing imprint. In an example, where the sensing imprint includes versions for multiple delivered transmission configurations, sensing receiver 502-1 may update only the version of the sensing imprint which corresponds to the delivered transmission configurations which are in use. In some examples, sensing receiver 502-1 may determine that the complete sensing imprint (i.e., for all delivered transmission configurations) between sensing receiver 502-1 and sensing transmitter 504-1 is to be updated. In such scenarios, sensing receiver 502-1 may request sensing transmissions with the required requested transmission configurations.

In an implementation, when sensing receiver 502-1 determines that a new sensing imprint is required, the new sensing imprint may be determined to be the channel impulse response at the point where the rate of change of the imprint delta of the time domain pulses drops below the imprint delta derivative threshold for the required imprint delta derivative period. In some examples, the new sensing imprint may be the average of sensing imprint average count channel impulse responses after the rate of change of the imprint delta drops below the imprint delta derivative threshold. In an implementation, sensing algorithm 518-1 may configure the sensing imprint average count of sensing measurements made on sensing transmissions from sensing transmitter 504-1 which share a common delivered transmission configuration that are averaged to reduce noise (for example, measurement noise). The resultant average full TD-CRI may become a sensing imprint for the delivered transmission configuration and sensing transmitter 504-1 that produced the sensing transmissions on which the sensing measurements were made.

According to an implementation, if it is determined that sensing receiver 502-1 or sensing transmitter 504-1 has moved (for example, based on detecting a complete change in the imprint delta, or by detecting a power interruption event, or due to a change in media access control (MAC) address of sensing receiver 502-1 or sensing transmitter 504-1), then sensing algorithm 558 may create one or more new sensing imprints for the propagation channels that involve the reconfigured sensing receiver 502-1 or sensing transmitter 504-1. Further, in situations where a new sensing transmitter is added to system 500, sensing algorithm 558 may create one or more new sensing imprints for the propagation channels that involve the new sensing transmitter.

Some embodiments of the present disclosure as described above define sensing message types for Wi-Fi sensing, namely, sensing configuration message, sensing configuration response message, delta CRI message, and sensing imprint transmission message.

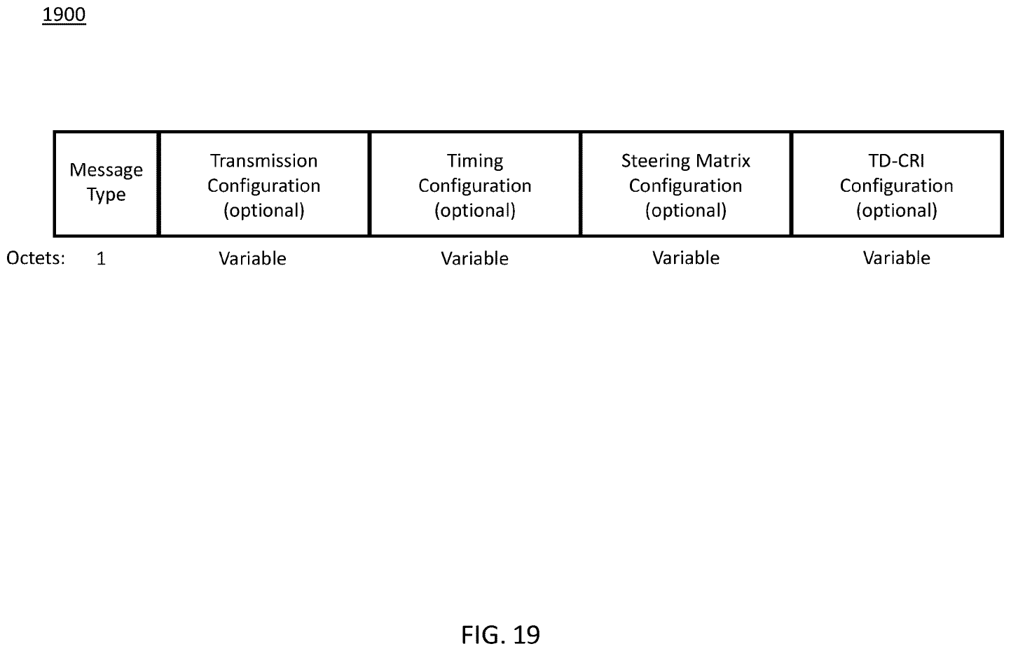

In an example, the sensing configuration message and the sensing configuration response message are carried in a new extension to a management frame of a type described in IEEE 802.11. FIG. 19 illustrates an example of a component of a management frame carrying a sensing transmission. In an example, system 500 may require acknowledgement frames, and the management frame carrying sensing messages may be implemented as an Action frame and in another example, system 500 may not require acknowledgement frames, and the management frame carrying sensing messages may be implemented as an Action No Ack frame.

In an implementation, the information content of all sensing message types may be carried in a format as shown in FIG. 19. In some examples, Transmission Configuration, Timing Configuration, Steering Matrix Configuration, and TD-CRI configuration as described in FIG. 19 are implemented as IEEE 802.11 elements. In some examples, the TD-CRI Configuration element is a part of the Transmission Configuration element.

In one or more embodiments, the sensing message types may be identified by the message type field, and each sensing message type may carry the other identified elements, according to some embodiments.

In an example, the data may be encoded into an element for inclusion in sensing messages between sensing receiver 502-1, sensing transmitter 504-1, and sensing algorithm 558. In a measurement campaign involving multiple sensing receivers and multiple sensing transmitters, these parameters may be defined for all sensing receivers-sensing transmitters pairs. In an example, when these parameters are transmitted from sensing algorithm 558 or sensing transmitter 504-1 including sensing algorithm 558 to sensing receiver 502-1, then these parameters configure sensing receiver 502-1 to process a sensing transmission and calculate sensing measurements. In some examples, when these parameters are transmitted from sensing receiver 502-1 to sensing algorithm 558 or sensing transmitter 504-1 including sensing algorithm 558, then these parameters report the configuration used by sensing receiver 502-1.

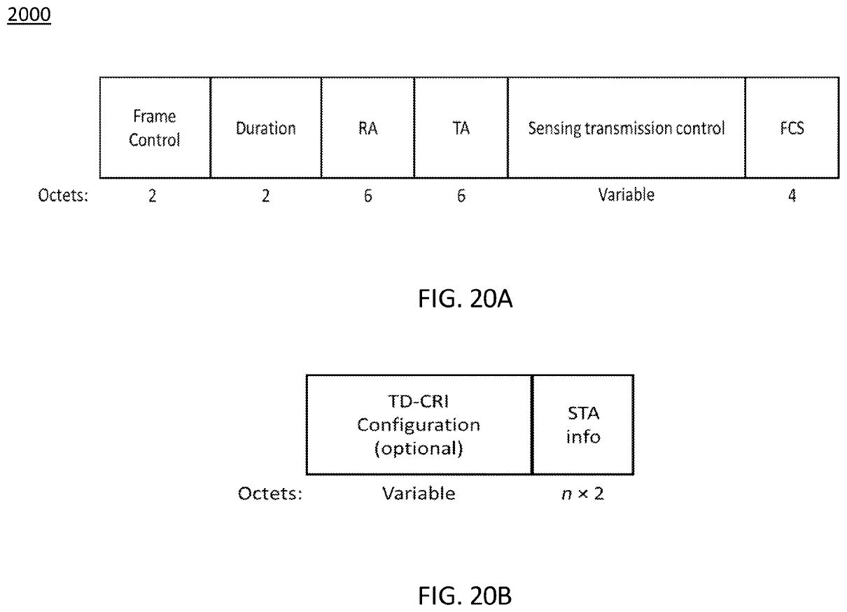

According to some implementations, a sensing transmission announcement may be carried in a new extension to a control frame of a type described in IEEE 802.11. In some implementations, the sensing transmission announcement may be carried in a new extension to a control frame extension described in IEEE 802.11. FIG. 20A illustrates an example of a format of control frame and FIG. 20B illustrates a format of a sensing transmission control field of control frame. In an example, the STA info field of the sensing transmission control field may address up to n sensing receivers via their association ID (AID). In an example implementation, the sensing transmission announcement may address n sensing receivers which are required to make a sensing measurement and to relay channel representation information back to the sensing initiator.

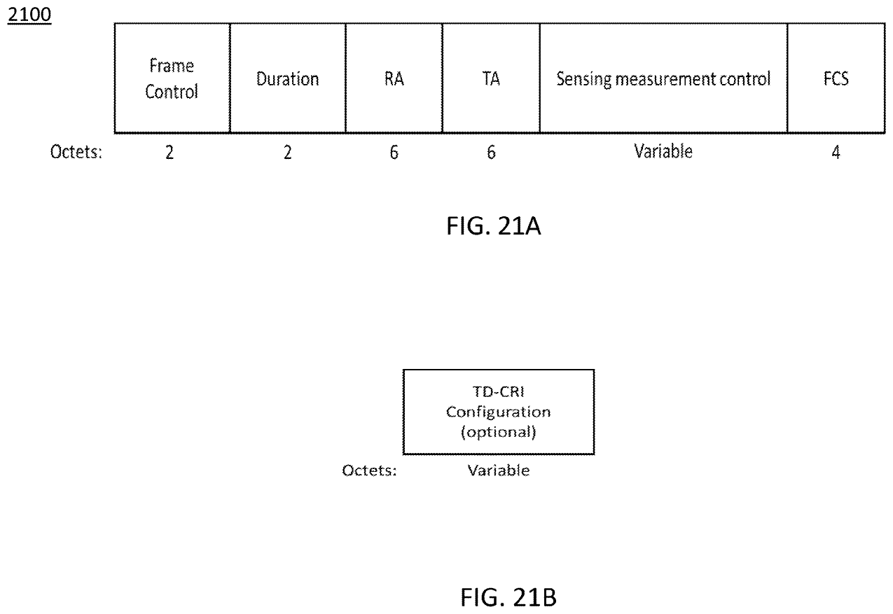

According to some implementations, the sensing measurement poll may be carried in a new extension to a control frame of a type described in IEEE 802.11. In some implementations, the sensing measurement poll may be carried in a new extension to a control frame extension described in IEEE 802.11. FIG. 21A illustrates an example of a format of control frame and FIG. 21B illustrates a format of a sensing measurement control field of control frame.

According to some implementations, when sensing receiver 502-1 has calculated sensing measurements and created channel representation information (for example, in form of filtered TD-CRI), the sensing receiver 502-1 may be required to communicate the channel representation information to sensing algorithm 558 or sensing transmitter 504-1 including sensing algorithm 558. In an example, the sensing measurements may be processed as described to form channel representation information in the form of a sensing imprint and, subsequently, an imprint delta.

In an implementation, to provide a baseline for filtered TD-CRI, a version of sensing imprint is required by sensing algorithm 558. In an example, a sensing imprint may be transferred by a management frame and in an example. In an example, a message type may be defined which represents a Sensing Imprint Transmission Message.

In an example, the filtered TD-CRI may be transferred by a management frame. In an example, a message type may be defined which represents a delta CRI message.

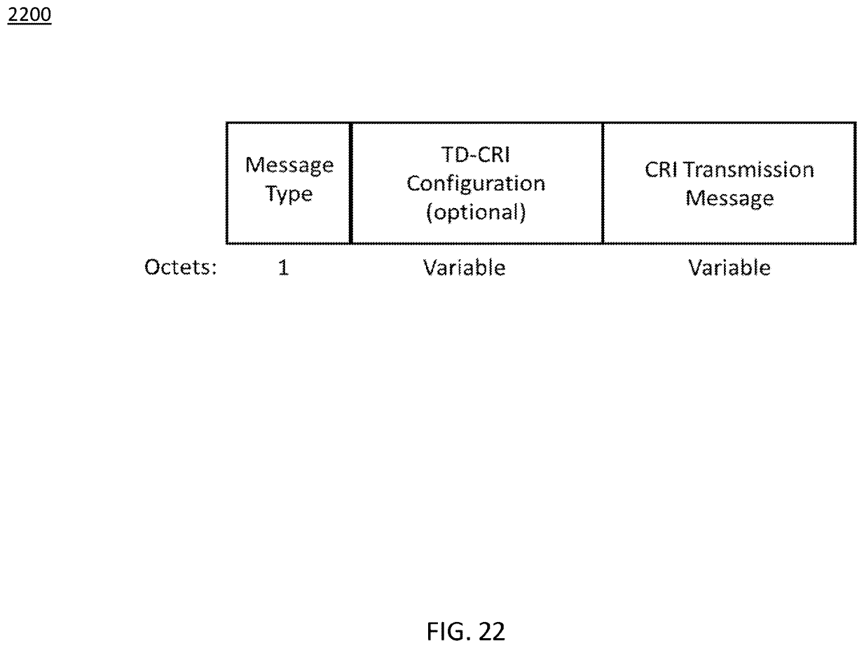

FIG. 22 illustrates an example of a component of a management frame 1300 carrying a CRI transmission message, according to some embodiments. In an example, system 500 may require acknowledgement frames, and the management frame carrying the CRI transmission message may be implemented as an Action frame and in another example, system 500 may not require acknowledgement frames and the management frame carrying the CRI transmission message may be implemented as an Action No Ack frame.

In examples a delta CRI message Element transfers the TD-CRI using a bit field to represent the active (included/selected) time domain pulses whilst accounting for DC tones and guard tones. Other examples of data representation are described earlier and in examples, the delta CRI message Element may be adjusted to reflect those data schemes.

In an example a sensing imprint transmission message Element transfers a sensing imprint from sensing receiver 502-1 to sensing algorithm 558 or to sensing transmitter 504-1 including sensing algorithm 558. In an example, the data structure may be transferred via the sensing imprint transmission message Element or it may be compressed prior to transmission using any available lossless compression technique. In an example, the data that describes the sensing imprint is accompanied by a header which describes the format of the data as well as the devices and configurations that the data is associated with.

In an implementation, when sensing algorithm 558 is implemented on a separate device (i.e., is not implemented within sensing transmitter 504-1), a management frame may not be necessary, and the sensing imprint and the TD-CRI may be encapsulated in a standard IEEE 802.11 data frame and transferred to sensing algorithm 558. In an example, a proprietary header or descriptor may be added to the data structure to allow sensing algorithm 558 to detect that the data structure is in the form of a sensing imprint transmission message Element or a delta CRI message Element. In an example, data may be transferred in the format shown in FIG. 22 and sensing algorithm 558 may be configured to interpret the Message Type value that represents a sensing imprint transmission message Element and a delta CRI message Element.

### C. Systems and Methods for Selecting and Updating a Set of Sounding Devices

The present disclosure generally relates to systems and methods for Wi-Fi sensing. In particular, the present disclosure relates to systems and methods for selecting and updating a set of sounding devices, adapting a selection of a set of sounding devices according to network utilization and selecting sensing devices using physical parameters of the link.

A Wi-Fi sensing system may be configured to detect features of interest in a sensing space. The Wi-Fi sensing system may be a network of Wi-Fi-enabled devices which are part of an IEEE 802.11 network (sometimes referred to as a Basic Service Set (BSS), or an Extended Service Set (ESS)). The features of interest may include motion of objects and motion tracking, presence detection, intrusion detection, gesture recognition, fall detection, breathing rate detection, and other applications. The sensing space may refer to any physical space in which a Wi-Fi sensing system may operate and may include a place of abode, a place of work, a shopping mall, a sports hall or sports stadium, a garden, or any other physical space.

Currently, an IEEE 802.11 physical channel constitutes a number of orthogonal frequency division multiplexing (OFDM) tones or carriers depending on the overall bandwidth of the channel and the revision of the specification. For example, 52 data and pilot carriers may be used for a 20 MHz channel bandwidth, and 104 data and pilot carriers may be used for a 40 MHz channel bandwidth. A baseband Wi-Fi receiver may calculate a sensing measurement (for example, channel state measurement (CSI)) consisting of a real and imaginary part for each element and the sensing measurement may be passed to a sensing algorithm to determine if there is motion or movement in the sensing space. In examples, motion may be determined in the sensing space by the sensing algorithm by looking for perturbation in the local environment, e.g., on transmission paths (links) between one or more transmitter devices (for example, sensing transmitters) and one or more receiver devices (for example, sensing receivers).

In examples, the BSS or the ESS that makes up a Wi-Fi sensing network in a sensing space may include multiple sensing capable devices. In an example, with the promulgation of the Internet of Things, a large number of Wi-Fi-enabled sensing capable devices may be present in various areas of the home. In an example, detecting motion in a sensing space requires sending sensing transmissions between Wi-Fi sensing capable devices and making sensing measurements on the received sensing transmissions (which may be referred to as sounding). Further, Wi-Fi sensing capable devices involved in making sensing transmissions may be referred to as sounding devices. Generally, sounding the sensing space between pairs of Wi-Fi sensing capable devices may take time as some or all sounding may take place sequentially and not in parallel. Further, sounding using dedicated sensing transmissions (e.g., sensing NDPs) requires that there be bandwidth available for the sensing transmissions, which may not be the case in a congested network. Therefore, a method to select a subset of Wi-Fi sensing devices in a Wi-Fi sensing network that are necessary to comprehensively sound the sensing space is required.

In a Wi-Fi sensing system, a motion in a sensing space may cause perturbances on one or more links (transmission paths) between one or more sensing transmitters and one or more sensing receivers simultaneously. If some links have substantial coverage overlap, then it may be possible to select one of the links to sense the overlapping coverage area in the sensing space. The present disclosure describes a solution to determine which links are the necessary links for sensing the sensing space and which links may be removed or trimmed, by analyzing the perturbances on the links.

In a Wi-Fi sensing system, there may be a plurality of sensing capable devices communicating with an access point. In examples, all or some of plurality of sensing capable devices may be used for Wi-Fi sensing. In an embodiment, the access point may be a sensing transmitter (for example, sensing transmitter 504-1), and the plurality of sensing capable devices may be a plurality of sensing receivers (for example, plurality of sensing receivers 502-(1-M)). According to an implementation, the access point (for example, sensing transmitter 504-1) may send a sensing announcement message followed by a sensing null data PPDU (NDP) to a sensing capable device (for example, sensing receiver 502-1) from amongst the plurality of sensing capable devices (for example, plurality of sensing receivers 502-(1-M)). The sensing capable device (for example, sensing receiver 502-1) may make a sensing measurement. Further, the access point (for example, sensing transmitter 504-1) may send a sensing measurement poll message to the sensing capable device (for example, sensing receiver 502-1) to trigger the sensing capable device to send the sensing measurement back to the access point (for example, sensing transmitter 504-1). According to some embodiments, the access point may be a sensing receiver (for example, sensing receiver 502-1), and the plurality of sensing capable devices may be a plurality of sensing transmitters (for example, plurality of sensing transmitters 504-(1-N)). According to an implementation, the access point (for example, sensing receiver 502-1) may send a sensing trigger frame to a sensing capable device (for example, sensing transmitter 504-1) from amongst the plurality of sensing transmitters (for example, plurality of sensing transmitters 504-(1-N)). In this scenario, the sensing capable device (for example, sensing transmitter 504-1) may make a sensing transmission on which the access point (for example, sensing receiver 502-1) may make a sensing measurement. Examples by which the access point and the one or more plurality of sensing capable devices communicate with each other are explained in detail in FIG. 11A, FIG. 11B, and FIG. 12.

According to an implementation, a connection between a sensing capable device (simply referred to as a “device” hereinafter) and an access point may be referred to as a link and may be denoted as “Ln”, where “n” is defined as the link number. For example, the link number of L1 is 1 and the link number of L2 is 2. In an example, the link may be a sensing link that may be used for sensing transmissions. In some examples, the link may be a data link that may be used for data transmissions. In some examples, the link may be both a data link and a sensing link. A link combo may include two or more links that have similar coverage in the sensing space and may be interchangeably used to sense motion in the sensing space. There may be several link combos in a sensing space. Further, there may be an area, known as a sensing coverage area, in which a motion may be detected by a sensing transmission between a sensing capable device and an access point. In some scenarios, a motion in a sensing space may cause perturbances on multiple links simultaneously. If some links have substantial overlapping coverage area, then it may be possible to select one or more links to sense the overlapping coverage area in the sensing space. In an example, the one or more links selected to sense the overlapping coverage area may be referred to as sensing links. The sensing links may be used for sounding the sensing space for a period of time. In examples, during the selection of the sensing links, one or more feasible, viable, or non-essential links may be trimmed (i.e., are not selected for sensing). In an example, the one or more links that are trimmed may be referred to as trimmed links. Examples by which sensing links and trimmed links are determined are described in detail below.

In a Wi-Fi sensing system, a data transmission or a sensing transmission may happen on a link at different transmission opportunities (TXOPs). In examples, the Wi-Fi sensing system may utilize an orthogonal frequency division multiple access (OFDMA) TXOP that is not used for data transmissions, for Wi-Fi sensing.

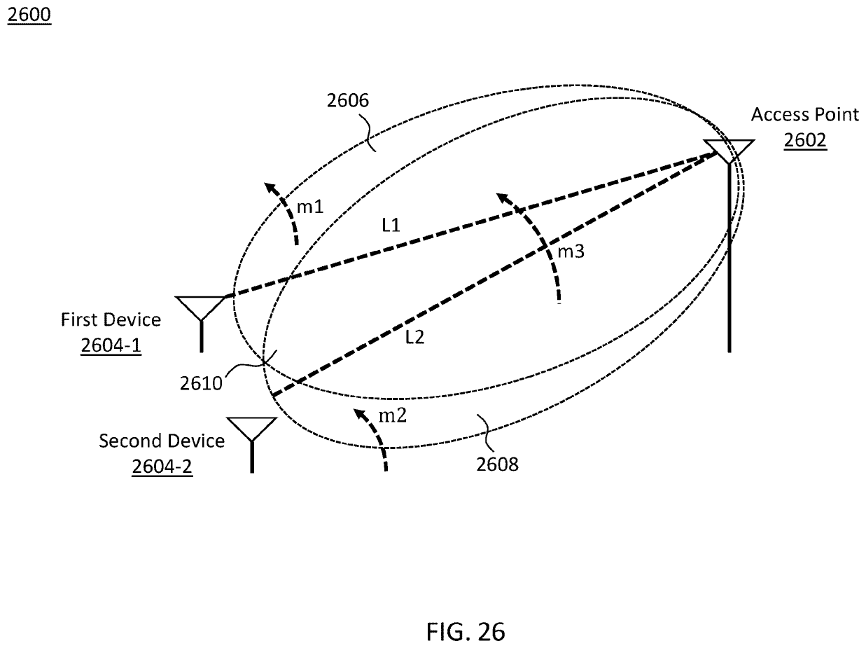

FIG. 26 depicts example representation 2600 of an overlapping coverage area in a Wi-Fi sensing system (for example, system 500), according to some embodiments. As shown in FIG. 26, the Wi-Fi sensing system includes access point 2602 and two sensing capable devices (simply referred to as a “devices” hereinafter), referred to as first device 2604-1 and second device 2604-2. In FIG. 26, two links (depicted by dashed lines) are shown between access point 2602 and two devices (i.e., first device 2604-1 and second device 2604-2). In examples, L1 represents a link between access point 2602 and first device 2604-1, and L2 represents a link between access point 2602 and second device 2604-2. FIG. 26 further shows a coverage area 1 of first device 2604-1 (represented by reference number “2606”) and a coverage area 2 of second device 2604-2 (represented by reference number “2608”). Also, there is a large overlapping coverage area of coverage area 1 and coverage area 2 (represented by reference number “2610”). FIG. 26 also shows three motions, referred to as m1, m2, and m3. Motion m1 occurs in coverage area 1 only, motion m2 occurs in coverage area 2 only, and motion m3 occurs in the overlapping coverage area of coverage area 1 and coverage area 2. In examples, motion m3 may be detected by either link L1 or link L2. In order to simplify the sensing measurement processing and reduce the number of sensing devices required for the sensing measurement processing, either of links L1 and L2 may be required. In an example, if link L1 is retained for sensing while link L2 is removed, then motion m2 may not be detected by link L1 because it does not occur in coverage area 1. However, the portion of coverage area 2 that is not in the overlapping coverage area of coverage area 1 and coverage area 2 may be very small, thus motions like m2 which are only in coverage area 2 may be very few, and as a result, the removal of link L2 may be acceptable for the Wi-Fi sensing system. Accordingly, link L1 may be selected as a sensing link and link L2 may be trimmed, i.e., not selected to be a sensing link.

As can be gathered from above, for Wi-Fi sensing purposes (e.g., motion detection or localization), not all the links within a link combo are necessary due to the coverage overlap. It takes time, processing capacity, and bandwidth to perform sensing on all links with all sensing capable devices. As a result, trimming the links down to only those that are essential to effectively detect motion in the sensing space is needed. In particular, a method for selecting a sensing link within a link combo based on a physical (PHY) layer criterion is required. The present disclosure describes solutions to determine which sensing links should be selected to effectively detect movement in a sensing space with the minimum number of sensing capable devices.

Examples by which links that are the necessary links for sensing a sensing space and links that may be trimmed are determined are described in detail below. In examples, where two or more sensing links are within a link combo, links may be trimmed based on PHY layer criterion.

According to an embodiment, an access point (which may be a sensing initiator) may be configured to discover or identify a candidate set of the plurality of networking devices. In an example, the plurality of networking devices may include a plurality of sensing capable devices, in order to support Wi-Fi sensing. Further, in an example, the candidate set may include a plurality of candidate devices capable of establishing transmission links with the access point. In examples, the plurality of candidate devices may include one or more of plurality of sensing capable devices. According to an example, the candidate set may refer to a group of discovered sensing capable devices that are presently not a part of a sensing link set. Further, individual sensing capable devices in the candidate set may be referred to as candidate devices. According to an example implementation, the access point may identify the plurality of candidate devices using procedures described in FIG. 9. For example, the access point may determine the presence of the plurality of candidate devices by sending a setup request (SENS Measurement Setup Request frame), to which plurality of candidate devices may respond with a SENS Measurement Setup Response frame. In examples, the access point may also check the availability of each candidate device to participate in a sensing session by sending a sensing poll (SENS Poll frame), to which available candidate devices may respond to with a CTS-to-self frame. Accordingly, the access point may become aware of the plurality of candidate devices that are capable of establishing transmission links or sensing links with the access point.

According to an implementation, the access point may be configured to establish a plurality of candidate sensing links (for example, to initiate sensing sessions) between the plurality of candidate devices and the access point. In examples, the access point may establish the plurality of candidate sensing links between the plurality of candidate devices and the access point based on the WLAN sensing procedure (also known as a Wi-Fi sensing procedure) described in FIG. 6. Referring to FIG. 6, a scenario when the access point performs simultaneous Wi-Fi sensing with three candidate devices, for example, a first device, a second device, and a third device is described. In examples, initially, a sensing session setup procedure may be performed between the access point and the first device (sensing transmitter 504-1) that establishes a sensing session identified by the AID of sensing transmitter 504-1 (AID 1). Further, while the access point and the first device still have the sensing session active, a new sensing session setup procedure may be performed between the access point and the second device that establishes a sensing session identified by the UID of the second device (UID 2). Furthermore, while the access point and the second device still have the sensing session active, a new sensing session setup procedure may be performed between the access point and the third device that establishes a sensing session identified by the AID of the third device (AID 3). In this way, every device has a different sensing session setup. In an implementation, after the plurality of links are established between the plurality of devices and the access point, the access point may select one or more links amongst the plurality of links as sensing links and trim remaining links.

Further, according to an implementation, the access point may be configured to monitor sensing transmissions transmitted via the plurality of candidate sensing links during an analysis period. In an implementation, the access point may identify a plurality of power variations based on the received powers among the plurality of candidate sensing links based on the sensing transmissions.

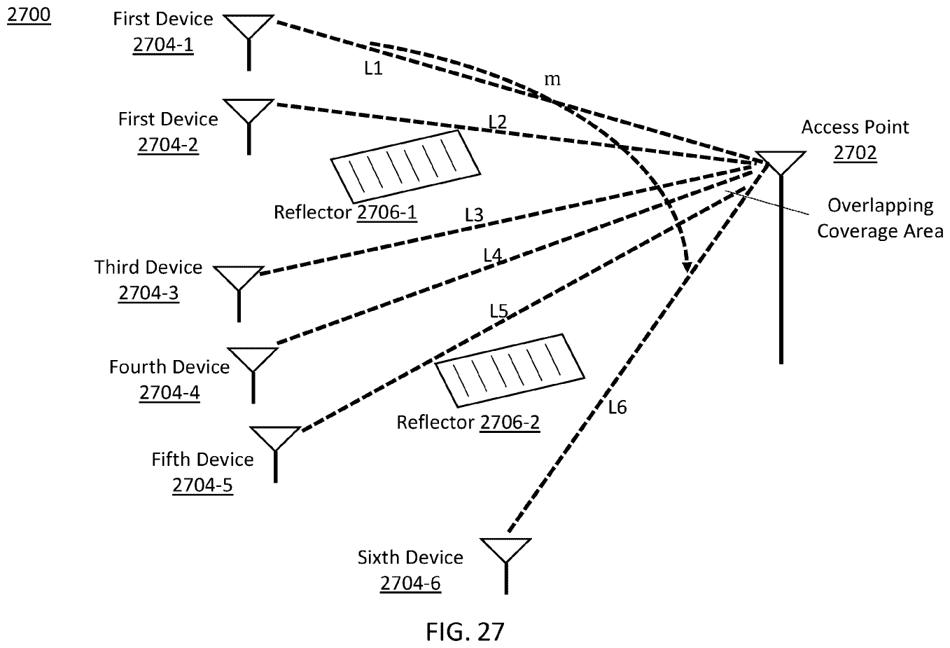

FIG. 27 depicts example 2700 of a Wi-Fi sensing system (for example, system 500) comprising a plurality of candidate devices, according to some embodiments. As shown in FIG. 27, the Wi-Fi sensing system includes access point 2702 and six devices, referred to as first device 2704-1, second device 2704-2, third device 2704-3, fourth device 2704-4, fifth device 2704-5, and sixth device 2704-6. Further, FIG. 27 shows two reflectors, referred to as first reflector 2706-1 and second reflector 2706-2. In FIG. 27, six links (depicted by dashed lines) are shown between access point 2702 and six devices (i.e., first device 2704-1, second device 2704-2, third device 2704-3, fourth device 2704-4, fifth device 2704-5, and sixth device 2704-6). In examples, L1 represents a link between access point 2702 and first device 2704-1, L2 represents a link between access point 2702 and second device 2704-2, L3 represents a link between access point 2702 and third device 2704-3, L4 represents a link between access point 2702 and fourth device 2704-4, L5 represents a link between access point 2702 and fifth device 2704-5, and L6 represents a link between access point 2702 and sixth device 2704-6. In examples, each of the links L1, L2, L3, L4, L5, and L6 may be a candidate sensing link that could be selected to be a sensing link or trimmed not to be a sensing link.

According to an implementation, the access point may be configured to monitor sensing transmissions transmitted via the plurality of candidate sensing links. In an implementation, the access point may be configured to determine an average power of the sensing transmissions over an analysis period. In an example, the analysis period may be an hour, a half day, a day, and so on. In examples, each of the sensing transmissions transmitted via the plurality of candidate sensing links are received at the access point with a received power. The received powers from the plurality of candidate sensing links over a sampling instance(s) at the access point may be defined as P1(s) for link L1, P2(s) for link L2, . . . , Pn(s) for link Ln.

In an implementation, the access point may identify a plurality of power variations based on the received powers from the plurality of candidate sensing links. In an example, each power variation may be characterized by a grouping of one or more candidate sensing links that display a variation in received power compared to the average power of the sensing transmissions of the respective candidate sensing links for one or more sampling instances(s) during the analysis period. In examples, the power variations from one or more sampling instances(s) may be defined as p1(s) for link L1, p2 (s) for link L2, . . . , pn(s) for link Ln. According to an implementation, if a motion impacts the received power of multiple candidate sensing links at the same sampling instance(s), then the impacted received power may be noted as a power variation of a link combo for these candidate sensing links. In an example, a power variation of a single candidate sensing link may have a grouping that includes only one candidate sensing link. Further, a power variation of a link combo may have a grouping that includes each candidate sensing link of the link combo. In an example, if a motion impacts the received powers of both links L1 and L2 at the same sampling instance(s), then it may be noted as a power variation of the link combo of L1 and L2, i.e., p1p2(s).

According to an implementation, the access point may be configured to create a sequence of power variations of links and/or link combos at different sampling instances (s1, s2, s3, . . . ) over the analysis period. In an example implementation, the access point may store the sequence of power variations of links and/or link combos in power variations information storage 562 for future use. In examples, a sequence of power variations of links and/or link combos over eleven (11) sampling instances (s1, s2, s3, . . . , s11) is shown in Table 1 provided below. Further, during the sampling instances from s1 to s11 as illustrated in Table 1, the in-combo Counter of each link is listed in Table 2 provided below.

TABLE 1
Power variations of links and/or link combos
over eleven (11) sampling instances

| | Power | | | |
|---|---|---|---|---|
| | variation of a | | | |
| Sampling | link or a link | Combo or | Variation | String |
| Instance | combo | Not | Counter | Counter |
| s1 | p1 | N | 1 | 1 |
| s2 | p1p2 | Y | 1 | 1 |
| s3 | p1p2 | Y | 2 | 2 |
| s4 | p1p2 | Y | 3 | 3 |
| s5 | p2p3 | Y | 1 | 1 |
| s6 | p1p2 | Y | 4 | 1 |
| s7 | p1p2 | Y | 5 | 2 |
| s8 | p3p4p5 | Y | 1 | 1 |
| s9 | p3p4p5 | Y | 2 | 2 |
| s10 | p3p4p5 | Y | 3 | 3 |
| s11 | p6 | N | 1 | 1 |

TABLE 2
In-combo counter for each link

| | In-Combo |
|---|---|
| Link | Counter |
| L1 | 5 |
| L2 | 6 |
| L3 | 4 |
| L4 | 3 |
| L5 | 3 |
| L6 | 0 |

In the example of Table 1, parameter “Combo or Not” indicates if the power variation impacts a single link (Not) or more than one link (Combo). For example, as shown in Table 1, for link combo “p1p2”, the power variation impacts links L1 and L2 (i.e., more than one link). Therefore, value of the parameter “Combo or Not” for link combo “p1p2” is Yes (Y). Further, parameter “Variation Counter” indicates the number of occurrences of a specific power variation of a link or a link combo during all sampling instances in the analysis period. In examples, each time the power variation of a link or a link combo occurs, the variation counter for the power variation of the link or the link combo will increase by one. Furthermore, parameter “String Counter” indicates the number of times a power variation of a link or a link combo occurs within a string. In an example, if the power variation of a link or a link combo occurs once within a string, then the string counter will increase by one. In some examples, if the power variation of a link or a link combo changes at a next sampling instance, then the string counter for the power variation of the link or the link combo will be reset to be zero. In the example of Table 2, parameter “In-Combo Counter” for a link may be defined as the number of times the link occurs in all power variations of link combos during all sampling instances in the analysis period. For example, as shown in Table 2, value of the parameter “In-Combo Counter” for link L5 is five as the link L5 occurred five times in all power variations of link combos during the eleven (11) sampling instances in the analysis period. In an embodiment, each power variation of a link or a link combo may have several strings. For example, for the power variation of the link combo “p1p2” in Table 1, the string length of first string (covering sampling instances s1, s2, and s3) of p1p2 is three, and the string length of second string (covering sampling instances s6 and s7) of p1p2 is two. Accordingly, the maximum string length of p1p2 is three. Further, the frequency of power variations of link combos is determined by the variation counter. In an example, the most frequent power variation of a link combo has the largest variation counter.

According to an implementation, the access point may be configured to identify a sensing link set according to the sensing transmissions. In an example, the sensing link set may include a plurality of selected sensing links selected from the plurality of candidate sensing links. According to an implementation, the access point may be configured to analyze the plurality of power variations to identify the sensing link set. In an implementation, the access point may analyze power variations of link combos in order to remove unnecessary links and retain a single necessary link in the sensing link set to represent a power variation of a link combo. According to an implementation, the access point may determine the order in which the different power variations of link combos may be analyzed. In an example, the power variations of link combos may be analyzed in order of variation counter, maximum string length, or combo length. In examples, the order in which the different power variations of the link combos are analyzed may be referred to as a significance ranking. For example, significance ranking may be determined according to at least one of a combo length representing a number of candidate sensing links occurring in the plurality of power variations, a variation counter representing a number of occurrences of each power variation from the plurality of power variations, and a maximum string length representing a largest number of consecutive occurrences of each power variation from the plurality of power variations. A list of the power variations of link combos in order of variation counter as a significance ranking is described in Table 3 provided below.

TABLE 3
List of power variations of link combos in order
of variation counter as a significance ranking

| | Power | | Maximum | |
|---|---|---|---|---|
| | variation of a | Variation | String | Combo |
| Top N | link combo | Counter | Length | Length |
| 1 | p1p2 | 5 | 3 | 2 |
| 2 | p3p4p5 | 3 | 3 | 3 |
| 3 | p2p3 | 1 | 1 | 2 |
| . . . | . . . | . . . | . . . | . . . |

In the example of Table 3, parameter “Combo Length” indicates the number of links in a power variation of a link combo. For example, as shown in Table 3, value of the parameter “Combo Length” for link combo “p3p4p5” is three.

According to an implementation, the access point may be configured to identify the sensing link set according to a sensing space coverage metric. In an implementation, the access point may determine a power variation test set including a subset of power variations selected from the plurality of power variations for analysis by the sensing space coverage metric. In examples, the power variation test set may be defined as a set of power variations of link combos that are selected from the plurality of power variations for analysis to determine which links are selected as the sensing links. According to the power variation test set, the access point may select a first power variation from the plurality of power variations according to a significance ranking of the plurality of power variations. Further, the access point may select a second power variation from the remaining ones of the plurality of power variations having no candidate sensing links in common with the first power variation according to the significance ranking of the remaining ones of the plurality of power variations. In examples, the power variation test set may include the first power variation and the second power variation. In an implementation, the power variation test set may further include one or more further power variations such that each candidate sensing link occurs in only one grouping from the first power variation, the second power variation, and the one or more further power variations. According to some implementations, the power variation test set may include a single power variation.

In an example implementation, the access point may analyze the plurality of power variations of link combos in order of combo length as a significance ranking to identify the sensing link set. An analysis of power variations of link combos in order of combo length as a significance ranking is described in Table 4 provided below.

TABLE 4
Analysis of power variations of link combos in
order of combo length as a significance ranking

| | | | | Higher | Link with | |
|---|---|---|---|---|---|---|
| | Power | | All Combo | than ratio | the largest | |
| Combo | variation of a | Selected | Links | threshold | In-Combo | Links |
| Length | link combo | or not | Covered | factor (rₜₕ) | Counter | removed |
| 3 | p3p4p5 | Y | N | Y | L3 | L4, L5 |
| 2 | p1p2 | Y | Y | Y | L2 | L1 |
| 2 | p2p3 | N | | | | |
| . . . | . . . | . . . | . . . | . . . | . . . | . . . |

In the example of Table 4, parameter “Selected or not” indicates if a power variation of a link combo is selected for analysis as a member of a power variation test set. In an example, parameter “All Combo Links Covered” indicates whether all combo links are included in the selected power variations of link combos. Once all combo links are covered, no further power variations of link combos are analyzed.

In examples, in Table 4, the power variation of the link combo “p3p4p5” with the largest combo length (i.e., three) is selected first. The next power variation of the link combo “p1p2” is selected because it has the next largest combo length (i.e., two) in the unselected combos (e.g., p1p2, p2p3, . . . ), and it does not include any combo links of the previous selections. As shown in Table 4, the power variation of the link combo “p2p3” is not selected because the link L3 (or p3) has already been included in the selected power variation of the link combo “p3p4p5”. In the example, after the second selection, all the combo links (e.g., L1, L2, L3, L4, and L5) are included in the selected power variations of link combos (e.g., “p3p4p5” and “p1p2”), therefore the selection is complete. Accordingly, the power variation test set includes the first power variation (i.e., “p3p4p5” and the second power variation (i.e., “p1p2”).

According to an implementation, once the power variation test set is determined, the access point may be configured to determine a power ratio parameter (R_{combo}) for a test power variation of the power variation test set. In an example, power ratio parameters may represent a ratio of a parameter of a power variation of a link combo (e.g., maximum string length, variation counter, etc.) to a corresponding parameter of a single link power variation of one of the candidate sensing links of the link combo power variation. In an example, a single link power variation may refer to the power variation associated with one of the candidate sensing links of the grouping of the power variation occurring without the other candidate sensing links of the grouping. For example, the candidate sensing links L2, L3, and L4 of the power variation characterized by the grouping p2p3p4, may, respectively, have associated single link power variations p2, p3, and p4.

In an implementation, the access point may determine the power ratio parameter (R_{combo}) by dividing a first maximum string length representing a largest number of consecutive occurrences of a test power variation from the power variation test set in the analysis period by a second maximum string length representing a largest number of consecutive occurrences in the analysis period from among single link power variations associated with each candidate sensing link of the grouping of the test power variation. The power ratio parameter (R_{combo}) determined based on the parameter “Maximum String Length” is represented as follows in Equation (9):

$${R}_{combo} = \frac{Maximum String Length of a Power Variation Combo}{\begin{matrix}max \{ Maximum String Length of each Link \\ in the Power Variation Combo \}\end{matrix}} \qquad ( 9 )$$

$$For example ,$$

$${R}_{combo “ p 1 p 2 ”} = \frac{Maximum String Length of “ p 1 p 2 ”}{\begin{matrix}max \{ Maximum String Length of “ p 1 ” , \\ Maximum String Length of “ p 2 ” \}\end{matrix}}$$

$${R}_{combo “ p 3 p 4 p 5 ”} = \frac{Maximum String Length “ p 3 p 4 p 5 ”}{\begin{matrix}max \{ Maximum String Length “ p 3 ” , \\ Maximum String Length “ p 4 ” , \\ Maximum String Length “ p 5 ” \}\end{matrix}}$$

In some implementations, the access point may determine the power ratio parameter (R_{combo}) based on dividing a first variation counter representing a number of occurrences of a test power variation from the power variation test set in the analysis period by a second variation counter representing a largest number of occurrences in the analysis period from among single link power variations associated with each candidate sensing link of the grouping of the test power variation. The power ratio parameter (R_{combo}) determined based on the parameter “Variation Counter” is represented as follows in Equation (10):

$${R}_{combo} = \frac{Variation Counter of a Power Variation Combo}{\begin{matrix}max \{ Variation Counter of each Link \\ in the Power Variation Combo \}\end{matrix}}$$

$$For example ,$$

$${R}_{combo “ p 1 p 2 ”} = \frac{Variation Counter of “ p 1 p 2 ”}{\begin{matrix}max \{ Variation Counter of “ p 1 ” , \\ Variation Counter of “ p 2 ” \}\end{matrix}}$$

$${R}_{combo “ p 3 p 4 p 5 ”} = \frac{Variation Counter of “ p 3 p 4 p 5 ”}{\begin{matrix}max \{ Variation Counter of “ p 3 ” , \\ Variation Counter of “ p 4 ” , \\ Variation Counter of “ p 5 ” \}\end{matrix}}$$

According to an implementation, the access point may determine additional power ratio parameters for additional power variations of the power variation test set. Further, the access point may compare the additional power ratio parameters to the ratio threshold factor (rₜₕ) for each of the additional power variations. In an implementation, the access point may select, for each additional power variation having an additional power ratio parameter exceeding the ratio threshold factor (rₜₕ), for inclusion in the sensing link set, an additional selected candidate sensing link from each grouping of the additional power variations according to the candidate sensing link occurring in a largest number of the plurality of power variations.

According to an implementation, upon determining the power ratio parameter (R_{combo}) for the test power variation of the power variation test set, the access point may be configured to compare the power ratio parameter (R_{combo}) to a ratio threshold factor (rₜₕ). In examples, the ratio threshold factor (rₜₕ) may be defined for Equation (9) or Equation (10), where the ratio threshold factor (rₜₕ) is the minimum power ratio parameter (R_{combo}) for which links may be removed. In an implementation, the ratio threshold factor (rₜₕ) may be empirically determined. In an example, value of the ratio threshold factor (rₜₕ) may be five. This indicates that if the coverage area of the power variation of a link combo is five times the coverage area of each combo link of the power variation of a link combo, then one or more links may be removed from the power variation of a link combo. In examples, if the ratio threshold factor (rₜₕ) is too low, then removing the links may result in less accurate motion detection. In an implementation, the access point may optimize the ratio threshold factor (rₜₕ) over time based on successful motion detection. In examples, the ratio threshold factor (rₜₕ) is required to be increased until optimal motion detection success rate is achieved.

According to an implementation, the access point may select, responsive to the power ratio parameter (R_{combo}) exceeding the ratio threshold factor (rₜₕ), for inclusion in the sensing link set, a selected candidate sensing link from the grouping of the test power variation according to the candidate sensing link occurring in a largest number of groupings of the plurality of power variations. Referring to Table 4, parameter “Higher than ratio threshold factor (rₜₕ)” indicates that power ratio parameter (R_{combo}) of the power variation of a link combo (for example, as calculated using Equation (9)) is greater than the ratio threshold factor (rₜₕ). In examples, if the power ratio parameter (R_{combo}) is greater than the ratio threshold factor (rₜₕ), then there may be significant overlap between the links of power variation of a link combo. For example, as shown in Table 4, for the power variation of the link combo “p3p4p5”, the power ratio parameter (R_{combo}) is greater than the ratio threshold factor (rₜₕ). As a result, there may be significant overlap between the links L3, L4, and L5. In examples, within this power variation of the link combo “p3p4p5”, the link with the largest in-combo counter (i.e., link L3) may represent the power variation of the link combo “p3p4p5” and may be added to the sensing link set, while other links (i.e., links L4 and L5) are removed.

In an implementation, the access point may retain links that are not represented in any power variation of a link combo. In an example, a link that is retained is a sensing link. In the example of Table 1, link L6 is not represented in any power variation of a link combo.

In examples, a link may be selected as the sensing link within a link combo if the link has the largest “In-Combo Counter” among all the links within the link combo. The other links within the link combo may be trimmed. In an example, a first link combo may include links L1 and L2, and a second link combo may include links L3, L4, and L5.

Table 5 provided below shows the necessary links from the above example. In example, the necessary links may form the sensing link set that may be used to measure the sensing space. In an embodiment, in the example of Table 5, within the link combo including links L1 and L2, link L2 is selected as the sensing link because link L2 has the largest In-Combo Counter, and link L1 is trimmed. Similarly, within the link combo including links L3, L4, and L5, link L3 is selected as the sensing link because link L3 has the largest In-Combo Counter, while other links L4 and L5 within this link combo are trimmed. Further, link L6 may not be a part be of a link combo and so link L6 is also kept as a sensing link.

TABLE 5
Necessary Links

| | In-Combo | Removed | Necessary |
|---|---|---|---|
| Link | Counter | or not | Links |
| L1 | 5 | Y | N |
| L2 | 6 | N | Y |
| L3 | 4 | N | Y |
| L4 | 3 | Y | N |
| L5 | 3 | Y | N |
| L6 | 0 | N | Y |

In an implementation, after the sensing link set is identified, the access point may set up multiple sensing sessions for the sensing links in the sensing link set for motion detection purposes. In examples, the access point may establish the plurality of selected sensing links between selected devices of the plurality of candidate devices (for example, one or more of plurality of sensing capable devices and the access point.

In an implementation, after the plurality of links are established between the plurality of devices and the access point, the access point may select one or more links amongst the plurality of links as sensing links and trim remaining links.

Continuing from the example described with respect to FIG. 27, FIG. 28 depicts an example representation of the same plurality of links in a sensing space, according to some embodiments.

In FIG. 28, three links, for example, links L2, L3, and L6 that are selected as the sensing links as shown as solid lines. In an example, the set of sensing links may be referred to as a sensing link set. Referring to the above example, the sensing link set includes links L2, L3, and L6 corresponding to selected second device 2804-2, third device 2804-3, and sixth device 2804-6, respectively. Although other known examples and implementations of determining the sensing link set are contemplated herein, these need not be described in full within this disclosure.

In an implementation, after the sensing link set is determined (or identified) by trimming off the non-essential links, there may be changes in the sensing space. In an example, changes in the sensing space may be due to an object in the sensing space being moved from its original location to a new location. For example, a reflector in the sensing space may move from its original location to a new location. In examples, changes in the sensing space or addition of new devices in the sensing space, may change the sensing link set. In some scenarios, some devices that are a part of the sensing link set may no longer be suitable (or useful) for sensing and should be removed.

In certain scenarios, after the sensing links have been selected, one or more of the sensing links may become congested, thus leaving a small amount of available bandwidth for sensing measurement exchanges. As a result, the ability of the Wi-Fi sensing system to effectively sound the sensing space may be impaired. Therefore, a method to detect congestion situations that are compromising the sensing of the sensing space, and to substitute sensing links with trimmed links without losing sensing fidelity is required.

Further, in examples, the plurality of candidate sensing links may include original sensing links of a previously established sensing link set (also referred to as an original sensing link set) and trimmed sensing links not included in the previously established sensing link set. In an example, each power variation may have at least one original sensing link. According to an implementation, the access point may access previously stored sensing sounding information. In examples, the access point may obtain or retrieve the sensing sounding information from sensing information storage 562. In some implementations, to obtain the sensing sounding information, the access point may be configured to establish a plurality of candidate sensing links between the plurality of devices and the access point as described in relation to FIG. 27. In examples, the access point may establish the plurality of candidate sensing links between the plurality of devices and the access point based on the WLAN sensing procedure (also known as a Wi-Fi sensing procedure) described in FIG. 6. According to the example illustrated in FIG. 27, the plurality of devices may include six devices, referred to as a first device, a second device, a third device, a fourth device, a fifth device, and a sixth device. Further, in an example, there may be six candidate sensing links between the access point and the devices. The six candidate sensing links may include links L1, L2, L3, L4, L5, and L6. In an example, out of the links L1, L2, L3, L4, L5, and L6, links L2, L3, and L6 may be original sensing links and links L1, L4, and L5 may be the original trimmed sensing links. Further, according to an implementation, the access point may be configured to monitor sensing transmissions transmitted via the plurality of candidate sensing links during an analysis period. In an implementation, the access point may identify a plurality of power variations among the plurality of candidate sensing links based on the sensing transmissions.

According to an implementation, upon obtaining the sensing sounding information, the access point may be configured to determine a plurality of data usage values corresponding to the plurality of candidate sensing links. In an example, data usage may represent how many TXOPs are used for data transmissions within X TXOPs. In examples, a data usage of a link may be zero if the link is not used for data transmissions in a relevant period. In examples, a data usage value of a link may be mathematically represented as:

$$Data Usage = ( Number of TXOPs used for data transmissions ) / X \qquad ( 11 )$$

In an implementation, the access point may determine the plurality of data usage values corresponding to the plurality of candidate sensing links using Equation (11).

According to an implementation, the access point may be configured to identify a sensing link set according to a sensing space coverage metric determined from the sensing sounding information and the plurality of data usage values. In examples, the sensing link set may include a plurality of representative sensing links selected from the plurality of candidate sensing links. In an implementation, the access point may determine a power variation test set including a subset of power variations selected from the plurality of power variations for analysis by the sensing space coverage metric. In examples, the power variation test set may be defined as a set of power variations of link combos that are selected from the plurality of power variations for analysis to determine which links are selected as the sensing links. Examples by which the sensing link set is identified are described in detail below.

In an implementation, the access point may identify a congested sensing link from among the original sensing links as having a corresponding data usage value from the plurality of data usage values exceeding a congestion threshold T. In an example, the congestion threshold T may indicate whether data usage of a link is high or low. For example, for a link, if Data Usage>=T (e.g., 90%), then the link may be defined as a congested link. Similarly, for a link, if Data Usage<T (e.g., 90%), then the link may be defined as an uncongested link. In examples, uncongested links could be used for sensing transmissions during TXOPs not used for data transmissions. In an example, out of the original sensing links L2, L3, and L6, data usage value of link L3 may exceed the congestion threshold T. For example, data usage value of link L3 may be 91%. Accordingly, link L3 may be identified as the congested sensing link.

Upon identifying the congested sensing link, in an implementation, the access point may be configured to identify a power variation corresponding to the congested sensing link based on the methods described above. Further, according to an implementation, the access point may be configured to identify one or more trimmed sensing links belonging to the power variation corresponding to the congested sensing link. In an example, trimmed sensing links L4 and L5 may be identified to be belonging to the power variation corresponding to the congested sensing link L3.

In an implementation, the access point may select a representative sensing link for the power variation from among the congested sensing link and the one or more trimmed sensing links. According to an implementation, the access point may select the representative sensing link for the power variation to balance link loads in the sensing link set. In examples, a link load of a link may be mathematically represented as shown in Equation 12.

$$Link Load = ( Number of TXOPs used for data transmissions + Number of TXOPs used for sensing transmissions ) / X \qquad ( 12 )$$

where, “Number of TXOPs used for sensing transmissions)/X” represents a sensing usage of the link.

According to some implementations, the access point may be configured to identify additional congested sensing links from among the original sensing links according to the plurality of data usage values. Further, the access point may be configured to identify additional power variations corresponding to the additional congested sensing links. The access point is further configured to identify additional sets of one or more trimmed sensing links belonging to the additional power variations. For each additional power variation, the access point may be configured to select a corresponding representative sensing link from among the corresponding additional congested sensing links and the corresponding additional set of one or more trimmed sensing links.

In an example implementation, the access point may select a trimmed sensing link (from among the one or more trimmed sensing links) occurring in a largest number of a plurality of groupings characterizing the plurality of power variations as the representative sensing link. In other words, a trimmed sensing link with the highest In-Combo Counter among the one or more trimmed sensing links of a link combo may be selected as the representative sensing link. In some example implementations, the access point may select a trimmed sensing link (from among the one or more trimmed sensing links) having a lowest data usage value from the plurality of data usage values as the representative sensing link.

According to some implementations, the access point may perform the selection of the representative sensing link for the power variation from among the congested sensing link and the one or more trimmed sensing links according to a switch factor defined for each of the congested sensing link and the one or more trimmed sensing links. In examples, a switch factor may be defined as a number of occurrences of a link in the groupings of the plurality of power variations divided by a data usage value corresponding to the link. The switch factor may be mathematically represented as shown in Equation 13.

$$Switch Factor = ( In - Combo Counter ) / ( \% Data Usage ) \qquad ( 13 )$$

In an implementation, the power variation may include the congested sensing link and an uncongested trimmed sensing link. According to an implementation, the access point may select the representative sensing link according to a highest switch factor among the congested sensing link and the uncongested trimmed sensing link. According to an implementation, a switch action may occur between the congested sensing link and the uncongested trimmed sensing link according to the highest switch factor among the congested sensing link and the uncongested trimmed sensing link. In an example, a switch action may be defined as an action to switch a congested sensing link to one of a plurality of uncongested trimmed sensing links within the same link combo. In an example implementation, if a sensing link is coincident with a congested link, and other trimmed sensing links are also on the congested links, then the switch action may not occur. In an example, if the uncongested trimmed sensing link has the highest switch factor, then the access point may select the uncongested trimmed sensing link as the representative sensing link. That means the congested sensing link (congested original sensing link) may be switched to the uncongested trimmed sensing link (i.e., the congested sensing link may be substituted with the uncongested trimmed sensing link). Accordingly, the uncongested trimmed sensing link is the updated sensing link.

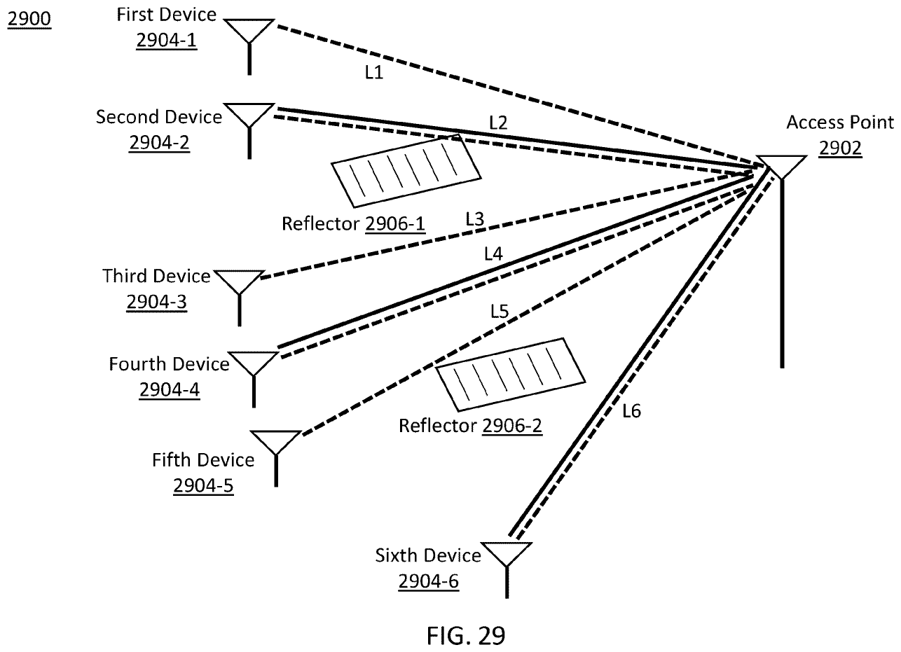

The updated sensing links are illustrated in FIG. 29. In FIG. 29, the Wi-Fi sensing system (for example, system 500 as illustrated in FIG. 27) is shown which comprising a plurality of candidate devices, according to some embodiments. As shown in FIG. 29, the Wi-Fi sensing system includes access point 2902 and six devices, referred to as first device 2904-1, second device 2904-2, third device 2904-3, fourth device 2904-4, fifth device 2904-5, and sixth device 2904-6. Further, FIG. 29 shows two reflectors, referred to as first reflector 2906-1 and second reflector 2906-2. In FIG. 29, six links (depicted by dashed lines) are shown between access point 2902 and six devices (i.e., first device 2904-1, second device 2904-2, third device 2904-3, fourth device 2904-4, fifth device 2904-5, and sixth device 2904-6). In examples, L1 represents a link between access point 2902 and first device 2904-1, L2 represents a link between access point 2902 and second device 2904-2, L3 represents a link between access point 2902 and third device 2904-3, L4 represents a link between access point 2902 and fourth device 2904-4, L5 represents a link between access point 2902 and fifth device 2904-5, and L6 represents a link between access point 2902 and sixth device 2904-6. In examples, each of the links L1, L2, L3, L4, L5, and L6 are candidate sensing links.

Examples of updated sensing links are described in Table 6 provided below. The solid lines on L2, L4, and L6 represent the updated sensing links after a switch action has occurred.

TABLE 6
Updated Sensing links

| | | | Original | | | | Updated |
|---|---|---|---|---|---|---|---|
| | In-Combo | Trimmed | Sensing | Congested | Data | Switch | Sensing |
| Links | Counter | or not | Links | or not | Usage | Factor | Links |
| L1 | 5 | Y | N | N | 60% | 8.33 | N |
| L2 | 6 | N | Y | N | 60% | 10.00 | Y |
| L3 | 4 | N | Y | Y | 91% | 4.40 | N |
| L4 | 3 | Y | N | N | 60% | 5.00 | Y |
| L5 | 3 | Y | N | Y | 95% | 3.16 | N |
| L6 | 0 | N | Y | N | 60% | 0.00 | Y |

In the example of Table 6, within the link combo including links L3, L4, and L5, link L3 is the congested sensing link (original sensing link) with the data usage value of 91%, link L4 is an uncongested trimmed sensing link with the data usage value of 60%, and link L5 is a congested trimmed sensing link with the data usage value of 95%. Further, as shown in Table 6, the switch factor of link L3 is 4.40 and the switch factor of link L4 is 5.00. Since the switch factor of link L4 is higher than the switch factor of link L3, a switch action may occur between link L3 and link L4. Accordingly, link L4 is the updated sensing link.

Further examples of updated sensing links are described in Table 7 provided below.

TABLE 7
Updated Sensing links

| | | | Original | | | | Updated |
|---|---|---|---|---|---|---|---|
| | In-Combo | Trimmed | Sensing | Congested | Data | Switch | Sensing |
| Links | Counter | or not | Links | or not | Usage | Factor | Links |
| L1 | 5 | Y | N | N | 60% | 8.33 | N |
| L2 | 6 | N | Y | N | 60% | 10.00 | Y |
| L3 | 4 | N | Y | Y | 91% | 4.40 | Y |
| L4 | 3 | Y | N | N | 80% | 3.75 | N |
| L5 | 3 | Y | N | Y | 95% | 3.16 | N |
| L6 | 0 | N | Y | N | 60% | 0.00 | Y |

In the example of Table 7, within the link combo including links L3, L4, and L5, link L3 is the congested sensing link (congested original sensing link) with the data usage value of 91%, link L4 is an uncongested trimmed sensing link with the data usage value of 60%, and link L5 is a congested trimmed sensing link with the data usage value of 95%. Further, in the example shown in Table 7, the switch factor of link L3 is 4.40 and the switch factor of link L4 is 3.75. Since the switch factor of link L4 is not higher than the switch factor of link L3, a switch action between link L3 and link L4 may not occur, and the updated sensing links are the same as the original sensing links.

In some implementations, the power variation may include the congested sensing link and a plurality of uncongested trimmed sensing links. According to an implementation, the access point may select the representative sensing link according to a highest switch factor among the congested sensing link and the plurality of uncongested trimmed sensing links. In some implementations, the access point may further select the representative sensing link among two uncongested trimmed sensing links having a same switch factor according to the uncongested trimmed sensing link having a lower link number.

In an example, if the congested sensing link and one of the plurality of uncongested trimmed sensing links exist in the same link combo, then a switch action may occur between the congested sensing link and the one of the plurality of uncongested trimmed sensing links. In some examples, if a switch factor of one of the plurality of uncongested trimmed sensing link is higher than the congested sensing link, then a switch action may occur between the congested sensing link and the uncongested trimmed sensing link having the higher switch factor. In some examples, if a switch factor of one of the plurality of uncongested trimmed sensing links is higher than the congested sensing link and is also highest amongst all uncongested trimmed sensing links within the same link combo, then a switch action may occur between the congested sensing link and the uncongested trimmed sensing link having the highest switch factor. In some examples, if the congested sensing link and the plurality of uncongested trimmed sensing links exist in the same link combo and the two or more uncongested trimmed sensing links have same switch factor, then a switch action may occur between the congested sensing link and the uncongested trimmed sensing link that has a lower link number.

Other examples of updated sensing links are described in Table 8 provided below.

TABLE 8
Updated Sensing links

| | | | Original | | | | Updated |
|---|---|---|---|---|---|---|---|
| | In-Combo | Trimmed | Sensing | Congested | Data | Switch | Sensing |
| Links | Counter | or not | Links | or not | Usage | Factor | Links |
| L1 | 5 | Y | N | N | 60% | 8.33 | N |
| L2 | 6 | N | Y | N | 60% | 10.00 | Y |
| L3 | 4 | N | Y | Y | 91% | 4.40 | N |
| L4 | 3 | Y | N | N | 60% | 5.00 | Y |
| L5 | 3 | Y | N | Y | 60% | 5.00 | N |
| L6 | 0 | N | Y | N | 60% | 0.00 | Y |

In the example of Table 8, within the link combo including links L3, L4, and L5, link L3 is the congested sensing link (congested original sensing link) with the data usage value of 91%, link L4 is an uncongested trimmed sensing link with the data usage value of 60%, and link L5 is a congested trimmed sensing link with the data usage value of 60%. Further, in the example shown in Table 8, the switch factor of link L3 is 4.40, the switch factor of link L4 is 5.00, and the switch factor of link L5 is also 5.00. Since the switch factors of link L4 and link L5 are same and higher than the switch factor of link L3, and link L4 has a smaller link number than link L5, a switch action may occur between link L3 and link L4. Accordingly, the updated sensing links (or the representative sensing links) are different from the original sensing links. As may be understood, after the switch action, the sensing link set is updated.

The updated sensing links (or the representative sensing links) are different from the original sensing links. As may be understood, after the switch action, the sensing link set is updated. The updated sensing link set includes updated sensing links. The updated sensing links after the switch action that occurred between link L3 and link L4 are illustrated in FIG. 29. FIG. 29 shows three updated sensing links (i.e., link L2, link L4, and link L6) that are identified after the switch action that occurred between link L3 and link L4. The updated sensing links L2, L4, and L6 are shown as solid lines in FIG. 29. As can be seen in FIG. 29 (and in comparison to FIG. 28), the congested original sensing link L3 is substituted with the uncongested trimmed sensing link L4.

According to an implementation, as a result of the switch action between link L3 and link L4, the link loads between link L3 and link L4 are balanced. For example, before the switch action, the link load of link L3=Data Usage+Sensing Usage (for example, 5%)=91%+5%=96% while the link load of link L4=Data Usage+Sensing Usage=60%+0=60%, thus the link loads between link L3 and link L4 were not balanced (95% vs. 60%). However, after the switch action, the link load of link L3=Data Usage+Sensing Usage=91%+0=91%, while the link load of link L4=Data Usage+Sensing Usage=60%+5%=65%, the link loads between L3 and L4 are more balanced (91% vs. 65%) than before.

In an implementation, the sensing link set (updated sensing link set) identified by the access point may include the plurality of representative sensing links (for example, links L2, L4, and L6) selected from the plurality of candidate sensing links. According to an implementation, the access point may be configured to establish the plurality of representative sensing links between corresponding ones of the plurality of devices and the access point. According to an implementation, the access point may set up multiple sensing sessions for the plurality of representative sensing links in the sensing link set for motion detection purposes. In some implementations, the sensing sessions may be measured over one or more sampling instances of an analysis period.

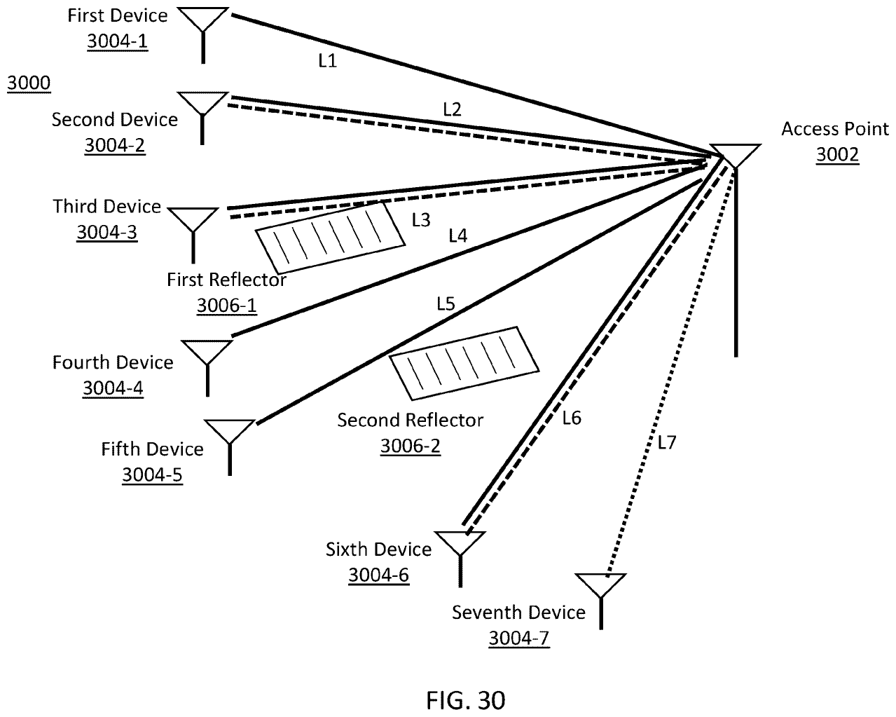

FIG. 30 depicts an example representation a plurality of links in a changed sensing space, according to some embodiments. In the example of FIG. 30, first reflector 3006-1 has moved from its original location (as shown in FIG. 29) to a new location. Further, as shown in FIG. 30, a new device (seventh device 3004-7) has been installed in the sensing space and is an idle device.

According to an implementation, the access point may be configured to maintain a plurality of selected sensing links as a sensing link set between selected devices of the plurality of devices and the access point. As described earlier, after the sensing link set is set up, there may be changes in the sensing space. In order to determine which devices to use for sensing the changed sensing space, the access point may periodically check the sensing space to determine if there are devices that are not a part of the sensing link set currently but could be used for sensing the changed sensing space. In some implementations, the access point may be configured to determine the devices, for example through association or through a discovery process as described earlier. In examples, the result of the discovery process results in the access point being aware of all devices that could form a sensing link with the access point. In an example, referring to FIG. 30, the discovered devices may include unselected devices (or trimmed devices) of the plurality of devices (for example, first device 3004-1, fourth device 3004-4, and fifth device 3004-5) and/or new devices that have been installed in the sensing space (for example, seventh device 3004-7).

In an implementation, the access point may be configured to identify a plurality of candidate links as a candidate link set between unselected devices of the plurality of devices and the access point. In an implementation, the access point may identify trimmed links not included in the sensing link set and include the trimmed links in the candidate link set as candidate links. In some implementations, the access point may include discovered devices as candidate devices in the candidate link set representing the candidate links. In examples, the candidate link set may include candidate links that could be established with devices (where no sensing link is present prior to the analysis period) that are discovered by the discovery process and/or the trimmed links (that the access point has already been aware of but that are not a part of the sensing link set currently).

Referring again to FIG. 30, data links (depicted by solid lines) are ongoing between access point 3002 and six devices (i.e., first device 3004-1, second device 3004-2, third device 3004-3, fourth device 3004-4, fifth device 3004-5, and sixth device 3004-6). Further, three links (for examples, link L2, link L3, and link L6 between access point 3002 and second device 3004-2, third device 3004-3, and sixth device 3004-6, respectively) are also sensing links of the sensing link set (depicted by dashed lines). In examples, the data links and the sensing links (link L2, link L3, and link L6) are on different TXOPs. With respect to FIG. 30, the candidate link set may include devices of the trimmed links (e.g., first device 3004-1 of trimmed link L1, fourth device 3004-4 of trimmed link L4, and fifth device 3004-5 of trimmed link L5) and the idle device (seventh device 3004-7).

According to an implementation, the access point may be configured to identify a plurality of assessment links as an assessment link set from the candidate link set and the original sensing link set for an analysis period (or an analysis period). In an implementation, the access point may select one or more of the plurality of sensing links as assessment links. In some implementations, the access point may select a subset of the plurality of candidate links as assessment links. In examples, since the assessment link set includes the sensing link set, there is continuity in the sensing of the sensing space. Table 9 provided below shows examples of assessment links.

TABLE 9
Assessment links

| | Original Sensing | Assessment |
|---|---|---|
| Link | Links | Links |
| L1 | N | N |
| L2 | Y | Y |
| L3 | Y | Y |
| L4 | N | Y |
| L5 | N | N |
| L6 | Y | Y |
| L7 | N | N |

In the example of Table 9, sensing links L2, L3, and L6 are selected as assessment links. Further, trimmed link L4 is also selected as an assessment link.

According to some implementations, the access point may be configured to determine whether a metric of congestion of the access point is above a congestion threshold. In response to determining that the metric of the congestion of the access point is above the congestion threshold, the access point may select one or more active devices (trimmed devices) of the candidate devices in the candidate link set for inclusion in the assessment link set. In examples, if the access point determines that its bandwidth is fully occupied, then the access system may select one or more devices that are only involved in established data links. These devices are referred to as active devices. Since the data links already have a negotiated bandwidth associated with them, no additional bandwidth is required. In an implementation, the number of idle devices that can be added to the assessment link set may depend on the overall congestion of the access point and/or the congestion of each of the ongoing data links.

In some implementations, the access point may be configured to determine whether a metric of congestion of the access point is below a congestion threshold. In response to determining that the metric of the congestion of the access point is below the congestion threshold, the access point may select one or more idle devices of the candidate devices in the candidate link set for inclusion in the assessment link set. In examples, if the access point determines that its bandwidth is not fully occupied, then the access point may add one or more idle devices to the assessment link set with the allocation of the bandwidth that has not been occupied, optionally in addition to including one or more active devices of the candidate devices in the assessment link set.

In examples, the congestion of the access point may be determined as a combination of the congestion of the links of the access point, for example using a metric for congestion of a data link, “Data Usage”, as previously described in relation to FIG. 29 and as described in Equation 11.

In an example, a metric for congestion of a sensing link may be “Sensing Usage”. In examples, sensing usage of a sensing link may be mathematically represented as shown in Equation 14:

$$Sensing Usage = ( Number of TXOPs used for sensing transmissions ) / X \qquad ( 14 )$$

In examples, for links that are used for both data transmissions and sensing transmissions, a metric for congestion may be “Link Load”. In examples, link load may be mathematically represented as shown in Equation 15:

$$Link Load = ( Number of TXOPs used for data transmissions + Number of TXOPs used for sensing transmissions ) / X \qquad ( 15 )$$

In an implementation, the access point may calculate a metric of the congestion of as a combination of the congestion of the links of the access point. In an example, the access point may calculate or determine the congestion based on averaging the data usage, the sensing usage, and the link load usage of all the links currently in use at the access point. In examples, the congestion of the access point may be determined using a congestion metric “AP Link Load”. In an implementation, AP link load may be mathematically represented as shown in Equation 16:

$$AP Link Load = {\sum }_{all links} ( Number of TXOPs used for data transmission + Number of TXOPs used for sensing transmissions ) / X \qquad ( 16 )$$

In examples, the number of idle devices added to the assessment link set may be a function of the AP congestion metric. In an example, the AP congestion metric may be normalized to a scale from 0 to 100, where 0 means that the access point is entirely idle, and 100 means that every possible TXOP of the access point is used. In examples, thresholds (for example, AP congestion thresholds) may be defined at which an additional idle device may be added to the assessment link. Examples of these thresholds are shown in Table 10 provided below.

TABLE 10
Thresholds

| | Number of Idle Devices |
|---|---|
| AP Congestion | That May Be Added to The |
| Threshold | Assessment Link Set |
| Greater than 80 | None |
| Between 60 and 80 | Up to 2 |
| Between 40 and 60 | Up to 4 |
| Under 40 | Maximum that can be |
| | supported depending on |
| | available access point |
| | bandwidth. |

According to an implementation, once the assessment link set is determined, the access point may be configured to determine an allocation of channel resources (i.e., transmission bandwidth) for the plurality of assessment links in the assessment link set in order to establish the plurality of assessment links. In an implementation, the access point may be configured to determine the allocation of channel resources for the devices included in the assessment link set. In an example implementation, the access point may be configured to determine the allocation of channel resources for the selected devices of the sensing link set (i.e., for the sensing devices in the current sensing link set) included in the assessment link set. In some example implementations, the access point may be configured to determine the allocation of channel resources for the one or more active devices included in the assessment link set. In some example implementations, the access point may be configured to determine the allocation of channel resources for the one or more idle devices included in the assessment link set. According to an implementation, the access point may maintain an existing allocation of resource units (RUs) for the selected devices and the one or more active devices included in the assessment link set. Further, in an implementation, the access point may allocate RUs to the one or more idle devices included in the assessment link set. In examples, for assessment links that are selected sensing links in the current sensing link set, the allocation of channel resources may remain unchanged for the analysis period. Further, in examples, for assessment links that are not sensing links in the current sensing link set but are currently data links (i.e., trimmed links), the access point may use the channel resource allocation that was allocated for the data link (prior to establishing the analysis period) for the analysis period. Also, in examples, for idle devices that are added to the assessment link set, the access point may determine an allocation of channel resources for the assessment link it establishes for each idle device. In an example, the allocation of the channel resources may depend on different factors, including the available bandwidth for the access point, the number of idle devices that the access point adds to the assessment link set, and the resolution that the access point seeks to establish for the assessment link with each idle device that it adds to the assessment link set (for example, scanning mode vs. detection mode.) In some examples, the access point may add as many idle devices to the assessment link set as possible, for example by allocating a small (or minimum) channel resource allocation to each idle device included in the assessment link set.

In an implementation, the access point may establish the plurality of assessment links according to the allocation for the analysis period. In some scenarios, there may be system changes during the analysis period, and the RU allocations for the assessment links may need to be adjusted accordingly. In some implementations, the access point may determine a reallocation of channel resources for the plurality of assessment links according to changes in data link bandwidth on the plurality of assessment links during the analysis period. In examples, if the RU allocation for one or more data links of the access point change during the analysis period, then for assessment links that are also data links, the access point may continue to align the RU allocation for the assessment to that of the ongoing data link (i.e., the assessment link bandwidth is the same as the updated data link bandwidth). In some examples, if the RU allocation for one or more data links of the access point (regardless of whether or not they are assessment links) increases during the analysis period, or if new data links are established with devices that are not part of the assessment link set, then the access point may need to reduce the RU allocation on assessment links that were established with idle devices that were added to the assessment link set, for example, for the duration of the analysis period, or until such time as more bandwidth is again available.

In examples, if the RU allocations for one or more data links of the access point change during the analysis period such that there are insufficient RUs available to perform sensing measurement sessions with all the devices in the assessment link set (even at the minimum RU allocation), the access point may discontinue sensing measurements on one or more assessment links (for example, on one or more previous idle devices) for the analysis period where there are insufficient RUs available. If the analysis period where insufficient RUs are available exceeds a threshold, then the access point may remove one or more assessment links from the assessment link set for the analysis period.

In some examples, if an assessment link which was a sensing link and a data link at the start of the analysis period ceases to be a data link during the analysis period, then the access point may maintain the RU allocation for the assessment link for the remaining duration of the analysis period or may choose to increase or reduce the RU allocation for the assessment link during the time where the assessment link is not being also used as a data link. In examples, if an assessment link is established by the access point with an idle device, and during the analysis period the access point establishes a data link with that device, then the access point may adapt the RU allocation assigned to the assessment link to align with the RU allocation established for the data link.

In examples, the access point may perform a sensing measurement session on the assessment links during a TXOP where no data communications are made with any devices of the assessment set, and the access point may allocate a predetermined sensing RU allocation to the assessment links for the sensing measurement session, where the predetermined sensing RU allocation may be different than the data RU allocation for assessment links that are also data links. Similarly, the access point may perform a sensing measurement session only on assessment links that are available in the TXOP, and not on assessment links that are unavailable, for example those used for data transmissions in the TXOP.

In a Wi-Fi sensing system, data transmissions and sensing transmissions may happen at different TXOPs. The access point may utilize bandwidth in a TXOP that is not used for data transmissions, for Wi-Fi sensing transmissions. Generally, the access point may attempt to make use of unused bandwidth in a TXOP for sensing transmissions. In an example, the access point may make sensing measurements on some devices of the assessment link set in one available TXOP and may make sensing measurements on other devices of the assessment link set in one or more different TXOPs, thus utilizing the bandwidth available in a TXOP and not removing any devices (or removing fewer devices) from the assessment link set.

After the RU allocations for the assessment links, the assessment links in the assessment link set may be evaluated over the analysis period. In an implementation, the access point may monitor sensing transmissions on the plurality of assessment links during the analysis period (or the analysis period). Further, in an implementation, the access point may be configured to identify an updated sensing link set according to the sensing transmissions. In examples, the updated sensing link set may include a plurality of updated sensing links selected from the plurality of assessment links according to a sensing space coverage metric. In examples, the updating of the sensing link set may involve removing one or more of the sensing links from the existing sensing link set (or the current sensing link set) and may involve adding one or more of the assessment links that were not sensing links from the existing sensing link set to the updated sensing link set.

According to an implementation, the access point may establish the updated sensing link set. In examples, after the sensing link set has been updated, the access point may set up multiple sensing sessions for the sensing links in the updated sensing link set for motion detection purposes. In some implementations, the sensing sessions may be measured over one or more sampling instances.

According to an implementation, the access point may be configured to obtain a plurality of time-domain channel representation information (TD-CRI) profile sets corresponding to respective ones of the plurality of candidate sensing links. In examples, the plurality of TD-CRI profile sets may include one TD-CRI profile set for each of the plurality of candidate sensing links obtained over an analysis period, where each TD-CRI profile set may include a plurality of TD-CRI profiles, each corresponding to a filter window in the analysis period.

In an implementation, the access point may be configured to obtain each TD-CRI profile of the plurality of TD-CRI profile sets for a candidate sensing link of the plurality of candidate sensing links based on obtaining a plurality of TD-CRI measurements at a plurality of sampling instances in a filter window for each candidate sensing link and applying an averaging filter to the plurality of TD-CRI measurements to obtain each TD-CRI profile. In some implementations, the access point may remove a time shift from one or more of the plurality of TD-CRI measurements prior to applying the averaging filter.

In examples, a coverage area of each candidate sensing link may be a function of a reflection structure that electromagnetic waves encountered between two devices of the candidate sensing link. The reflection structure can be objectively measured by a CSI packet in the frequency domain. In an example, the CSI packet may be converted into TD-CRI in the time domain. In examples, a TD-CRI of a candidate sensing link over a sampling instance may be represented by amplitudes of multi-path time domain pulses and time delays of the time domain pulses received at receiver.

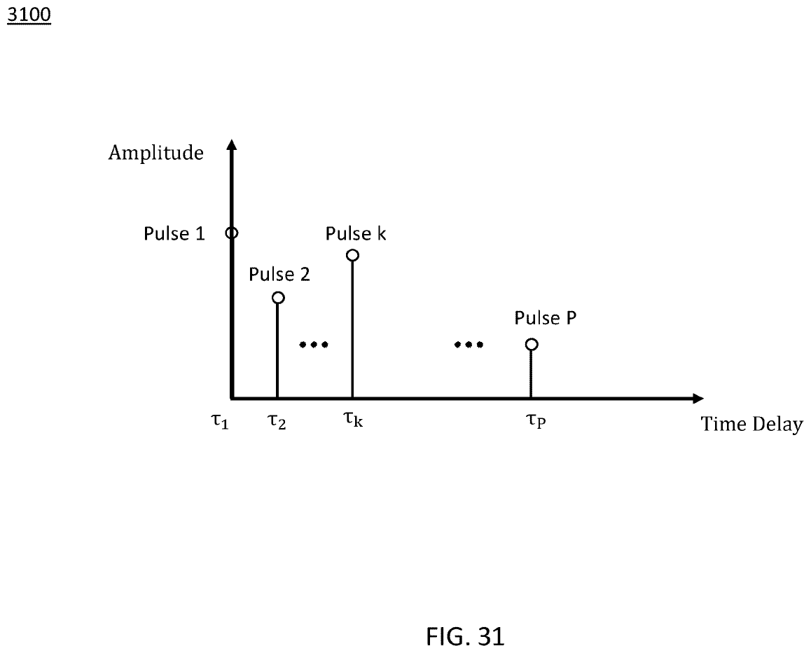

FIG. 31 depicts example representation 3100 of a TD-CRI of a candidate sensing link for a sampling instance, according to some embodiments. In FIG. 31, X axis is a representation of time delays of time domain pulses and Y axis is a representation of amplitudes of time domain pulses. Multiple time domain pulses from pulse 1 to pulse P, and corresponding time delays from τ₁ and τₚ are shown in FIG. 31. In an example, pulse 1 is the line-of-sight time domain pulse, and the time delay of pulse 1 is lowest in comparison to other time domain pulses. In an implementation, the time domain pulses to be used for further calculations may be selected based on a time domain mask. In examples, time domain pulses with amplitudes greater than a predefined threshold may be selected for further calculations. In some examples, time domain pulses with time delays less than a predefined threshold may be selected for further calculations.

In an implementation, the generation of a TD-CRI profile for a candidate sensing link over a period of time may serve as a representation of the reflection structure of the candidate sensing link. Further, a TD-CRI with a perturbation in the transmission channel may be defined as an excited TD-CRI, and a TD-CRI with no perturbation in the transmission channel may be defined as an unexcited TD-CRI. In a Wi-Fi system, there may be only a few instances of motion in the sensing space during a period of time. If the period of time is noted as T, then the time when the excited TD-CRI occurs is noted as Te, and the time when the unexcited TD-CRI occurs is noted as Tu, where Te<<Tu.

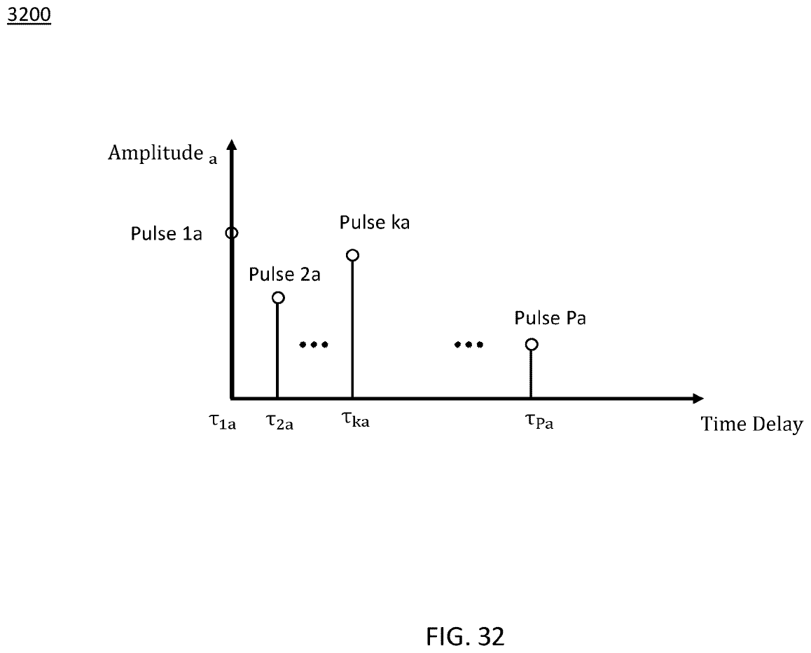

As described earlier, the access point may be configured to obtain the plurality of TD-CRI measurements at the plurality of sampling instances in the filter window for each candidate sensing link and apply the averaging filter to the plurality of TD-CRI measurements to obtain each TD-CRI profile. In an example, by averaging the TD-CRI over a period of time, the TD-CRI will converge to a stable TD-CRI profile. The averaging filter may be used to average the TD-CRI of a candidate sensing link within the filter window. The TD-CRI profile may be a collection of the averages of the individual time domain pulses of the TD-CRI of each of the plurality of sampling instances in the filter window. FIG. 32 depicts example representation 3200 of a TD-CRI profile of a candidate sensing link, according to some embodiments. In FIG. 32, the variable “a” of “Amplitudeₐ” indicates that the amplitude shown for each time domain pulse is the average amplitude of the time domain pulse over the filter window.

Also, as described above, there may be a TD-CRI of a candidate sensing link converted from a CSI packet at a receiver. In examples, the CSI packet detection delay at the receiver may generate a random amount of receiver time delay, which may result in a difference between the actual phase of the TD-CRI without the receiver time delay and the phase of the TD-CRI with the receiver time delay. This difference may be defined as a phase shift. The phase shift may need to be removed from a TD-CRI over a sampling instance prior to applying the averaging filter as the amplitude of TD-CRI needs to be averaged and the phase shift may cause an inaccuracy of the averaged amplitude in the averaging filter. Accordingly, in an implementation, the access point may remove the phase shift from the TD-CRI prior to applying the averaging filter.

In examples, the averaging filter may include at least one of a low pass filter (in which the TD-CRI at each sampling instance is given equal weighting) and an exponential moving average filter (in which the weighing of the TD-CRI is such that TD-CRI from most recent sampling instances has a greater weight than TD-CRI from older sampling instances). Other examples of averaging filter that are not discussed here are contemplated herein.

Further, in examples, the averaging filter may have several taps, the number of which is the filter window and which each represent a TD-CRI sampling instance. In examples, the filter window may be aligned with the size of the FFT/IFFT. For example, if the CSI is generated from a 64-point FFT in the frequency domain, the filter window may be set to 64 taps. In this example, the TD-CRI sampling instances may be referred to as sₘ, sₘ₊₁, . . . , sₘ₊₆₃, and the TD-CRI measured for each sampling instance may be referred to as TD-CRI (sₘ), TD-CRI (sₘ₊₁), . . . , TD-CRI (sₘ₊₆₃). Then TD-CRI (sₘ), TD-CRI (sₘ₊₁), . . . , TD-CRI (sₘ₊₆₃) of a candidate sensing link may be averaged within this filter window.

According to an implementation, upon obtaining the plurality of TD-CRI profile sets corresponding to respective ones of the plurality of candidate sensing links, the access point may be configured to identify a plurality of TD-CRI spans corresponding to respective ones of the plurality of candidate sensing links according to the plurality of TD-CRI profile sets. In examples, the output of the averaging filter for each candidate sensing link may be used to determine the TD-CRI span of the candidate sensing link. In examples, each TD-CRI span of the plurality of TD-CRI spans may correspond to a TD-CRI profile set of the plurality of TD-CRI profile sets and is selected from a plurality of filter window TD-CRI spans, where the plurality of filter window TD-CRI spans correspond to the plurality of TD-CRI profiles of the TD-CRI profile set. In examples, each filter window TD-CRI span of the plurality of filter window TD-CRI spans may be obtained from a corresponding TD-CRI profile. In an implementation, the access point may select the plurality of TD-CRI spans based on determining each TD-CRI span as the maximum filter window TD-CRI span for each TD-CRI profile set. In some implementations, the access point may select the plurality of TD-CRI spans based on determining each TD-CRI span as an average of the plurality of filter window TD-CRI spans for each TD-CRI profile set. In an example, TD-CRI span of a candidate sensing link may be calculated based on a highest (or last) index of a TD-CRI time domain pulse and a first index of a TD-CRI time domain pulse. In an example, filter window TD-CRI span may refer to a TD-CRI span of a candidate sensing link could be calculated based on a highest index of a TD-CRI time domain pulse and a first index of a TD-CRI time domain pulse at the output of an averaging filter.

In an implementation, the access point may obtain the plurality of filter window TD-CRI spans based on identifying effective time domain pulses in the corresponding TD-CRI profile as time domain pulses having an amplitude surpassing the amplitude threshold. In examples, the access point may determine the amplitude threshold for each TD-CRI profile as a percentage (for example, 1% or 2%) of a maximum amplitude of time domain pulses in the TD-CRI profile. In an example, the access point may tune the amplitude threshold based on the acceptable success rate of the motion detection (i.e., the number of successful motion detections divided by the number of motions).

In an implementation, the access point may identify a first index of a first effective time domain pulse having a lowest time delay of the effective time domain pulses in the corresponding TD-CRI profile. Further, the access point may be configured to identify a last index of a last effective time domain pulse having a greatest time delay of the effective time domain pulses in the corresponding TD-CRI profile. The access point may define each filter window TD-CRI span as the last index minus the first index for the corresponding TD-CRI profile. In examples, the last index may be the highest index.

Assuming that the first index of the first effective TD-CRI time domain pulse (i.e., the time domain pulse having the lowest time delay) is “1”, and the last index of the last effective TD-CRI time domain pulse (i.e., the time domain pulse with the greatest time delay) is “Q”, then the TD-CRI span is calculated from the indices of effective TD-CRI time domain pulses as shown in Equation 17 below:

$$TD - CRI Span = Q - 1 \qquad ( 17 )$$

In example, the TD-CRI span of a candidate sensing link may include a number of effective TD-CRI time domain pulses of a candidate sensing link. The TD-CRI span may also represent the delay spread of the transmission channel and the multi-path reflection structure of the candidate sensing link. In an example, the TD-CRI span may be considered a proxy for a measurement of the coverage area. The wider the TD-CRI span of a candidate sensing link is, there are more reflections (or coverage area) of that candidate sensing link in the sensing space. In examples, a candidate sensing link with greater coverage area (and therefore a larger TD-CRI span) could be more sensitive to detect motion in the sensing space and provides a better sensing space coverage.

According to an implementation, the access point may be configured to identify a sensing link set according to the plurality of TD-CRI spans. In examples, the sensing link set may include a plurality of selected sensing links selected from the plurality of candidate sensing links. Examples by which the sensing link set is identified are described in detail below.

According to an implementation, the access point may be configured to monitor sensing transmissions transmitted via the plurality of candidate sensing links during an analysis period and the access point may identify a plurality of power variations among the plurality of candidate sensing links based on the sensing transmissions as previously described.

In an implementation, the access point may determine a power variation test set as previously described. According to the power variation test set, the access point may select a first power variation from the plurality of power variations according to a significance ranking of the plurality of power variations, as previously described. In examples, the order in which the different power variations of the link combos are analyzed may be referred to as a significance ranking. A list of the power variations of link combos in order of variation counter as a significance ranking is described in Table 11 provided below.

TABLE 11
List of power variations of link combos in order
of variation counter as a significance ranking

| | Power | | Maximum | |
|---|---|---|---|---|
| | variation of a | Variation | String | Combo |
| Top X | link combo | Counter | Length | Length |
| 1 | p1p2 | 5 | 3 | 2 |
| 2 | p3p4p5 | 3 | 3 | 3 |
| 3 | p2p3 | 1 | 1 | 2 |
| . . . | . . . | . . . | . . . | . . . |

In the example of Table 11, parameter “Combo Length” indicates the number of links in a power variation of a link combo. For example, as shown in Table 11, value of the parameter “Combo Length” for link combo “p3p4p5” is three.

Although other known examples and implementations of determining the power variation test set are contemplated herein, these need not be described in full within this disclosure.

In an implementation, the access point may select, for each power variation of the power variation test set, for inclusion in the sensing link set, a candidate sensing link from the grouping of the test power variation according to the candidate sensing link having a largest TD-CRI span.

As an assumption, there may be a number of filter windows within a given analysis period and these filter windows may be denoted as w1, w2, . . . , wm. In an implementation, after determining the TD-CRI span over a filter window for each candidate sensing link, if it is determined that a given analysis period is much longer than the filter window, then TD-CRI span of each candidate sensing link over the given analysis period may be defined as any of the two options, referred to as a first option and a second option, provided below.

According to the first option, the access point may determine each TD-CRI span as the maximum filter window TD-CRI span for each TD-CRI profile set. The maximum filter window TD-CRI span of a candidate sensing link over the analysis period may be mathematically expressed as below in Equation 18 and may be adopted as TD-CRI Span_{L}.

$$TD - CRI {Span}_{L} = maximum \{ TD - CRI Span of w 1 , TD - CRI Span of w 2 , … , TD - CRI Span of wm \} \qquad ( 18 )$$

According to the second option, the access point may be configured to determine each TD-CRI span as an average of the plurality of filter window TD-CRI spans for each TD-CRI profile set. The average of the plurality of filter window TD-CRI spans of a candidate sensing link over the analysis period may be mathematically expressed as shown below in Equation 19 and may be adopted as TD-CRI Span_{L}.

$$TD - CRI {Span}_{L} = average \{ TD - CRI Span of w 1 , TD - CRI Span of w 2 , … , TD - CRI Span of wm \} \qquad ( 19 )$$

In an example, TD-CRI Span of a candidate sensing link L is used to represent the TD-CRI span for the candidate sensing link over a filter window. Examples of TD-CRI Span_{L} of candidate sensing links are depicted in Table 12 provided below.

TABLE 12
TD-CRI Span_{L} of each candidate sensing link

| Link | TD-CRI Span_{L} |
|---|---|
| L1 | 10 |
| L2 | 20 |
| L3 | 30 |
| L4 | 20 |
| L5 | 20 |
| L6 | 10 |

In examples, the TD-CRI span is used to select a candidate sensing link to be a sensing link from a link combo. In examples, a candidate sensing link within a link combo that has the largest TD-CRI span in an analysis period may be selected for sensing, and other candidate sensing links within the link combo may be removed or trimmed. In an example, if a candidate sensing link is not a part of any link combo, then the link will not be removed and will be selected as a sensing link. A link combo may be impacted by a motion if all the links of the link combo are impacted by the motion. In the example shown in FIG. 27, for the purpose of explanation, the first link combo may include links L1 and L2, and the second link combo may include links L3, L4, and L5. Further, link L6 is not part of a link combo and will therefore be selected as a sensing link.

Table 13 provided below shows analysis of link combos based on the TD-CRI Span_{L}.

TABLE 13
Analysis of link combos based on the TD-CRI Span_{L}

| | Link with the | |
|---|---|---|
| Link | largest TD-CRI | Links |
| combo | Span_{L} | removed |
| L1L2 | L2 | L1 |
| L3L4L5 | L3 | L4, L5 |

In the examples shown above, within the link combo “L1L2”, the link L2 has the largest TD-CRI Span_{L}. Further, within the link combo “L3L4L5”, the link L3 has the largest TD-CRI Span_{L}.

Table 14 provided below shows selected sensing links among all the candidate sensing links.

TABLE 14
Selected sensing links

| | Link | Trimmed or | Sensing |
|---|---|---|---|
| Link | Combo | not | Links |
| L1 | L1L2 | Y | N |
| L2 | L1L2 | N | Y |
| L3 | L3L4L5 | N | Y |
| L4 | L3L4L5 | Y | N |
| L5 | L3L4L5 | Y | N |
| L6 | N/A | N | Y |

In the example of Table 14, within the link combo including links L1 and L2, link L2 is selected as the sensing link because link L2 has the largest TD-CRI Span_{L}, and link L1 is trimmed. Similarly, within the link combo including links L3, L4, and L5, link L3 is selected as the sensing link because link L3 has the largest TD-CRI Span_{L}, while other links L4 and L5 within this link combo are trimmed. Further, link L6 is not a part of a link combo and so link L6 is also kept as a sensing link. Accordingly, the sensing set includes links L2, L3, and L6.

In an implementation, after the sensing link set is identified, the access point may set up multiple sensing sessions for the sensing links in the sensing link set for motion detection purposes. In examples, the access point may establish the plurality of selected sensing links between selected devices of the plurality of candidate devices and the access point.

FIG. 33 depicts flowchart 3300 for establishing a plurality of selected sensing links between selected devices of a plurality of candidate devices and an access point, according to some embodiments.

In a brief overview of an implementation of flowchart 3300, at step 3302, an access point may identify a candidate set of a plurality of networking devices. The plurality of networking devices may include a plurality of sensing capable devices and the access point. In example, the candidate set may include a plurality of candidate devices capable of establishing transmission links with the access point. At step 3304, the access point may establish a plurality of candidate sensing links between the plurality of candidate devices and the access point. At step 3306, the access point may monitor sensing transmissions transmitted via the plurality of candidate sensing. At step 3308, the access point may identify a sensing link set according to the sensing transmissions. In an example, the sensing link set may include a plurality of selected sensing links selected from the plurality of candidate sensing links. At step 3310, the access point may establish the plurality of selected sensing links between selected devices of the plurality of candidate devices and the access point.

Step 3302 includes identifying a candidate set of the plurality of networking devices, the candidate set including a plurality of candidate devices capable of establishing transmission links with the access point. According to an implementation, the access point (which may be either sensing receiver 502-(1-M) or sensing transmitter 504-(1-N)) may be configured to identify the candidate set of the plurality of networking devices (for example, plurality of sensing capable devices (which may be either sensing transmitter 504-(1-N) or sensing receiver 502-(1-M))). In an example, the candidate set may include a plurality of candidate devices (for example, one or more of plurality of sensing capable devices) capable of establishing transmission links with the access point.

Step 3304 includes establishing a plurality of candidate sensing links between the plurality of candidate devices and the access point. According to an implementation, the access point (which may be either sensing receiver 502-(1-M) or sensing transmitter 504-(1-N)) may be configured to establish a plurality of candidate sensing links between the plurality of candidate devices and the access point.

Step 3306 includes monitoring sensing transmissions transmitted via the plurality of candidate sensing links. According to an implementation, the access point (which may be either sensing receiver 502-(1-M) or sensing transmitter 504-(1-N)) may be configured to monitor the sensing transmissions transmitted via the plurality of candidate sensing links. In an example implementation, the access point may be configured to monitor the sensing transmissions based on determining an average power of the sensing transmissions over an analysis period. In some example implementations, the access point may be configured to monitor the sensing transmissions based on identifying a plurality of power variations, each power variation being characterized by a grouping of one or more candidate sensing links that display a variation in received power compared to an average power of the sensing transmissions of the respective candidate sensing links for one or more sampling instances during the analysis period.

Step 3308 includes identifying a sensing link set according to the sensing transmissions, the sensing link set including a plurality of selected sensing links selected from the plurality of candidate sensing links. According to an implementation, the access point (which may be either sensing receiver 502-(1-M) or sensing transmitter 504-(1-N)) may be configured to identify the sensing link set according to the sensing transmissions. In an example, the sensing link set may include the plurality of selected sensing links selected from the plurality of candidate sensing links. In an example implementation, the access point may be configured to identify the sensing link set based on identifying the plurality of sensing links according to a sensing space coverage metric.

Step 3310 includes establishing the plurality of selected sensing links between selected devices of the plurality of candidate devices and the access point. According to an implementation, the access point (which may be either sensing receiver 502-(1-M) or sensing transmitter 504-(1-N)) may be configured to establish the plurality of selected sensing links between selected devices of the plurality of candidate devices and the access point.

FIG. 34A and FIG. 34B depict flowchart 3400 for establishing a selected candidate sensing link between a selected device of a plurality of candidate devices and an access point, according to some embodiments.

In a brief overview of an implementation of flowchart 3400, at step 3402, an access point may identify a candidate set of a plurality of networking devices. The plurality of networking devices may include a plurality of sensing capable devices and the access point. In example, the candidate set may include a plurality of candidate devices capable of establishing transmission links with the access point. At step 3404, the access point may establish a plurality of candidate sensing links between the plurality of candidate devices and the access point. At step 3406, the access point may identify a plurality of power variations. Each power variation being characterized by a grouping of one or more candidate sensing links that display a variation in received power compared to an average power of the sensing transmissions of the respective candidate sensing links for one or more sampling instances during the analysis period. At step 3408, the access point may determine a power variation test set including a subset of power variations selected from the plurality of power variations for analysis by a sensing space coverage metric. At step 3410, the access point may determine a power ratio parameter for a test power variation of the power variation test set. At step 3412, the access point may compare the power ratio parameter to a ratio threshold factor. At step 3414, responsive to the power ratio parameter exceeding the ratio threshold factor, the access point may select a candidate sensing link from the grouping of the test power variation for inclusion in a sensing link set according to the candidate sensing link occurring in a largest number of groupings of the plurality of power variations. At step 3416, the access point may establish the selected candidate sensing link between selected device of the plurality of candidate devices and the access point.

Step 3402 includes identifying a candidate set of the plurality of networking devices, the candidate set including a plurality of candidate devices capable of establishing transmission links with the access point. According to an implementation, the access point (which may be either sensing receiver 502-(1-M) or sensing transmitter 504-(1-N)) may be configured to identify the candidate set of the plurality of networking devices (for example, plurality of sensing capable devices). In an example, the candidate set may include a plurality of candidate devices (for example, one or more of plurality of sensing capable devices) capable of establishing transmission links with the access point.

Step 3404 includes establishing a plurality of candidate sensing links between the plurality of candidate devices and the access point. According to an implementation, the access point (which may be either sensing receiver 502-(1-M) or sensing transmitter 504-(1-N)) may be configured to establish a plurality of candidate sensing links between the plurality of candidate devices and the access point.

Step 3406 includes identifying a plurality of power variations, where each power variation being characterized by a grouping of one or more candidate sensing links that display a variation in received power compared to an average power of the sensing transmissions of the respective candidate sensing links for one or more sampling instances during the analysis period. According to an implementation, the access point (which may be either sensing receiver 502-(1-M) or sensing transmitter 504-(1-N)) may be configured to identify the plurality of power variations, where each power variation is characterized by the grouping of one or more candidate sensing links that display the variation in received power compared to the average power of the sensing transmissions of the respective candidate sensing links for one or more sampling instances during an analysis period.

Step 3408 includes determining a power variation test set including a subset of power variations selected from the plurality of power variations for analysis by a sensing space coverage metric. According to an implementation, the access point (which may be either sensing receiver 502-(1-M) or sensing transmitter 504-(1-N)) may be configured to determine the power variation test set including the subset of power variations selected from the plurality of power variations for analysis by the sensing space coverage metric. In an example implementation, the access point may be configured to determine the power variation test set based on selecting a first power variation from the plurality of power variations according to a significance ranking of the plurality of power variations, and selecting a second power variation from remaining ones of the plurality of power variations having no candidate sensing links in common with the first power variation according to the significance ranking of the remaining ones of the plurality of power variations, wherein the power variation test set includes the first power variation and the second power variation. In examples, the access point may determine the significance ranking according to at least one of a combo length representing a number of candidate sensing links occurring in the plurality of power variations, a variation counter representing a number of occurrences of each power variation from the plurality of power variations, and a maximum string length representing a largest number of consecutive occurrences of each power variation from the plurality of power variations. In some implementations, the power variation test set further includes one or more further power variations such that each candidate sensing link occurs in only one grouping from the first power variation, the second power variation, and the one or more further power variations.

Step 3410 includes determining a power ratio parameter for a test power variation of the power variation test set. According to an implementation, the access point (which may be either sensing receiver 502-(1-M) or sensing transmitter 504-(1-N)) may be configured to determine the power ratio parameter for the test power variation of the power variation test set. In some implementations, determining the power ratio parameter may include dividing a first maximum string length representing a largest number of consecutive occurrences of a test power variation from the power variation test set in the analysis period by a second maximum string length representing a largest number of consecutive occurrences in the analysis period from among single link power variations associated with each candidate sensing link of the grouping of the test power variation. In some implementations, determining the power ratio parameter may include dividing a first variation counter representing a number of occurrences of a test power variation from the power variation test set in the analysis period by a second variation counter representing a largest number of occurrences in the analysis period from among single link power variations associated with each candidate sensing link of the grouping of the test power variation. In an implementation, the access point may determine the power ratio parameter based on Equation (9) or Equation (10).

Step 3412 includes comparing the power ratio parameter to a ratio threshold factor. According to an implementation, the access point (which may be either sensing receiver 502-(1-M) or sensing transmitter 504-(1-N)) may be configured to compare the power ratio parameter to the ratio threshold factor.

Step 3414 includes selecting, responsive to the power ratio parameter exceeding the ratio threshold factor, for inclusion in a sensing link set, a selected candidate sensing link from the grouping of the test power variation according to the candidate sensing link occurring in a largest number of groupings of the plurality of power variations. According to an implementation, the access point (which may be either sensing receiver 502-(1-M) or sensing transmitter 504-(1-N)) may be configured to select, responsive to the power ratio parameter exceeding the ratio threshold factor, for inclusion in the sensing link set, a selected candidate sensing link from the grouping of the test power variation according to the candidate sensing link occurring in the largest number of groupings of the plurality of power variations. According to some implementations, the access point may be configured to determine additional power ratio parameters for additional power variations of the power variation test set and compare the additional power ratio parameters to the ratio threshold factor for each of the additional power variations. Further, the access point may be configured to select, for each additional power variation having an additional power ratio parameter exceeding the ratio threshold factor, for inclusion in the sensing link set, an additional selected candidate sensing link from each grouping of the additional power variations according to the candidate sensing link occurring in a largest number of the plurality of power variations.

Step 3416 includes establishing the selected candidate sensing link between selected device of the plurality of candidate devices and the access point. According to an implementation, the access point (which may be either sensing receiver 502-(1-M) or sensing transmitter 504-(1-N)) may be configured to establish the selected candidate sensing link between selected device of the plurality of candidate devices and the access point.

FIG. 35A and FIG. 35B depict flowchart 3500 for establishing an updated link set, according to some embodiments.

In a brief overview of an implementation of flowchart 3500, at step 3502, an access point may maintain a plurality of selected sensing links as a sensing link set between selected devices of a plurality of sensing capable devices and the access point. At step 3504, the access point may identify a plurality of candidate links as a candidate link set between unselected devices of the plurality of sensing capable devices and the access point. At step 3506, the access point may identify a plurality of assessment links as an assessment link set from the candidate link set and the sensing link set. At step 3508, the access point may determine an allocation of channel resources for the plurality of assessment links. At step 3510, the access point may establish the plurality of assessment links according to the allocation. At step 3512, the access point may monitor sensing transmissions on the plurality of assessment links during an analysis period. At step 3514, the access point may identify an updated sensing link set according to the sensing transmissions. The updated sensing link set may include a plurality of updated sensing links selected from the plurality of assessment links according to a sensing space coverage metric. At step 3516, the access point may establish the updated link set.

Step 3502 includes maintaining a plurality of selected sensing links as a sensing link set between selected devices of a plurality of sensing capable devices and an access point. According to an implementation, the access point (which may be either sensing receiver 502-(1-M) or sensing transmitter 504-(1-N)) may be configured to maintain the plurality of selected sensing links as the sensing link set between selected devices of the plurality of sensing capable devices and the access point.

Step 3504 includes identifying a plurality of candidate links as a candidate link set between unselected devices of the plurality of sensing capable devices and the access point. According to an implementation, the access point (which may be either sensing receiver 502-(1-M) or sensing transmitter 504-(1-N)) may be configured to identify the plurality of candidate links as the candidate link set between unselected devices of the plurality of sensing capable devices and the access point. In an implementation, the access point may be configured to identify the plurality of candidate links based on performing a discovery process for sensing capable devices and including discovered sensing capable devices as candidate devices in the candidate link set representing candidate links. In some implementations, the access point may be configured to identify the plurality of candidate links based identifying trimmed links not included in the sensing link set and including the trimmed links in the candidate link set as candidate links.

Step 3506 includes identifying a plurality of assessment links as an assessment link set from the candidate link set and the sensing link set. According to an implementation, the access point (which may be either sensing receiver 502-(1-M) or sensing transmitter 504-(1-N)) may be configured to identify the plurality of assessment links as the assessment link set from the candidate link set and the sensing link set. In some implementations, the access point may be configured to determine the assessment link set based on selecting one or more of the plurality of sensing links as assessment links and selecting a subset of the plurality of candidate links as assessment links. According to an implementation, the access point (which may be either sensing receiver 502-(1-M) or sensing transmitter 504-(1-N)) may be configured to determine whether a metric of congestion of the access point is above a congestion threshold. In response to determining that the metric of congestion of the access point is above the congestion threshold, the access point may select one or more active sensing capable devices of the candidate devices in the candidate link set for inclusion in the assessment link set. In some implementations, the access point may be configured to determine whether a metric of congestion of the access point is below a congestion threshold. In response to determining that the metric of congestion of the access point is below the congestion threshold, the access point may select one or more idle sensing capable devices of the candidate devices in the candidate link set for inclusion in the assessment link set.

Step 3508 includes determining an allocation of channel resources for the plurality of assessment links. According to an implementation, the access point (which may be either sensing receiver 502-(1-M) or sensing transmitter 504-(1-N)) may be configured to determine the allocation of channel resources for the plurality of assessment links. In an implementation, the access point may determine the allocation of channel resources for the one or more active sensing capable devices included in the assessment link set. In an example, the access point may maintain an existing allocation of resource units (RUs) for the one or more active sensing capable devices included in the assessment link set. In some implementations, the access point may determine the allocation of channel resources for the one or more idle sensing capable devices included in the assessment link set. In examples, the access point may allocate RUs to the one or more idle sensing capable devices included in the assessment link set.

Step 3510 includes establishing the plurality of assessment links according to the allocation. According to an implementation, the access point (which may be either sensing receiver 502-(1-M) or sensing transmitter 504-(1-N)) may be configured to establish the plurality of assessment links according to the allocation.

Step 3512 includes monitoring sensing transmissions on the plurality of assessment links during an analysis period. According to an implementation, the access point (which may be either sensing receiver 502-(1-M) or sensing transmitter 504-(1-N)) may be configured to monitor the sensing transmissions on the plurality of assessment links during the analysis period.

Step 3514 includes identifying an updated sensing link set according to the sensing transmissions. The updated sensing link set includes a plurality of updated sensing links selected from the plurality of assessment links according to a sensing space coverage metric. According to an implementation, the access point (which may be either sensing receiver 502-(1-M) or sensing transmitter 504-(1-N)) may be configured to identify the updated sensing link set according to the sensing transmissions. The updated sensing link set includes the plurality of updated sensing links selected from the plurality of assessment links according to the sensing space coverage metric.

Step 3516 includes establishing the updated sensing set. According to an implementation, the access point (which may be either sensing receiver 502-(1-M) or sensing transmitter 504-(1-N)) may be configured to establish the updated sensing set.

FIG. 36A and FIG. 36B depict another flowchart 3600 for establishing an updated link set, according to some embodiments.

In a brief overview of an implementation of flowchart 3600, at step 3602, an access point may maintain a plurality of selected sensing links as a sensing link set between selected devices of a plurality of sensing capable devices and the access point. At step 3604, the access point may identify a plurality of candidate links as a candidate link set between unselected devices of the plurality of sensing capable devices and the access point based on identifying trimmed links not included in the sensing link set and including the trimmed links in the candidate link set as candidate links. At step 3606, the access point may identify a plurality of assessment links as an assessment link set from the candidate link set and the sensing link set based on selecting one or more of the plurality of sensing links as assessment links and selecting a subset of the plurality of candidate links as assessment links. At step 3608, the access point may determine an allocation of channel resources for the plurality of assessment links. At step 3610, the access point may determine reallocation of channel resources for the plurality of assessment links according to changes in data link bandwidth on the plurality of assessment links during an analysis period. At step 3612, the access point may establish the plurality of assessment links according to the allocation. At step 3614, the access point may monitor sensing transmissions on the plurality of assessment links during an analysis period. At step 3616, the access point may identify an updated sensing link set according to the sensing transmissions. The updated sensing link set includes a plurality of updated sensing links selected from the plurality of assessment links according to a sensing space coverage metric. At step 3618, the access point may establish the updated sensing link set.

Step 3602 includes maintaining a plurality of selected sensing links as a sensing link set between selected devices of a plurality of sensing capable devices and an access point. According to an implementation, the access point (which may be either sensing receiver 502-(1-M) or sensing transmitter 504-(1-N)) may be configured to maintain the plurality of selected sensing links as the sensing link set between selected devices of the plurality of sensing capable devices and the access point.

Step 3604 includes identifying a plurality of candidate links as a candidate link set between unselected devices of the plurality of sensing capable devices and the access point based on identifying trimmed links not included in the sensing link set and including the trimmed links in the candidate link set as candidate links. According to an implementation, the access point (which may be either sensing receiver 502-(1-M) or sensing transmitter 504-(1-N)) may be configured to identify the plurality of candidate links as the candidate link set between unselected devices of the plurality of sensing capable devices and the access point based on identifying trimmed links not included in the sensing link set and including the trimmed links in the candidate link set as candidate links. In some implementations, the access point may be configured to identify the plurality of candidate links based identifying trimmed links not included in the sensing link set and including the trimmed links in the candidate link set as candidate links.

Step 3606 includes identifying a plurality of assessment links as an assessment link set from the candidate link set and the sensing link set based on selecting one or more of the plurality of sensing links as assessment links and selecting a subset of the plurality of candidate links as assessment links. According to an implementation, the access point (which may be either sensing receiver 502-(1-M) or sensing transmitter 504-(1-N)) may be configured to identify the plurality of assessment links as the assessment link set from the candidate link set and the sensing link set based on selecting one or more of the plurality of sensing links as assessment links and selecting a subset of the plurality of candidate links as assessment links. According to an implementation, the access point (which may be either sensing receiver 502-(1-M) or sensing transmitter 504-(1-N)) may be configured to determine whether a metric of congestion of the access point is above a congestion threshold. In response to determining that the metric of congestion of the access point is above the congestion threshold, the access point may select one or more active sensing capable devices of the candidate devices in the candidate link set for inclusion in the assessment link set. In some implementations, the access point may be configured to determine whether a metric of congestion of the access point is below a congestion threshold. In response to determining that the metric of congestion of the access point is below the congestion threshold, the access point may select one or more idle sensing capable devices of the candidate devices in the candidate link set for inclusion in the assessment link set.

Step 3608 includes determining an allocation of channel resources for the plurality of assessment links. According to an implementation, the access point (which may be either sensing receiver 502-(1-M) or sensing transmitter 504-(1-N)) may be configured to determine the allocation of channel resources for the plurality of assessment links. In examples, determining the allocation of channel resources for the sensing capable devices included in the assessment link set includes, for the selected devices, maintaining an existing allocation of RUs, for the one or more idle sensing capable devices, allocating RUs, and for the one or more active sensing capable devices, maintaining an existing allocation of RUs.

Step 3610 includes determining reallocation of channel resources for the plurality of assessment links according to changes in data link bandwidth on the plurality of assessment links during an analysis period. According to an implementation, the access point (which may be either sensing receiver 502-(1-M) or sensing transmitter 504-(1-N)) may be configured to determine reallocation of channel resources for the plurality of assessment links according to changes in data link bandwidth on the plurality of assessment links during the analysis period.

Step 3612 includes establishing the plurality of assessment links according to the allocation. According to an implementation, the access point (which may be either sensing receiver 502-(1-M) or sensing transmitter 504-(1-N)) may be configured to establish the plurality of assessment links according to the allocation.

Step 3614 includes monitoring sensing transmissions on the plurality of assessment links during an analysis period. According to an implementation, the access point (which may be either sensing receiver 502-(1-M) or sensing transmitter 504-(1-N)) may be configured to monitor the sensing transmissions on the plurality of assessment links during the analysis period.

Step 3616 includes identifying an updated sensing link set according to the sensing transmissions. The updated sensing link set includes a plurality of updated sensing links selected from the plurality of assessment links according to a sensing space coverage metric. According to an implementation, the access point (which may be either sensing receiver 502-(1-M) or sensing transmitter 504-(1-N)) may be configured to identify the updated sensing link set according to the sensing transmissions. The updated sensing link set includes the plurality of updated sensing links selected from the plurality of assessment links according to the sensing space coverage metric.

Step 3618 includes establishing the updated sensing set. According to an implementation, the access point (which may be either sensing receiver 502-(1-M) or sensing transmitter 504-(1-N)) may be configured to establish the updated sensing set.

FIG. 37 depicts flowchart 3700 for establishing a plurality of representative sensing links between corresponding ones of a plurality of sensing capable devices and the access point, according to some embodiments.

In a brief overview of an implementation of flowchart 3700, at step 3702, the access point may obtain sensing sounding information. The sensing sounding information may include information about a plurality of power variations among a plurality of candidate sensing links between the plurality of sensing capable devices and the access point. Each power variation is characterized by a grouping of one or more candidate sensing links that display a variation in received power compared to an average power of sensing transmissions of the respective candidate sensing links during one or more sampling instances of an analysis period. At step 3704, the access point may determine a plurality of data usage values corresponding to the plurality of candidate sensing links. At step 3706, the access point may identify a sensing link set according to a sensing space coverage metric determined from the sensing sounding information and the plurality of data usage values. The sensing link set may include a plurality of representative sensing links selected from the plurality of candidate sensing links. At step 3708, the access point may establish the plurality of representative sensing links between corresponding ones of the plurality of sensing capable devices and the access point.

Step 3702 includes obtaining sensing sounding information. The sensing sounding information may include information about a plurality of power variations among a plurality of candidate sensing links between the plurality of sensing capable devices and the access point. Each power variation is characterized by a grouping of one or more candidate sensing links that display a variation in received power compared to an average power of sensing transmissions of the respective candidate sensing links during one or more sampling instances of an analysis period. According to an implementation, the access point (which may be either sensing receiver 502-(1-M) or sensing transmitter 504-(1-N)) may be configured to obtain the sensing sounding information. The sensing sounding information may include information about a plurality of power variations among a plurality of candidate sensing links between the plurality of sensing capable devices and the access point. Each power variation is characterized by a grouping of one or more candidate sensing links that display a variation in received power compared to an average power of sensing transmissions of the respective candidate sensing links during one or more sampling instances of an analysis period. In an example, the plurality of candidate sensing links may include original sensing links of a previously established sensing link set and trimmed sensing links not included in the previously established sensing link set, each power variation having at least one original sensing link.

In some implementations, the access point may be configured to establish the plurality of candidate sensing links between the plurality of sensing capable devices and the access point. Further, in an implementation, the access point may be configured to monitor sensing transmissions transmitted via the plurality of candidate sensing links during the analysis period. Also, the access point may be configured to identify the plurality of power variations based on the sensing transmissions.

Step 3704 includes determining a plurality of data usage values corresponding to the plurality of candidate sensing links. According to an implementation, the access point (which may be either sensing receiver 502-(1-M) or sensing transmitter 504-(1-N)) may be configured to determine the plurality of data usage values corresponding to the plurality of candidate sensing links.

Step 3706 include identifying a sensing link set according to a sensing space coverage metric determined from the sensing sounding information and the plurality of data usage values. The sensing link set includes a plurality of representative sensing links selected from the plurality of candidate sensing links. According to an implementation, the access point (which may be either sensing receiver 502-(1-M) or sensing transmitter 504-(1-N)) may be configured to identify the sensing link set according to the sensing space coverage metric determined from the sensing sounding information and the plurality of data usage values. The sensing link set includes the plurality of representative sensing links selected from the plurality of candidate sensing links.

Step 3708 includes establishing the plurality of representative sensing links between corresponding ones of the plurality of sensing capable devices and the access point. According to an implementation, the access point (which may be either sensing receiver 502-(1-M) or sensing transmitter 504-(1-N)) may be configured to establish the plurality of representative sensing links between corresponding ones of the plurality of sensing capable devices and the access point.

FIG. 38A and FIG. 38B depict flowchart 3800 for establishing a representative sensing link between corresponding one of the plurality of sensing capable devices and the access point, according to some embodiments.

In a brief overview of an implementation of flowchart 3800, at step 3802, the access point may obtain sensing sounding information based on accessing previously stored sensing information. The sensing sounding information may include information about a plurality of power variations among a plurality of candidate sensing links between the plurality of devices and the access point, wherein the plurality of candidate sensing links include original sensing links of a previously established sensing link set and trimmed sensing links not included in the previously established sensing link set. At step 3804, the access point may determine a plurality of data usage values corresponding to the plurality of candidate sensing links. At step 3806, the access point may identify a congested sensing link from among the original sensing links as having a corresponding data usage value from the plurality of data usage values exceeding a congestion threshold T. At step 3808, the access point may identify a power variation corresponding to the congested sensing link. At step 3810, the access point may identify one or more trimmed sensing links belonging to the power variation. At step 3812, the access point may select a representative sensing link for the power variation from among the congested sensing link and the one or more trimmed sensing links based on a switch factor defined for each of the congested sensing links and the one or more trimmed sensing links. At step 3814, the access point may establish the representative sensing link between corresponding one of the plurality of sensing capable devices and the access point.

Step 3802 includes obtaining sensing sounding information based on accessing previously stored sensing information. The sensing sounding information may include information about a plurality of power variations among a plurality of candidate sensing links between the plurality of sensing capable devices and the access point, wherein the plurality of candidate sensing links may include original sensing links of a previously established sensing link set and trimmed sensing links not included in the previously established sensing link set. According to an implementation, the access point (which may be either sensing receiver 502-(1-M) or sensing transmitter 504-(1-N)) may be configured to obtain the sensing sounding information based on accessing previously stored sensing information. The sensing sounding information may include information about a plurality of power variations among a plurality of candidate sensing links between the plurality of sensing capable devices and the access point, wherein the plurality of candidate sensing links may include original sensing links of a previously established sensing link set and trimmed sensing links not included in the previously established sensing link set. In an implementation, the access point may retrieve the sensing sounding information from sensing information storage 564.

Step 3804 includes determining a plurality of data usage values corresponding to the plurality of candidate sensing links. According to an implementation, the access point (which may be either sensing receiver 502-(1-M) or sensing transmitter 504-(1-N)) may be configured to determine the plurality of data usage values corresponding to the plurality of candidate sensing links.

Step 3806 includes identifying a congested sensing link from among the original sensing links as having a corresponding data usage value from the plurality of data usage values exceeding a congestion threshold T. According to an implementation, the access point (which may be either sensing receiver 502-(1-M) or sensing transmitter 504-(1-N)) may be configured to identify the congested sensing link from among the original sensing links as having the corresponding data usage value from the plurality of data usage values exceeding the congestion threshold T.

Step 3808 includes identifying a power variation corresponding to the congested sensing link. According to an implementation, the access point (which may be either sensing receiver 502-(1-M) or sensing transmitter 504-(1-N)) may be configured to identify the power variation corresponding to the congested sensing link.

Step 3810 includes identifying one or more trimmed sensing links belonging to the power variation. According to an implementation, the access point (which may be either sensing receiver 502-(1-M) or sensing transmitter 504-(1-N)) may be configured to identify the one or more trimmed sensing links belonging to the power variation.

Step 3812 includes selecting a representative sensing link for the power variation from among the congested sensing link and the one or more trimmed sensing links based on a switch factor defined for each of the congested sensing links and the one or more trimmed sensing links. According to an implementation, the access point (which may be either sensing receiver 502-(1-M) or sensing transmitter 504-(1-N)) may be configured to select the representative sensing link for the power variation from among the congested sensing link and the one or more trimmed sensing links based on the switch factor defined for each of the congested sensing links and the one or more trimmed sensing links. In an implementation, the access point may select the representative sensing link for the power variation to balance link loads in the sensing link set. In an implementation, the switch factor is defined as a number of occurrences of a link in the groupings of the plurality of power variations divided by a data usage value corresponding to the link. In examples, the power variation may include the congested sensing link and an uncongested trimmed sensing link. The access point may select the representative sensing link according to a highest switch factor among the congested sensing link and the uncongested trimmed sensing link.

In some examples, the power variation includes the congested sensing link and a plurality of uncongested trimmed sensing links. The access point may select the representative sensing link according to a highest switch factor among the congested sensing link and the plurality of uncongested trimmed sensing links. The representative sensing link may further be selected among two uncongested trimmed sensing links having a same switch factor according to the uncongested trimmed sensing link having a lower link number. In an example, the access point may select the trimmed sensing link occurring in a largest number of a plurality of groupings characterizing the plurality of power variations as the representative sensing link. In some examples, the access point may select the trimmed sensing link having a lowest data usage value from the plurality of data usage values as the representative sensing link.

Step 3814 includes establishing the representative sensing link between corresponding one of the plurality of sensing capable devices and the access point. According to an implementation, the access point (which may be either sensing receiver 502-(1-M) or sensing transmitter 504-(1-N)) may be configured to establish the representative sensing link between corresponding one of the plurality of sensing capable devices and the access point.

FIG. 39A, FIG. 39B, and FIG. 39C depict flowchart 3900 for establishing a plurality of representative sensing links between corresponding ones of the plurality of sensing capable devices and the access point, according to some embodiments.

In a brief overview of an implementation of flowchart 3900, at step 3902, the access point may obtain sensing sounding information based on accessing previously stored sensing information. The sensing sounding information may include information about a plurality of power variations among a plurality of candidate sensing links between the plurality of devices and the access point, wherein the plurality of candidate sensing links include original sensing links of a previously established sensing link set and trimmed sensing links not included in the previously established sensing link set. At step 3904, the access point may determine a plurality of data usage values corresponding to the plurality of candidate sensing links. At step 3906, the access point may identify a congested sensing link from among the original sensing links as having a corresponding data usage value from the plurality of data usage values exceeding a congestion threshold T. At step 3908, the access point may identify a power variation corresponding to the congested sensing link. At step 3910, the access point may identify one or more trimmed sensing links belonging to the power variation. At step 3912, the access point may select a representative sensing link for the power variation from among the congested sensing link and the one or more trimmed sensing links. At step 3914, the access point may identify additional congested sensing links from among the original sensing links according to the plurality of data usage values. At step 3916, the access point may identify additional power variations corresponding to the additional congested sensing links. At step 3918, the access point may identify additional sets of one or more trimmed sensing links belonging to the additional power variations. At step 3920, for each additional power variation, the access point may select a corresponding representative sensing link from among the corresponding additional congested sensing links and the corresponding additional set of one or more trimmed sensing links. At step 3922, the access point may establish the plurality of representative sensing links between corresponding ones of the plurality of sensing capable devices and the access point.

Step 3902 includes obtaining sensing sounding information based on accessing previously stored sensing information. The sensing sounding information may include information about a plurality of power variations among a plurality of candidate sensing links between the plurality of sensing capable devices and the access point, wherein the plurality of candidate sensing links may include original sensing links of a previously established sensing link set and trimmed sensing links not included in the previously established sensing link set. According to an implementation, the access point (which may be either sensing receiver 502-(1-M) or sensing transmitter 504-(1-N)) may be configured to obtain the sensing sounding information based on accessing previously stored sensing information. The sensing sounding information may include information about a plurality of power variations among a plurality of candidate sensing links between the plurality of sensing capable devices and the access point, wherein the plurality of candidate sensing links may include original sensing links of a previously established sensing link set and trimmed sensing links not included in the previously established sensing link set. In an implementation, the access point may retrieve the sensing sounding information from sensing information storage 564.

Step 3904 includes determining a plurality of data usage values corresponding to the plurality of candidate sensing links. According to an implementation, the access point (which may be either sensing receiver 502-(1-M) or sensing transmitter 504-(1-N)) may be configured to determine the plurality of data usage values corresponding to the plurality of candidate sensing links.

Step 3906 includes identifying a congested sensing link from among the original sensing links as having a corresponding data usage value from the plurality of data usage values exceeding a congestion threshold T. According to an implementation, the access point (which may be either sensing receiver 502-(1-M) or sensing transmitter 504-(1-N)) may be configured to identify the congested sensing link from among the original sensing links as having the corresponding data usage value from the plurality of data usage values exceeding the congestion threshold T.

Step 3908 includes identifying a power variation corresponding to the congested sensing link. According to an implementation, the access point (which may be either sensing receiver 502-(1-M) or sensing transmitter 504-(1-N)) may be configured to identify the power variation corresponding to the congested sensing link.

Step 3910 includes identifying one or more trimmed sensing links belonging to the power variation. According to an implementation, the access point (which may be either sensing receiver 502-(1-M) or sensing transmitter 504-(1-N)) may be configured to identify the one or more trimmed sensing links belonging to the power variation.

Step 3912 includes selecting a representative sensing link for the power variation from among the congested sensing link and the one or more trimmed sensing links. According to an implementation, the access point (which may be either sensing receiver 502-(1-M) or sensing transmitter 504-(1-N)) may be configured to select the representative sensing link for the power variation from among the congested sensing link and the one or more trimmed sensing links. According to an implementation, the access point (which may be either sensing receiver 502-(1-M) or sensing transmitter 504-(1-N)) may be configured to select the representative sensing link for the power variation from among the congested sensing link and the one or more trimmed sensing links based on the switch factor defined for each of the congested sensing links and the one or more trimmed sensing links. In an implementation, the access point may select the representative sensing link for the power variation to balance link loads in the sensing link set. In an implementation, the switch factor is defined as a number of occurrences of a link in the groupings of the plurality of power variations divided by a data usage value corresponding to the link. In examples, the power variation may include the congested sensing link and an uncongested trimmed sensing link. The access point may select the representative sensing link according to a highest switch factor among the congested sensing link and the uncongested trimmed sensing link.

In some examples, the power variation includes the congested sensing link and a plurality of uncongested trimmed sensing links. The access point may select the representative sensing link according to a highest switch factor among the congested sensing link and the plurality of uncongested trimmed sensing links. The representative sensing link may further be selected among two uncongested trimmed sensing links having a same switch factor according to the uncongested trimmed sensing link having a lower link number. In an example, the access point may select the trimmed sensing link occurring in a largest number of a plurality of groupings characterizing the plurality of power variations as the representative sensing link. In some examples, the access point may select the trimmed sensing link having a lowest data usage value from the plurality of data usage values as the representative sensing link.

Step 3914 includes identifying additional congested sensing links from among the original sensing links according to the plurality of data usage values. According to an implementation, the access point (which may be either sensing receiver 502-(1-M) or sensing transmitter 504-(1-N)) may be configured to identify the additional congested sensing links from among the original sensing links according to the plurality of data usage values.

Step 3916 includes identifying additional power variations corresponding to the additional congested sensing links. According to an implementation, the access point (which may be either sensing receiver 502-(1-M) or sensing transmitter 504-(1-N)) may be configured to identify the additional power variations corresponding to the additional congested sensing links.

Step 3918 includes identifying additional sets of one or more trimmed sensing links belonging to the additional power variations. According to an implementation, the access point (which may be either sensing receiver 502-(1-M) or sensing transmitter 504-(1-N)) may be configured identify additional sets of one or more trimmed sensing links belonging to the additional power variations.

Step 3920 includes for each additional power variation, selecting a corresponding representative sensing link from among the corresponding additional congested sensing links and the corresponding additional set of one or more trimmed sensing links. According to an implementation, the access point (which may be either sensing receiver 502-(1-M) or sensing transmitter 504-(1-N)) may be configured to, for each additional power variation, select the corresponding representative sensing link from among the corresponding additional congested sensing links and the corresponding additional set of one or more trimmed sensing links.

Step 3922 includes establishing the plurality of representative sensing links between corresponding ones of the plurality of sensing capable devices and the access point. According to an implementation, the access point (which may be either sensing receiver 502-(1-M) or sensing transmitter 504-(1-N)) may be configured to establish the plurality of representative sensing links between corresponding ones of the plurality of sensing capable devices and the access point.

FIG. 40A and FIG. 40B depict flowchart 4000 for establishing a plurality of selected sensing links between selected devices of candidate devices and the access point, according to some embodiments.

In a brief overview of an implementation of flowchart 4000, at step 4002, the access point may identify a candidate set of a plurality of networking devices. The plurality of networking devices may include a plurality of sensing capable devices. In examples, the candidate set may include a plurality of candidate devices capable of establishing transmission links with the access point. At step 4004, the access point may establish a plurality of candidate sensing links between the plurality of candidate devices and the access point. At step 4006, the access point may obtain a plurality of time-domain channel representation information (TD-CRI) profile sets corresponding to respective ones of the plurality of candidate sensing links. At step 4008, the access point may identify a plurality of TD-CRI spans corresponding to respective ones of the plurality of candidate sensing links according to the plurality of TD-CRI profile sets. At step 4010, the access point may identify a sensing link set according to the plurality of TD-CRI spans. The sensing link set may include a plurality of selected sensing links selected from the plurality of candidate sensing links. At step 4012, the access point may establish the plurality of selected sensing links between selected devices of the candidate devices and the access point.

Step 4002 includes identifying a candidate set of a plurality of networking devices. The candidate set includes a plurality of candidate devices capable of establishing transmission links with an access point. According to an implementation, the access point (which may be either sensing receiver 502-(1-M) or sensing transmitter 504-(1-N)) may be configured to identify the candidate set of the plurality of networking devices. The candidate set includes the plurality of candidate devices capable of establishing transmission links with the access point.

Step 4004 includes establishing a plurality of candidate sensing links between the plurality of candidate devices and the access point. According to an implementation, the access point (which may be either sensing receiver 502-(1-M) or sensing transmitter 504-(1-N)) may be configured to establish the plurality of candidate sensing links between the plurality of candidate devices and the access point.

Step 4006 includes obtaining a plurality of TD-CRI profile sets corresponding to respective ones of the plurality of candidate sensing links. According to an implementation, the access point (which may be either sensing receiver 502-(1-M) or sensing transmitter 504-(1-N)) may be configured to obtain the plurality of TD-CRI profile sets corresponding to respective ones of the plurality of candidate sensing links. In examples, the plurality of TD-CRI profile sets may include one TD-CRI profile set for each of the plurality of candidate sensing links obtained over an analysis period, wherein each TD-CRI profile set includes a plurality of TD-CRI profiles, each corresponding to a filter window in the analysis period. In an implementation, the access point may obtain each TD-CRI profile of the plurality of TD-CRI profile sets for a candidate sensing link of the plurality of candidate sensing links based on obtaining a plurality of TD-CRI measurements at a plurality of sampling instances in a filter window for each candidate sensing link, and applying an averaging filter to the plurality of TD-CRI measurements to obtain each TD-CRI profile. In some implementations, the access point may remove a time shift from one or more of the plurality of TD-CRI measurements prior to applying the averaging filter. In examples, the averaging filter may include at least one of a low pass filter and an exponential moving average filter.

Step 4008 includes identifying a plurality of TD-CRI spans corresponding to respective ones of the plurality of candidate sensing links according to the plurality of TD-CRI profile sets. According to an implementation, the access point (which may be either sensing receiver 502-(1-M) or sensing transmitter 504-(1-N)) may be configured to identify the plurality of TD-CRI spans corresponding to respective ones of the plurality of candidate sensing links according to the plurality of TD-CRI profile sets. In examples, each TD-CRI span of the plurality of TD-CRI spans may correspond to a TD-CRI profile set of the plurality of TD-CRI profile sets and is selected from a plurality of filter window TD-CRI spans, wherein the plurality of filter window TD-CRI spans correspond to the plurality of TD-CRI profiles of the TD-CRI profile set. Further, in examples, each filter window TD-CRI span of the plurality of filter window TD-CRI spans may be obtained from a corresponding TD-CRI profile. According to an implementation, the access point (which may be either sensing receiver 502-(1-M) or sensing transmitter 504-(1-N)) may be configured to obtain the plurality of filter window TD-CRI spans based on identifying effective time domain pulses in the corresponding TD-CRI profile as time domain pulses having an amplitude surpassing an amplitude threshold, identifying a first index of a first effective time domain pulse having a lowest time delay of the effective time domain pulses in the corresponding TD-CRI profile, identifying a last index of a last effective time domain pulse having a greatest time delay of the effective time domain pulses in the corresponding TD-CRI profile, and defining each filter window TD-CRI span as the last index minus the first index for the corresponding TD-CRI profile. In examples, the amplitude threshold may be determined for each TD-CRI profile as a percentage of a maximum amplitude of time domain pulses in the TD-CRI profile. In an implementation, the access point may select the plurality of TD-CRI spans based on determining each TD-CRI span as the maximum filter window TD-CRI span for each TD-CRI profile set. In some implementations, the access point may select the plurality of TD-CRI spans based on determining each TD-CRI span as an average of the plurality of filter window TD-CRI spans for each TD-CRI profile set.

Step 4010 includes identifying a sensing link set according to the plurality of TD-CRI spans. The sensing link set includes a plurality of selected sensing links selected from the plurality of candidate sensing links. According to an implementation, the access point (which may be either sensing receiver 502-(1-M) or sensing transmitter 504-(1-N)) may be configured to identify the sensing link set according to the plurality of TD-CRI spans. The sensing link set includes the plurality of selected sensing links selected from the plurality of candidate sensing links. In an implementation, the access point (which may be either sensing receiver 502-(1-M) or sensing transmitter 504-(1-N)) may be configured to identify a sensing link set according to the plurality of TD-CRI spans based on identifying a plurality of power variations, each power variation being characterized by a grouping of one or more candidate sensing links that display a variation in received power compared to an average power of sensing transmissions of the respective candidate sensing links for one or more sampling instances during an analysis period, determining a power variation test set including a subset of power variations selected from the plurality of power variations, and selecting, for each power variation of the power variation test set, for inclusion in the sensing link set, a selected candidate sensing link from the grouping of the test power variation according to the candidate sensing link having a largest TD-CRI span.

Step 4012 includes establishing the plurality of selected sensing links between selected devices of the candidate devices and the access point. According to an implementation, the access point (which may be either sensing receiver 502-(1-M) or sensing transmitter 504-(1-N)) may be configured to establish the plurality of selected sensing links between selected devices of the candidate devices and the access point.

FIG. 41A, FIG. 41B, and FIG. 41C depict flowchart 4100 for establishing a plurality of selected sensing links between selected devices of candidate devices and the access point, according to some embodiments.

In a brief overview of an implementation of flowchart 4100, at step 4102, the access point may identify a candidate set of a plurality of networking devices. The plurality of networking devices may include a plurality of sensing capable devices. In examples, the candidate set may include a plurality of candidate devices capable of establishing transmission links with the access point. At step 4104, the access point may establish a plurality of candidate sensing links between the plurality of candidate devices and the access point. At step 4106, the access point may obtain a plurality of time-domain channel representation information (TD-CRI) profile sets corresponding to respective ones of the plurality of candidate sensing links. At step 4108, the access point may identify a plurality of TD-CRI spans corresponding to respective ones of the plurality of candidate sensing links according to the plurality of TD-CRI profile sets. At step 4110, the access point may identify a plurality of power variations, each power variation being characterized by a grouping of one or more candidate sensing links that display a variation in received power compared to an average power of sensing transmissions of the respective candidate sensing links for one or more sampling instances during an analysis period. At step 4112, the access point may determine a power variation test set including a subset of power variations selected from the plurality of power variations. At step 4114, the access point may select, for each power variation of the power variation test set, for inclusion in a sensing link set, a candidate sensing link from the grouping of the test power variation according to the candidate sensing link having a largest TD-CRI span. At step 4116, the access point may establish the plurality of selected sensing links between selected devices of the candidate devices and the access point.

Step 4102 includes identifying a candidate set of a plurality of networking devices. The candidate set includes a plurality of candidate devices capable of establishing transmission links with an access point. According to an implementation, the access point (which may be either sensing receiver 502-(1-M) or sensing transmitter 504-(1-N)) may be configured to identify the candidate set of a plurality of networking devices. The candidate set includes a plurality of candidate devices capable of establishing transmission links with the access point.

Step 4104 includes establishing a plurality of candidate sensing links between the plurality of candidate devices and the access point. According to an implementation, the access point (which may be either sensing receiver 502-(1-M) or sensing transmitter 504-(1-N)) may be configured to establish the plurality of candidate sensing links between the plurality of candidate devices and the access point.

Step 4106 includes obtaining a plurality of TD-CRI profile sets corresponding to respective ones of the plurality of candidate sensing links. According to an implementation, the access point (which may be either sensing receiver 502-(1-M) or sensing transmitter 504-(1-N)) may be configured to obtain the plurality of TD-CRI profile sets corresponding to respective ones of the plurality of candidate sensing links. In examples, the plurality of TD-CRI profile sets may include one TD-CRI profile set for each of the plurality of candidate sensing links obtained over an analysis period, wherein each TD-CRI profile set includes a plurality of TD-CRI profiles, each corresponding to a filter window in the analysis period. In an implementation, the access point may obtain each TD-CRI profile of the plurality of TD-CRI profile sets for a candidate sensing link of the plurality of candidate sensing links based on obtaining a plurality of TD-CRI measurements at a plurality of sampling instances in a filter window for each candidate sensing link, and applying an averaging filter to the plurality of TD-CRI measurements to obtain each TD-CRI profile. In some implementations, the access point may remove a time shift from one or more of the plurality of TD-CRI measurements prior to applying the averaging filter. In examples, the averaging filter may include at least one of a low pass filter and an exponential moving average filter.

Step 4108 includes identifying a plurality of TD-CRI spans corresponding to respective ones of the plurality of candidate sensing links according to the plurality of TD-CRI profile sets. According to an implementation, the access point (which may be either sensing receiver 502-(1-M) or sensing transmitter 504-(1-N)) may be configured to identify the plurality of TD-CRI spans corresponding to respective ones of the plurality of candidate sensing links according to the plurality of TD-CRI profile sets. In examples, each TD-CRI span of the plurality of TD-CRI spans may correspond to a TD-CRI profile set of the plurality of TD-CRI profile sets and is selected from a plurality of filter window TD-CRI spans, wherein the plurality of filter window TD-CRI spans correspond to the plurality of TD-CRI profiles of the TD-CRI profile set. Further, in examples, each filter window TD-CRI span of the plurality of filter window TD-CRI spans may be obtained from a corresponding TD-CRI profile. According to an implementation, the access point (which may be either sensing receiver 502-(1-M) or sensing transmitter 504-(1-N)) may be configured to obtain the plurality of filter window TD-CRI spans based on identifying effective time domain pulses in the corresponding TD-CRI profile as time domain pulses having an amplitude surpassing an amplitude threshold, identifying a first index of a first effective time domain pulse having a lowest time delay of the effective time domain pulses in the corresponding TD-CRI profile, identifying a last index of a last effective time domain pulse having a greatest time delay of the effective time domain pulses in the corresponding TD-CRI profile, and defining each filter window TD-CRI span as the last index minus the first index for the corresponding TD-CRI profile. In examples, the amplitude threshold may be determined for each TD-CRI profile as a percentage of a maximum amplitude of time domain pulses in the TD-CRI profile. In an implementation, the access point may select the plurality of TD-CRI spans based on determining each TD-CRI span as the maximum filter window TD-CRI span for each TD-CRI profile set. In some implementations, the access point may select the plurality of TD-CRI spans based on determining each TD-CRI span as an average of the plurality of filter window TD-CRI spans for each TD-CRI profile set.

Step 4110 includes identifying a plurality of power variations, each power variation being characterized by a grouping of one or more candidate sensing links that display a variation in received power compared to an average power of sensing transmissions of the respective candidate sensing links for one or more sampling instances during an analysis period. According to an implementation, the access point (which may be either sensing receiver 502-(1-M) or sensing transmitter 504-(1-N)) may be configured to identify the plurality of power variations, each power variation being characterized by the grouping of one or more candidate sensing links that display the variation in received power compared to the average power of sensing transmissions of the respective candidate sensing links for one or more sampling instances during the analysis period.

Step 4112 includes determining a power variation test set including a subset of power variations selected from the plurality of power variations. According to an implementation, the access point (which may be either sensing receiver 502-(1-M) or sensing transmitter 504-(1-N)) may be configured to determine the power variation test set including the subset of power variations selected from the plurality of power variations.

Step 4114 includes selecting, for each power variation of the power variation test set, for inclusion in a sensing link set, a candidate sensing link from the grouping of the test power variation according to the candidate sensing link having a largest TD-CRI span. According to an implementation, the access point (which may be either sensing receiver 502-(1-M) or sensing transmitter 504-(1-N)) may be configured to select, for each power variation of the power variation test set, for inclusion in the sensing link set, the candidate sensing link from the grouping of the test power variation according to the candidate sensing link having the largest TD-CRI span.

Step 4116 includes establishing the plurality of selected sensing links between selected devices of the candidate devices and the access point. According to an implementation, the access point (which may be either sensing receiver 502-(1-M) or sensing transmitter 504-(1-N)) may be configured to establish the plurality of selected sensing links between selected devices of the candidate devices and the access point.

Further embodiments consistent with the disclosure include the following.

Embodiment 1 is a method for Wi-Fi sensing carried out by a Wi-Fi system including a plurality of networking devices, the plurality of networking devices including a plurality of sensing capable devices and an access point, the method comprising: identifying a candidate set of the plurality of networking devices, the candidate set including a plurality of candidate devices capable of establishing transmission links with the access point; establishing a plurality of candidate sensing links between the plurality of candidate devices and the access point; monitoring sensing transmissions transmitted via the plurality of candidate sensing links; identifying a sensing link set according to the sensing transmissions, the sensing link set including a plurality of selected sensing links selected from the plurality of candidate sensing links; and establishing the plurality of selected sensing links between selected devices of the plurality of candidate devices and the access point.

Embodiment 2 is the method of embodiment 1, wherein monitoring the sensing transmissions includes determining an average power of the sensing transmissions over an analysis period.

Embodiment 3 is the method of any of embodiments 1 or 2, wherein monitoring the sensing transmissions includes identifying a plurality of power variations, each power variation being characterized by a grouping of one or more candidate sensing links that display a variation in received power compared to an average power of the sensing transmissions of the respective candidate sensing links for one or more sampling instances during the analysis period.

Embodiment 4 is the method of embodiment 3, wherein identifying the sensing link set includes identifying the plurality of sensing links according to a sensing space coverage metric.

Embodiment 5 is the method of embodiment 4, wherein identifying the plurality of sensing links according to the sensing space coverage metric includes: determining a power variation test set including a subset of power variations selected from the plurality of power variations for analysis by the sensing space coverage metric; determining a power ratio parameter for a test power variation of the power variation test set; comparing the power ratio parameter to a ratio threshold factor; and selecting, responsive to the power ratio parameter exceeding the ratio threshold factor, for inclusion in the sensing link set, a selected candidate sensing link from the grouping of the test power variation according to the candidate sensing link occurring in a largest number of groupings of the plurality of power variations.

Embodiment 6 is the method of embodiment 5, wherein identifying the plurality of sensing links according to the sensing space coverage metric further includes: determining additional power ratio parameters for additional power variations of the power variation test set; comparing the additional power ratio parameters to the ratio threshold factor for each of the additional power variations; and selecting, for each additional power variation having an additional power ratio parameter exceeding the ratio threshold factor, for inclusion in the sensing link set, an additional selected candidate sensing link from each grouping of the additional power variations according to the candidate sensing link occurring in a largest number of the plurality of power variations

Embodiment 7 is the method of embodiment 6 wherein determining the power variation test set includes: selecting a first power variation from the plurality of power variations according to a significance ranking of the plurality of power variations; and selecting a second power variation from remaining ones of the plurality of power variations having no candidate sensing links in common with the first power variation according to the significance ranking of the remaining ones of the plurality of power variations; wherein the power variation test set includes the first power variation and the second power variation.

Embodiment 8 is the method of embodiment 7, wherein the power variation test set further includes one or more further power variations such that each candidate sensing link occurs in only one grouping from the first power variation, the second power variation, and the one or more further power variations.

Embodiment 9 is the method of embodiment 7, wherein the significance ranking is determined according to at least one of: a combo length representing a number of candidate sensing links occurring in the plurality of power variations; a variation counter representing a number of occurrences of each power variation from the plurality of power variations; and a maximum string length representing a largest number of consecutive occurrences of each power variation from the plurality of power variations.

Embodiment 10 is the method of any of embodiments 5-9, wherein determining the power ratio parameter includes dividing a first maximum string length representing a largest number of consecutive occurrences of a test power variation from the power variation test set in the analysis period by a second maximum string length representing a largest number of consecutive occurrences in the analysis period from among single link power variations associated with each candidate sensing link of the grouping of the test power variation.

Embodiment 11 is the method of any of embodiments 5-10, wherein determining the power ratio parameter includes dividing a first variation counter representing a number of occurrences of a test power variation from the power variation test set in the analysis period by a second variation counter representing a largest number of occurrences in the analysis period from among single link power variations associated with each candidate sensing link of the grouping of the test power variation.

Embodiment 12 is a system for Wi-Fi sensing comprising a plurality of networking devices, the plurality of networking devices including a plurality of sensing capable devices and an access point, the system being configured for: identifying a candidate set of the plurality of networking devices, the candidate set including a plurality of candidate devices capable of establishing transmission links with the access point; establishing a plurality of candidate sensing links between the plurality of candidate devices and the access point; monitoring sensing transmissions transmitted via the plurality of candidate sensing links; identifying a sensing link set according to the sensing transmissions, the sensing link set including a plurality of selected sensing links selected from the plurality of candidate sensing links; and establishing the plurality of selected sensing links between selected devices of the plurality of candidate devices and the access point.

Embodiment 13 is the system of embodiment 12, wherein monitoring the sensing transmissions includes determining an average power of the sensing transmissions over an analysis period.

Embodiment 14 is the system of any of embodiments 12 or 13, wherein monitoring the sensing transmissions includes identifying a plurality of power variations, each power variation being characterized by a grouping of one or more candidate sensing links that display a variation in received power compared to an average power of the sensing transmissions of the respective candidate sensing links for one or more sampling instances during the analysis period.

Embodiment 15 is the system of embodiment 14, wherein identifying the sensing link set includes identifying the plurality of sensing links according to a sensing space coverage metric.

Embodiment 16 is the system of embodiment 15, wherein identifying the plurality of sensing links according to the sensing space coverage metric includes: determining a power variation test set including a subset of power variations selected from the plurality of power variations for analysis by the sensing space coverage metric; determining a power ratio parameter for a test power variation of the power variation test set; comparing the power ratio parameter to a ratio threshold factor; and selecting, responsive to the power ratio parameter exceeding the ratio threshold factor, for inclusion in the sensing link set, a selected candidate sensing link from the grouping of the test power variation according to the candidate sensing link occurring in a largest number of groupings of the plurality of power variations.

Embodiment 17 is the system of embodiment 16, wherein identifying the plurality of sensing links according to the sensing space coverage metric further includes: determining additional power ratio parameters for additional power variations of the power variation test set; comparing the additional power ratio parameters to the ratio threshold factor for each of the additional power variations; and selecting, for each additional power variation having an additional power ratio parameter exceeding the ratio threshold factor, for inclusion in the sensing link set, an additional selected candidate sensing link from each grouping of the additional power variations according to the candidate sensing link occurring in a largest number of the plurality of power variations

Embodiment 18 is the system of embodiment 17, wherein determining the power variation test set includes: selecting a first power variation from the plurality of power variations according to a significance ranking of the plurality of power variations; and selecting a second power variation from remaining ones of the plurality of power variations having no candidate sensing links in common with the first power variation according to the significance ranking of the remaining ones of the plurality of power variations; wherein the power variation test set includes the first power variation and the second power variation.

Embodiment 19 is the system of embodiment 18, wherein the power variation test set further includes one or more further power variations such that each candidate sensing link occurs in only one grouping from the first power variation, the second power variation, and the one or more further power variations.

Embodiment 20 is the system of any of embodiments 18 or 19, wherein the significance ranking is determined according to at least one of: a combo length representing a number of candidate sensing links occurring in the plurality of power variations; a variation counter representing a number of occurrences of each power variation from the plurality of power variations; and a maximum string length representing a largest number of consecutive occurrences of each power variation from the plurality of power variations.

Embodiment 21 is the system of any of embodiments 16-20, wherein determining the power ratio parameter includes dividing a first maximum string length representing a largest number of consecutive occurrences of a test power variation from the power variation test set in the analysis period by a second maximum string length representing a largest number of consecutive occurrences in the analysis period from among single link power variations associated with each candidate sensing link of the grouping of the test power variation.

Embodiment 22 is the system of any of embodiments 16-21, wherein determining the power ratio parameter includes dividing a first variation counter representing a number of occurrences of a test power variation from the power variation test set in the analysis period by a second variation counter representing a largest number of occurrences in the analysis period from among single link power variations associated with each candidate sensing link of the grouping of the test power variation.

Embodiment 23 is a method for Wi-Fi sensing carried out by a Wi-Fi system including a plurality of networking devices, the plurality of networking devices including a plurality of sensing capable devices and an access point, the method comprising: maintaining a plurality of selected sensing links as a sensing link set between selected devices of the plurality of sensing capable devices and the access point; identifying a plurality of candidate links as a candidate link set between unselected devices of the plurality of sensing capable devices and the access point; identifying a plurality of assessment links as an assessment link set from the candidate link set and the sensing link set, determining an allocation of channel resources for the plurality of assessment links; establishing the plurality of assessment links according to the allocation; monitoring sensing transmissions on the plurality of assessment links during an analysis period; identifying an updated sensing link set according to the sensing transmissions, the updated sensing link set including a plurality of updated sensing links selected from the plurality of assessment links according to a sensing space coverage metric; establishing the updated sensing link set.

Embodiment 24 is the method of embodiment 23, wherein identifying the plurality of candidate links includes: performing a discovery process for sensing capable devices; and including discovered sensing capable devices as candidate devices in the candidate link set representing candidate links.

Embodiment 25 is the method of any of embodiments 23 or 24, wherein identifying the plurality of candidate links includes: identifying trimmed links not included in the sensing link set; and including the trimmed links in the candidate link set as candidate links.

Embodiment 26 is the method of any of embodiments 23-25, wherein determining the assessment link set includes: selecting one or more of the plurality of sensing links as assessment links; and selecting a subset of the plurality of candidate links as assessment links.

Embodiment 27 is the method of embodiment 26, further comprising: determining that a metric of congestion of the access point is above a congestion threshold; and selecting one or more active sensing capable devices of the candidate devices in the candidate link set for inclusion in the assessment link set.

Embodiment 28 is the method of embodiment 27, wherein determining the allocation of channel resources for the one or more active sensing capable devices included in the assessment link set includes maintaining an existing allocation of resource units (RUs) for the one or more active sensing capable devices included in the assessment link set.

Embodiment 29 is the method of embodiment 26, further comprising: determining that a metric of congestion of the access point is below a congestion threshold; and selecting one or more idle sensing capable devices of the candidate devices in the candidate link set for inclusion in the assessment link set.

Embodiment 30 is the method of embodiment 29, wherein determining the allocation of channel resources for the one or more idle sensing capable devices included in the assessment link set includes allocating resource units (RUs) to the one or more idle sensing capable devices included in the assessment link set.

Embodiment 31 is the method of any of embodiments 29 or 30, further comprising: selecting one or more active sensing capable devices of the candidate devices in the candidate link set for inclusion in the assessment link set, wherein determining the allocation of channel resources for the sensing capable devices included in the assessment link set includes: for the selected devices, maintaining an existing allocation of RUs, for the one or more idle sensing capable devices, allocating RUs, and for the one or more active sensing capable devices, maintaining an existing allocation of RUs.

Embodiment 32 is the method of any of embodiments 23-31, further comprising: determining a reallocation of channel resources for the plurality of assessment links according to changes in data link bandwidth on the plurality of assessment links during an analysis period.

Embodiment 33 is a system for Wi-Fi sensing including a plurality of networking devices, the plurality of networking devices including a plurality of sensing capable devices and an access point, the system being configured for: maintaining a plurality of selected sensing links as a sensing link set between selected devices of the plurality of sensing capable devices and the access point; identifying a plurality of candidate links as a candidate link set between unselected devices of the plurality of sensing capable devices and the access point; identifying a plurality of assessment links as an assessment link set from the candidate link set and the sensing link set, determining an allocation of channel resources for the plurality of assessment links; establishing the plurality of assessment links according to the allocation; monitoring sensing transmissions on the plurality of assessment links during an analysis period; identifying an updated sensing link set according to the sensing transmissions, the updated sensing link set including a plurality of updated sensing links selected from the plurality of assessment links according to a sensing space coverage metric; establishing the updated sensing link set.

Embodiment 34 is the system of embodiment 33, wherein identifying the plurality of candidate links includes: performing a discovery process for sensing capable devices; and including discovered sensing capable devices as candidate devices in the candidate link set representing candidate links.

Embodiment 35 is the system of any of embodiments 33 or 34, wherein identifying the plurality of candidate links includes: identifying trimmed links not included in the sensing link set; and including the trimmed links in the candidate link set as candidate links.

Embodiment 36 is the system of any of embodiments 33-35, wherein determining the assessment link set includes: selecting one or more of the plurality of sensing links as assessment links; and selecting a subset of the plurality of candidate links as assessment links.

Embodiment 37 is the system of embodiment 36, further comprising: determining that a metric of congestion of the access point is above a congestion threshold; and selecting one or more active sensing capable devices of the candidate devices in the candidate link set for inclusion in the assessment link set.

Embodiment 38 is the system of embodiment 37, wherein determining the allocation of channel resources for the one or more active sensing capable devices included in the assessment link set includes maintaining an existing allocation of resource units (RUs) for the one or more active sensing capable devices included in the assessment link set.

Embodiment 39 is the system of any of embodiments 36-38, wherein the system is further configured for: determining that a metric of congestion of the access point is below a congestion threshold; and selecting one or more idle sensing capable devices of the candidate devices in the candidate link set for inclusion in the assessment link set.

Embodiment 40 is the system of embodiment 39, wherein determining the allocation of channel resources for the one or more idle sensing capable devices included in the assessment link set includes allocating resource units (RUs) to the one or more idle sensing capable devices included in the assessment link set.

Embodiment 41 is the system of any of embodiments 39 or 40, wherein the system is further configured for: selecting one or more active sensing capable devices of the candidate devices in the candidate link set for inclusion in the assessment link set, wherein determining the allocation of channel resources for the sensing capable devices included in the assessment link set includes: for the selected devices, maintaining an existing allocation of RUs, for the one or more idle sensing capable devices, allocating RUs, and for the one or more active sensing capable devices, maintaining an existing allocation of RUs.

Embodiment 42 is the system of any of embodiments 33-41, wherein the system is further configured for: determining a reallocation of channel resources for the plurality of assessment links according to changes in data link bandwidth on the plurality of assessment links during an analysis period.

Embodiment 43 is a method for Wi-Fi sensing carried out by a Wi-Fi system including a plurality of networking devices, the plurality of networking devices including a plurality of sensing capable devices and an access point, the method comprising: obtaining sensing sounding information, the sensing sounding information including information about a plurality of power variations among a plurality of candidate sensing links between the plurality of sensing capable devices and the access point, each power variation being characterized by a grouping of one or more candidate sensing links that display a variation in received power compared to an average power of sensing transmissions of the respective candidate sensing links during one or more sampling instances of an analysis period; determining a plurality of data usage values corresponding to the plurality of candidate sensing links; identifying a sensing link set according to a sensing space coverage metric determined from the sensing sounding information and the plurality of data usage values, the sensing link set including a plurality of representative sensing links selected from the plurality of candidate sensing links; and establishing the plurality of representative sensing links between corresponding ones of the plurality of sensing capable devices and the access point.

Embodiment 44 is the method of embodiment 43, wherein: obtaining the sensing sounding information includes: establishing a plurality of candidate sensing links between the plurality of sensing capable devices and the access point, monitoring sensing transmissions transmitted via the plurality of candidate sensing links during the analysis period, and identifying the plurality of power variations based on the sensing transmissions.

Embodiment 45 is the method of any of embodiments 43 or 44, wherein: obtaining the sensing sounding information includes accessing previously stored sensing information, and the plurality of candidate sensing links include original sensing links of a previously established sensing link set and trimmed sensing links not included in the previously established sensing link set, each power variation having at least one original sensing link.

Embodiment 46 is the method of embodiment 45, wherein identifying the sensing link set includes: identifying a congested sensing link from among the original sensing links as having a corresponding data usage value from the plurality of data usage values exceeding a congestion threshold; identifying a power variation corresponding to the congested sensing link; identifying one or more trimmed sensing links belonging to the power variation; and selecting the representative sensing link for the power variation from among the congested sensing link and the one or more trimmed sensing links.

Embodiment 47 is the method of embodiment 46, wherein identifying the sensing link set further includes: identifying additional congested sensing links from among the original sensing links according to the plurality of data usage values; identifying additional power variations corresponding to the additional congested sensing links; identifying additional sets of one or more trimmed sensing links belonging to the additional power variations; and for each additional power variation, selecting a corresponding representative sensing link from among the corresponding additional congested sensing links and the corresponding additional set of one or more trimmed sensing links.

Embodiment 48 is the method of any of embodiments 46 or 47, wherein selecting the representative sensing link further includes: selecting the trimmed sensing link occurring in a largest number of a plurality of groupings characterizing the plurality of power variations as the representative sensing link.

Embodiment 49 is the method of any of embodiments 46-48, wherein selecting the representative sensing link further includes: selecting the trimmed sensing link having a lowest data usage value from the plurality of data usage values as the representative sensing link.

Embodiment 50 is the method of any of embodiments 46-49, wherein selecting the representative sensing link for the power variation from among the congested sensing link and the one or more trimmed sensing links is performed according to a switch factor defined for each of the congested sensing link and the one or more trimmed sensing links.

Embodiment 51 is the method of embodiment 50, wherein the switch factor is defined as a number of occurrences of a link in the groupings of the plurality of power variations divided by a data usage value corresponding to the link.

Embodiment 52 is the method of any of embodiments 50-51, wherein the power variation includes the congested sensing link and an uncongested trimmed sensing link and the representative sensing link is selected according to a highest switch factor among the congested sensing link and the uncongested trimmed sensing link.

Embodiment 53 is the method of any of embodiments 50-52, wherein the power variation includes the congested sensing link and a plurality of uncongested trimmed sensing links and the representative sensing link is selected according to a highest switch factor among the congested sensing link and the plurality of uncongested trimmed sensing links.

Embodiment 54 is the method of any of embodiments 50-53, wherein the representative sensing link is further selected among two uncongested trimmed sensing links having a same switch factor according to the uncongested trimmed sensing link having a lower link number.

Embodiment 55 is the method of any of embodiments 46-54, wherein the representative sensing link for the power variation is selected to balance link loads in the sensing link set.

Embodiment 56 is a system for Wi-Fi sensing including a plurality of networking devices, the plurality of networking devices including a plurality of sensing capable devices and an access point, the system being configured for: obtaining sensing sounding information, the sensing sounding information including information about a plurality of power variations among a plurality of candidate sensing links between the plurality of sensing capable devices and the access point, each power variation being characterized by a grouping of one or more candidate sensing links that display a variation in received power compared to an average power of sensing transmissions of the respective candidate sensing links during one or more sampling instances of an analysis period; determining a plurality of data usage values corresponding to the plurality of candidate sensing links; identifying a sensing link set according to a sensing space coverage metric determined from the sensing sounding information and the plurality of data usage values, the sensing link set including a plurality of representative sensing links selected from the plurality of candidate sensing links; and establishing the plurality of representative sensing links between corresponding ones of the plurality of sensing capable devices and the access point.

Embodiment 57 is the system of embodiment 56, wherein: obtaining the sensing sounding information includes: establishing a plurality of candidate sensing links between the plurality of sensing capable devices and the access point, monitoring sensing transmissions transmitted via the plurality of candidate sensing links during the analysis period, and identifying the plurality of power variations based on the sensing transmissions.

Embodiment 58 is the system of any of embodiments 56 or 57, wherein: obtaining the sensing sounding information includes accessing previously stored sensing information, and the plurality of candidate sensing links include original sensing links of a previously established sensing link set and trimmed sensing links not included in the previously established sensing link set, each power variation having at least one original sensing link.

Embodiment 59 is the system of embodiment 58, wherein identifying the sensing link set includes: identifying a congested sensing link from among the original sensing links as having a corresponding data usage value from the plurality of data usage values exceeding a congestion threshold; identifying a power variation corresponding to the congested sensing link; identifying one or more trimmed sensing links belonging to the power variation; and selecting the representative sensing link for the power variation from among the congested sensing link and the one or more trimmed sensing links.

Embodiment 60 is the system of embodiment 59, wherein identifying the sensing link set further includes: identifying additional congested sensing links from among the original sensing links according to the plurality of data usage values; identifying additional power variations corresponding to the additional congested sensing links; identifying additional sets of one or more trimmed sensing links belonging to the additional power variations; and for each additional power variation, selecting a corresponding representative sensing link from among the corresponding additional congested sensing links and the corresponding additional set of one or more trimmed sensing links.

Embodiment 61 is the system of any of embodiments 59 or 60, wherein selecting the representative sensing link further includes: selecting the trimmed sensing link occurring in a largest number of a plurality of groupings characterizing the plurality of power variations as the representative sensing link.

Embodiment 62 is the system of any of embodiments 59-61, wherein selecting the representative sensing link further includes: selecting the trimmed sensing link having a lowest data usage value from the plurality of data usage values as the representative sensing link.

Embodiment 63 is the system of any of embodiments 59-62, wherein selecting the representative sensing link for the power variation from among the congested sensing link and the one or more trimmed sensing links is performed according to a switch factor defined for each of the congested sensing link and the one or more trimmed sensing links.

Embodiment 64 is the system of embodiment 63, wherein the switch factor is defined as a number of occurrences of a link in the groupings of the plurality of power variations divided by a data usage value corresponding to the link.

Embodiment 65 is the system of any of embodiments 63 or 64, wherein the power variation includes the congested sensing link and an uncongested trimmed sensing link and the representative sensing link is selected according to a highest switch factor among the congested sensing link and the uncongested trimmed sensing link.

Embodiment 66 is the system of any of embodiments 63-65, wherein the power variation includes the congested sensing link and a plurality of uncongested trimmed sensing links and the representative sensing link is selected according to a highest switch factor among the congested sensing link and the plurality of uncongested trimmed sensing links.

Embodiment 67 is the system of any of embodiments 56-66, wherein the representative sensing link is further selected among two uncongested trimmed sensing links having a same switch factor according to the uncongested trimmed sensing link having a lower link number.

Embodiment 68 is the system of any of embodiments 63-68, wherein the representative sensing link for the power variation is selected to balance link loads in the sensing link set.

Embodiment 69 is a method for Wi-Fi sensing carried out by a Wi-Fi system including a plurality of networking devices, the plurality of networking devices including a plurality of sensing capable devices and an access point, the method comprising: identifying a candidate set of the plurality of networking devices, the candidate set including a plurality of candidate devices capable of establishing transmission links with the access point; establishing a plurality of candidate sensing links between the plurality of candidate devices and the access point; obtaining a plurality of time-domain channel representation information (TD-CRI) profile sets corresponding to respective ones of the plurality of candidate sensing links; identifying a plurality of TD-CRI spans corresponding to respective ones of the plurality of candidate sensing links according to the plurality of TD-CRI profile sets; identifying a sensing link set according to the plurality of TD-CRI spans, the sensing link set including a plurality of selected sensing links selected from the plurality of candidate sensing links; and establishing the plurality of selected sensing links between selected devices of the candidate devices and the access point.

Embodiment 70 is the method of embodiment 69, wherein obtaining each TD-CRI profile of the plurality of TD-CRI profile sets for a candidate sensing link of the plurality of candidate sensing links includes: obtaining a plurality of TD-CRI measurements at a plurality of sampling instances in a filter window for each candidate sensing link; and applying an averaging filter to the plurality of TD-CRI measurements to obtain each TD-CRI profile.

Embodiment 71 is the method of embodiment 70, wherein the averaging filter includes at least one of: a low pass filter and an exponential moving average filter.

Embodiment 72 is the method of any of embodiments 70 or 71, further comprising removing a time shift from one or more of the plurality of TD-CRI measurements prior to applying the averaging filter.

Embodiment 73 is the method of any of embodiments 69-72, wherein the plurality of TD-CRI profile sets includes one TD-CRI profile set for each of the plurality of candidate sensing links obtained over an analysis period, wherein each TD-CRI profile set includes a plurality of TD-CRI profiles, each corresponding to a filter window in the analysis period.

Embodiment 74 is the method of embodiment 73, wherein each TD-CRI span of the plurality of TD-CRI spans corresponds to a TD-CRI profile set of the plurality of TD-CRI profile sets and is selected from a plurality of filter window TD-CRI spans, wherein the plurality of filter window TD-CRI spans correspond to the plurality of TD-CRI profiles of the TD-CRI profile set.

Embodiment 75 is the method of embodiment 74, wherein selecting the plurality of TD-CRI spans includes: determining each TD-CRI span as the maximum filter window TD-CRI span for each TD-CRI profile set.

Embodiment 76 is the method of any of embodiments 74-75, wherein selecting the plurality of TD-CRI spans includes: determining each TD-CRI span as an average of the plurality of filter window TD-CRI spans for each TD-CRI profile set.

Embodiment 77 is the method of any of embodiments 74-76, wherein each filter window TD-CRI span of the plurality of filter window TD-CRI spans is obtained from a corresponding TD-CRI profile, and obtaining the plurality of filter window TD-CRI spans includes: identifying effective time domain pulses in the corresponding TD-CRI profile as time domain pulses having an amplitude surpassing an amplitude threshold; identifying a first index of a first effective time domain pulse having a lowest time delay of the effective time domain pulses in the corresponding TD-CRI profile; identifying a last index of a last effective time domain pulse having a greatest time delay of the effective time domain pulses in the corresponding TD-CRI profile; and defining each filter window TD-CRI span as the last index minus the first index for the corresponding TD-CRI profile.

Embodiment 78 is the method of embodiment 77, wherein the amplitude threshold is determined for each TD-CRI profile as a percentage of a maximum amplitude of time domain pulses in the TD-CRI profile.

Embodiment 79 is the method of any of embodiments 69-78, wherein identifying a sensing link set according to the plurality of TD-CRI spans includes: identifying a plurality of power variations, each power variation being characterized by a grouping of one or more candidate sensing links that display a variation in received power compared to an average power of sensing transmissions of the respective candidate sensing links for one or more sampling instances during an analysis period; determining a power variation test set including a subset of power variations selected from the plurality of power variations; and selecting, for each power variation of the power variation test set, for inclusion in the sensing link set, a selected candidate sensing link from the grouping of the test power variation according to the candidate sensing link having a largest TD-CRI span.

Embodiment 80 is a system for Wi-Fi sensing comprising a plurality of networking devices, the plurality of networking devices including a plurality of sensing capable devices and an access point, the system being configured for: identifying a candidate set of the plurality of networking devices, the candidate set including a plurality of candidate devices capable of establishing transmission links with the access point; establishing a plurality of candidate sensing links between the plurality of candidate devices and the access point; obtaining a plurality of time-domain channel representation information (TD-CRI) profile sets corresponding to respective ones of the plurality of candidate sensing links; identifying a plurality of TD-CRI spans corresponding to respective ones of the plurality of candidate sensing links according to the plurality of TD-CRI profile sets; identifying a sensing link set according to the plurality of TD-CRI spans, the sensing link set including a plurality of selected sensing links selected from the plurality of candidate sensing links; and establishing the plurality of selected sensing links between selected devices of the candidate devices and the access point.

Embodiment 81 is the system of embodiment 80, wherein obtaining each TD-CRI profile of the plurality of TD-CRI profile sets for a candidate sensing link of the plurality of candidate sensing links includes: obtaining a plurality of TD-CRI measurements at a plurality of sampling instances in a filter window for each candidate sensing link; and applying an averaging filter to the plurality of TD-CRI measurements to obtain each TD-CRI profile.

Embodiment 82 is the system of embodiment 81, wherein the averaging filter includes at least one of: a low pass filter and an exponential moving average filter.

Embodiment 83 is the system of any of embodiments 81 or 82, wherein the system is further configured for removing a time shift from one or more of the plurality of TD-CRI measurements prior to applying the averaging filter.

Embodiment 84 is the system of any of embodiments 80-83, wherein the plurality of TD-CRI profile sets includes one TD-CRI profile set for each of the plurality of candidate sensing links obtained over an analysis period, wherein each TD-CRI profile set includes a plurality of TD-CRI profiles, each corresponding to a filter window in the analysis period.

Embodiment 85 is the system of embodiment 84, wherein each TD-CRI span of the plurality of TD-CRI spans corresponds to a TD-CRI profile set of the plurality of TD-CRI profile sets and is selected from a plurality of filter window TD-CRI spans, wherein the plurality of filter window TD-CRI spans correspond to the plurality of TD-CRI profiles of the TD-CRI profile set.

Embodiment 86 is the system of embodiment 85, wherein selecting the plurality of TD-CRI spans includes: determining each TD-CRI span as the maximum filter window TD-CRI span for each TD-CRI profile set.

Embodiment 87 is the system of any of embodiments 85 or 86, wherein selecting the plurality of TD-CRI spans includes: determining each TD-CRI span as an average of the plurality of filter window TD-CRI spans for each TD-CRI profile set.

Embodiment 88 is the system of any of embodiments 85-87, wherein each filter window TD-CRI span of the plurality of filter window TD-CRI spans is obtained from a corresponding TD-CRI profile, and obtaining the plurality of filter window TD-CRI spans includes: identifying effective time domain pulses in the corresponding TD-CRI profile as time domain pulses having an amplitude surpassing an amplitude threshold; identifying a first index of a first effective time domain pulse having a lowest time delay of the effective time domain pulses in the corresponding TD-CRI profile; identifying a last index of a last effective time domain pulse having a greatest time delay of the effective time domain pulses in the corresponding TD-CRI profile; and defining each filter window TD-CRI span as the last index minus the first index for the corresponding TD-CRI profile.

Embodiment 89 is the system of embodiment 88, wherein the amplitude threshold is determined for each TD-CRI profile as a percentage of a maximum amplitude of time domain pulses in the TD-CRI profile.

Embodiment 90 is the system of any of embodiments 80-89, wherein identifying a sensing link set according to the plurality of TD-CRI spans includes: identifying a plurality of power variations, each power variation being characterized by a grouping of one or more candidate sensing links that display a variation in received power compared to an average power of sensing transmissions of the respective candidate sensing links for one or more sampling instances during an analysis period; determining a power variation test set including a subset of power variations selected from the plurality of power variations; and selecting, for each power variation of the power variation test set, for inclusion in the sensing link set, a selected candidate sensing link from the grouping of the test power variation according to the candidate sensing link having a largest TD-CRI span.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

1. A method for Wi-Fi sensing carried out by an access point in a Wi-Fi system including a plurality of networking devices, the plurality of networking devices including a plurality of sensing capable devices and the access point, the method comprising:
identifying a candidate set of the plurality of networking devices, the candidate set including a plurality of candidate devices capable of establishing transmission links with the access point;
establishing a plurality of candidate sensing links between the plurality of candidate devices and the access point;
monitoring sensing transmissions transmitted via the plurality of candidate sensing links;
identifying a sensing link set according to the sensing transmissions, the sensing link set including a plurality of selected sensing links selected from the plurality of candidate sensing links; and
establishing the plurality of selected sensing links between selected devices of the plurality of candidate devices and the access point.

2. (canceled)

3. The method of claim 1, wherein monitoring the sensing transmissions includes identifying a plurality of power variations, each power variation being characterized by a grouping of one or more candidate sensing links that display a variation in received power compared to an average power of the sensing transmissions of the respective candidate sensing links for one or more sampling instances during the analysis period.

4. The method of claim 3, wherein identifying the sensing link set includes identifying the plurality of sensing links according to a sensing space coverage metric.

5. The method of claim 4, wherein identifying the plurality of sensing links according to the sensing space coverage metric includes:
determining a power variation test set including a subset of power variations selected from the plurality of power variations for analysis by the sensing space coverage metric;
determining a power ratio parameter for a test power variation of the power variation test set;
comparing the power ratio parameter to a ratio threshold factor; and
selecting, responsive to the power ratio parameter exceeding the ratio threshold factor, for inclusion in the sensing link set, a selected candidate sensing link from the grouping of the test power variation according to the candidate sensing link occurring in a largest number of groupings of the plurality of power variations.

6-22. (canceled)

23. A method for Wi-Fi sensing carried out by an access point in a Wi-Fi system including a plurality of networking devices, the plurality of networking devices including a plurality of sensing capable devices and the access point, the method comprising:
maintaining a plurality of selected sensing links as a sensing link set between selected devices of the plurality of sensing capable devices and the access point;
identifying a plurality of candidate links as a candidate link set between unselected devices of the plurality of sensing capable devices and the access point;
identifying a plurality of assessment links as an assessment link set from the candidate link set and the sensing link set,
determining an allocation of channel resources for the plurality of assessment links;
establishing the plurality of assessment links according to the allocation;
monitoring sensing transmissions on the plurality of assessment links during an analysis period;
identifying an updated sensing link set according to the sensing transmissions, the updated sensing link set including a plurality of updated sensing links selected from the plurality of assessment links according to a sensing space coverage metric;
establishing the updated sensing link set.

24-42. (canceled)

43. A method for Wi-Fi sensing carried out by an access point in a Wi-Fi system including a plurality of networking devices, the plurality of networking devices including a plurality of sensing capable devices and the access point, the method comprising:
obtaining sensing sounding information, the sensing sounding information including information about a plurality of power variations among a plurality of candidate sensing links between the plurality of sensing capable devices and the access point, each power variation being characterized by a grouping of one or more candidate sensing links that display a variation in received power compared to an average power of sensing transmissions of the respective candidate sensing links during one or more sampling instances of an analysis period;
determining a plurality of data usage values corresponding to the plurality of candidate sensing links;
identifying a sensing link set according to a sensing space coverage metric determined from the sensing sounding information and the plurality of data usage values, the sensing link set including a plurality of representative sensing links selected from the plurality of candidate sensing links; and
establishing the plurality of representative sensing links between corresponding ones of the plurality of sensing capable devices and the access point.

44. (canceled)

45. The method of claim 43, wherein:
obtaining the sensing sounding information includes accessing previously stored sensing information, and
the plurality of candidate sensing links include original sensing links of a previously established sensing link set and trimmed sensing links not included in the previously established sensing link set, each power variation having at least one original sensing link.

46. The method of claim 45, wherein identifying the sensing link set includes:
identifying a congested sensing link from among the original sensing links as having a corresponding data usage value from the plurality of data usage values exceeding a congestion threshold;
identifying a power variation corresponding to the congested sensing link;
identifying one or more trimmed sensing links belonging to the power variation; and
selecting the representative sensing link for the power variation from among the congested sensing link and the one or more trimmed sensing links.

47-68. (canceled)

69. A method for Wi-Fi sensing carried out by an access point in a Wi-Fi system including a plurality of networking devices, the plurality of networking devices including a plurality of sensing capable devices and the access point, the method comprising:
identifying a candidate set of the plurality of networking devices, the candidate set including a plurality of candidate devices capable of establishing transmission links with the access point;
establishing a plurality of candidate sensing links between the plurality of candidate devices and the access point;
obtaining a plurality of time-domain channel representation information (TD-CRI) profile sets corresponding to respective ones of the plurality of candidate sensing links;
identifying a plurality of TD-CRI spans corresponding to respective ones of the plurality of candidate sensing links according to the plurality of TD-CRI profile sets;
identifying a sensing link set according to the plurality of TD-CRI spans, the sensing link set including a plurality of selected sensing links selected from the plurality of candidate sensing links; and
establishing the plurality of selected sensing links between selected devices of the candidate devices and the access point.

70-78. (canceled)

79. The method of claim 69, wherein identifying a sensing link set according to the plurality of TD-CRI spans includes:
identifying a plurality of power variations, each power variation being characterized by a grouping of one or more candidate sensing links that display a variation in received power compared to an average power of sensing transmissions of the respective candidate sensing links for one or more sampling instances during an analysis period;
determining a power variation test set including a subset of power variations selected from the plurality of power variations; and
selecting, for each power variation of the power variation test set, for inclusion in the sensing link set, a selected candidate sensing link from the grouping of the test power variation according to the candidate sensing link having a largest TD-CRI span.

80-90. (canceled)
